(19) United States
(12) Patent Application Publication
(10) Pub. No.: US 2024/0316779 A1
(43) Pub. Date: Sep. 26, 2024

(54) ROBOTIC SYSTEM WITH OBJECT HANDLING MECHANISM FOR LOADING AND UNLOADING OF CARGO CARRIERS

(71) Applicant: MUJIN, Inc., Tokyo (JP)

(72) Inventors: Yoshiki Kanemoto, Tokyo (JP); Shintaro Matsuoka, Tokyo (JP); Jose Jeronimo Moreira Rodrigues, Tokyo (JP); Kentaro Wada, Tokyo (JP); Rosen Nikolaev Diankov, Tokyo (JP); Puttichai Lertkultanon, Tokyo (JP); Lei Lei, Guangzhao (CN); Yixuan Zhang, Guangzhao (CN); Xutao Ye, Guangzhao (CN); Yufan Du, Guangzhao (CN); Mingjian Liang, Guangzhao (CN); Lingping Gao, Guangzhao (CN); Xinhao Wen, Guangzhao (CN); Xu Chen, Guangzhao (CN)

(21) Appl. No.: 18/607,407

(22) Filed: Mar. 15, 2024

Related U.S. Application Data
(60) Provisional application No. 63/453,167, filed on Mar. 20, 2023.

(51) Int. Cl. B25J 9/16; B25J 9/00; B65G 67/08; B65G 67/20; B65G 67/24

(52) U.S. Cl. CPC B25J 9/1687; B25J 9/0093; B25J 9/1612; B25J 9/1697; B65G 67/08; B65G 67/20; B65G 67/24

(57) ABSTRACT

A robotic system may include a chassis operatively coupled to a proximal conveyor, a first segment including a first segment conveyor extending along a length of the first segment, and a gripper including a distal conveyor extending along a length of the gripper. The robotic system may further include a controller configured to operate the chassis, the conveyors, the segments, the gripper, or a combination thereof to remove and transfer objects away from a cargo loading structure, such as a cargo container.

### CROSS-REFERENCE TO RELATED APPLICATION

The present application claims the benefit of U.S. Provisional Patent Application No. 64/453,167, filed Mar. 20, 2023, the entirety of which is incorporated herein by reference.

### TECHNICAL FIELD

The present disclosure is generally related to robotic systems and, more specifically, to systems, processes, and techniques for object handling mechanisms. Embodiments herein may relate to robotic systems for loading and/or unloading cargo carriers (e.g., shipping containers, trailers, box trucks, etc.).

### BACKGROUND

With their ever-increasing performance and lowering cost, many robots (e.g., machines configured to automatically/autonomously execute physical actions) are now extensively used in various different fields. Robots, for example, can be used to execute various tasks (e.g., manipulate or transfer an object through space) in manufacturing and/or assembly, packing and/or packaging, transport and/or shipping, etc. In executing the tasks, the robots can replicate human actions, thereby replacing or reducing human involvements that are otherwise required to perform dangerous or repetitive tasks.

However, despite the technological advancements, robots often lack the sophistication necessary to duplicate human interactions required for executing larger and/or more complex tasks, such as for transferring objects to/from cargo carriers. Accordingly, there remains a need for improved techniques and systems for managing operations and/or interactions between robots.

### BRIEF DESCRIPTION OF THE DRAWINGS

Detailed descriptions of implementations of the present technology will be described and explained through the use of the accompanying drawings.

FIG. 1 illustrates an example environment in which a robotic system with a coordinated transfer mechanism may operate.

FIG. 2 is a block diagram illustrating the robotic system in accordance with one or more embodiments.

FIG. 3 is a perspective view of a robotic system in accordance with embodiments of the present technology.

FIG. 4 is an enlarged side view of the robotic system of FIG. 3 illustrating actuation of supporting legs in accordance with embodiments of the present technology.

FIG. 5 is a side view of the robotic system of FIG. 3 illustrating vertical actuation of a segment in accordance with embodiments of the present technology.

FIG. 6 is a top view of the robotic system of FIG. 3 illustrating horizontal actuation the segment in accordance with embodiments of the present technology.

FIGS. 7A and 7B are side views of the robotic system of FIG. 3 illustrating vertical actuation of the segment relative to a cargo carrier in accordance with embodiments of the present technology.

FIG. 8 is a side schematic of a robotic system in accordance with one or more embodiments.

FIG. 9 is a top schematic of the robotic system of FIG. 8 in a first state.

FIG. 10 is a top schematic of the robotic system of FIG. 8 in a second state.

FIG. 11 is a schematic illustrating a robotic system positioned inside of a cargo carrier in accordance with one or more embodiments.

FIG. 12A illustrates a robotic system in a first state of a process of unloading a cargo carrier in accordance with one or more embodiments.

FIGS. 12B and 12C illustrate the robotic system of FIG. 12A in a second state of a process of unloading a cargo carrier in accordance with one or more embodiments.

FIG. 12D illustrates a perspective view the robotic system of FIG. 12A in the second state of the process of unloading a cargo carrier in accordance with one or more embodiments.

FIG. 12E illustrates the robotic system of FIG. 12A in a third state of a process of unloading a cargo carrier in accordance with one or more embodiments.

FIG. 12F illustrates the robotic system of FIG. 12A in a fourth state of a process of unloading a cargo carrier in accordance with one or more embodiments.

FIG. 13 is a flow diagram illustrating a process of operating a robotic system in accordance with one or more embodiments.

FIG. 14 is a flow diagram illustrating a process of operating a robotic system in accordance with one or more embodiments.

FIG. 15 is a side schematic of a gripper for a robotic system in accordance with one or more embodiments.

FIG. 16 is a top schematic of the gripper of FIG. 15.

FIG. 17A is a schematic illustrating a first state of a process of operating a robotic system in accordance with one or more embodiments.

FIG. 17B is a schematic illustrating a second state of a process of operating a robotic system in accordance with one or more embodiments.

FIG. 17C is a schematic illustrating a third state of a process of operating a robotic system in accordance with one or more embodiments.

FIG. 17D is a schematic illustrating a fourth state of a process of operating a robotic system in accordance with one or more embodiments.

FIG. 17E is a schematic illustrating a fifth state of a process of operating a robotic system in accordance with one or more embodiments.

FIG. 17F is a schematic illustrating a sixth state of a process of operating a robotic system in accordance with one or more embodiments.

FIG. 18 is a flow diagram illustrating a process of operating a robotic system in accordance with one or more embodiments.

FIG. 19 is a perspective view of a robotic system in accordance with embodiments of the present technology.

FIG. 20 is an enlarged side view of the robotic system of FIG. 19 in accordance with embodiments of the present technology.

FIG. 21 is a perspective view of the robotic system of FIG. 19 on a warehouse floor in accordance with embodiments of the present technology.

FIGS. 22 and 23 are enlarged side views of the robotic system of FIG. 19 illustrating actuation of supporting legs in accordance with embodiments of the present technology.

FIG. 24 is an enlarged perspective view of front wheels of the robotic system of FIG. 19 in accordance with embodiments of the present technology.

FIG. 25 is an enlarged perspective view of a rear supporting leg of the robotic system of FIG. 19 in accordance with embodiments of the present technology.

FIG. 26 is a perspective view of a chassis joint for a robotic system in accordance with one or more embodiments.

FIG. 27 is a flow diagram illustrating a process of operating a robotic system in accordance with one or more embodiments.

FIG. 28 is a front view of a robotic system and chassis joint in a first state in accordance with one or more embodiments.

FIG. 29 is a front view of the robotic system and chassis joint of FIG. 28 in a second state.

FIG. 30 is a flow diagram illustrating a process of operating a robotic system in accordance with one or more embodiments.

FIG. 31 is a partially schematic isometric view of a robotic system configured in accordance with some embodiments of the present technology.

FIGS. 32A and 32B are partially schematic upper and lower side views of an end effector configured in accordance with some embodiments of the present technology.

FIGS. 33A-33F are partially schematic side views of an end effector of the type illustrated in FIG. 32A at various stages of a process for picking up a target object in accordance with some embodiments of the present technology.

FIG. 34 is a partially schematic upper-side view of an end effector configured in accordance with some embodiments of the present technology.

FIG. 35 is a partially schematic side view of a gripping component for an end effector configured in accordance with some embodiments of the present technology.

FIGS. 36A-36E are partially schematic side views of an end effector of the type illustrated in FIG. 34 at various stages of a process for picking up a target object in accordance with some embodiments of the present technology.

FIG. 37 is a flow diagram of a process for picking up a target object in accordance with some embodiments of the present technology.

FIGS. 38A and 38B are partially schematic upper-side views illustrating additional features at a distal region of an end effector configured in accordance with some embodiments of the present technology.

FIGS. 39A and 39B are partially schematic top and upper-side views, respectively, of an end effector configured in accordance with some embodiments of the present technology.

FIG. 40 is a partially schematic upper-side view of a distal joint for a robotic system configured in accordance with some embodiments of the present technology.

FIG. 41 is a partially schematic bottom view of a distal joint for a robotic system configured in accordance with some embodiments of the present technology.

FIGS. 42A and 42B are partially schematic side views of a distal joint for a robotic system configured in accordance with some embodiments of the present technology.

FIGS. 43A-43C are partially schematic top views of a distal joint for a robotic system configured in accordance with some embodiments of the present technology.

FIG. 43D is a partially schematic bottom view of a distal joint for a robotic system configured in accordance with some embodiments of the present technology.

FIGS. 44A-44C are partially schematic side views of a distal joint of the type illustrated in FIGS. 43A-43C configured in accordance with some embodiments of the present technology.

FIG. 45 is a partially schematic upper-side view of connection management features within a distal joint of the type illustrated in FIG. 40 in accordance with some embodiments of the present technology.

FIG. 46 is a partially schematic cross-sectional view of connection management features of the type illustrated in FIG. 45 in accordance with some embodiments of the present technology.

FIG. 47 is a partially schematic isometric view of a drive component for a gripping component configured in accordance with some embodiments of the present technology.

FIG. 48 is a partially schematic isometric view of a branching component of a drive component configured in accordance with some embodiments of the present technology.

FIG. 49 is a partially schematic isometric view illustrating additional details on a drive component for a gripping component in accordance with some embodiments of the present technology.

FIG. 50 shows various images illustrating vision processing of an arrangement of objects in accordance with one or more embodiments.

FIG. 51 shows various images illustrating vision processing of unrecognized objects after removal of an object in accordance with one or more embodiments.

FIG. 52 shows various images illustrating vision processing of verifying unrecognized objects in accordance with one or more embodiments.

FIG. 53 shows various images illustrating target selection for unrecognized objects in accordance with one or more embodiments.

FIGS. 54A-B show images illustrating grasp computation for rotated objects in accordance with one or more embodiments.

FIG. 55 is a top view of an environment for illustrating alignment of rotated unrecognized objects in accordance with one or more embodiments.

FIG. 56 is a top view of an environment for illustrating a grasp computation for objects in accordance with one or more embodiments.

FIG. 57 is a flow diagram of a method for picking up objects in accordance with some embodiments of the present technology.

FIGS. 58A-E are example illustrations of support detection processes for unrecognized objects in accordance with one or more embodiments.

FIG. 59 is a flow diagram of a method for detecting new objects from unrecognized regions in accordance with some embodiments of the present technology.

FIGS. 60A-D are example illustrations of target object selection rules in accordance with one or more embodiments of the present technology.

FIG. 61 is a flow diagram of a method for evaluating selection criteria for picking up objects in accordance with some embodiments of the present technology.

FIG. 62 is a front view of an environment for illustrating a support grasp computation for unrecognized objects in accordance with one or more embodiments.

FIG. 63 is a flow diagram of a method for deriving stable grip poses for transporting objects in accordance with some embodiments of the present technology.

FIGS. 64A-B are example illustrations of support target validation for object transfer processes in accordance with one or more embodiments.

FIG. 65 is a flow diagram of a method for validating spatial conditions for picking up objects in accordance with some embodiments of the present technology.

FIG. 66 is a flow diagram of a method for monitoring real-time performance for picking up objects in accordance with some embodiments of the present technology.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology includes methods, apparatuses, and systems for robotic handling of objects. Specifically, according to some embodiments herein, the disclosed technology includes methods, apparatuses, and systems for robotic loading and unloading of cargo carriers, including, but not limited to, shipping containers, trailers, cargo beds, and box trucks. Conventional processes for loading and unloading cargo carriers are highly labor intensive. Typically, cargo carriers are loaded or unloaded via manual labor by hand or with human-operated tools (e.g., pallet jacks). This process is therefore time-consuming and expensive, and such processes require repetitive, physically strenuous work. Previous attempts to automate portions of a load or unload process have certain detriments that prevent widespread adoption.

Many existing robotic systems are unable to compensate for variability in packing pattern and object size within a cargo carrier, such as for handling mixed stock keeping units (SKUs). For example, cargo carriers packed with irregularly sized boxes often cannot be removed automatically (i.e., without human input/effort) in a regular or repeating pattern. Introduced here are robotic systems to that are configured automatically/autonomously unload/load cargo carriers packed with irregularly sized and oriented objects, such as mixed SKU boxes. As discussed further herein, a robotic system may employ a vision system to reliably recognize irregularly sized objects and control an end of arm tool (EOAT) including a gripper based on that recognition.

Further, many existing robotic systems require replacement or adjustment of existing infrastructure in a load/unload area of a warehouse or other distribution center (e.g., truck bay, etc.). In many cases, existing warehouses have conveyor systems for moving objects through the warehouse. Typically, objects are removed from such a conveyor and placed into a cargo carrier manually to load the cargo carrier. Conversely, objects may be manually placed on the conveyor after being manually removed from a cargo carrier to unload the cargo carrier. Conventional automatic devanning/loading solutions often require adjustments to the existing warehouse systems (e.g., conveyors) for the corresponding interface. Accordingly, there is existing infrastructure in warehouses or other distribution centers but with a gap between a cargo carrier and that infrastructure that is currently filled by manual labor or requires physical adjustments. Existing robotic systems may require replacement or removal of such pre-existing infrastructure, increasing costs and time to implement the robotic system. As discussed further herein, a robotic system may include a chassis configured to integrate with existing infrastructure in a warehouse or other distribution center. In this manner, robotic systems according to embodiments herein may be retrofit to existing infrastructure in a warehouse or distribution center, in some embodiments.

In some embodiments, a robotic system may be configured to load or unload a cargo carrier automatically or semi-automatically. In some embodiments, a robotic system may employ computer vision and other sensors to control actions of various components of the robotic system. In some embodiments, a robotic system may include a gripper including at least one suction cup and at least one conveyor. The at least one suction cup may be configured to grasp an object when a vacuum is applied to the at least one suction cup, and the conveyor may be configured to move the object in a proximal direction after being grasped by the at least one suction cup. The robotic system may also include one or more sensors configured to obtain information (e.g., two-dimensional (2D) and/or three-dimensional (3D) image data) including a plurality of objects stored within a cargo carrier (e.g., within a coronal and/or frontal plane of the cargo carrier). For example, the sensor can include (1) one or more cameras configured to obtain visual spectrum image(s) of one or more of the objects in the cargo container, (2) one or more distance sensors (e.g., light detecting and ranging (lidar) sensors) configured to measure distances from the one or more distance sensors to the plurality of objects, or a combination thereof.

Many conventional approaches for computer vision are computationally intensive and subject to error in dynamic, variable environments. For example, in the case of boxes, boxes may have different colors, labels, orientations, sizes, etc., which may make it difficult to reliably identify the boundaries of the boxes within a cargo container with computer vision alone. Accordingly, in some embodiments a robotic system may include a local controller configured to receive both image information and information from one or more distance sensors to more consistently identify objects within a cargo carrier for removal by the robotic system in a less computationally intensive manner. The local controller may include one or more processors and memory. The local controller may receive image information from at least one vision sensor that images a plurality of objects. The local controller may identify, based on the image, a minimum viable region (MVR) corresponding to a first object of the plurality of objects. The MVR may be a region of image corresponding to a high confidence of being a single object. Stated differently, when the region in the image is not sufficiently matched with a known object in master data, the MVR can represent a portion within the unrecognized image region (1) having sufficient likelihood (e.g., according to a predetermined threshold) of belonging to a single object and/or (2) corresponding to a smallest operable or graspable area. In some cases, an MVR may be assigned based on known smallest dimensions of objects within the cargo carrier. In other embodiments, the MVR may be assigned by one or more computer vision algorithms with a margin of error. The MVR may be smaller than the size of an object in the plurality of objects. After assigning the MVR, the controller may command the gripper to grasp an unrecognized object using the corresponding MVR, for example, by applying a vacuum to at least one suction cup to contact and grip at the MVR. The controller may further command the gripper to lift the first object after it is grasped, thereby creating a gap or a separation between the grasped object and an underlying object. The controller may then receive from the one or more sensors (e.g., sensors at the EOAT) depicting a region below the MVR. Based on these sensor outputs, the controller may identify a bottom boundary of the lifted object. In a similar manner, the controller may also obtain a plurality of distance measurements in a horizontal direction. Based on these sensor outputs, a side boundary of the object may be identified. The controller can update the dimensions (e.g., width and height) and/or actual edges of the previously unrecognized object using the identified boundaries, and the object may be removed from the plurality of objects. The controller may then subtract the MVR and/or the area defined by the updated edges from the previously obtained image (e.g., from a different system imager) and proceed to operate on a different/new target based on the remaining image. In this manner, operation of the robotic system may be based on capturing a single image from a first sensor of all objects to be removed, and operation may continue by subtracting regions from the original image without capturing and processing a new image for each removed object. Such an arrangement may be particularly effective in instances where objects are arranged in multiple vertical layers, as the objects behind previously removed objects may not be falsely identified as being next for removal.

Systems and methods for a robotic system with a coordinated transfer mechanism are described herein. The robotic system (e.g., an integrated system of devices that each execute one or more designated tasks) configured in accordance with some embodiments autonomously executes integrated tasks by coordinating operations of multiple units (e.g., robots).

Several details describing structures or processes that are well-known and often associated with robotic systems and subsystems, but that can unnecessarily obscure some significant aspects of the disclosed techniques, are not set forth in the following description for purposes of clarity. Moreover, although the following disclosure sets forth several embodiments of different aspects of the present technology, several other embodiments can have different configurations or different components than those described in this section. Accordingly, the disclosed techniques can have other embodiments with additional elements or without several of the elements described below.

### Terminology

Many embodiments or aspects of the present disclosure described below can take the form of computer- or controller-executable instructions, including routines executed by a programmable computer or controller. Those skilled in the relevant art will appreciate that the disclosed techniques can be practiced on computer or controller systems other than those shown and described below. The techniques described herein can be embodied in a special-purpose computer or data processor that is specifically programmed, configured, or constructed to execute one or more of the computer-executable instructions described below. Accordingly, the terms “computer” and “controller” as generally used herein refer to any data processor and can include Internet appliances and handheld devices (including palm-top computers, wearable computers, cellular or mobile phones, multi-processor systems, processor-based or programmable consumer electronics, network computers, mini computers, and the like). Information handled by these computers and controllers can be presented at any suitable display medium, including a liquid crystal display (LCD). Instructions for executing computer- or controller-executable tasks can be stored in or on any suitable computer-readable medium, including hardware, firmware, or a combination of hardware and firmware. Instructions can be contained in any suitable memory device, including, for example, a flash drive, USB device, and/or other suitable medium.

In the following, numerous specific details are set forth to provide a thorough understanding of the presently disclosed technology. In other embodiments, the techniques introduced here can be practiced without these specific details. In other instances, well-known features, such as specific functions or routines, are not described in detail in order to avoid unnecessarily obscuring the present disclosure. References in this description to “an embodiment,” “one embodiment,” or the like mean that a particular feature, structure, material, or characteristic being described is included in at least one embodiment of the present disclosure. Thus, the appearances of such phrases in this specification do not necessarily all refer to the same embodiment. On the other hand, such references are not necessarily mutually exclusive either. Furthermore, the particular features, structures, materials, or characteristics can be combined in any suitable manner in one or more embodiments. It is to be understood that the various embodiments shown in the figures are merely illustrative representations and are not necessarily drawn to scale.

References in the present disclosure to “an embodiment” or “some embodiments” mean that the feature, function, structure, or characteristic being described is included in at least one embodiment. Occurrences of such phrases do not necessarily refer to the same embodiment, nor are they necessarily referring to alternative embodiments that are mutually exclusive of one another.

Unless the context clearly requires otherwise, the terms “comprise,” “comprising,” and “comprised of” are to be construed in an inclusive sense rather than an exclusive or exhaustive sense. That is, in the sense of “including but not limited to.” The term “based on” is also to be construed in an inclusive sense. Thus, the term “based on” is intended to mean “based at least in part on.”

The terms “coupled” and “connected,” along with their derivatives, can be used herein to describe structural relationships between components. It should be understood that these terms are not intended as synonyms for each other. Rather, in particular embodiments, “connected” can be used to indicate that two or more elements are in direct contact with each other. Unless otherwise made apparent in the context, the term “coupled” can be used to indicate that two or more elements are in either direct or indirect (with other intervening elements between them) contact with each other, or that the two or more elements co-operate or interact with each other (e.g., as in a cause-and-effect relationship, such as for signal transmission/reception or for function calls), or both.

The term “module” may refer broadly to software, firmware, hardware, or combinations thereof. Modules are typically functional components that generate one or more outputs based on one or more inputs. A computer program may include or utilize one or more modules. For example, a computer program may utilize multiple modules that are responsible for completing different tasks, or a computer program may utilize a single module that is responsible for completing all tasks.

When used in reference to a list of multiple items, the word “or” is intended to cover all of the following interpretations: any of the items in the list, all of the items in the list, and any combination of items in the list.

Embodiments of the present disclosure are described thoroughly herein with reference to the accompanying drawings. Like numerals represent like elements throughout the several figures, and in which example embodiments are shown. However, embodiments of the claims can be embodied in many different forms and should not be construed as limited to the embodiments set forth herein. The examples set forth herein are non-limiting examples and are merely examples, among other possible examples.

Throughout this specification, plural instances (e.g., “610”) can implement components, operations, or structures (e.g., “610a”) described as a single instance. Further, plural instances (e.g., “610”) refer collectively to a set of components, operations, or structures (e.g., “610a”) described as a single instance. The description of a single component (e.g., “610a”) applies equally to a like-numbered component (e.g., “610b”) unless indicated otherwise. These and other aspects, features, and implementations can be expressed as methods, apparatuses, systems, components, program products, means or steps for performing a function, and in other ways. These and other aspects, features, and implementations will become apparent from the following descriptions, including the claims.

For ease of reference, the robotic system and components thereof are sometimes described herein with reference to top and bottom, upper and lower, upwards and downwards, and/or horizontal plane, x-y plane, vertical, or z-direction relative to the spatial orientation of the embodiments shown in the figures. It is to be understood, however, that the robotic system and components thereof can be moved to, and used in, different spatial orientations without changing the structure and/or function of the disclosed embodiments of the present technology.

Further, embodiments herein may refer to various translational and rotational degrees of freedom. “Translation” may refer to linear change of position along an axis. “Rotation” may refer to an angular change of orientation along an axis. A “pose” may refer to a combination of position and orientation in a reference frame. Degrees of freedom as described herein may be with reference to various reference frames, including global reference frames (e.g., with reference to a gravitational direction) or local reference frames (e.g., with reference to a local direction or dimension, such as a longitudinal dimension, with reference to a cargo carrier, with reference to a vertical plane of object within a cargo carrier, or with reference to a local environment of the robotic system). Rotational degrees of freedom may be referred to as “roll”, “pitch”, and “yaw”, which may be based on a local reference frame such as with respect to a longitudinal and/or transverse plane of various components of the robotic unit (e.g., longitudinal and/or transverse plane of the chassis). For example, “roll” may refer to rotational about a longitudinal axis that is at least generally parallel to a longitudinal plane of the chassis, “pitch” may refer to rotation about a transverse axis perpendicular to the longitudinal axis that is at least generally parallel to a transverse plane of the chassis, and “yaw” may refer to rotation about a second transverse axis perpendicular to both the longitudinal axis and the transverse axis and/or perpendicular to both the longitudinal plane and the transverse plane of the chassis and/or gripper. In some embodiments, a longitudinal axis may be aligned with proximal and distal directions. In some cases, “proximal” may refer to direction away from a cargo carrier, and “distal” may refer to a direction toward a cargo carrier.

### Overview of an Example Robotic System

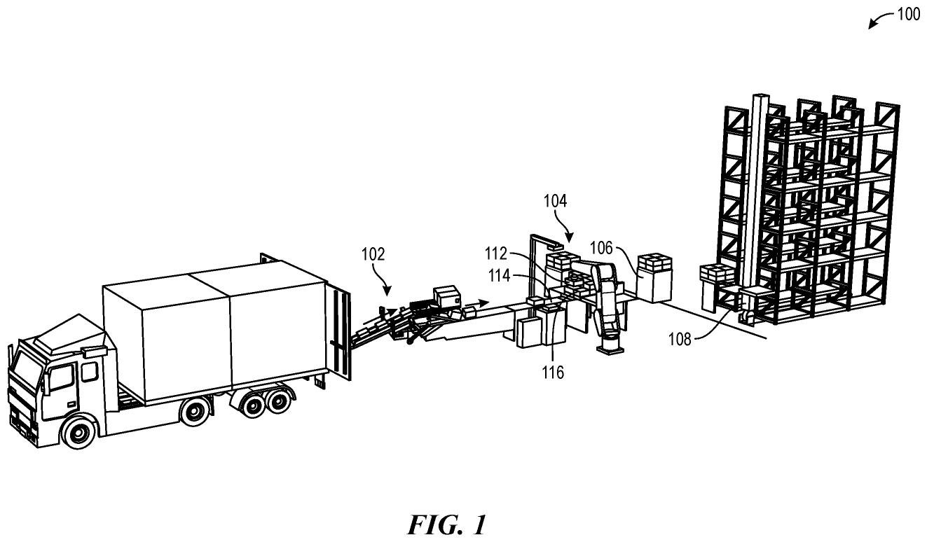

FIG. 1 illustrates an example environment in which a robotic system 100 with a coordinated transfer mechanism may operate. The robotic system 100 can include and/or communicate with one or more units (e.g., robots) configured to execute one or more tasks. Aspects of the coordinated transfer mechanism can be practiced or implemented by the various units.

For the example illustrated in FIG. 1, the robotic system 100 can include an endpoint unit 102, such as a truck loader/unloader, a transfer unit 104 (e.g., a palletizing robot and/or a piece-picker robot), a transport unit 106, a storage interfacing unit 108, or a combination thereof in a warehouse or a distribution/shipping hub. Each of the units in the robotic system 100 can be configured to execute one or more tasks. The tasks can be combined in sequence to perform an operation that achieves a goal, such as to unload objects from a cargo carrier (e.g., a truck, a cargo container, or a van) and store them in a warehouse or to unload objects from storage locations and prepare them (e.g., by loading into the carrier) for shipping. In some embodiments, the task can include placing the objects on a target location (e.g., on top of a conveyor and/or inside the cargo carrier). As described in detail below, the robotic system 100 can derive individual placement locations/orientations, calculate corresponding motion plans, or a combination thereof for loading and/or unloading the objects. Each of the units can be configured to execute a sequence of actions (e.g., operating one or more components therein) to execute a task.

In some embodiments, the task can include manipulation (e.g., moving and/or reorienting) of a target object 112 (e.g., one of the packages, boxes, cases, cages, pallets, etc. corresponding to the executing task) from a start/source location 114 to a task/destination location 116. For example, the endpoint unit 102 (e.g., a devanning robot) can be configured to transfer the target object 112 from a location in a carrier (e.g., a truck) to a location on a conveyor. Also, the transfer unit 104 can be configured to transfer the target object 112 from one location (e.g., the conveyor, a pallet, or a bin) to another location (e.g., a pallet, a bin, etc.). For another example, the transfer unit 104 (e.g., a palletizing robot) can be configured to transfer the target object 112 from a source location (e.g., a pallet, a pickup area, and/or a conveyor) to a destination pallet. In completing the operation, the transport unit 106 (e.g., a conveyor, an automated guided vehicle (AGV), a shelf-transport robot, etc.) can transfer the target object 112 from an area associated with the transfer unit 104 to an area associated with the storage interfacing unit 108, and the storage interfacing unit 108 can transfer the target object 112 (by, e.g., moving the pallet carrying the target object 112) from the transfer unit 104 to a storage location (e.g., a location on the shelves).

For illustrative purposes, the robotic system 100 is described in the context of a packaging and/or shipping center or warehouse; however, it is understood that the robotic system 100 can be configured to execute tasks in other environments/for other purposes, such as for manufacturing, assembly, storage/stocking, healthcare, and/or other types of automation. It is also understood that the robotic system 100 can include other units, such as manipulators, service robots, modular robots, etc., not shown in FIG. 1. For example, in some embodiments, the robotic system 100 can include a depalletizing unit for transferring the objects from cage carts or pallets onto conveyors or other pallets, a container-switching unit for transferring the objects from one container to another, a packaging unit for wrapping/casing the objects, a sorting unit for grouping objects according to one or more characteristics thereof, a piece-picking unit for manipulating (e.g., for sorting, grouping, and/or transferring) the objects differently according to one or more characteristics thereof, or a combination thereof.

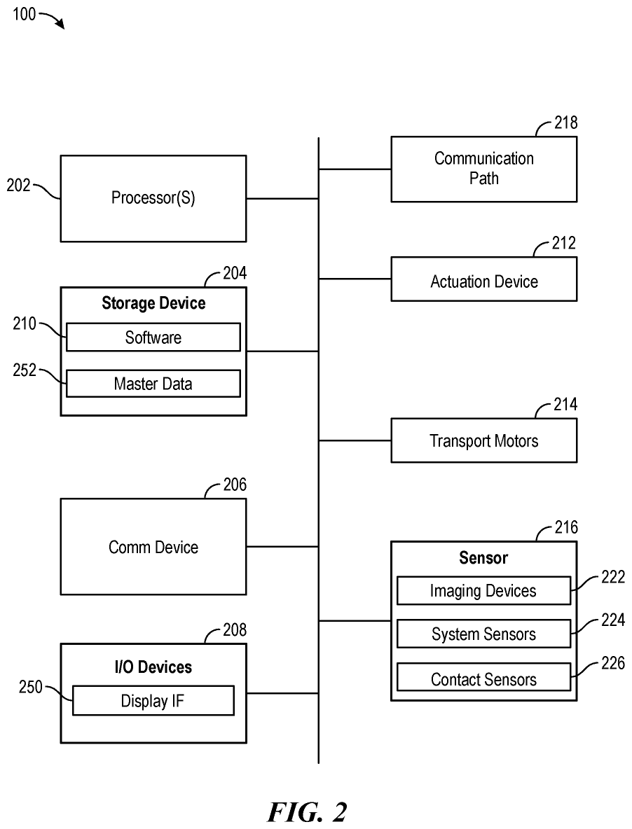

FIG. 2 is a block diagram illustrating the robotic system 100 in accordance with one or more embodiments. In some embodiments, for example, the robotic system 100 (e.g., at one or more of the units and/or robots described above) can include electronic/electrical devices, such as one or more processors 202, one or more storage devices 204 (e.g., non-transitory memory), one or more communication devices 206, one or more input-output devices 208, one or more actuation devices 212, one or more transport motors 214, one or more sensors 216, or a combination thereof. The various devices can be coupled to each other via wire connections and/or wireless connections (e.g., system communication path 218). For example, the robotic system 100 can include a bus, such as a system bus, a Peripheral Component Interconnect (PCI) bus or PCI-Express bus, a HyperTransport or industry standard architecture (ISA) bus, a small computer system interface (SCSI) bus, a universal serial bus (USB), an IIC (I2C) bus, or an Institute of Electrical and Electronics Engineers (IEEE) standard 1394 bus (also referred to as “Firewire”). Also, for example, the robotic system 100 can include bridges, adapters, processors, or other signal-related devices for providing the wire connections between the devices. The wireless connections can be based on, for example, cellular communication protocols (e.g., 3G, 4G, LTE, 5G, etc.), wireless local area network (LAN) protocols (e.g., wireless fidelity (Wi-Fi)), peer-to-peer or device-to-device communication protocols (e.g., Bluetooth, Near-Field communication (NFC), etc.), Internet of Things (IoT) protocols (e.g., NB-IoT, LTE-M, etc.), and/or other wireless communication protocols.

The processors 202 can include data processors (e.g., central processing units (CPUs), special-purpose computers, graphics processing units (GPUs), and/or onboard servers) configured to execute instructions (e.g., software instructions) stored on the storage devices 204 (e.g., computer memory). In some embodiments, the processors 202 can be included in a separate/stand-alone controller that is operably coupled to the other electronic/electrical devices illustrated in FIG. 2 and/or the robotic units illustrated in FIG. 1. The processors 202 can implement the program instructions to control/interface with other devices, thereby causing the robotic system 100 to execute actions, tasks, and/or operations.

The storage devices 204 can include non-transitory computer-readable mediums having stored thereon program instructions (e.g., software 210). Some examples of the storage devices 204 can include volatile memory (e.g., cache and/or random-access memory (RAM)) and/or non-volatile memory (e.g., flash memory and/or magnetic disk drives). Other examples of the storage devices 204 can include portable memory and/or cloud storage devices.

In some embodiments, the storage devices 204 can be used to further store and provide access to processing results and/or predetermined data/thresholds. For example, the storage devices 204 can store master data 252 that includes descriptions of objects (e.g., boxes, cases, and/or products) that may be manipulated by the robotic system 100. In one or more embodiments, the master data 252 can include a dimension, a shape (e.g., templates for potential poses and/or computer-generated models for recognizing the object in different poses), a color scheme, an image, identification information (e.g., bar codes, quick response (QR) codes, logos, etc., and/or expected locations thereof), an expected weight, other physical/visual characteristics, or a combination thereof for the objects expected to be manipulated by the robotic system 100. In some embodiments, the master data 252 can include manipulation-related information regarding the objects, such as a center-of-mass (COM) location on each of the objects, expected sensor measurements (e.g., for force, torque, pressure, and/or contact measurements) corresponding to one or more actions/maneuvers, or a combination thereof.

The communication devices 206 can include circuits configured to communicate with external or remote devices via a network. For example, the communication devices 206 can include receivers, transmitters, modulators/demodulators (modems), signal detectors, signal encoders/decoders, connector ports, network cards, etc. The communication devices 206 can be configured to send, receive, and/or process electrical signals according to one or more communication protocols (e.g., the Internet Protocol (IP), wireless communication protocols, etc.). In some embodiments, the robotic system 100 can use the communication devices 206 to exchange information between units of the robotic system 100 and/or exchange information (e.g., for reporting, data gathering, analyzing, and/or troubleshooting purposes) with systems or devices external to the robotic system 100.

The input-output devices 208 can include user interface devices configured to communicate information to and/or receive information from human operators. For example, the input-output devices 208 can include a display 250 and/or other output devices (e.g., a speaker, a haptics circuit, or a tactile feedback device, etc.) for communicating information to the human operator. Also, the input-output devices 208 can include control or receiving devices, such as a keyboard, a mouse, a touchscreen, a microphone, a user interface (UI) sensor (e.g., a camera for receiving motion commands), a wearable input device, etc. In some embodiments, the robotic system 100 can use the input-output devices 208 to interact with the human operators in executing an action, a task, an operation, or a combination thereof.

The robotic system 100 can include physical or structural members (e.g., robotic manipulator arms) that are connected at joints for motion (e.g., rotational and/or translational displacements). The structural members and the joints can form a kinetic chain configured to manipulate an end-effector (e.g., the gripper and/or the EOAT) configured to execute one or more tasks (e.g., gripping, spinning, welding, etc.) depending on the use/operation of the robotic system 100. The robotic system 100 can include the actuation devices 212 (e.g., motors, actuators, wires, artificial muscles, electroactive polymers, etc.) configured to drive or manipulate (e.g., displace and/or reorient) the structural members about or at a corresponding joint. In some embodiments, the robotic system 100 can include the transport motors 214 configured to transport the corresponding units/chassis from place to place.

The robotic system 100 can include the sensors 216 configured to obtain information used to implement the tasks, such as for manipulating the structural members and/or for transporting the robotic units. The sensors 216 can include devices configured to detect or measure one or more physical properties of the robotic system 100 (e.g., a state, a condition, and/or a location of one or more structural members/joints thereof) and/or of a surrounding environment. Some examples of the sensors 216 can include accelerometers, gyroscopes, force sensors, strain gauges, tactile sensors, torque sensors, position encoders, crossing sensors, etc.

In some embodiments, for example, the sensors 216 can include one or more vision sensors 222 (e.g., visual and/or infrared cameras, 2D and/or 3D imaging cameras, distance measuring devices such as lidars or radars, etc.) configured to detect the surrounding environment. The vision sensors 222 can generate representations of the detected environment, such as digital images and/or point clouds, that may be processed via machine/computer vision (e.g., for automatic inspection, robot guidance, or other robotic applications). As described in further detail below, the robotic system 100 (via, e.g., the processors 202) can process the digital image and/or the point cloud to identify the target object 112 of FIG. 1, the start location 114 of FIG. 1, the task location 116 of FIG. 1, a pose of the target object 112, a confidence measure regarding the start location 114 and/or the pose, or a combination thereof.

For manipulating the target object 112, the robotic system 100 (via, e.g., the various circuits/devices described above) can capture and analyze image data of a designated area (e.g., a pickup location, such as inside the truck or on the conveyor belt) to identify the target object 112 and the start location 114 thereof. Similarly, the robotic system 100 can capture and analyze image data of another designated area (e.g., a drop location for placing objects on the conveyor, a location for placing objects inside the container, or a location on the pallet for stacking purposes) to identify the task location 116. For example, the vision sensors 222 can include one or more cameras configured to generate image data of the pickup area and/or one or more cameras configured to generate image data of the task area (e.g., drop area). Based on the image data, as described below, the robotic system 100 can determine the start location 114, the task location 116, the associated poses, and/or other processing results.

In some embodiments, for example, the sensors 216 can include system sensors 224 (e.g., position encoders, potentiometers, etc.) configured to detect positions of structural members (e.g., the robotic arms and/or the end-effectors) and/or corresponding joints of the robotic system 100. The robotic system 100 can use the position sensors 224 to track locations and/or orientations of the structural members and/or the joints during execution of the task. Additionally, the system sensors 224 can include sensors, such as crossing sensors, configured to track the location/movement of the transferred object.

### Overview of an Example End-Point Interface System

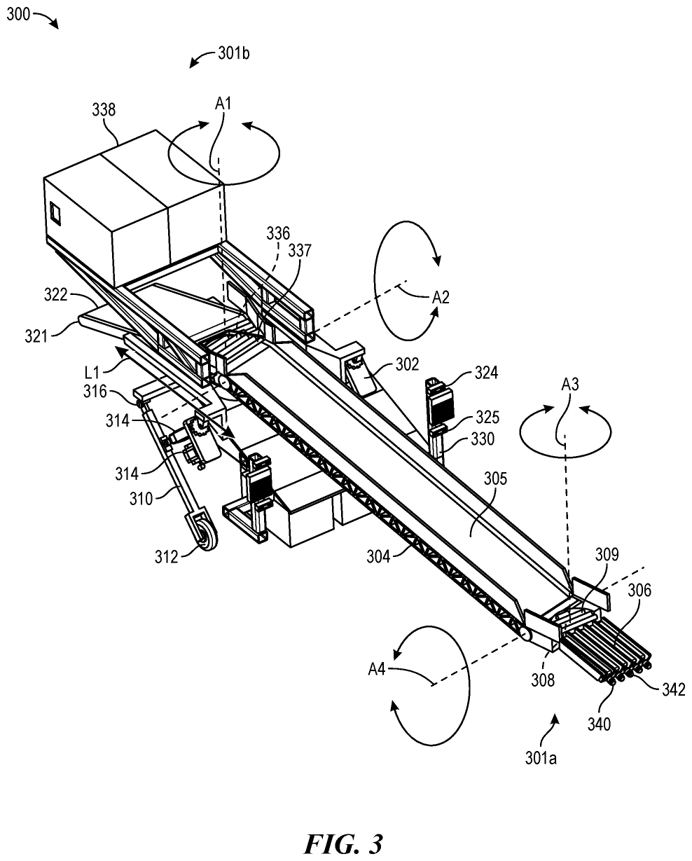

FIG. 3 is a perspective view of a robotic system 300 in accordance with embodiments of the present technology. The robotic system 300 can be an example of the robotic system 100 (e.g., the endpoint unit 102) illustrated in and described above with respect to FIG. 1. In the illustrated embodiment, the robotic system 300 includes a chassis 302, a conveyor arm or first segment 304 (“first segment”) coupled to the chassis 302 and extending toward a distal portion 301a of the robotic system 300, a second segment 321 coupled to the chassis 302 and extending toward a proximal portion 301b of the robotic system 300, and a gripper 306 coupled to the first segment 304 at the distal portion 301a. As discussed above with respect to the robotic system 100, the robotic system 300 can be configured to execute one or more tasks to perform an operation that achieves a goal, such as to unload objects from a cargo carrier (e.g., a truck, a van) and store them in a warehouse, or to unload objects from storage locations and prepare them for shipping (e.g., load them into the cargo carrier). For example, in some embodiments, the robotic system 300 can be positioned such that the second segment 321 is adjacent to a warehouse conveyor (e.g., a conveyor previously/already in place within the operating environment). Objects can then be conveyed along a path formed by the warehouse conveyor, the second segment 321, the chassis 302, and the first segment 304 toward or away from the gripper 306. As discussed in further detail herein, the chassis 302, the first segment 304, the second segment 321, and the gripper 306 can be actuated to various positions and/or angular positions, or otherwise operated, such that objects can be conveyed or transferred between the warehouse to the cargo carrier in a desired and efficient manner.

The robotic system 300 can also include supporting legs 310 coupled to the chassis 302, one or more controllers 338 supported by the chassis 302, first joint rollers 309 coupled between the first segment 304 and the gripper 306, and second joint rollers 337 coupled between the first segment 304 and the second segment 321. The chassis 302, the first segment 304, the second segment 321, the sensor arms 330, the supporting legs 310, and/or other components of the robotic system 300 can be made from metal (e.g., aluminum, stainless steel), plastic, and/or other suitable materials.

The chassis 302 can include a frame structure that supports the first segment 304, the second segment 321, the controllers 338, and/or one or more sensor arms 330 coupled to the chassis 302. In the illustrated embodiment, two sensor arms 330 each extend vertically on either side of the first segment 304. An upper sensor 324 (e.g., an upper vision sensor) and a lower sensor 325 (e.g., a lower vision sensor) are coupled to each sensor arm 330 along a vertical direction and are positioned to generally face toward the distal portion 301a.

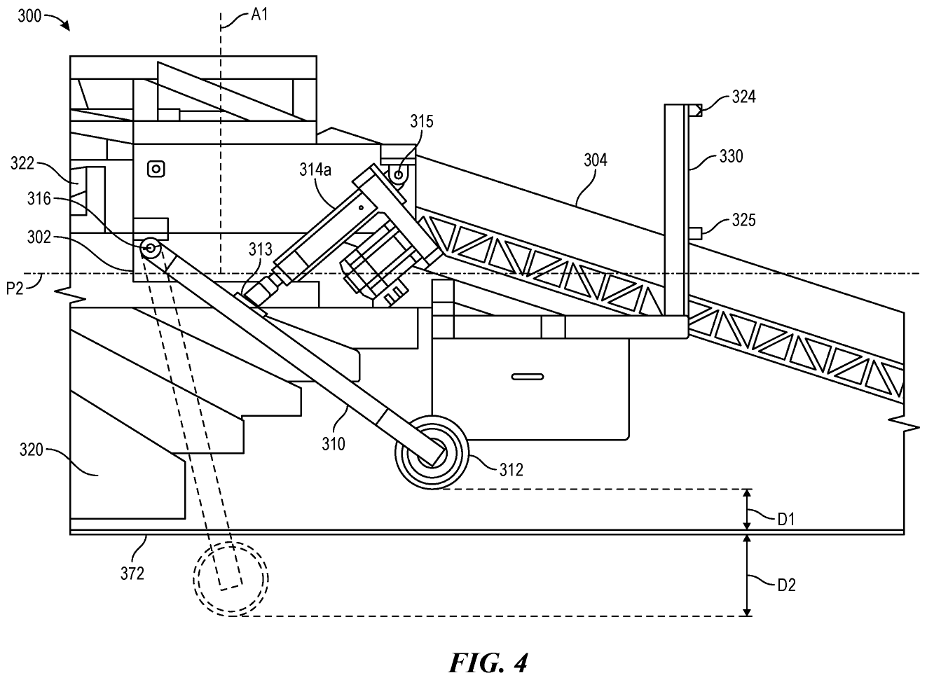

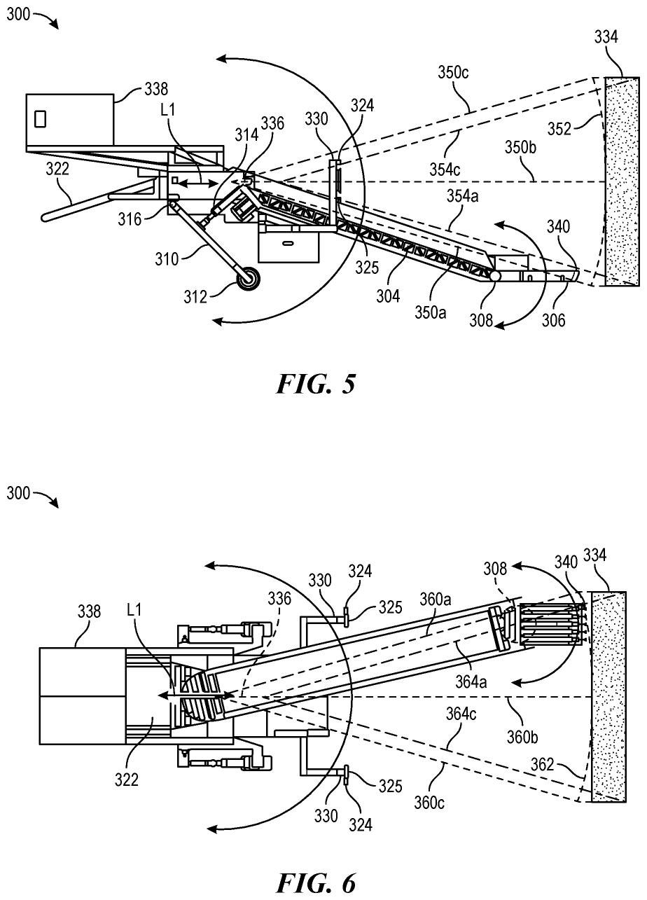

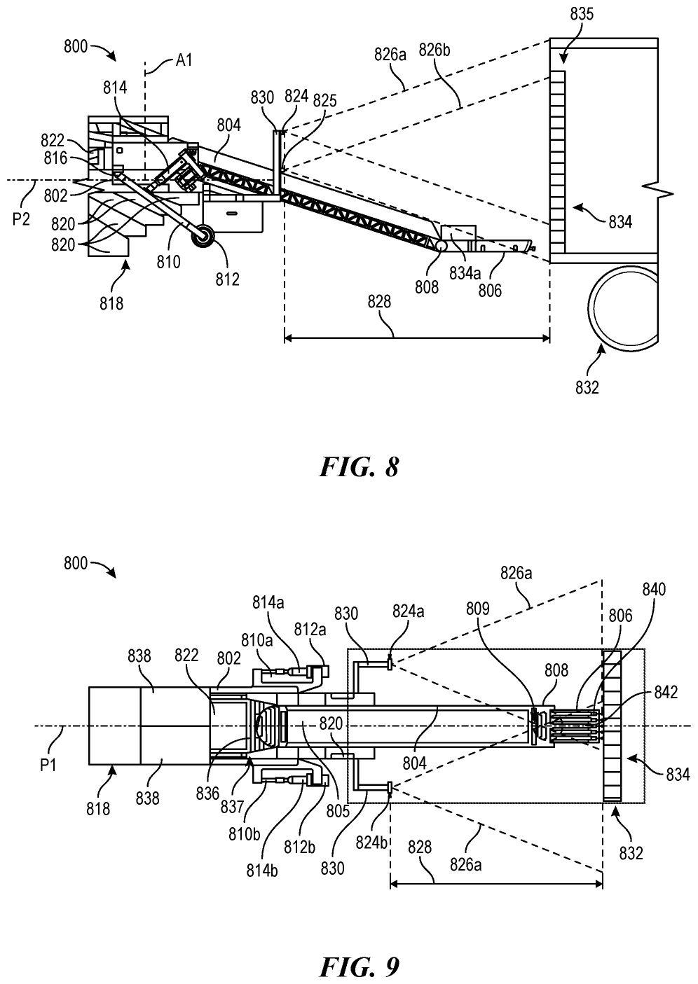

The first segment 304 is coupled to extend from the chassis 302 toward the distal portion 301a in a cantilevered manner. The first segment 304 supports a first conveyor 305 (e.g., a conveyor belt) extending along and/or around the first segment 304. Similarly, the second segment 321 is coupled to extend from the chassis 302 in a cantilevered manner, but toward a proximal portion 301b of the robotic system 300. The second segment 321 supports a second conveyor 322 (e.g., a conveyor belt) extending along and/or around the second segment 321. In some embodiments, one or more actuators 336 (e.g., motors) configured to move the first and second conveyors 305, 322 are coupled to the chassis 302. In some embodiments, the actuators are positioned elsewhere (e.g., housed in or coupled to the first and/or second segments 304, 321). The actuators 336 can also be operated to rotate the first segment 304 about a first axis A₁ and/or a second axis A₂. As illustrated in FIG. 3, the first axis A₁ can be generally orthogonal to a transverse plane of the chassis 302 (e.g., a second plane P₂ illustrated in FIG. 4 and FIG. 8) while the second axis A₂ can be generally parallel to the transverse plane of the chassis 302. Said another way, the first axis A₁ can be in a first plane that is generally orthogonal to a second plane containing the second axis A₂. In some embodiments, the actuators 336 can also pivot the second joint rollers 337 about the first and second axes A₁, A₂ or different axes. Movement and/or rotation of the first segment 304 relative to the chassis 302 are discussed in further detail below with respect to FIGS. 5-7B.

As mentioned above, the gripper 306 can be coupled to extend from the first segment 304 toward the distal portion 301a with the first joint rollers 309 positioned therebetween. In some embodiments, the gripper 306 is configured to grip objects using a vacuum and to selectively release the objects. The gripper 306 can include suction cups 340 (and/or any other suitable gripping element, such as a magnetic component, a mechanical gripping component, and/or the like, sometimes referred to generically as “gripper elements,” “gripping elements,” and/or the like) and/or a distal conveyor 342. The suction cups 340 can pneumatically grip objects such that the suction cups 340 can carry and then place the object the distal conveyor 342, which in turn transports the object in the proximal direction.

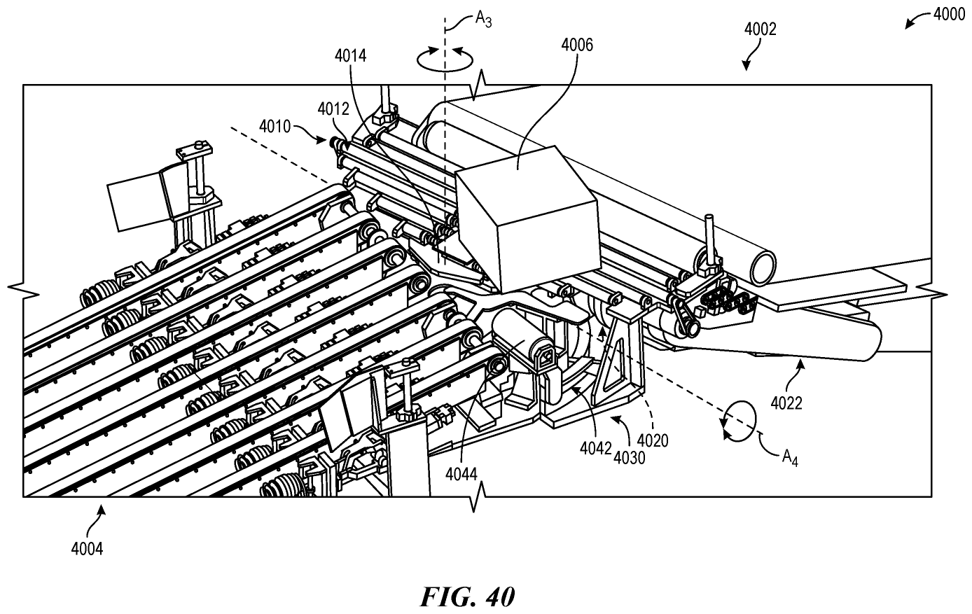

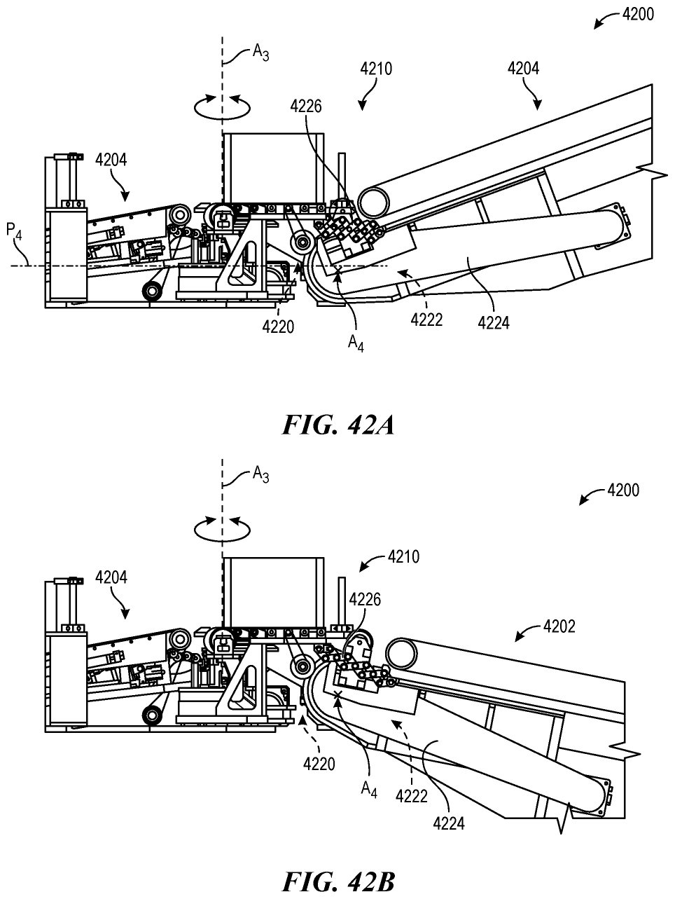

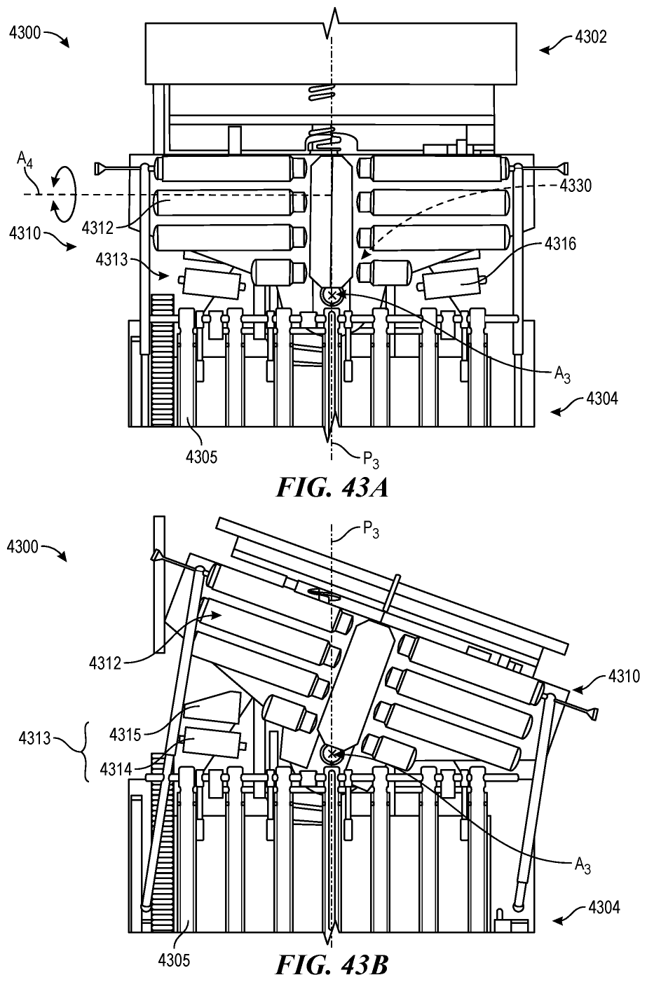

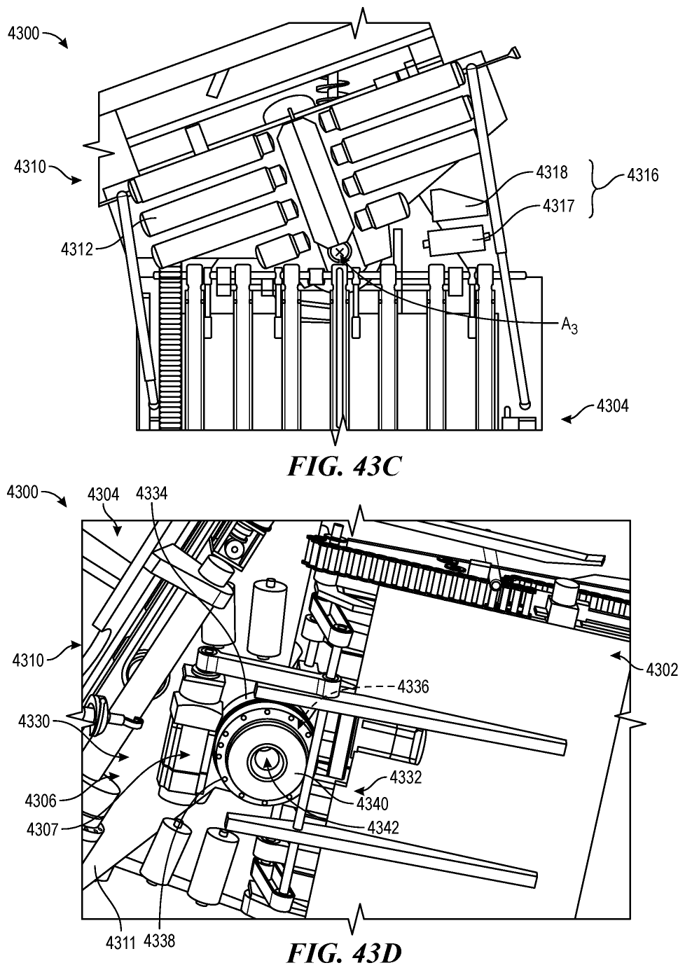

In some embodiments, one or more actuators 308 (e.g., motors) are configurated to rotate the gripper 306 and/or the first joint rollers 309 relative to the first segment 304 about a third axis A₃ and/or a fourth axis A₄. As illustrated in FIG. 3 and discussed in more detail below with reference to FIGS. 40-44C, the third axis A₃ can be generally parallel to a longitudinal plane of the gripper 306 (e.g., a third plane P₃ illustrated in FIG. 43A) while the fourth axis A₄ can be generally orthogonal to the longitudinal plane of the gripper 306. Additionally, or alternatively, the third axis A₃ can be generally orthogonal to a transverse plane of the gripper 306 (e.g., a fourth plane P₄ illustrated in FIG. 42A) while the fourth axis A₄ can be generally parallel orthogonal to the transverse plane of the gripper 306. Said another way, the third axis A₃ can be in a third plane that is generally orthogonal to a fourth plane containing the fourth axis A₄. In some embodiments, as discussed in more detail below, the robotic system 300 can maintain the transverse plane of the gripper 306 generally parallel with the transverse plane of the chassis 302 (e.g., such that rotation about the second axis A₂ is met with an opposite rotation about the fourth axis A₄. As a result, for example, in some embodiments, the third axis A₃ can be generally orthogonal to the transverse plane of the chassis 302 and/or the fourth axis A₄ can be generally parallel to the transverse plane of the chassis 302.

In some embodiments, the actuators 308 are configured to operate the suction cups 340 and/or the distal conveyor 342. In some embodiments, the actuators 308 are coupled to the first segment 304, the first joint rollers 309, and/or the gripper 306. Movement and/or rotation of the gripper 306 relative to the second segment 304 and components of the gripper 306 are described in further detail below.

In the illustrated embodiment, two supporting legs 310 are rotatably coupled to the chassis 302 about pivots 316 positioned on either side of the chassis 302. A wheel 312 is mounted to a distal portion of each supporting leg 310. The chassis 302 also supports actuators 314 (e.g., linear actuators, motors) operably coupled to the supporting legs 310. In some embodiments, the robotic system 300 includes fewer or more supporting legs 310, and/or supporting legs 310 configured in different positions and/or orientations. In some embodiments, the wheels 312 can be motorized to move the chassis 302, and thus the rest of the robotic system 300, along linear direction L1. Operation of the actuators 314 is described in further detail below with respect to FIG. 4.

The controllers 338 can be operably coupled (e.g., via wires or wirelessly) to control the actuators 308, 336, 314. In some embodiments, the controllers 338 are positioned to counterbalance the moment exerted on the chassis 302 by, for example, the cantilevered first segment 304. In some embodiments, the robotic system 100 includes counterweights coupled to the chassis 302 to counterbalance such moments.

As an illustrative example, the robotic system 300 can be configured to provide an interface and operate between (1) the cargo carrier located at or about the distal portion 301a and (2) an existing object handling component, such as a conveyor preinstalled at the truck bay, located at or about the proximal portion 301b. The supporting legs 310 can allow the chassis 302 and/or the second segment 321 to be positioned over and/or overlap the existing object handling component. For example, the supporting legs 310 can be adjacent to or next to peripheral surfaces of the warehouse conveyor and position the chassis 302 and/or the second segment 321 over and/or partially overlapping an end portion of the warehouse conveyor.

Based on the relative arrangement described above, the robotic system 300 can automatically transfer target objects between the cargo carrier and the warehouse conveyor. Using the devanning process as an illustrative example, the robotic system 300 can use the first segment 304 to successively/iteratively position the EOAT (e.g., the gripper 306) adjacent to or in front of target objects located/stacked in the cargo carrier. The robotic system 300 can use the EOAT to (1) grasp and initially remove the target object from the cargo carrier and (2) place/release the grasped target object onto the first joint rollers 309 and/or the first conveyor 305. The robotic system 300 can operate the connected sequence of rollers and conveyors, such as the first joint rollers 309, the first conveyor 306, the second joint rollers 337, the second conveyor 322, etc., to transfer the target object from the EOAT to the warehouse conveyor.

In transferring the target objects, the robotic system 300 can analyze the sensor information, such as one or more image data (e.g., 2D and/or 3D data) and other observed physical characteristics of the objects. For example, the mixed SKU environment can have objects of different types, sizes, etc. stacked on top of and adjacent to each other. The coplanar surfaces (e.g., front surfaces) of the stacked objects can form walls or vertical planes that extend at least partially across a width and/or a height inside the cargo carrier. The robotic system 300 can use 2D and/or 3D image data from the vision sensors 324 and/or 325 to initially detect objects within the cargo carrier. The detection operation can include identifying edges, calculating and assessing dimensions of or between edges, assessing surface texture, such as visual characteristics including codes, numbers, letters, shapes, drawings, or the like identifying the object or its contents. The robotic system 300 can compare the sensor outputs and/or the derived data to attributes of known or expected objects as listed in the master data 252 of FIG. 2. When the compared attributes match, the robotic system 300 can detect the object depicted in the image data by determining the type or the identifier for the object and the estimated real-world location of the objects (e.g., the peripheral edges of the object). The robotic system 300 can perform additional operations and analyses, such as to confirm detection or related data and/or when portions of the image fail to match the attributes listed in the master data 252, indicating that the corresponding portions may be depicting unrecognized objects. Details regarding the operations and corresponding details of the robotic system 300 are described below.

FIG. 4 is an enlarged side view of the robotic system 300 illustrating actuation of the supporting legs 310 in accordance with embodiments of the present technology. In the illustrated embodiment, the robotic system 300 is positioned on top of a conveyor segment 320 that may already be present at a warehouse or other operating site. Specifically, the chassis 302 is positioned at or over a distal end of the conveyor segment 320 such that the first segment 304 is able to rotate relative to the chassis 302 without abutting against the conveyor segment 320. The conveyor segment 320 can be on a support surface or floor 372 (or other surface) in the warehouse. The robotic system 300 can compensate for uneven floors, sloped floors, and other environments to position one or more of the components with acceptable ranges of positions for transporting objects. For example, the robot system 300 can level the chassis 302 by, for example, moving the chassis 302 relative to the floor 372. The chassis 302 can then be at a generally level orientation (e.g., a traverse plane of the chassis 302 can be generally horizontal) such the conveyor belts of the robotic system 300 are within target ranges of positions for carrying objects.

In the illustrated embodiment, one end of the actuator 314 is rotatably coupled to the chassis 302 via hinge 315. The other end of the actuator 314 is coupled to the supporting leg 310 via a hinge or bearing 313 such that the actuator 314 and the supporting leg 310 can rotate relative to one another. During operation, the actuator 314 can be controlled (e.g., via the controllers 338 shown in FIG. 2) to move the supporting leg 310 between a first state (illustrated in FIG. 4 with solid lines) and a second state (illustrated in FIG. 4 with dotted lines). In the first state, the supporting leg 310 is pulled or otherwise positioned by the actuator 314 toward the hinge 315 such that the wheel 312 is at a level above the floor 372. In some embodiments, the illustrated first state corresponds to the maximum vertical distance (e.g., height) that the wheel 312 can be lifted relative to the floor 372, defined by distance D1. The distance D1 can be at least 140 millimeters (mm), 160 mm, 180 mm, 200 mm, 220 mm, or within a range of 140-220 mm. In the second state, the supporting leg 310 is pushed or otherwise positioned by the actuator 314 away from the hinge 315 such that the wheel 312 is at a level below the floor 372. In some embodiments, the illustrated second state corresponds to the maximum vertical that the wheel 312 can be lowered relative to the floor 372, defined by distance D2. The distance D2 can be at least 290 mm, 310 mm, 330 mm, 350 mm, 370 mm, or within a range of 290-370 mm.

During operation, the supporting legs 310 and the wheels 312 can provide support to the chassis 302 such that the conveyor segment 320 need not support the entire weight of the robotic system 300. As will be described in further detail below, the wheels 312 can also be motorized to move the chassis 302 closer to or away from, for example, a cargo carrier (e.g., a truck). The wheels 312 can be motorized wheels that include one or more move drive motors, brakes, sensors (e.g., position sensors, pressure sensors, etc.), hubs, and tires. The components and configuration of the wheels 312 can be selected based on the operation and environment. In some embodiments, the wheels 312 are connected to a drive train of the chassis 302. The wheels 312 can also be locked (e.g., using a brake) to prevent accidental movement during, for example, unloading and loading cargo from and onto the cargo carrier.

The ability to lift and lower the supporting legs 310 and the wheels 312 attached thereto can be advantageous for several reasons. For example, the supporting legs 310 can be rotated to the illustrated dotted position (e.g., to the distance D2) to lift and/or rotate the chassis 302, further extending the range of the gripper 306. The supporting legs 310 can also be rotated to the illustrated position (e.g., to the distance D1) to lower and/or rotate the chassis 302. In another example, the floor 372 may be uneven such that the conveyor segment 320 and the wheel 312 contact the floor 372 at different levels. The robotic system 300 can therefore adapt to variability in the warehouse environment without requiring additional support mechanisms. In another example, the wheels 312 can be lifted (e.g., while the wheels 312 are locked) to move the conveyor segment 320 (e.g., extend horizontally). The wheels 312 can be lowered once the conveyor segment 320 is moved or extended to the desired position. In yet another example, the robotic system 300 can be moved at least partially into a cargo carrier (e.g., the rear of a truck) to reach cargo or spaces deeper within the cargo carrier. If the floor of the cargo carrier is higher or lower than the floor 372 of the warehouse, the supporting legs 310 can be lifted or lowered accordingly.

In other embodiments, the components described above can be arranged differently from the illustrated embodiment. For example, the actuator 314 can be fixedly coupled to the chassis 302. In another example, the actuator 314 can be positioned behind or proximal of the supporting leg 310 such that the supporting leg 310 is pushed to be lifted and pulled to be lowered.

FIG. 5 is a side view of the robotic system 300 illustrating vertical actuation of the first segment 304 in accordance with embodiments of the present technology. In the illustrated embodiment, the robotic system 300 is positioned and operated to reach a target area 334. The target area 334 can include cargo (e.g., a stack of object, such as boxes, containers, etc.) or other items to be loaded and unloaded. The first segment 304 is shown angled in a lowered position. The gripper 306, which can be rotated (e.g., via the actuators 308) about a pivot point near the actuators 308, is shown oriented generally horizontally. The illustrated position of the first segment 304 can correspond to dotted line 350a, which extends from a pivot point near the actuators 336. During operation, the first segment 304 can be rotated (e.g., by the actuators 336) about the pivot point to a horizontal position corresponding to dotted line 350b, to a raised position corresponding to dotted line 350c, and any position therebetween. In some embodiments, the dotted lines 350a and 350c represent the lowest and highest positions that the first segment 304 can be rotated.

Due to the rotation of the first segment 304 about the pivot point near the actuators 336, the reach of the suction cups 340 of the gripper 306 extends along dotted curve 352. In the illustrated embodiment, the dotted curve 352 can be tangent to the target area 334 such that the suction cups 340 can reach the target area 334 when the first segment 304 is in the horizontal position (dotted line 350b), but not when the first segment 304 is in the lowered (dotted line 350a) or raised (dotted line 350c) positions. To allow the suction cups 340 to reach the entirety of the target area 334 (e.g., position the suction cups 340 generally along the vertical planar target area 334), the robotic system 300 can be moved (e.g., via the motorized wheels and/or extension of the conveyor segment 320 (FIG. 4)) along the linear direction L1. Movement of the robotic system 300 translates the first segment 304 to a new lowered position corresponding to dotted line 354a and a new raised position corresponding to dotted line 354c. As shown by dotted lines, the suction cups 340 can reach the distal-most edge of the target area 334 when the first segment 304 is either in the new lowered (dotted line 354a) or new raised positions (dotted line 354c). As will be discussed in further detail below, the actuators 308 can be operated to rotate the gripper 306 vertically relative to the first segment 304 at any time to reach objects as needed. Furthermore, the upper vision sensors 324 and the lower vision sensors 325 on sensor arms 330 can be used to determine the positions and/or orientations of the first segment 304, the gripper 306, and/or regions of the target area 334, and relay the information to the controllers 338 for real-time control.

FIG. 6 is a top view of the robotic system 300 illustrating horizontal actuation the first segment 304 in accordance with embodiments of the present technology. In the illustrated embodiment, the first segment 304 is shown angled in a left-leaning position. The gripper 306, which can be rotated (e.g., via the actuators 308) about a pivot point near the actuators 308, is shown oriented generally parallel to the chassis 302 (e.g., facing the target area 334). The illustrated position of the first segment 304 can correspond to dotted line 360a, which extends from a pivot point near the actuators 336. During operation, the first segment 304 can be rotated (e.g., by the actuators 336) about the pivot point to a straight position corresponding to dotted line 360b, to a right-leaning position corresponding to dotted line 360c, and any position therebetween. In some embodiments, the dotted lines 360a and 360c represent the most left-leaning and most right-leaning positions that the first segment 304 can be rotated.

Due to the rotation of the first segment 304 about the pivot point near the actuators 336, the reach of the suction cups 340 of the gripper 306 extends along dotted curve 362. In the illustrated embodiment, the dotted curve 362 is tangent to the target area 334 such that the suction cups 340 can reach the target area 334 when the first segment 304 is in the straight position (dotted line 360b), but not when the first segment 304 is in the left-leaning (dotted line 360a) or right-leaning (dotted line 360c) positions. To allow the suction cups 340 to reach the entirety of the target area 334, the robotic system 300 can be moved (e.g., via the motorized wheels and/or extension of the conveyor segment 320 (FIG. 4)) along the linear direction L1. Movement of the robotic system 300 translates the first segment 304 to a new left-leaning position corresponding to dotted line 364a and a new right-leaning position corresponding to dotted line 364c. As shown by dotted lines, the suction cups 340 can reach the distal-most edge of the target area 334 when the first segment 304 is either in the new left-leaning (dotted line 364a) or new right-leaning positions (dotted line 364c). As will be discussed in further detail below, the actuators 308 can be operated to rotate the gripper 306 horizontally relative to the first segment 304 at any time to reach objects as needed. Furthermore, the upper vision sensors 324 and the lower vision sensors 325 on sensor arms 330 can be used to determine the positions and/or orientations of the first segment 304 and the gripper 306, and relay the information to the controllers 338 for real-time control.

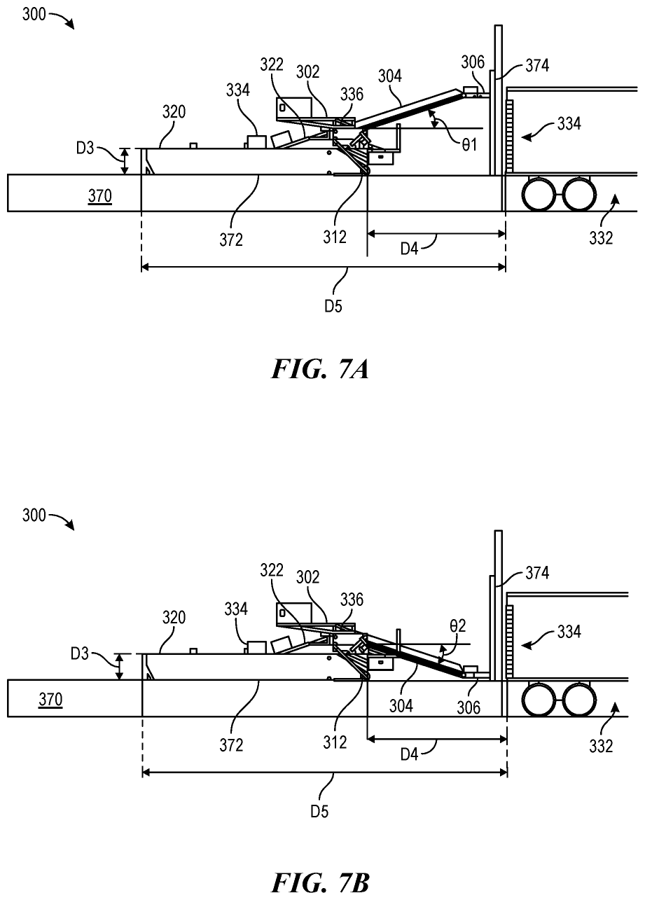

In some embodiments, the vertical motions of the first segment 304 and the gripper 306 illustrated in FIG. 5 can be combined with the horizontal motions of the first segment 304 and the gripper 306 illustrated in FIG. 6. For example, the target area 334 may comprise a rectangular volume (e.g., corresponding to the interior of a truck) and the first segment 304 can be controlled to pivot horizontally, pivot vertically, pivot diagonally, move laterally, and/or move in other directions to reach any desired position in the rectangular target area 334. The entire or most of the length of the robotic system 300 can be moved distally into the trailer (e.g., semi-trailer of FIGS. 1 and 7B) to access objects at the front of the trailer so that robotic system 300 can unload the entire trailer without contacting the sidewalls or ceiling of the trailer. The robotic system 300 can use maximum envelopes for environments, restricted envelopes for accessing objects, and operating or work envelopes for performing tasks. The robotic system 300 can determine robotic work envelops for emptying trailers using, for example, trailer-specific robotic work envelops, user selected robotic work envelops, or the like. The trailer-specific robotic work envelops can be determined based on inspection of the interior of the trailer and be modified any number times during use. A user selected robotic work envelops can be inputted by a user based on the configuration (e.g., dimensions, model type of trailer, etc.) of the trailer. The robotic work envelops can include areas the robotic system 300 is allowed to move or reach, range of motion, etc. The robotic system 300 can perform one or more simulations to evaluate a set of robotic work envelops and predicted outcomes, including unloading times, potential adverse events (e.g., object slippage, likelihood of dropped objects, likelihood of damage to fragile objects, etc.), acceptable conveyor belts speeds based on conveyor belt orientations. The robotic system 300 can select the robotic work envelop from the set of simulated robotic work envelop based on the simulations and predicted outcomes.

FIGS. 7A and 7B are side views of the robotic system 300 illustrating vertical actuation of the first segment 304 relative to a cargo carrier in accordance with embodiments of the present technology. Referring to FIGS. 7A and 7B together, the conveyor segment 320 is on the floor 372 and the chassis 302 is positioned atop the conveyor segment 320 while the wheels 312 are contacting the floor 372. A cargo carrier 332 (e.g., a loading truck) is positioned such that a rear end of the cargo carrier 332 faces a warehouse bay opening 374. In particular, the conveyor segment 320 can be positioned such that a distal end of the conveyor segment 320 is at a distance D4 from the rear end cargo carrier 332 and a proximal end of the conveyor segment 320 is at a distance D5 from the rear end of the cargo carrier 332. The conveyor segment 320 can have a height of D3 such the chassis 302 is raised from the floor 372 at the height D3. In some embodiments, the distance D4 can be at least 3 meters (m), 4 m, 5 m, 6 m, 7 m, or within a range of 3-7 m (e.g., 4.7 m). In some embodiments, the distance D5 can be at least 8 meters (m), 10 m, 12 m, 14 m, 16 m, or within a range of 8-16 m (e.g., 12.2 m). In some embodiments, the height D3 can be at least 0.7 meters (m), 0.8 m, 0.9 m, 1.0 m, 1.1 m, or within a range of 0.7-1.1 m. These dimensions can be used to generate, for example, a trailer-specific robotic work envelop. Cargo items 334 can be positioned anywhere in the cargo carrier 332 (e.g., at the rear section, as illustrated) for unloading and/or loading by the robotic system 300. The trailer-specific robotic work envelop can be used to access any of those cargo items 334 can be updated or modified when cargo items 334 are removed.

Referring first to FIG. 7A, the first segment 304 is in the raised position such that the first segment 304 forms angle θ1 with the horizontal. The angle θ1 represent the maximum angle by which the first segment 304 can be raised, and can be at least 16°, 18°, 20°, 22°, 24°, or within a range of 16-24°. In the illustrated embodiment, the length of the first segment 304 and the angle θ1 are such that the gripper 306 reaches the top of the rear end of the cargo carrier 332. To reach farther into the cargo carrier 332, the robotic system 300 and/or the conveyor segment 320 can be distally advanced toward the cargo carrier 332 such that the gripper 306 can reach farther in the cargo carrier 332.

Referring next to FIG. 7B, the first segment 304 is in the lowered position such that the first segment 304 forms angle θ2 with the horizontal. The angle θ2 represent the maximum angle by which the first segment 304 can be lowered, and can be at least 16°, 18°, 20°, 22°, 24°, or within a range of 16-24°. In the illustrated embodiment, the length of the first segment 304 and the angle θ1 are such that the gripper 306 reaches the bottom of the rear end of the cargo carrier 332. The angles θ1, θ2 can be used to determine a robotic work envelop designed to access the objects.

As discussed above, the first segment 304 and the gripper 306 can be moved (e.g., pivoted) between various angles in multiple directions (e.g., vertically, horizontally, diagonally) and the robotic system 300 can be moved distally to reach any desired cargo 334 or space in the cargo carrier 332. For example, conveyor segment 320 may be extended distally and/or the wheels 312 may be operated to move the chassis 302 distally such that the wheels 312 enter the cargo carrier 332. In the illustrated embodiment, the floor 372 of the warehouse 370 and the floor of the cargo carrier 332 are level, so the wheels 312 can remain at the illustrated height while entering the cargo carrier 332. In some embodiments, the wheels 312 can be lifted to avoid any gap between the floor 372 of the warehouse 370 and the floor of the cargo carrier 332. In some embodiments, the floor of the cargo carrier 332 is higher or lower than the floor 372 of the warehouse, in which case the robotic system 300 can lift or lower the wheels 312 accordingly, as discussed above with respect to FIG. 4.

### Methods of Operating Robotic System

FIG. 8 is a side schematic of a robotic system 800 in accordance with one or more embodiments. In the embodiment of FIG. 8, the robotic system includes a chassis 802. The chassis 802 supports a segment 804. As will be discussed herein, the segment 804 is configured to rotate relative to the chassis 802 in two rotational degrees of freedom. The robotic system further includes a gripper 806 that is operatively coupled to the segment 804 at a joint 808. The joint 808 may provide multiple degrees of freedom for the gripper 806 relative to the segment 804. The rotational degrees of freedom of the gripper 806 may be the same as those of the segment 804. In this manner, an orientation of the gripper 806 may be maintained with respect to an environmental reference frame or local reference frame, while the position of the gripper 806 is changed by a change in orientation of the segment 804.

As shown in FIG. 8, the robotic system 800 includes a leg 810 supporting the chassis 802. The leg 810 includes a wheel 812 at a lower end of the leg. The wheel 812 is configured to rotate to allow the chassis 802 to move in a first translational degree of freedom (e.g., a horizontal degree of freedom). For example, the chassis 802 can move linearly in a direction generally parallel to its longitudinal axis, midplane, etc. If the chassis 802 is located on a horizontal surface, the chassis 802 can be moved linearly in a horizontal direction. In the depicted embodiment, the leg is coupled to the chassis at an upper end at a leg joint 816. In the example of FIG. 8, the leg 810 is configured to rotate about the leg joint 816 to move the wheel 812 in a vertical direction to correspondingly move the chassis 802 in a second translational degree of freedom (e.g., a vertical degree of freedom) perpendicular to the first translational degree of freedom. For example, the chassis 802 can move linearly in a direction generally parallel to its traverse plane. If the chassis 802 is located on a horizontal surface, the chassis 802 can be moved linearly in a vertical direction. In some embodiments as shown in FIG. 8, the robotic system 800 includes a leg actuator 814 configured to move the leg in a vertical direction. The leg actuator 814 is configured to rotate the leg 810 about the leg joint 816 in the example of FIG. 8.

The robotic system 800 is configured to move objects 834 (e.g., boxes) disposed in a cargo carrier 832 in a proximal direction to unload the objects from the cargo carrier. In the example of FIG. 8, the robotic system 800 is configured to move the objects to a warehouse conveyor 818 disposed in a warehouse or other object processing center. The warehouse conveyor 818 includes telescoping segments 820 that are configured to extend and retract. The chassis 802 may be coupled to a distal end of the warehouse conveyor 818. As shown in FIG. 8, the robotic system may include a proximal conveyor 822 positioned above the warehouse conveyor and configured to move objects from the segment 804 to the warehouse conveyor 818. The segment 804 includes a segment conveyor configured to move the object 834 to the proximal conveyor 822.

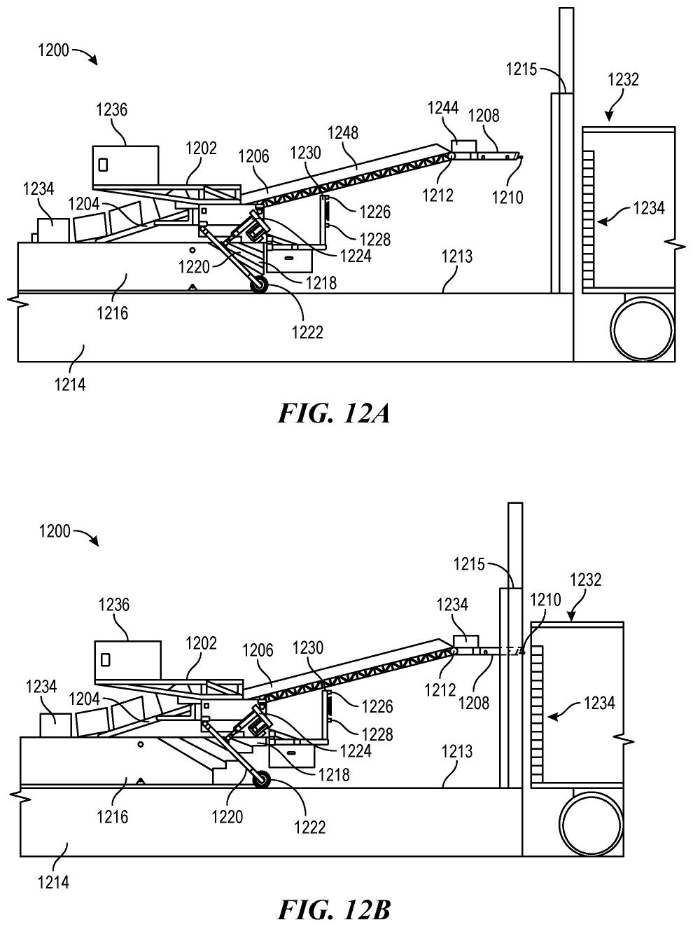

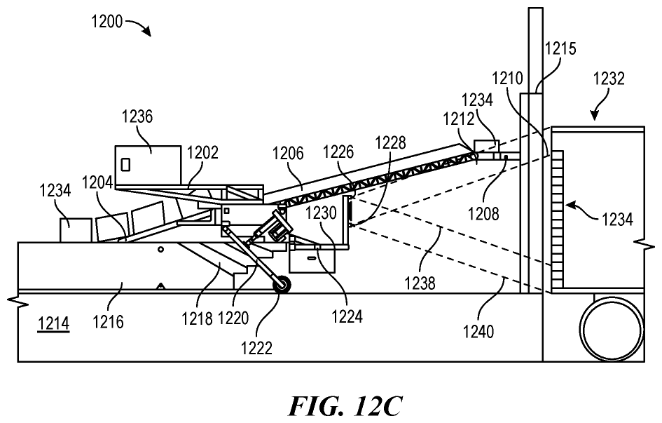

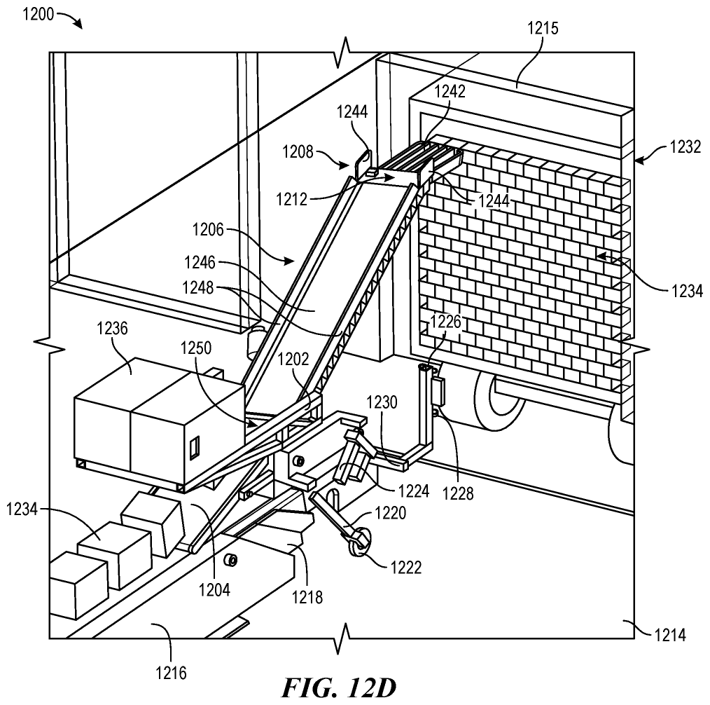

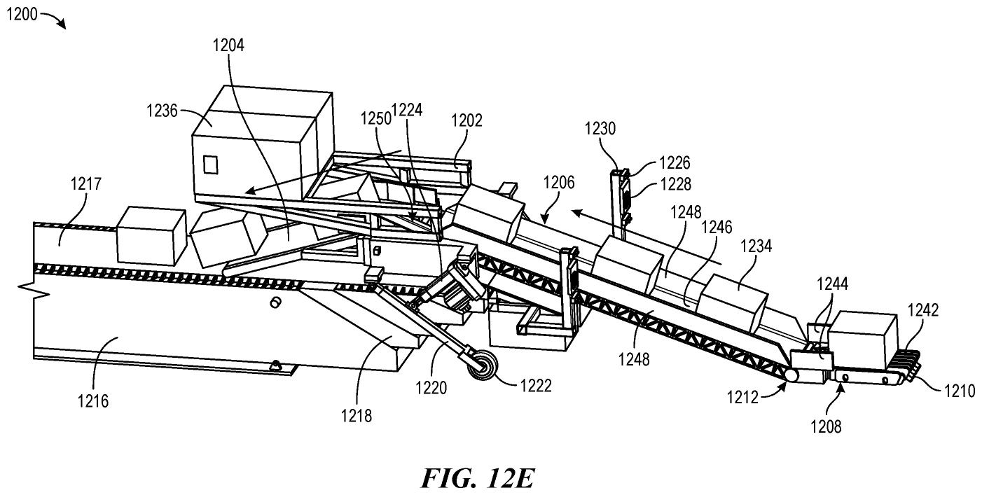

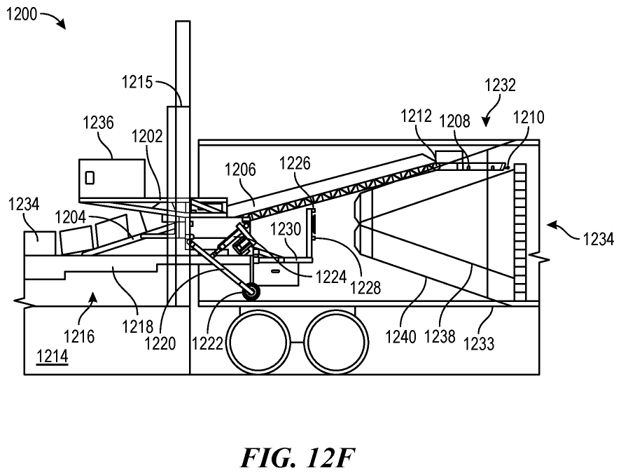

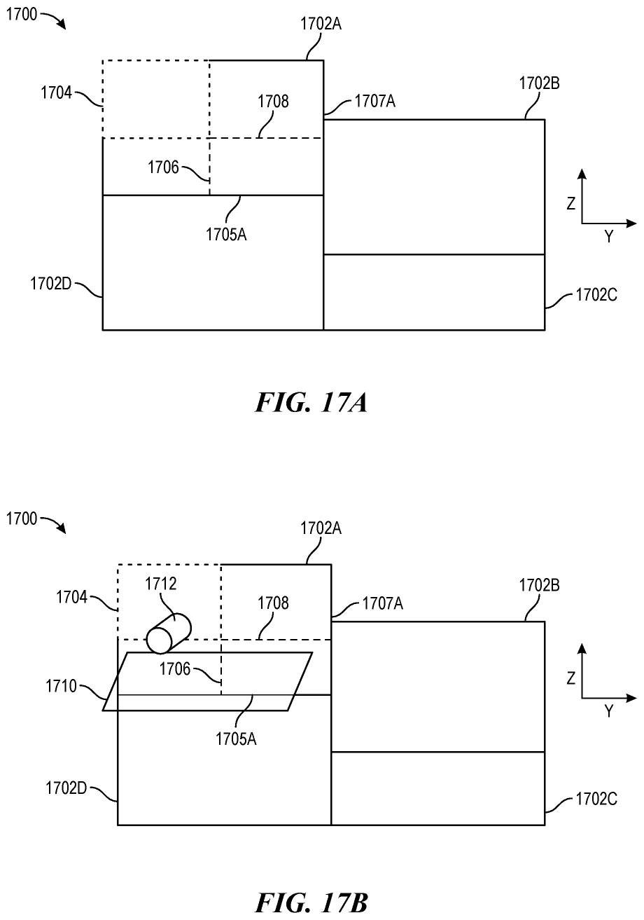

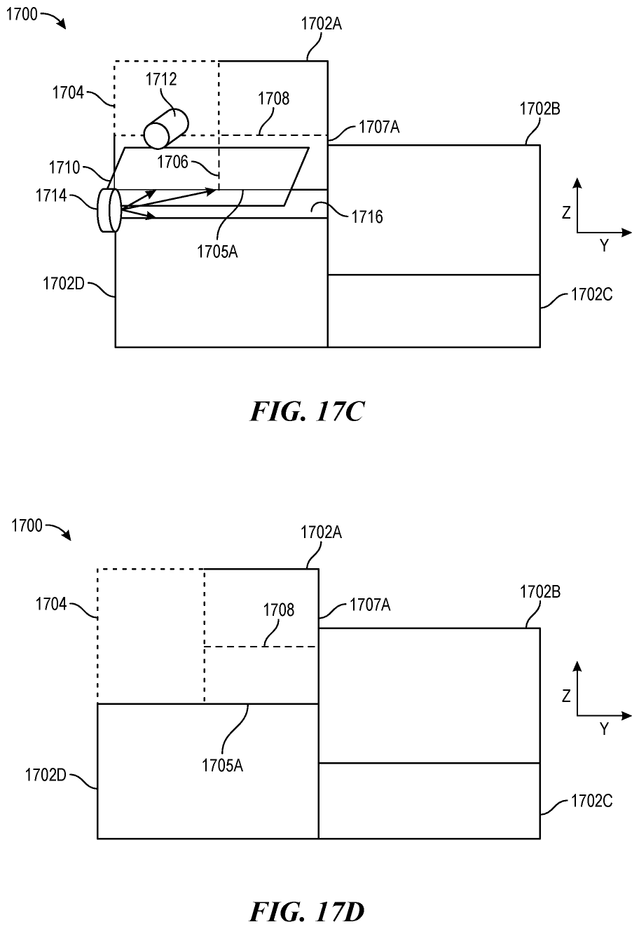

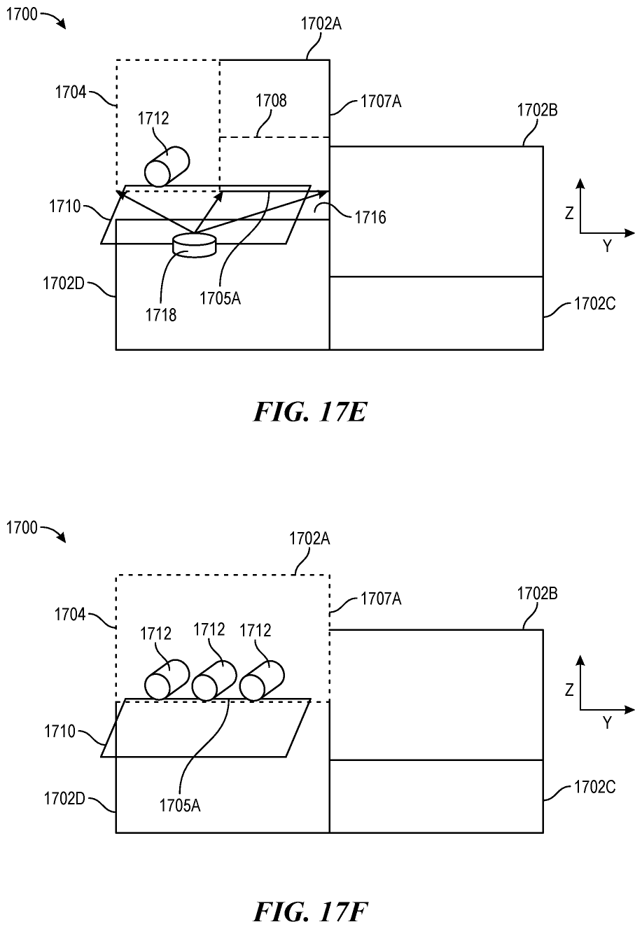

In the example depicted in FIG. 8, the cargo carrier 832 is a truck trailer and includes a plurality of objects 834. As shown in FIG. 8, the plurality of objects may be arranged in a vertical plane (e.g., generally parallel to a coronal and/or frontal plane of the cargo carrier, such as the y-z plane illustrated in FIGS. 17A-17F). In some cases, the objects may not be arranged in a perfect vertical plane, but rather a vertical stack approximating a vertical plane. The robotic system 800 includes ones or more upper vision sensors 824 and one or more lower vision sensors 825 configured to obtain an image of the cargo carrier 832 and the plurality of objects 834. Specifically, the vision sensors are configured to capture an image of the vertical plane of objects 834. The image information may be employed by a local controller to control operation of the robotic system, examples of which are discussed further with reference to FIGS. 12A-12F and 15-18. As shown in the example of FIG. 8, the upper vision sensor 824 may have a first field of view 826a and the lower vision sensor 825 may have a second field of view 826b. In some cases, it may be desirable to employ multiple vision sensors to ensure complete coverage of a cargo carrier 832 and all of the objects 834 disposed therein. In other embodiments, a single vision sensor or any number of vision sensors may be employed. The upper and lower vision sensors may be cameras (e.g., 2 dimensional (2D) or image sensor and/or 3 dimensional (3D) depth sensors, such as LIDARs, corresponding to the imaging devices 222 of FIG. 2), in some embodiments. As shown in FIG. 8, the upper vision sensor 824 and the lower vision sensor 825 are supported by an arm 830 coupled to the chassis 802. The placement of the vision sensors on the arm 830 may reduce obstructions caused by portions of the robotic system itself. Additionally, the placement of the vision sensors on the arm 830 may allow the vision sensors to enter the cargo carrier 832. The vision sensors are configured to image the objects 834 at an imaging distance 828 that is less than the combined length of the segment 804 and the gripper 806. Moreover, the arm 830 can be directly attached to the chassis 302 and otherwise separate from the segments 304, 804, etc., thereby providing views/images that are referenced to the chassis 302 and unaffected by the pose/movement of the segments 304.

FIG. 9 is a top schematic of the robotic system 800 of FIG. 8 in a first state. In the state shown in FIG. 9, the robotic system 800 has reached into the cargo carrier 832. Specifically, a distal end of the robotic system 800 is disposed within the cargo carrier 832, while a proximal end of the robotic system remains outside of the cargo carrier. Accordingly, the gripper 806 of the robotic system 800 is able to access objects 834 disposed within the cargo carrier 832. As shown in FIG. 9, the segments 820 of the warehouse conveyor 818 extend to accommodate the movement of the robotic system 800 into the cargo carrier 832. Also shown in FIG. 9 are local controllers 838 of the robotic system 800 that are disposed on the chassis 802. The controllers 838 may control the various components of the robotic system, as discussed further herein with reference to exemplary methods.

FIG. 9 illustrates that the robotic system 800 can be generally symmetrical about its longitudinal axis. For example, the robotic system 800 can include a first leg 810a and a first wheel 812a. On an opposing side, the robotic system 800 includes a second leg 810a and a second wheel 812a. The first leg 810a is moveable in a vertical direction by a first leg actuator 814a and the second leg 810b is movable by a second leg actuator 814b. In the example of FIG. 9, the robotic system 800 includes a first upper vision sensor 824a and a second upper vision sensor 824b disposed on opposite sides of a longitudinal axis of the robotic system. The upper vision sensors are each supported on symmetrical arms 830 are mirrored across the longitudinal axis. The first upper vision sensor 824a has a first field of view 826a and the second upper vision sensor 824b has a second field of view 826c. The fields of view ensure complete coverage of a plurality of objects 834 disposed in the cargo carrier 832. Additionally, the placement of the vision sensors on two sides of the segment 804 (as well as above and below the segment 804 as shown in FIG. 8) ensures that a complete image of the objects 834 may be captured without obstruction by the segment 804 and the gripper 806. In some embodiments, positioning the vision sensors below the segment 804 (or below a zero pitch position of a segment) may have certain benefits in cases where an unloading process begins at a top of a vertical stack. In such cases, a segment may be placed at a high pitch angle to begin, allowing vision sensors placed below the segment to obtain an unobstructed view of a plurality of objects.

As shown in FIG. 9, the segment 804 is coupled to the chassis 802 and the proximal conveyor 822 by a joint 836. The joint 836 is configured to provide multiple rotational degrees of freedom of the segment 804 with respect to the chassis 802 and the proximal conveyor 822. In some embodiments, the proximal conveyor 822 may be fixed with respect to the chassis 802. The joint 836 provides two rotational degrees of freedom for the segment 804. In the embodiment of FIG. 9, the joint 836 provides a yaw degree of freedom (e.g., rotation about a vertical axis and generally parallel to a longitudinal plane P₁ of the chassis 802 illustrated in FIG. 9) and a pitch degree of freedom (e.g., rotation about a transverse horizontal axis that is vertical on the page and generally parallel to the transverse plane P₂ of the chassis 802). In some embodiments as shown in FIG. 9, the join 836 includes a plurality of rollers 837 configured to move an object 834 in a proximal direction from the segment 804 to the proximal conveyor 822.

The gripper 806 coupled to the segment 804 by a joint 808. The joint 808 is configured to provide multiple rotational degrees of freedom of the gripper 806 with respect to the segment 804. The joint 808 provides two rotational degrees of freedom for the gripper 806. In the embodiment of FIG. 9, the joint 808 provides a yaw degree of freedom (e.g., rotation about the vertical axis, such as the first axis A₁ of FIG. 3) and a pitch degree of freedom (e.g., rotation about the transverse horizontal axis, such as the second axis A₂ of FIG. 3). In some embodiments as shown in FIG. 9, the joint 808 includes a plurality of rollers 809 configured to move an object 834 in a proximal direction from the gripper 806 to the segment 804.

According to the example of FIG. 9, the robotic system 800 is configured to grasp an object 834 of the plurality of objects with the gripper 806 and move the object in a proximal direction along a series of conveyors. As shown FIG. 9, the gripper 806 includes a plurality of suction cups 840 (and/or any other suitable gripper element) and a plurality of distal conveyors 842. The suction cups 840 are configured to be place in contact with an object 834 and grasp the object when a vacuum force (or other suitable drive force) is applied to the suction cup 840. The distal conveyors 842 are belt conveyors in the example of FIG. 9 and are configured to move the object in a proximal direction once the object is grasped by the suction cups 840. Examples of grasping object is discussed further herein with reference to grippers and end of arm tool (EOAT) arrangements. The object 834 is moved in a proximal direction to the joint 808 and comes into contact with the rollers 809. The rollers 809 may be driven and may further move the object 834 on a segment conveyor 805 disposed on the segment 804. The segment conveyor 805 may be a belt conveyor and may be configured to move the object to the joint 836 and the rollers 837. The rollers 837 may move the object to the proximal conveyor 822. The proximal conveyor may also be a belt conveyor. The proximal conveyor may move the object to the warehouse conveyor 818. In some embodiments, the warehouse conveyor may be a belt conveyor or roller conveyor.

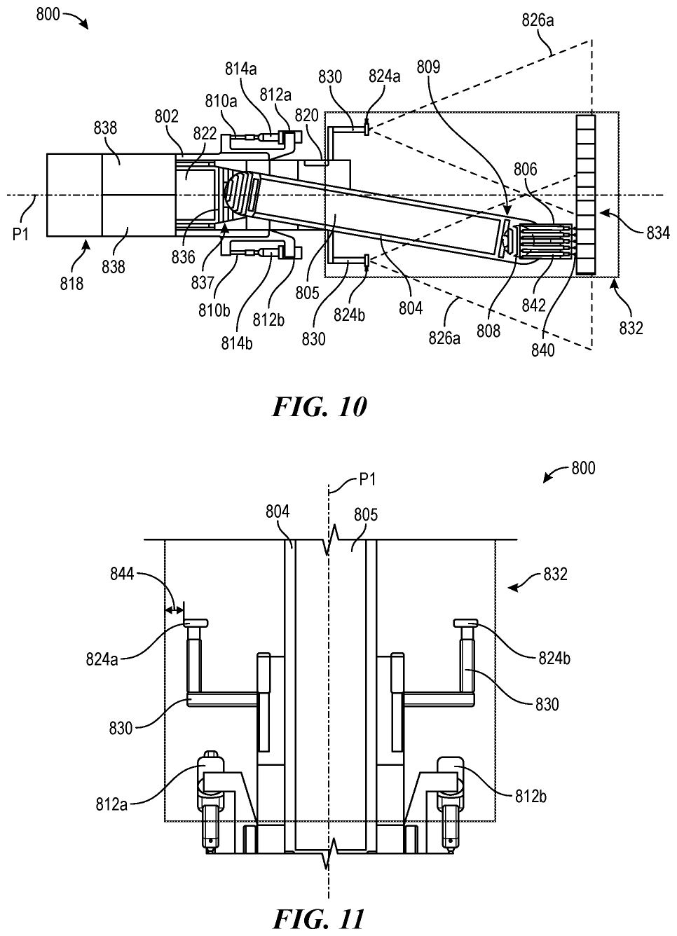

FIG. 10 is a top schematic of the robotic system 800 of FIG. 9 in a second state demonstrating a yaw range of motion provided by the joint 808 and the joint 836. Compared to the state shown in FIG. 9, the segment 804 has rotated about the joint 836 in a yaw direction (e.g., clockwise about an axis into the page, such as the first axis A₁ of FIG. 3). Correspondingly, the gripper 806 has rotated about joint 808 in an opposite direction (e.g., counterclockwise about the axis into the page). The rotation of the segment 804 has changed the position of the gripper 806 with respect to the cargo carrier 832 and objects 834. However, the orientation of the gripper 806 with respect to the cargo carrier 832 and objects 834 remain the same. Such an arrangement may be beneficial in allowing the gripper 806 to reach edges of a rectangular prism shaped cargo carrier (such as a box truck, shipping container, semi-truck trailer, etc.). For example, as shown in FIG. 10, the gripper 806 may be able to align with the side walls of the cargo container even as its position changes due to the rotation of the segment 804. Additionally, the suction cups 840 of the gripper may remain square with the objects 834 to ensure the suction cups can reliably grasp the objects. In the example of FIG. 10, the distal conveyors 842 and proximal conveyor 822 may remain parallel to one another throughout the change of position of the gripper. The angle of the segment conveyor 805 may change as the gripper is moved through its range of motion. The rollers 809 of the joint 808 and the rollers 837 of the joint 836 may accommodate this change in angle and allow an object to move in a proximal direction from the distal conveyors 842 to the segment conveyor 805 and the proximal conveyor 822.

FIG. 11 is a schematic illustrating a robotic system 800 positioned inside of a cargo carrier 832 in accordance with one or more embodiments. FIG. 11 represents an enlarged view of the state shown in FIG. 8. A segment 804 is disposed within the cargo carrier 832 and includes a segment conveyor 805. On a first side of the segment 804 is a first vision sensor 824a disposed on an arm 830a. On a second opposing side of the segment 804 is a second vision sensor 824b disposed on a second arm 830b. The overall width between the first vision sensor 824a and the second vision sensor 824b may be less than an overall width of the cargo carrier 832. A tolerance gap distance 844 is provided between the walls of the cargo carrier (not shown) and the vision sensors. In some embodiments as shown in FIG. 11, wheels 812a, 812b of the robotic system 800 may enter the cargo carrier 832.

FIGS. 12A-12F illustrate a robotic system through a process of unloading a cargo carrier 1232 adjacent to a warehouse or other structure 1213 in accordance with one or more embodiments. Specifically, FIGS. 12A-12F illustrate how the various components of a robotic system interact and are controlled (e.g., by a local controller 1236) to access and unload a plurality of objects 1234 that may be stacked in vertical columns within the cargo carrier 1232.

As shown in FIG. 12A, the robotic system 1200 includes a chassis 1202, a proximal conveyor 1204 a segment 1206, and a gripper 1208. The segment is operatively coupled to the proximal conveyor 1204 at a proximal end of the segment via a first joint providing two rotational degrees of freedom. Accordingly, a distal end of the segment 1206 may have a semispherical range of motion. The gripper 1208 is operatively coupled to the segment 1206 via a second joint 1212 providing two rotational degrees of freedom. Accordingly, a distal end of the gripper 1208 may have a semispherical range of motion. The gripper 1208 includes a plurality of suction cups 1210 (or other suitable gripper element) configured to grasp the objects 1234. The chassis 1202 is supported by legs 1220 which each include a wheel 1222. The wheels 1222 contact an environment 1214 in which the robotic system is placed, which in the example of FIGS. 12A-12F may be a warehouse. The environment 1214 includes a warehouse bay opening 1215 through which the cargo carrier 1232 is accessed. The legs 1220 are movable in a vertical direction by corresponding leg actuators 1224. In the example of FIGS. 12A-12F, the robotic system includes two legs, two wheels, and two leg actuators. In the example of FIGS. 12A-12F, the robotic system 800 cooperated with a warehouse conveyor 1216, which in some cases may be pre-existing in the environment 1214. The warehouse conveyor 1216 includes a plurality of telescoping segments 1218, allowing the warehouse conveyor to extend and retract. The warehouse conveyor 1216 of FIGS. 12A-12F includes a belt 1217. The chassis 1202 may be connected to a distal end of the warehouse conveyor, such that the distal end of the warehouse conveyor and the chassis move together in a translational degree of freedom.

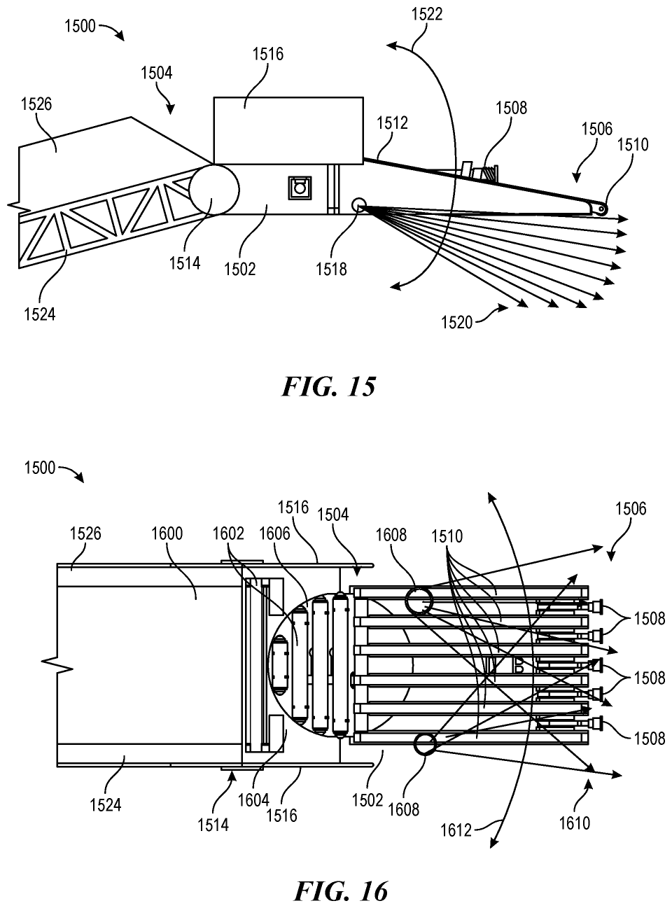

According to the embodiment of FIGS. 12A-12F, the robotic system 1200 includes a controller 1236 (including, e.g., the processor(s) 202 of FIG. 2, the storage device 204 of FIG. 2, and/or the like) configured to control the various components of the robotic system with one or more actuators. The controller 1236 is also configured to receive information from one or more sensors (e.g., the sensors 216 of FIG. 2), including upper vision sensors 1226 and lower vision sensor 1228 mounted on arms 1230. Control algorithms that may be implemented by the controller 1236 are discussed further with reference to FIGS. 15-18. For example, the controller 1236 can execute the instructions or the software 210 of FIG. 2 using the processor(s) 202 to implement the control algorithms.

The state of FIG. 12A may represent a starting state, with the robotic system 1200 positioned entirely on one side of the warehouse bay opening 1215. The warehouse conveyor segments 1218 are fully retracted. The segment 1206 may be positioned such that the gripper 1208 is at an uppermost position. For example, with respect to pitch, the segment 1206 may be at an uppermost end of its range of motion. As shown in FIG. 12A, the gripper 1208 may rotate about the second joint 1212 to ensure the gripper remains level (e.g., aligned with a horizontal plane, such as the transverse plane of the chassis illustrated in FIG. 9). In the state of FIG. 12B, the chassis 1202 of the robotic system has moved in a distal direction (e.g., right relative to the page). Correspondingly, the telescoping segments 1218 have extended in the distal direction. The gripper 1208 and its suction cups 1210 pass through the warehouse bay opening 1215 and approach the plurality of objects 1234 in the cargo carrier 1232, which are arranged in a vertical column, approximating a vertical plane (e.g., a plane generally parallel to a coronal and/or frontal plane of the cargo carrier, such as the y-z plane illustrated in FIGS. 17A-17F). The movement of the chassis 1202 in the distal direction may be provided by driving the wheels 1222 with one or more wheel motors. In some embodiments, the unloading process of the cargo carrier 1232 may begin with unloading the objects 1234 disposed at the top of the cargo carrier.

FIGS. 12C and 12D illustrate the robotic system 1200 of FIG. 12A in the second state of the process of unloading a cargo carrier in accordance with one or more embodiments. As shown in FIG. 12C, the upper vision sensors 1226 can have a first field of view 1238 and the lower vision sensors 1228 can have a second field of view 1240. FIG. 12D illustrates a perspective view of how the gripper 1208 and the segment 1206 are positioned to allow the gripper 1208 to reach the top of the plurality of objects 1234. FIG. 12D, further illustrates the first joint 1250 providing rotational degrees of freedom for the segment 1206 relative to the chassis 1202 and the proximal conveyor 1204. The gripper 1208 includes distal conveyors 1242 configured to move the objects 1234 sequentially in a proximal direction toward the segment 1206. The segment 1206 includes a segment conveyor 1246 that moves the objects 1234 sequentially in a proximal direction toward the proximal conveyor 1204. The proximal conveyor 1204 is positioned above the warehouse conveyor 1216 and is configured to move the objects 1234 sequentially in the proximal direction onto the warehouse conveyor. In some embodiments as shown in FIG. 12D, the robotic system 1200 may include guides for objects to ensure the objects remain on the sequence of conveyors. The first joint 1212 includes gripper guides 1244 that serve as boundaries for objects moving in the proximal direction. The segment 1206 also includes segment guides 1248 that serve has boundaries for moving objects along the segment conveyor 1246.

FIG. 12E illustrates the robotic system 1200 of FIG. 12A in a third state of a process of unloading a cargo carrier in accordance with one or more embodiments. FIG. 12E specifically illustrates how the objects 1234 are moved along the series of conveyors of the robotic system so that the objects can be delivered to the warehouse conveyor 1216. In the robotic system of FIGS. 12A-12F, the objects 1234 are moved sequentially (e.g., one at a time) along the series of conveyors. An object 1234 is first grasped by the suction cups 1210 of the gripper 1208. The suction cups 1210 place the object 1234 onto the distal conveyors 1242, which move the object 1234 in a proximal direction to the second joint 1212. The object 1234 then continues to the segment conveyor 1246 which continues to move the object in the proximal direction to the first joint 1250. The object 1234 then continues to the proximal conveyor 1204, which continues to move the object in the proximal direction to the warehouse conveyor 1216. In some embodiments, the joints between the various components include joint conveyors (e.g., rollers) that assist in transferring the objects between the components. In some embodiments as shown in FIG. 12E, the proximal conveyor 1204 is inclined downward to the warehouse conveyor 1216. The segment conveyor 1246 may be inclined upward or downward in the proximal direction depending on the orientation of the segment about the first joint 1250.

The robotic system 1200 of FIGS. 12A-12F may repetitively grasp and move objects in a proximal direction until an entire vertical stack of objects is removed. Subsequently, the chassis 1202 may be moved in a distal direction to advance the gripper 1208 to the next stack of objects 1234. The grasping and moving process may then repeat for the next stack of objects. Subsequently, the chassis 1202 may be moved again in a distal direction to advance the gripper 1208 to the next stack of objects 1234. This pattern may repeat until all objects 1234 from the cargo carrier 1232 are unloaded. The chassis 1202 may be moved any time throughout this process.

As discussed above with reference to FIGS. 5-6, the rotation of the segment 1206 effects a position change of the gripper 1208. However, as the gripper 1208 is coupled to a distal end of the segment 1206, the gripper 1208 moves in an arc with the rotation of the segment 1206. With two degrees of freedom (e.g., pitch and yaw), the segment 1206 moves the gripper 1208 in a semispherical range of motion. Accordingly, with respect to the vertical plane of objects 1234, if the chassis 1202 remains stationary, the gripper 1208 will move toward or away the objects depending on the angle of the segment 1206 in pitch and yaw. A maximum reach of the gripper 1208 will be at a location corresponding to zero pitch and zero yaw of the segment 1206. Correspondingly, a minimum reach of the gripper 1208 will be at a location corresponding to maximum pitch or maximum yaw of the segment 1206. At the minimum reach, the suction cups 1210 may not be able to reach the objects 1234 arranged in the vertical plane. Accordingly, in some embodiments, the chassis 1202 may move in a distal or proximal direction to compensate for the change in position of the gripper 1208 with respect to the objects 1234 caused by the rotation of the segment 1206. For example, as the segment increases in pitch angle, the wheels 1222 may be driven (e.g., by wheel motors) to move the chassis 1202 in a distal direction to maintain the gripper 1208 at a desired distance from the plane of the objects 1234. Continuing this example, as the segment decreases in pitch angle (e.g., returning to zero), the wheels 1222 may be driven to move the chassis 1202 in a proximal direction to maintain the gripper 1208 at the desired distance from the plane of the objects 1234. A similar approach may be employed for change of a yaw angle of the segment 1206. In this manner, the position of the gripper 1208 may be changed with respect to the objects 1234 without moving the gripper 1208 out of range of the objects.

FIG. 12F illustrates the robotic system 1200 of FIG. 12A in a fourth state of a process of unloading a cargo carrier in accordance with one or more embodiments. The state of FIG. 12F in particular illustrates how the robotic system 1200 moves into the cargo carrier 1232 to continue to unload objects 1234 in additional vertical stacks. In some embodiments as shown in FIG. 12F, the wheels 1222 of the robotic system 1200 may move into the cargo carrier 1232 and may rest on a floor 1233 of the cargo carrier. The legs 1220 may move in a vertical direction to ensure the components of the robotic system 1200 clear the internal vertical dimension of the cargo carrier. As shown in FIG. 12F, the telescoping segments 1218 may extend past a warehouse bay opening 1215 in some embodiments and into the cargo carrier 1232. In other embodiments a warehouse conveyor may remain entirely in a warehouse, as the present disclosure is not so limited. Additionally, in some embodiments the proximal conveyor 1204 may extend and retract instead of or in addition to the warehouse conveyor 1216.

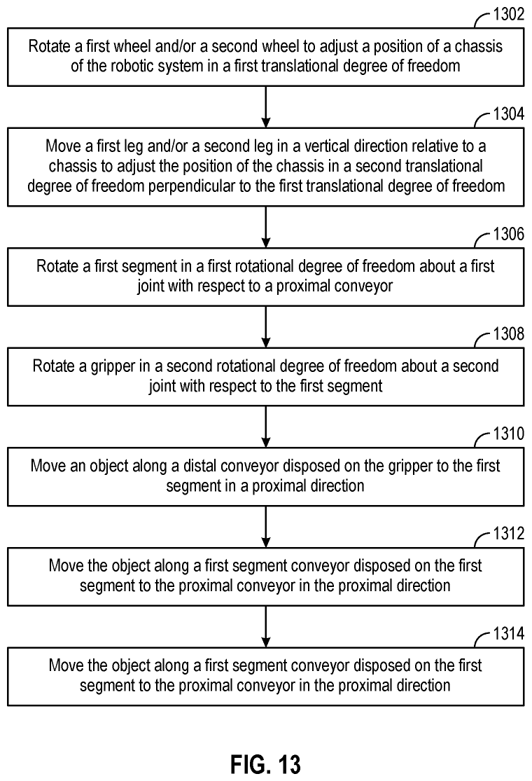

FIG. 13 is a flow diagram illustrating a process of operating a robotic system in accordance with one or more embodiments. For example, one or more of the robotic systems described above can execute the software through one or more of the processors, thereby controlling one or more actuators/motors and interacting with sensors, to implement the process.

At block 1302, the process includes rotating a first wheel and/or a second wheel to adjust a position of a chassis of the robotic system in a first translational degree of freedom (e.g., a distal/proximal degree of freedom). In some embodiments, rotating the first wheel and/or second wheel may include driving a first wheel motor coupled to the first wheel and a second wheel coupled to the second wheel.

The robotic system can control the first wheel and/or the second wheel to position the chassis and/or actuators for the proximal conveyor 1204 (e.g., an exit location) such that the chassis and/or the end portion of the proximal conveyor 1204 overlaps the warehouse conveyor 1216 (e.g., the receiving structure location) as the transferred objects move past the rear segment. For example, the robotic system can control the position of the chassis as the warehouse conveyor 1216 moves so that the exit location remains with a targeted receiving location on the warehouse conveyor 1216.

At block 1304, the process further includes moving a first leg and/or a second leg in a vertical direction relative to a chassis to adjust the position of the chassis in a second translational degree of freedom perpendicular to the first translational degree of freedom. Accordingly, the robotic system can maintain the chassis above the warehouse conveyor 1216. In some embodiments, moving the first leg and/or second leg includes rotating the first leg and/or second leg relative to the chassis. In some embodiments, the first leg and second leg may be moved in the vertical direction independently of one another. Moving the first leg and/or second leg may include commanding one or more leg actuators to move the first leg and/or second leg relative to the chassis. Additionally, the robotic system can control the actuators for the proximal conveyor 1204 to adjust an angle/pose thereof, thereby maintaining the end portion of the proximal conveyor 1204 within a threshold height from the top surface of the warehouse conveyor 1216.

At block 1306, the process further includes rotating a first segment in a first rotational degree of freedom about a first joint with respect to a proximal conveyor. In some embodiments, the first rotational degree of freedom is a pitch degree of freedom. In some embodiments, the process may further include rotating the first segment in a roll degree of freedom. Rotating the first segment may include commanding one or more actuators to move the first segment about the first joint. In some embodiments, the one or more actuators may be disposed in the first joint.

At block 1308, the process further includes rotating a gripper in a second rotational degree of freedom about a second joint with respect to the first segment. In some embodiments, the second rotational degree of freedom is a pitch degree of freedom. In some embodiments, the process may further include rotating the gripper in a roll degree of freedom. Rotating the gripper may include commanding one or more actuators to move the gripper about the second joint. In some embodiments, the one or more actuators may be disposed in the second joint.

At block 1310, the process includes moving an object along a distal conveyor disposed on the gripper to the first segment in a proximal direction. At block 1312, the process further includes moving the object along a first segment conveyor disposed on the first segment to the proximal conveyor in the proximal direction.

At block 1314, the process further includes moving the object along the proximal conveyor in the proximal direction. In some embodiments, the object may be moved onto a warehouse conveyor from the proximal conveyor. The robotic system can control the speed of the proximal conveyor according to the pose and/or the height of the exit point above the warehouse conveyor.

In some embodiments, the process may include detecting the object with one or more vision sensors. That is, image information including the object may be obtained and processed to identify the object. The acts of 1306 and 1308 may be based in part on the image information and the identified object. The object may be grasped (e.g., by one or more gripping elements in the gripper) and placed on the distal conveyor of the gripper.

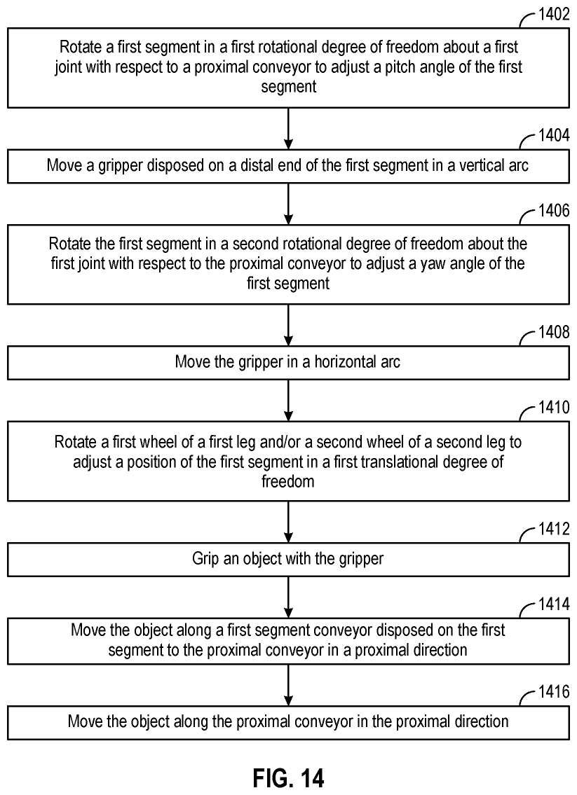

FIG. 14 is a flow diagram illustrating a process of operating a robotic system in accordance with one or more embodiments. For example, one or more of the robotic systems described above can execute the software through one or more of the processors, thereby controlling one or more actuators/motors and interacting with sensors, to implement the process.

At block 1402, the process includes rotating a first segment in a first rotational degree of freedom about a first joint with respect to a proximal conveyor to adjust a pitch angle of the first segment. In some embodiments, rotating the first segment may include operating one or more actuators to move the first segment. In some embodiments, the one or more actuators may be disposed in the first joint.

At block 1404, the process includes moving a gripper disposed on the distal end of the first segment in a vertical arc. The movement in the vertical arc may be based on the rotation of the first segment, as the gripper may be attached to a distal end of the first segment, and the first segment may rotate about its proximal end at the first joint. Accordingly, a change in pitch of the first segment moves the gripper in a vertical arc.

At block 1406, the process includes rotating a first segment in a second rotational degree of freedom about the first joint with respect to the proximal conveyor to adjust a yaw angle of the first segment. In some embodiments, rotating the first segment may include operating the one or more actuators to move the first segment.

At block 1408, the process includes moving a gripper disposed on the distal end of the first segment in a horizontal arc. The movement in the horizontal arc may be based on the rotation of the first segment, as the gripper may be attached to a distal end of the first segment, and the first segment may rotate about its proximal end at the first joint. Accordingly, a change in pitch of the first segment moves the gripper in a horizontal arc. In some embodiments, the movement in the horizontal arc and the vertical arc moves the gripper within a semispherical range of motion.

At block 1410, the process includes rotating a first wheel of a first leg and/or a second wheel of a second leg to adjust a position of the first segment in a first translational degree of freedom. The translational degree of freedom may be in a distal/proximal direction, aligned with a longitudinal axis of the robotic system. The rotation of the first wheel and/or second wheel may move the gripper in the translational degree of freedom as well. In this manner, a distance between the gripper and a vertical plane may be maintained despite the movement of the gripper in an arc. In some embodiments, the first translational degree of freedom is perpendicular to the vertical plane. The vertical plane may be representative of a stack of objects within a cargo carrier (e.g., a plane generally parallel to a coronal and/or frontal plane of the cargo carrier, such as the y-z plane illustrated in FIGS. 17A-17F).

At block 1412, the process includes gripping an object with the gripper. In some embodiments, gripping the object with a gripper includes applying a vacuum force to one or more suction cups in contact with the object (and/or another suitable drive force to another suitable gripping element).

At block 1414, the process includes moving the object along a first segment conveyor disposed on the first segment to the proximal conveyor in a proximal direction. In some embodiments, the gripper may place the object on the first segment conveyor. In some embodiments, the one or more suction cups may place the object onto one or more distal conveyors of the gripper, which move the object in a proximal direction to the first segment conveyor.

At block 1416, the process includes moving the object along the proximal conveyor in the proximal direction. In some embodiments, the process may include moving the object to a warehouse conveyor. In some embodiments, the first segment conveyor may include a belt, and the proximal conveyor may include a belt.

In some embodiments, the process further includes moving the gripper both linearly and arcuately to position the gripper to a target gripping position for gripping the object (e.g., a position immediately in front of or otherwise adjacent to the object). In some embodiments, the process further includes selecting the object and translating the first segment relative to the object while the gripper moves along the first arc and/or the second arc to move the gripper toward a target gripping position for gripping the object. In some embodiments, the process further includes determining a pick-up path (e.g., including linear and/or arcuate path portions) for moving the gripper toward a target gripping position for gripping the object, and reconfiguring the robotic system to move the gripper along the pick-up path while the gripper moves along the first arc and/or the second arc. In some embodiments, the pick-up path is determined based, at least in part, on one or more joint parameters of the first joint and/or the second joint. In some embodiments, the one or more joint parameters includes at least one of a range of motion, a joint speed, joint strength (e.g., high torque), or a joint accuracy.

In some embodiments, the process further includes controlling the robotic system to move the gripper along a pick-up path toward a target gripping position for the gripper to grip the object, and wherein the pick-up path is a linear path or a non-linear path. In some embodiments, the process further includes moving the robotic system along a support surface while the first joint and/or second joint move the gripper. In some embodiments, the process further includes controlling the robotic system to move the gripper toward the object to compensate for movement along at least one of the first arc or the second arc to position the gripper at a gripping position for gripping the object.

### Example EOAT for the End-Point Interface System

FIG. 15 is a side schematic of a gripper assembly 1500 for a robotic system in accordance with one or more embodiments. According to the embodiment of FIG. 15, the gripper assembly includes a gripper frame 1502. The gripper frame has a proximal end 1504 and a distal end 1506. The gripper includes a plurality of suction cups 1508 (and/or any other suitable gripping element). As discussed further herein, the suction cups 1508 may move relative to the gripper frame 1502 to lift and drag/carry objects onto distal conveyors 1510. In some embodiments as shown in FIG. 15, the distal conveyors 1510 may extend to the distal end 1506 of the gripper assembly. The distal conveyors may each include a belt configured to move objects toward the proximal end, in some embodiments. As shown in FIG. 15, the gripper frame 1502 can include an inclined portion 1512. The inclined portion may assist the gripper frame 1502 in fitting into a cargo carrier and reaching objects disposed near the internal walls of the cargo carrier. Additionally, such an arrangement may assist in moving objects onto the conveyors and avoiding object stiction. The distal conveyors 1510 may be inclined along with the inclined portion 1512. The gripper assembly also includes gripper guides 1516 configured to guide the object across a joint 1514. The joint 1514 couples the gripper frame 1502 to a segment 1524. The segment 1524 includes segment guides 1526 which keep objects on the segment.

As shown in FIG. 15, the gripper assembly 1500 includes a distance sensor 1518. The distance sensor 1518 may be a distance sensor configured to collect a plurality of distance measurements 1520 in a vertical direction 1522. As discussed further below, such distance measurements may supplement image information and may be used to identify and remove objects from a vertical stack of objects. In some embodiments as shown in FIG. 15, the distance sensor 1518 may obtain its distance measurements 1520 below the gripper frame 1502 in a distal direction.

FIG. 16 is a top schematic of the gripper assembly 1500 of FIG. 15. The view of FIG. 16 better illustrates the conveyor arrangement and the joint 1514. As shown in FIG. 16, the gripper assembly 1500 includes a plurality of suction cups 1508 (and/or another suitable gripping element) and distal conveyors 1510. In the depicted example, the distal conveyors 1510 and suction cups 1508 alternate with one another. For example, each suction cup is positioned between two conveyors, and the conveyors are positioned between two suction cups. Each distal conveyor 1510 includes a belt in the example of FIG. 16 that is configured to support an object and move the object in a proximal direction toward the segment 1524. The segment 1524 includes a segment conveyor 1600 configured to receive the object and continue moving the object in the proximal direction.

The joint 1514 shown In FIG. 16 provides rotational degrees of freedom to the gripper frame 1502 as discussed with reference to other embodiments herein. In the depicted example, the joint 1514 includes a first joint portion 1604 (e.g., a socket portion) and a second joint portion 1606 (e.g., a ball portion) configured to rotate within the first joint portion 1604. The joint 1514 also includes a plurality of rollers 1602 that may be driven to move an object across the first joint from the distal conveyors 1510 to the segment conveyor 1600. In some embodiment, at least some of the rollers may be driven to rotate. In some embodiments, at least some of the rollers may be passive and free spinning. As shown in FIG. 16, the rollers on the first joint portion 1604 and the rollers on the second joint portion 1606 overlap with one another, such that even as the joint moves an object may move from the first joint portion to the second joint portion on the roller.

As shown in FIG. 16, the gripper assembly 1500 further includes distance sensors 1608. The distance sensors 1608 may be distance sensors configured to collect a plurality of distance measurements 1610 in a horizontal direction 1612. As discussed further below, such distance measurements may supplement image information and may be used to identify and remove objects from a vertical stack of objects. In some embodiments as shown in FIG. 15, the distance sensors 1608 may obtain their distance measurements 1610 in a distal direction. In some embodiments, the distance measurements 1610 may be taken below the gripper frame 1502. In some embodiments, the distance sensors 1608 may include the distance sensor 1518. For example, a single distance sensor may be configured to obtain distance measurements in a vertical direction and a horizontal/lateral direction. In some embodiments, while two distance sensors 1608 are shown in FIG. 16, in other embodiments a single distance sensor may be employed or any number of distance sensors, as the present disclosure is not so limited.

FIGS. 17A-17F are schematics illustrating a process of operating a robotic system in accordance with one or more embodiments. The schematic shown in FIGS. 17A-17F is representative of an image 1700 (e.g., a visual 2D representation, such as color or grayscale image, a 3D representation, or a combination thereof) and how that image is used to control a gripper (e.g., the gripper 306 of FIG. 3, 806 of FIG. 8, 1500 of FIG. 15, etc.) to remove objects from a vertical stack in a reliable and efficient manner. In the example of FIG. 17A, the image can depict a first object 1702A, a second object 1702B, a third object 1702C, and a fourth object 1702D. The objects of FIGS. 17A-17F may be representative of boxes, for example, of mixed sizes (e.g., mixed stock keeping units (SKU)) disposed in a cargo carrier. The image 1700 may be taken in a horizontal direction perpendicular to a vertical plane in which the objects 1702A-1702D are arranged (e.g., a plane generally parallel to a coronal and/or frontal plane of the cargo carrier, such as the y-z plane). According to the example of FIGS. 17A-17F, each object includes four boundaries: two side boundaries (e.g., side boundary 1707A), a top boundary, and a bottom boundary (e.g., bottom boundary 1705A).

FIG. 17A is a schematic illustrating a first state of the process. The image in FIG. 17A may be obtained from one or more vision sensors (e.g., upper and/or lower vision sensors described above, such as in FIG. 3, FIG. 8, etc.). The vision sensors may be mounted on a portion of a robotic system. Based on the image 1700, a minimum viable region (MVR) 1704 is computed and applied to the image 1700. The MVR 1704 can represent a portion in the image having a sufficient likelihood (e.g., according to a predetermined confidence threshold/requirement) of corresponding to one object or one continuous surface. Accordingly, the robotic system can compute a unique instance of the MVR 1704 for one or more of the objects 1702A-1702D.

In computing the MVR 1704, the robotic system can process 2D and/or 3D features in the image 1700 to identify a reference or a starting point, such as an exposed 3D corner and a corresponding edge. Using the reference, the robotic system can compute the MVR 1704 by determining or overlaying or computing a rectangular area (e.g., an Axis-Aligned Bounding Box (AABB)) aligned with the reference corner/edge. The rectangular area (e.g., edges complementing/opposing and intersecting with the reference edges) can be computed using a variety of features, such as a minimum grip area/shape of the gripper and/or dimensions of a known/expected smallest object/SKU. Additionally or alternatively, the robotic system can compute the rectangular area based on features, such as edges and related attributes, depicted in the image. Some examples of the edge attributes can include whether the detected edge is a 2D or 3D edge, a confidence value associated with the detection of the edge, whether the edge intersects another edge, an angle between the intersecting edges, a length of the edge between intersections, a thickness or a width of the edge, a clarity measure for the edge, and/or a separation between the edge and a corresponding/parallel edge.

Moreover, the robotic system can be configured to compute the MVR 1704 as an area overlapping and/or contained within the actual exposed surface of the corresponding object. In other words, the robotic system can be configured to contain the MVR 1704 within the corresponding object. Otherwise, when the object/edge detection provides sufficiently accurate results, the robotic system can determine the MVR 1704 to match the exposed surface of the object such that the edges of the MVR 1704 match the actual edges of the corresponding object. In this manner, the MVR represents a safe location for the object to be grasped, and is spaced from the boundaries of the object bordering other objects, for example, bottom boundary 1705A and side boundary 1707A. As a result, the MVR 1704 may have a vertical delta 1706 to the bottom boundary 1705A and a horizontal delta 1708 to the side boundary 1707A. In other embodiments, the MVR 1704 may be assigned by one or more computer vision algorithms with a margin of error.

In using the 3D corner (e.g., an intersection of two bisecting edges detected in the 3D image data), the robotic system can compute an initial MVR and iteratively compute the MVR as objects are removed from the stack to expose new 3D corners. In some embodiments as shown in FIG. 17A, the initial MVR may correspond to the uppermost and leftmost object (e.g., an object having its left vertical edge exposed or abutting a container wall) depicted in the image. In other embodiments, an initial MVR identified may correspond to the uppermost and rightmost object (e.g., an object having its right vertical edge exposed or abutting a container wall) depicted in the image. In some embodiments, an initial MVR identified may correspond to any uppermost object.

FIG. 17B is a schematic illustrating a second state of the process. After the MVR 1704 is computed using the image 1700, a gripper 1710 (e.g., one or more of the grippers described above, such as in FIG. 3, FIG. 8, FIG. 15, etc.) can be used to grasp the first object 1702A corresponding to the MVR 1704. Specifically, the robotic system can compute a maximum number and corresponding locations of suction cups 1712 that can fit within the MVR 1704. The robotic system can operate the actuators and place the gripper 1710 such that the targeted suction cup(s) 1712 are aligned with the computed location(s). The robotic system can then use the one or more suction cups 1712 (and/or another suitable gripping elements) to grasp the first object within the MVR 1704. In the case that the gripper 1710 includes other suction cups 1712 that end up outside of the MVR 1704, the robotic system may only utilize or actuate the suction cups disposed within the MVR 1704 to grasp the first object 1702A. In some embodiments, the gripper 1710 may be positioned adjacent the first object 1702A by rotating a segment and moving a chassis in a translational degree of freedom, as discussed with reference to other embodiments herein. In some embodiments, the gripper includes a vacuum generator connected to the suction cup configured to generate and supply a vacuum force to the suction cup. In such embodiments, grasping the first object 1702A may include placing the suction cup 1712 in contact with the first object and generating the vacuum force for the suction cup with the vacuum generator.

FIG. 17C is a schematic illustrating a third state of the process. As shown in FIG. 17C, the gripper 1710 can initially displace (e.g., lift) the first object 1702A after the first object 1702A is grasped within the MVR 1704. For example, the robotic system can perform the initial lift based on retracting the suction cups 1508 of FIG. 15 from a fully extended position (e.g., as shown in FIG. 16 and/or having its bottom portion coplanar with or below the distal conveyors 1510) to a higher position. Lifting the first object 1702A creates a gap 1716 between the bottom boundary 1705A of the first object 1702A and an underlying object (e.g., fourth object 1702D). As shown in FIG. 17C, the gripper 1710 may include a distance sensor 1714 (e.g., the distance sensors 1518 and/or 1608 described above in relation to FIG. 15 and FIG. 16) configured to obtain a plurality of distance measurements in a vertical direction and/or a lateral direction. In the example of FIG. 17C, the distance sensor 1714 is configured to obtain a series of distance measurements in a vertical direction (e.g., the z-direction) across the gap 1716 and the bottom boundary 1705A of the first object 1702A. In some embodiments, the distance sensor may be a laser rangefinder, for example, measuring distances by time of flight or phase shift of a laser. The plurality of distance measurements may be used to detect the position of the bottom boundary 1705A of the first object 1702A. For example, there may be a stepwise change in the distance measurements between measurements of the gap 1716 and the bottom boundary 1705A. In some cases, such a stepwise change may be indicative of the presence of the bottom boundary 1705A. In some such embodiments, the change in distance measurements may be compared to a predetermined non-zero threshold, where exceeding the threshold is indicative of the bottom boundary 1705A. In other embodiments other criteria may be employed, such as a profile of distance measurements matching a predetermined profile, as the present disclosure is not so limited.

FIG. 17D is a schematic illustrating a fourth state of the process. In some cases as shown in FIG. 17D, the first object 1702A may be released by the gripper, such that the gap 1716 of FIG. 17C is eliminated. For example, the engaged suction cups 1508 can return to the fully extended position and then deactivated to release the object at or about its initial location. Based on the distance measurements taken in the vertical direction, the position of the bottom boundary 1705A may be identified and the MVR 1704 updated to remove the vertical delta 1706 shown in FIGS. 17A-17C. For example, the robotic system can reestablish the bottom edge of the MVR 1704 and/or verify the bottom edge according to the bottom boundary 1705A observed during the initial lift. Accordingly, as of the state in FIG. 17D, the MVR can have a vertical dimension that matches that of the first object 1702A. In some cases, the step of releasing the first object shown in FIG. 17D may be optional.

FIG. 17E is a schematic illustrating a fifth state of the process. As shown in FIG. 17E, the first object 1702A is grasped in the updated MVR 1704 with one or more suction cups 1712. For example, the robotic system can place the suction cups 1712 closer to or aligned with the verified bottom boundary 1705A. Additionally, based on one or more lateral distance measurements from the first initial lift, the robotic system can confirm that a minimum width of the previous gap exceeds the lateral dimension of the MVR 1704. Accordingly, the robotic system can extend the lateral dimensions of the MVR 1704 correspondingly and determine that additional suction cups may be used to grip the object. Based on the reestablished or updated grip, the gripper 1710 further lifts the first object 1702A to generate the gap 1716 again. In some embodiments, the suction cup 1712 may lift the first object 1702A relative to a gripper conveyor, for example, in a vertical direction.

As shown in FIG. 17E, the gripper 1710 may include a second distance sensor 1718 configured to obtain a plurality of distance measurements in a lateral direction. In the example of FIG. 17E, the second distance sensor 1718 is configured to obtain a series of distance measurements in a horizontal direction (e.g., the y-direction) across the gap 1716 and the side boundary 1707A of the first object 1702A. In some embodiments, the second distance sensor may be a laser rangefinder, for example, measuring distances by time of flight or phase shift of a laser.

The plurality of distance measurements may be used to detect the position of the side boundary 1707A of the first object 1702A. For example, there may be a stepwise change in the distance measurements between measurements of the gap 1716 and measurements of the second object 1702B that is adjacent with the first object 1702A. In some cases, such a stepwise change may be indicative of the presence of the side boundary 1707A, inferred from the boundary being shared with the second object 1702B. In some such embodiments, the change in distance measurements may be compared to a predetermined non-zero threshold, where exceeding the threshold is indicative of the side boundary 1707A. In other embodiments other criteria may be employed, such as a profile of distance measurements matching a predetermined profile, as the present disclosure is not so limited. In some embodiments, the distance sensor 1714 and the second distance sensor 1718 may be a single distance sensor.

For illustrative purposes, the robotic system is described as performing two initial lifts with corresponding directional measurements to detect/validate the actual edges. However, it is understood that the robotic system can perform the measurements and validate the edges through one initial lift. For example, one or more distance sensors (e.g., LIDAR sensors) may be employed to obtain distance measurements in a vertical direction and a horizontal direction. Accordingly, the measurements shown in FIG. 17E and the measurements shown in 17C may be taken at the same time following or during the one initial lift.

FIG. 17F is a schematic illustrating a sixth state of the process. In some cases, as shown in FIG. 17F, the first object 1702A may be again released by the gripper, such that the gap 1716 of FIG. 17E is eliminated. Based on the distance measurements taken in the horizontal direction, the position of the side boundary 1707A may be identified and the MVR 1704 updated or expanded to remove the horizontal delta 1708 shown in FIGS. 17A-17E. Accordingly, as of the state in FIG. 17F, the MVR shares a horizontal dimension with the first object 1702A.

Once the MVR 1704 is updated in the vertical and horizontal directions, the gripper 1710 may regrasp the first object 1702A across the entire MVR, for example, with multiple/additional suction cups 1712. In some embodiments, multiple suction cups 1712 may be arranged in a line (e.g., a horizontal line). For example, a first suction cup, a second suction cup, and a third suction cup are arranged in a line (e.g., in the y-direction), as shown in FIG. 17F. In some embodiments, once the MVR 1704 has been fully updated and thus verified, the gripper 1710 may grasp the first object proximate the bottom boundary 1705A.

For illustrative purposes, the robotic system is described as releasing or re-placing the object after the initial lift and then regripping per the verified MVR. However, it is understood that the robotic system can update/verify the MVR, identify the additional suction cups, and operate the additional suctions cups without releasing or re-placing the object. In other words, the robotic system can determine and apply the additional grip while the object is in the initially lifted position.

The process of FIGS. 17A-17F may be repeated for other object (e.g., objects having detection confidence values below a predetermined threshold) in a vertical stack in the image 1700. Once the first object is removed after updating the MVR 1704, the MVR may be subtracted from the image 1700. For example, the robotic system can adjust or update the initial image captured by the upper/lower image sensors by overlaying the verified MVR of the removed object on the initial image and considering the overlaid MVR as a gap or an empty space. Accordingly, the next MVR may be assigned based on the remaining image including the other objects. For example, the robotic system can identify the object 1702B as the next target object and consider its upper left corner and left edge (previously abutting the object 1702A) as being exposed based on the updates to the image 1700. Also, the robotic system can similarly identify the object 1702D as having its upper left corner and the upper edge (previously abutting the object 1702A) as being exposed based on the updates to the image 1700.

In this manner, the robotic system can remove multiple objects or even entire stack(s) (e.g., exposed layer of objects) using one image provide by the upper/lower image sensors. In some embodiments, the process described with reference to FIGS. 17A-17F may be repeated for multiple objects or each object within a vertical stack. In some embodiments, a robotic system may prioritize removal of object at an uppermost level within a cargo container, in a left to right direction (e.g., left-most or right most object located on the uppermost level of a corresponding layer/stack).

Additionally, the robotic system can prioritize sufficiently detected objects. In detecting the object, the robotic system can determine that depicted portions (e.g., an area bounded by sufficiently detected edges) of the image 1700 of FIG. 17A matches corresponding attributes (e.g., dimensions and/or surface image/texture) of registered objects in the master data 252 of FIG. 2. When the confidence level of the match exceeds a predetermined detection threshold, the robotic system can consider/recognize the corresponding portion of the image as depicting the registered object. The robotic system can identify and/or validate the location of the object edges based on the image 1700 and the registered attributes, such as by using the matched portion and extrapolating the surface using the registered dimensions. Based on the detection, the robotic system can prioritize removal of detected objects in the top row/layer as shown in the image. Additionally or alternatively, the robotic system can consider portions of the image adjacent to the detected objects as either being empty (e.g., by comparing with 3D portion of the image) or belonging to an unrecognized object. Similar to the use of the verified MVR of the removed object, the robotic system can consider edges/corners of unrecognized objects abutting detected objects as being exposed. Accordingly, the robotic system can leverage the detected objects in computing the MVRs for the unrecognized objects as described above.

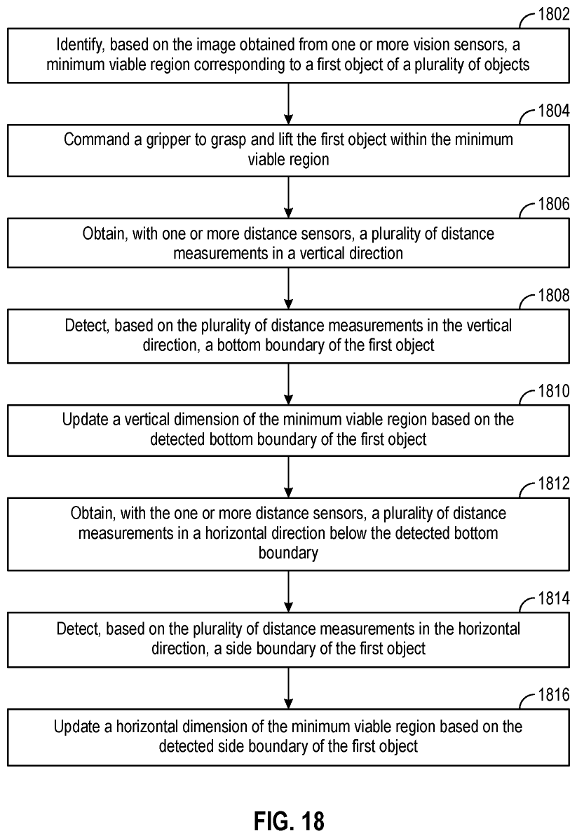

FIG. 18 is a flow diagram illustrating a process of operating a robotic system in accordance with one or more embodiments. The flow diagram of FIG. 18 may correspond to the process shown in FIGS. 17A-17F, in some embodiments. At block 1802, the process includes identifying, based on an image obtained from one or more vision sensors (e.g., sensors located between the chassis and the gripper, such as the upper/lower image sensors), an MVR corresponding to a first object of a plurality of objects. At block 1804, the process further includes commanding a gripper to grasp and lift the first object within the MVR. At block 1806, the process includes obtaining, with one or more distance sensors, a plurality of distance measurements in a vertical direction. At block 1808, the process includes detecting, based on the plurality of distance measurements in the vertical direction, a bottom boundary of the first object. At block 1810, the process includes updating a vertical dimension of the MVR based on the detected bottom boundary of the first object. At block 1812, the process includes obtaining, with the one or more distance sensors, a plurality of distance measurements in a horizontal direction below the detected bottom boundary. At block 1814, the process includes detecting, based on the plurality of distance measurements in the horizontal direction, a side boundary of the first object. At block 1816, the process includes updating a horizontal dimension of the MVR based on the detected side boundary of the first object.

As described above, the process can further include gripping the object based on the updated/verified MVR and transferring the grasped object. For example, the robotic system can transfer the grasped object out of the container (via, e.g., the conveyors over the gripper and the sections) and onto the conveyor segment of the warehouse as described above. Based on the verified MVR and/or removal of the corresponding object, the robotic system can update the image. The robotic system can use the updated image in processing the next target object. Accordingly, the robotic system can iteratively implement the process and remove multiple unrecognized and/or detected objects using one image. The robotic system can obtain a new image based on reaching a predetermined condition, such as a removal of predetermined number of objects, removal of all exposed/accessible regions depicted in the image, and/or other similar operating conditions.

### Example Chassis for Robotic System

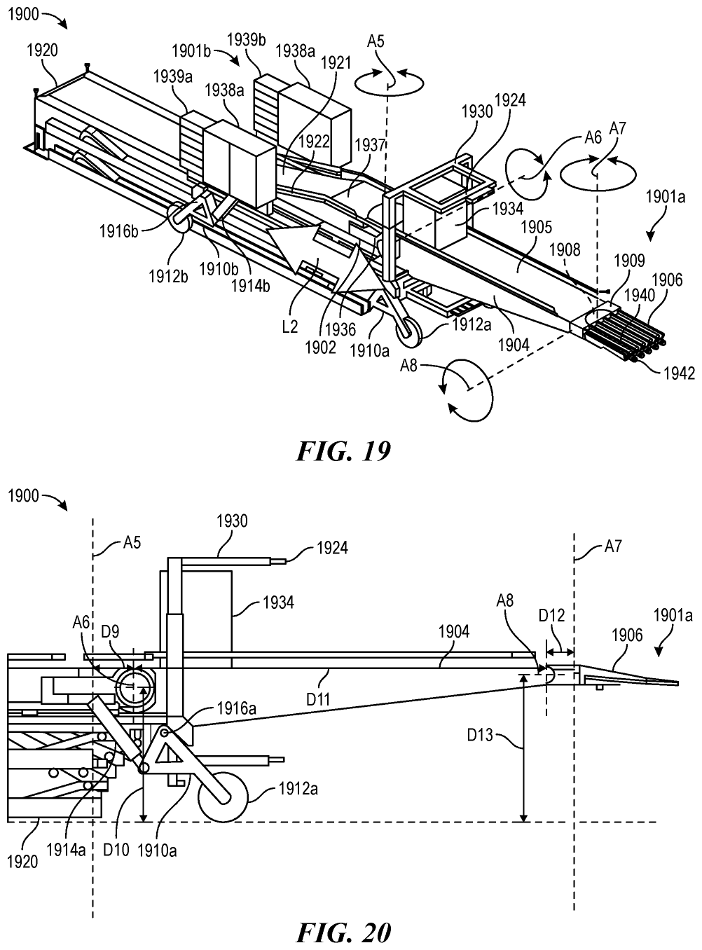

FIG. 19 is a perspective view of a robotic system 1900 in accordance with embodiments of the present technology. The robotic system 1900 can be an example of the robotic system 100 illustrated in and described above with respect to FIG. 1. The robotic system 1900 is positioned on top of a conveyor segment 1920 that may already be present at a warehouse or other operating site. In the illustrated embodiment, the robotic system 1900 includes a chassis 1902, a first segment 1904 coupled to the chassis 1902 and extending toward a distal portion 1901a of the robotic system 1900, a second segment 1921 coupled to the chassis 1902 and extending toward a proximal portion 1901b of the robotic system 1900, and a gripper 1906 coupled to the first segment 1904 at the distal portion 1901a. The robotic system 1900 can also include supporting legs 1910 coupled to the chassis 1902, one or more controllers (individually labeled 1938a, 1938b, collectively referred to as “controllers 1938”) and one or more counterweights (individually labeled 1939a, 1939b, collectively referred to as “counterweights 1939”) supported by the chassis 1902, first joint rollers 1909 coupled between the first segment 1904 and the gripper 1906, and second joint rollers 1937 coupled between the first segment 1904 and the second segment 1921. The chassis 1902, the first segment 1904, the second segment 1921, the supporting legs 1910, and/or other components of the robotic system 1900 can be made from metal (e.g., aluminum, stainless steel), plastic, and/or other suitable materials.

The chassis 1902 can include a frame structure that supports the first segment 1904, the second segment 1921, the controllers 1938, the counterweights 1939, and/or a sensor mount 1930 coupled to the chassis 1902. In the illustrated embodiment, the sensor mount 1930 extends vertically on either side of the first segment 1904 and horizontally over the first segment 1904. One or more sensors 1924 (e.g., vision sensors) are coupled to the sensor mount 1930 and are positioned to generally face toward the distal portion 1901a. In some embodiments, the sensor mount 1930 does not extend horizontally over the first segment 1904 such that cargo 1934 may travel along the first segment 1904 without a height restriction imposed by the sensor mount 1930.

The first segment 1904 is coupled to extend from the chassis 1902 toward the distal portion 1901a in a cantilevered manner. The first segment 1904 supports a first conveyor 1905 (e.g., a conveyor belt) extending along and/or around the first segment 1904. The second segment 1921 is coupled to extend from the chassis 1902 toward a proximal portion 1901b of the robotic system 1900. The second segment 1921 supports a second conveyor 1922 (e.g., a conveyor belt) extending along and/or around the second segment 1921. In some embodiments, one or more actuators 1936 (e.g., motors) configured to move the first and second conveyors 1905, 1922 are coupled to the chassis 1902. In some embodiments, the actuators are positioned elsewhere (e.g., housed in or coupled to the first and/or second segments 1904, 1921). The actuators 1936 (or other actuators) can be operated to rotate the first segment 1904 about a fifth axis A₅ and/or a sixth axis A₆. In some embodiments, the actuators 1936 can also pivot the second joint rollers 1937 about the first and second axes A₅, A₆ or different axes. In some embodiment, as illustrated in FIG. 19, the fifth axis A₅ can be generally orthogonal to a transverse plane of the chassis 1902 (e.g., a second plane P₂ illustrated in FIG. 8) while the sixth axis A₆ can be generally parallel to the transverse plane of the chassis 1902. As a result, movement and/or rotation of the first segment 1904 relative to the chassis 1902 can be generally similar to the movement and/or rotation of the first segment 304 as discussed in further detail above with respect to FIGS. 5-7B.

As mentioned above, the gripper 1906 can be coupled to extend from the first segment 1904 toward the distal portion 1901a with the first joint rollers 1909 positioned therebetween. In some embodiments, the gripper 1906 includes suction cups 1940, any other suitable gripping element, and/or a distal conveyor 1942. In some embodiments, one or more actuators 1908 (e.g., motors) are configurated to rotate the gripper 1906 and/or the first joint rollers 1909 relative to the first segment 1904 about a seventh axis A₇ and/or an eighth axis A₈. As illustrated in FIG. 19, the seventh axis A₇ can be generally parallel to a longitudinal plane of the gripper 1906 (e.g., the third plane P₃ illustrated in FIG. 43A) while the eighth axis A₈ can be generally orthogonal to the longitudinal plane of the gripper 1906. Additionally, or alternatively, the seventh axis A₇ can be generally orthogonal to a transverse plane of the gripper 1906 (e.g., the fourth plane P₄ illustrated in FIG. 42A) while the eighth axis A₈ can be generally parallel orthogonal to the transverse plane of the gripper 1906. In some embodiments, as discussed in more detail below, the robotic system 1900 can maintain the transverse plane of the gripper 1906 generally parallel with the transverse plane of the chassis 1902 (e.g., such that rotation about the sixth axis A₆ is met with an opposite rotation about the eighth axis A₈. As a result, for example, in some embodiments, the seventh axis A₇ can be generally orthogonal to the transverse plane of the chassis 1902 and/or the eighth axis A₈ can be generally parallel to the transverse plane of the chassis 1902.

In some embodiments, the actuators 1908 (or other actuators) are configured to operate the suction cups 1940 and/or the distal conveyor 1942. In some embodiments, the actuators 1908 are coupled to the first segment 1904, the first joint rollers 1909, and/or the gripper 1906. Movement and/or rotation of the gripper 1906 relative to the first segment 1904 and components of the gripper 1906 are described in further detail herein.

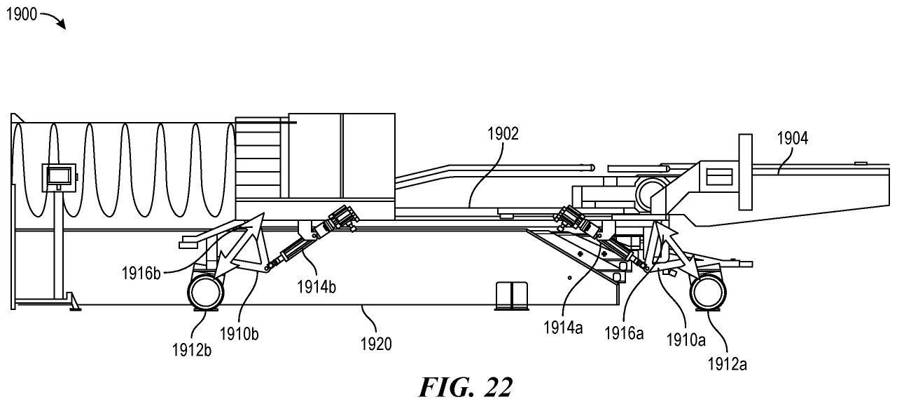

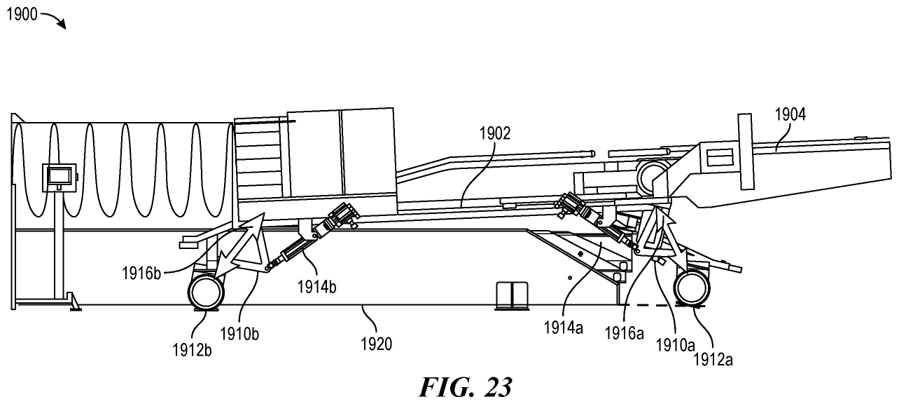

In the illustrated embodiment, two front supporting legs 1910a are rotatably coupled to the chassis 1902 about respective front pivots 1916a (see FIG. 20) positioned on either side of the chassis 1902. A front wheel 1912a is mounted to a distal portion of each front supporting leg 1910a. Similarly, two rear supporting legs 1910b are rotatably coupled to the chassis 1902 about respective rear pivots 1916b positioned on either side of the chassis 1902. A rear wheel 1912b is mounted to a distal portion of each rear supporting leg 1910b. The chassis 1902 also supports two front actuators 1914a (e.g., linear actuators, motors) (see FIG. 20) operably coupled to the front supporting legs 1910a and two rear actuators 1914b operably coupled to the rear supporting legs 1910b. In some embodiments, the robotic system 1900 includes fewer or more supporting legs 1910, and/or supporting legs 1910 configured in different positions and/or orientations. In some embodiments, the wheels 1912 can be motorized to move the chassis 1902, and thus the rest of the robotic system 1900, along linear direction L2. Operation of the actuators 1914 is described in further detail below with respect to FIGS. 22 and 23.

The controllers 1938 (e.g., the processor(s) 202 of FIG. 2 therein) can be operably coupled (e.g., via wires or wirelessly) to control the actuators 1908, 1936, 1914, and/or other actuators (e.g., corresponding to the actuation device 212 of FIG. 2). The counterweights 1939 can be positioned (e.g., towards the proximal portion 1901b) to counter any moment exerted on the chassis 1902 by, for example, cargo 1934 carried by the grippers 1906 and/or the first segment 1904.

FIG. 20 is an enlarged side view of the robotic system 1900 in accordance with embodiments of the present technology. As shown, while the first segment 1904 is rotatable about the axes A₅, A₆, the axes A₅, A₆ may not intersect and instead be separated by distance D9. The distance D9 can be around 200 mm, 300 mm, 400 mm, 500 mm, 600 mm, any distance therebetween, or other distances. When the chassis 1902 sits atop the conveyor segment 1920, as illustrated, the sixth axis A₆ can be positioned at a distance D10 from the floor on which the conveyor segment 1920 and the wheels 1912 sit. The distance D10 can be about 1100 mm, 1200 mm, 1300 mm, 1400 mm, 1500 mm, any distance therebetween, or other distances. However, as discussed in further detail herein, the wheels 1912 can be moved vertically to change the distance D10.

The sixth and eighth axes A₆, A₈ can be separated horizontally (e.g., along the first segment 1904) by distance D11. The distance D11 can be about 3000 mm, 3500 mm, 4000 mm, 4500 mm, 5000 mm, any distance therebetween, or other distances.

While the gripper 1906 is rotatable about the axes A₇, A₈, the axes A₇, A₈ may not intersect and instead be separated by distance D12. The distance D12 can be around 220 mm, 250 mm, 280 mm, 310 mm, 340 mm, any distance therebetween, or other distances. When the chassis 1902 sits atop the conveyor segment 1920 and the first segment 1904 remains in a horizontal orientation, as illustrated, the eighth axis A₈ can be positioned at a distance D13 from the floor on which the conveyor segment 1920 and the wheels 1912 sit. The distance D13 can be about 1200 mm, 1300 mm, 1400 mm, 1500 mm, 1600 mm, any distance therebetween, or other distances. However, as discussed in further detail herein, the first segment 1904 can be rotated about the sixth axis A₆ to change the distance D13.

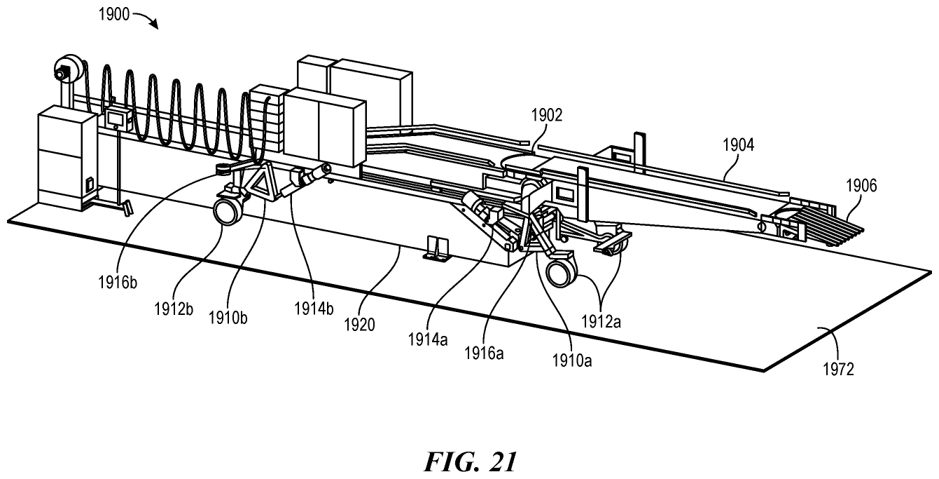

FIG. 21 is a perspective view of the robotic system 1900 on a warehouse floor 1972 in accordance with embodiments of the present technology. The discussed above, the robotic system 1900 can include two front wheels 1912a, each positioned on either side of the chassis 1902 and near the first segment 1904, and two rear wheels 1912b (one of which is obscured from view), each positioned on either side of the chassis 1902 and near the second segment 1921. Each front wheel 1912a is coupled to a front supporting leg 1910a rotatably mounted on the chassis 1902 about front pivot 1916a, and each rear wheel 1912b is coupled to a rear supporting leg 1910b rotatably mounted on the chassis 1902 about rear pivot 1916b. Front actuators 1914a and rear actuators 1914b are coupled between the chassis 1902 and the front supporting legs 1910a and rear supporting legs 1910b, respectively.

In the illustrated embodiment, each supporting leg 1910 has a triangular shape with a first vertex coupled to the pivot 1916, a second vertex coupled to the wheel 1912, and a third vertex coupled to the actuator 1914. Furthermore, the actuators 1914 (e.g., motorized linear actuators) can be coupled to the chassis 1902 between the front and rear pivots 1916 such that in operation, the front actuators 1914a can push the front supporting legs 1910a towards the front and pull the front supporting legs 1910a towards the rear, and the rear actuators 1914b can push the rear supporting legs 1910b towards the rear and pull the front supporting legs 1910a towards the front. When the actuators 1914 push the supporting legs 1910, the corresponding wheels 1912 are lifted vertically off the floor 1972. Conversely, when the actuators 1914 pull the supporting legs 1910, the corresponding wheels 1912 are lowered vertically toward the floor 1972. As discussed above with respect to FIG. 4, lowering the wheels 1912 can be advantageous when moving the robotic system 1900 to a lower floor. Furthermore, in some embodiments, the vertical distance that the wheels 1912 can be lifted and/or lowered can be generally similar to the distances D1 and D2 discussed above with respect to FIG. 4.

FIGS. 22 and 23 are enlarged side views of the robotic system 1900 illustrating actuation of supporting legs in accordance with embodiments of the present technology. In some embodiments, the four actuators 1914 (e.g., the two front actuators 1914a and the two rear actuators 1914b) can be operated independently of one another. For example, comparing FIG. 23 to FIG. 22, the two front actuators 1914a can be operated to lift the first segment 1904 while the two rear actuators 1914b remain stationary, thereby rotating the chassis 1902 about a pitch axis in one direction. More specifically, the front actuators 1914a can be operated to pull the front supporting legs 1910a such that the front wheels 1912a remain in contact with the ground and the front pivots 1916a are raised accordingly.

In another example, the two rear actuators 1914b can be operated to lift the second segment 1921 while the two front actuators 1914a remain stationary, thereby rotating the chassis 1902 about the pitch axis in the opposite direction. In yet another example, the front and rear actuators 1914 on the right side (e.g., shown in FIGS. 22 and 23) can be operated to lift the right side of the chassis 1902 while the front and rear actuators 1914 on the left side (e.g., obscured from view) can remain stationary such that the chassis 1902 rotates about a roll axis. In yet another example, the four actuators 1914 can be operated to move by different amounts to also achieve rotation of the chassis 1902 about the pitch and/or roll axes. Other combinations of controlling the four actuators 1914 are within the scope of the present technology

Raising, lowering, and/or rotating the chassis 1902 about the pitch and/or roll axes can be advantageous in extending the range of the gripper 1906, maneuvering the robotic system 1900 through constrained spaces, and shifting the weight distribution and mechanical stress on the robotic system 1900. In some embodiments, the robotic system 1900 also includes sensors (e.g., distance sensors) coupled to, for example, the chassis 1902 to measure and detect the degree of rotation of each supporting leg 1910 and/or the height of the wheels 1912 relative to the chassis 1902.

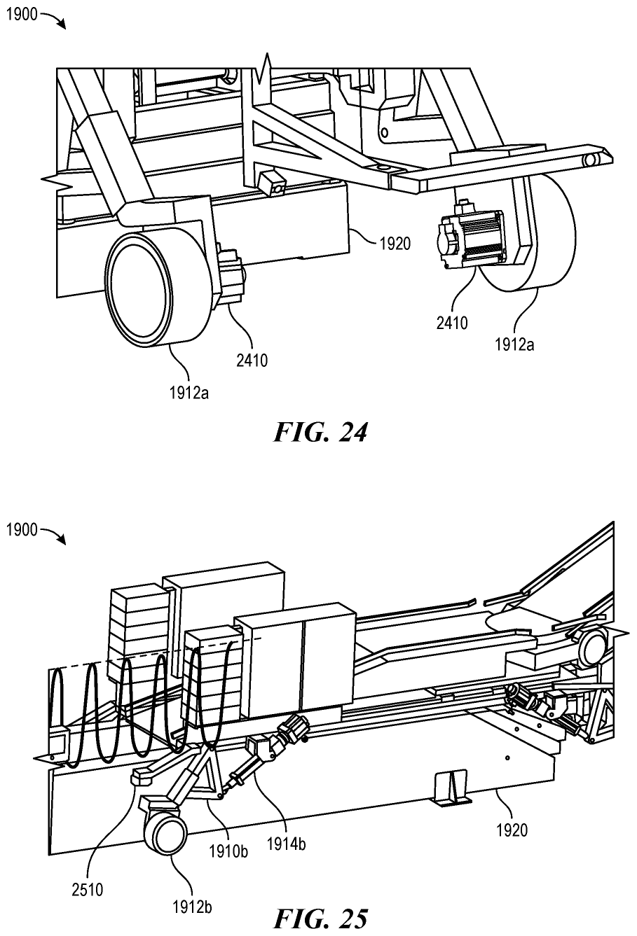

FIG. 24 is an enlarged perspective view of front wheels 1912a in accordance with embodiments of the present technology. In the illustrated embodiment, a motor 2410 is operably coupled to each front wheel 1912a. In operation, the motors 2410 can be used to drive the front wheels 1912a and move the robotic system 1900 in a desired direction (e.g., forward, backward). In some embodiments, the motors 2410 are coupled to a reducer (e.g., a gearbox) and/or a braking component such that the speed and acceleration of the front wheels 1912a can be controlled to slow down and/or brake.

In some embodiments, the front wheels 1912a are motorized, as shown, while the rear wheels 1912b are not motorized. In some embodiments, alternatively or additionally, the rear wheels 1912b are motorized. In some embodiments, the front wheels 1912a are made from a relatively high-traction material (e.g., rubber) and the rear wheels 1912b are made from a relatively normal-traction material (e.g., polyurethane). The different materials can help improve the consistency between the telescopic direction of the conveyor segment 1920 and the movement direction of the robotic system 1900.

FIG. 25 is an enlarged perspective view of the rear supporting leg 1910b and the corresponding rear wheel 1912b in accordance with embodiments of the present technology. As shown, the robotic system 1900 includes a stopper 2510 positioned above the rear wheels 1912b. The stopper 2510 can be coupled to the chassis 1902. The stopper 2510 can be configured to define a maximum degree of rotation of the rear supporting leg 1910b by physically preventing the rear supporting leg 1910b and/or the rear wheel 1912b from moving past the stopper 2510. The stopper 2510 can be made from silicone, rubber, or other suitable material to avoid damaging the rear supporting leg 1910b and/or the rear wheel 1912b. In some embodiments, the stopper 2510 is relied upon only under emergency circumstances, such as when the rear actuator 1914b fails and/or breaks off from the chassis 1902. In some embodiments, alternatively or additionally, the robotic system 1900 includes other stoppers configured to define a maximum degree of rotation for the front supporting legs 1910a.

In some embodiments, a method of operating a robotic system (e.g., the robotic system 1900) includes obtaining, from one or more sensors (e.g., the sensors 1924), an image of at least one object (e.g., the cargo 1934) to be engaged by a gripper (e.g., the gripper 1906) and conveyed along a chassis conveyor belt of a chassis (e.g., the chassis 1902) and an arm conveyor belt of an arm (e.g., the first segment 1904), determining, based on the image: (1) at least one of a first position for the chassis or a first angular position for the chassis, (2) a second position for the gripper, and (3) a second angular position for the arm, actuating (e.g., via the actuators 1914) one or more supporting legs (e.g., the supporting legs 1910) coupled to the chassis such that the chassis is at least at one of the first position or the first angular position, and actuating one or more joints (e.g., about axes A₅-A₈) of the robotic system such that the gripper is at the second position and the arm is at the second angular position.

In some embodiments, a combination of the first and second angular positions is configured to prevent or at least reduce slippage of the object along the chassis conveyor belt and/or the arm conveyor belt. In some embodiments, the method further includes detecting slippage of the object along the arm conveyor belt. Upon detecting such slippage, the method can further include actuating the one or more supporting legs to raise or lower the first position of the chassis while maintaining the gripper at the second position, thereby lowering the second angular position of the arm. Alternatively, the method can further include actuating the one or more joints to raise or lower the second position of the gripper while maintaining the chassis at the first position, thereby lowering the second angular position of the arm. Alternatively, the method can further include actuating the one or more supporting legs to raise or lower the first position of the chassis, and actuating the one or more joints to raise or lower the second position of the gripper, thereby lowering the second angular position of the arm.

In some embodiments, the method further includes detecting, via the one or more sensors, slippage of the object along the chassis conveyor belt, and actuating the one or more supporting legs to decrease the first angular position of the chassis. In some embodiments, the method further includes detecting, via the one or more sensors, a tilt of the robotic system caused by an uneven surface on which the robotic system is positioned, and actuating at least a subset of the one or more supporting legs to compensate for the tilt of the robotic system caused by the uneven surface. For example, the surface may be uneven such that the chassis tilts sideways (e.g., laterally and away from a longitudinal axis extending along the chassis conveyor belt). Supporting legs on either side of the chassis can be actuated independently (e.g., by different degrees) to tilt the chassis in the opposite direction to compensate for the uneven surface.

In some embodiments, the method further includes driving one or more wheels (e.g., the wheels 1912) attached to corresponding ones of the one or more supporting legs to move the chassis in a forward or backward direction relative to the at least one object such that the gripper maintains the second position relative to the at least one object. For example, rotating a supporting leg about a pivot (e.g., pivot 1916) on the chassis may cause the chassis to move forward or backward as the wheel maintains contact with the surface.

In some embodiments, the robotic system is positioned over a warehouse conveyor belt such that the chassis conveyor belt and the warehouse conveyor belt form a continuous travel path for the at least one object, and the one or more supporting legs are actuated such that the continuous travel path is maintained while the chassis is actuated to at least at one of the first position or the first angular position.

In some embodiments, determining the at least one of the first position or the first angular position comprises determining a first range of acceptable positions or a first range of acceptable angular positions. In some embodiments, determining the second position comprises determining a second range of acceptable positions. In some embodiments, determining the second angular position comprises determining a second range of acceptable angular positions. In some embodiments, the first and second positions are determined relative to a support surface on which the robotic system is positioned. In some embodiments, the first and second positions are determined relative to the at least one object.

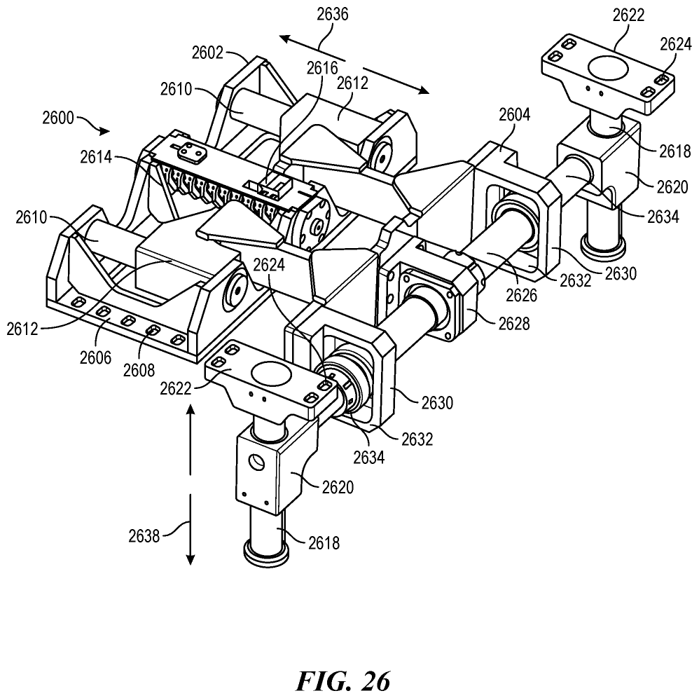

FIG. 26 is a perspective view of a chassis joint 2600 for a robotic system in accordance with one or more embodiments. As discussed above with reference to FIGS. 22-25, a chassis of a robotic system may have multiple degrees of freedom. For example, independent movement of four legs of a robotic system may (1) move the chassis in a translation degree of freedom (e.g., vertically); (2) rotate the chassis in a chassis roll degree of freedom; and (3) rotate the chassis in a chassis pitch degree of freedom. Such movements may be desirable to allow the robotic system to adapt to various environments and cargo containers, especially in retrofit environments. However, conveyors fixed to a local environment (e.g., a warehouse conveyor) typically are typically limited to a single degree of freedom: extension and retraction. As discussed further below, the chassis joint 2600 provides the chassis these degrees of freedom while allowing a warehouse conveyor or other proximal conveyor to which the chassis is operatively coupled to remain fixed or otherwise constrained to a single degree of freedom. Additionally, control of the robotic system to maintain a relative positioning between a distal end of an extending conveyor is challenging where the conveyor and the robotic system have separate controllers. As discussed further below, the chassis joint 2600 allows a robotic system to automatically follow a warehouse conveyor to which the chassis is operatively coupled when the warehouse conveyor is extended or retracted. Conversely, in some embodiments, the chassis joint 2600 may allow the conveyor to extended or retract following the movement of a robotic system chassis in a distal or proximal direction.

The chassis joint 2600 includes a conveyor mount 2602 and a chassis mount 2604. The conveyor mount 2602 is configured to be coupled to a portion of a conveyor (e.g., a warehouse conveyor or other proximal conveyor). The chassis mount 2604 is configured to be coupled to a chassis of a robotic system. In some embodiments as shown in FIG. 26, the conveyor mount 2602 includes a conveyor mounting plate 2606 having a plurality of holes 2608 that receive fasteners (e.g., bolts, screws, rivets, etc.). The chassis mount similar includes mounting plates 2622 having holes 2624 configured to received fasteners.

According to the embodiment of FIG. 26, the chassis mount 2604 is configured to move relative to the conveyor mount 2602 in a first translational degree of freedom 2636, for example, a horizontal direction along a proximal/distal axis. The conveyor mount 2602 includes two horizontal shafts 2610. The chassis mount includes two horizontal couplers 2612 configured to slide on the horizontal shafts. Accordingly, the chassis mount 2604 may slide relative to the conveyor mount 2602 in the example of FIG. 26 and therefore accommodated relative movements between extension of a conveyor and movement of the chassis of a robotic system. In some embodiments as shown in FIG. 26, the chassis joint 2600 includes a spring 2614 configured to bias the chassis mount 2604 and the conveyor mount 2602 to a predetermined position. In some embodiments, the predetermined position may be a neutral position where the chassis mount and conveyor mount can slide relative to one another in either direction. In some embodiments, the spring 2614 may be a compression spring.

The chassis joint 2600 includes a position sensor 2616 configured to provide information indicative of a relative position of the chassis mount 2604 and the conveyor mount 2602. In some embodiments, the position sensor may be a linear potentiometer. In other embodiments other sensors may be employed, as the present disclosure is not so limited. In some embodiments, an output of the position sensor may be received by a local controller and used to command rotation of wheels of a robotic system. For example, a change in relative position measured by the position sensor 2616 may trigger a controller to drive wheels of the robotic system. In this manner, the robotic system may be automatically controlled to follow the conveyor (as indicated by movement of the conveyor mount 2602). In other embodiments, the output of the position sensor 2616 may be received by a controller of a conveyor. In such embodiments, a change in relative position measured by the position sensor 2616 may trigger a conveyor controller to extend or retract the conveyor. In this manner, the conveyor may be automatically controlled to follow the robotic system (as indicated by movement of the chassis mount 2604).

The chassis joint 2600 is further configured to accommodate relative vertical movement between a robotic system chassis and a conveyor in a second translational degree of freedom 2638 (e.g., in a vertical direction). In the example of FIG. 26, the chassis mount 2604 includes two vertical shafts 2618 and two vertical couplers 2620 configured to slide on the vertical shafts 2618. The vertical shafts 2618 are attached to the chassis mounting plates 2622. Accordingly, the remainder of the chassis joint 2600 including the conveyor mount 2602 is configured to slide in a vertical direction along the vertical shafts 2618.

The chassis joint 2600 is further configured to accommodate relative pitch rotation between a robotic system chassis and a conveyor (e.g., from movement of the chassis in a chassis pitch rotational degree of freedom). In some embodiments, the vertical couplers 2620 may be further configured to rotate about a pitch axis perpendicular to a plane of the vertical axis of the vertical shafts 2618. According to such an arrangement, the chassis mounting plates 2622 and vertical shafts 2618 may rotate with a change in pitch angle of the chassis. The vertical couplers 2620 may pivot about their respective axes to accommodate this change in pitch angle without movement of the conveyor mount 2602.

The chassis joint 2600 is further configured to accommodate relative roll rotation between a robotic system chassis and a conveyor (e.g., from movement of the chassis in a chassis roll rotational degree of freedom). The vertical couplers 2620 are both coupled to an axle 2626. The axle 2626 is coupled to the conveyor mount 2602 via a swivel joint 2628. The swivel joint is configured to allow the axle to rotate about a roll axis (e.g., parallel to a plane of a longitudinal axis or a distal/proximal axis). In some embodiments as shown in FIG. 26, the chassis mount includes a pair of support brackets 2630 that support the axle 2626 and allow the axle to rotate in the roll direction. The axle includes two bushings 2634 that slide within a channel 2632 of each support bracket. In this manner, the relative heights of the first vertical coupler and the second vertical coupled may be different. For example, rotation of the axle in the swivel joint 2628 may move a first vertical coupler upwards, and a second vertical coupler downwards. The rotation of the axle 2626 in the swivel joint 2628 may occur while the conveyor mount 2602 remains stationary.

According to the embodiment of FIG. 26, a single position sensor 2616 for the first translation degree of freedom (e.g., horizontal direction) is included in the chassis joint 2600. In other embodiments, additional sensors may be included to monitor the relative position of the chassis mount 2604 and a conveyor mount 2602 in the other degrees of freedom. Outputs of such sensors may be received by a local controller and used to control various actuators of a robotic system, for example, to avoid reaching end of travel. In some embodiments, a chassis joint may include a vertical position sensor configured to obtain position information of the vertical couplers 2620 on the vertical shafts 2618. In some embodiments, a chassis joint may include a pitch position sensor configured to obtain orientation information of the vertical couplers 2620 with respect to a vertical axis. In some embodiments, a chassis joint may include roll position sensors configured to obtain orientation information of the axle 2626 with respect to a longitudinal axis. Any single sensor, subcombination, or combination of these sensors may be employed. A sensor may include, but is not limited, to a potentiometer or an encoder. In some embodiments, such sensors may be located on a robotic system and/or conveyor, and may not be included as a part of a chassis joint.

While in the embodiment of FIG. 26 the chassis joint provides for relative movement of a chassis and a conveyor in four degrees of freedom (e.g., horizontal, vertical, pitch, and roll), in other embodiments a chassis joint may provide fewer or more degrees of freedom. For example, a chassis joint may only provide for relative horizontal movement between a chassis and a conveyor, in some embodiments. Any single relative degree of freedom, subcombination, or combination of relative degrees of freedom may be provided by a chassis joint of some embodiments.

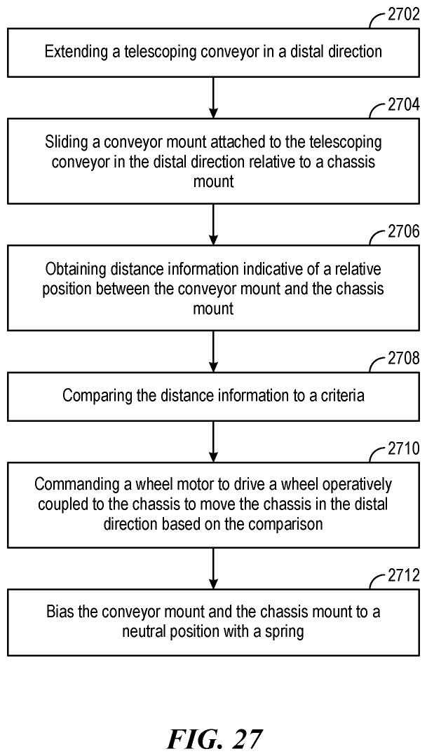

FIG. 27 is a flow diagram illustrating a process of operating a robotic system in accordance with one or more embodiments. At block 2702, the process includes extending a telescoping conveyor in a distal direction. Extending the conveyor in the distal direction may include moving a distal end of the conveyor in the distal direction, in some embodiments. At block 2704, the process includes sliding a conveyor mount attached to the telescoping conveyor in the distal direction relative to a chassis mount. The chassis mount may be attached to a chassis that remains stationary relative to the telescoping conveyor. At block 2706, the process including obtaining position information indicative of a relative position between the conveyor mount and the chassis mount. In some embodiments, the position information may be obtained from one or more distance sensors. In some embodiments, the one or more distance sensors may include a potentiometer. At block 2708, the process includes comparing the distance information to a criterion or criteria. In some embodiments, the criteria may be a numerical threshold. For example, if a magnitude of a position change as indicated by the position information may be compared against a predetermined non-zero threshold.

At block 2710, the process includes commanding a wheel motor to drive a wheel operatively coupled to the chassis to move the chassis in the distal direction based on the comparison to the criteria. For example, if the magnitude of a position change as indicated by the position information exceeds the predetermined non-zero threshold, the wheel motor may be commanded to rotate a wheel to move the chassis in the distal direction. In some embodiments, the speed of a wheel motor may be controlled based on the position information. For example, the wheel motor may be controlled such that the chassis is moved to maintain a neutral position with the telescoping conveyor. For example, for a bigger change in relative position, the wheel speed may be increased to allow the delta from the neutral position to be reduced. Correspondingly, as the delta decreases and the telescoping conveyor and chassis are close to their neural position with respect to one another, wheel speed may be decreased to match a speed of the distal end of the conveyor. In this manner, the method may include driving the wheel motor to ensure the chassis follows the telescoping conveyor. In other embodiments, the process may be inverted, such that the conveyor is controlled to follow the chassis. In optional act 2712, the process includes biasing the conveyor mount and the chassis mount to a neutral position with a spring. The spring may reduce shock loads and may assist the chassis in returning to a neutral position with respect to the telescoping conveyor.

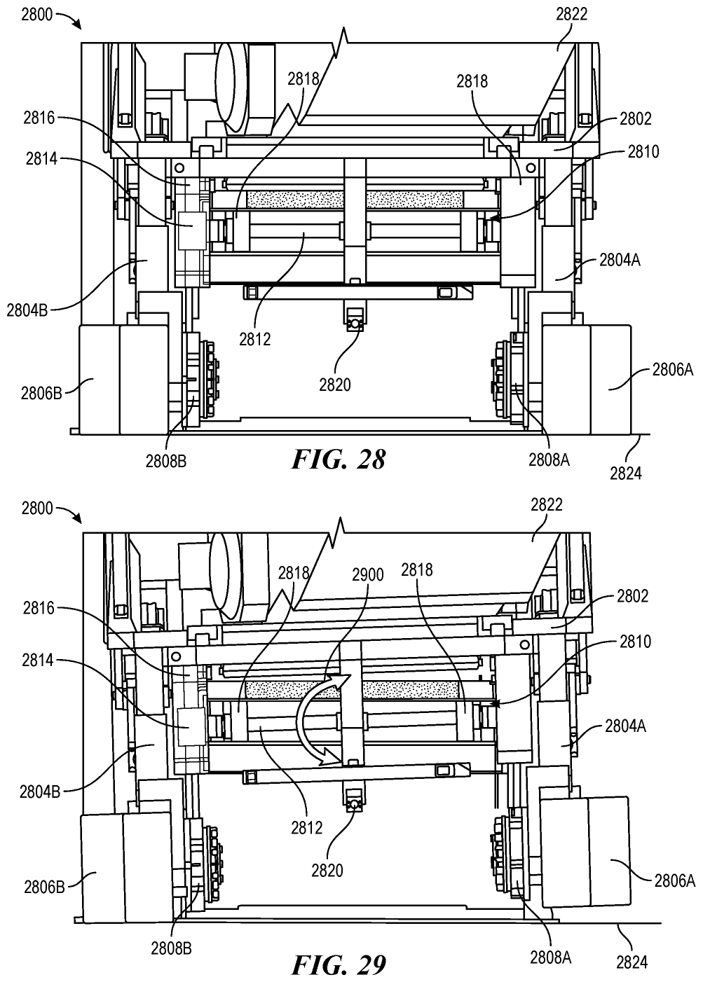

FIG. 28 is a front view of a robotic system 2800 and chassis joint in a first state in accordance with one or more embodiments, and FIG. 29 is the front view of the robotic system in a second state. The views of FIGS. 28-29 are taken looking in a proximal direction along a longitudinal axis of the robotic system 2800. As shown in FIG. 28, the robotic system 2800 includes a chassis 2802, a first leg 2804A, and a second leg 2804B. The first leg 2804A is disposed on a first side of the chassis 2802, and the second leg 2804B is disposed on a second side of the chassis 2802. The first leg 2804A includes a first wheel 2806A, and the second leg includes a second wheel 2806B. The first and second wheels are configured to rotate to allow the chassis to move in translational degree of freedom corresponding to movement along a longitudinal axis of the robotic system (e.g., moving the chassis in a proximal or distal direction). In some embodiments as shown in FIG. 28, the first wheel 2806A is coupled to a first wheel motor 2808A and the second wheel 2806B is coupled to a second wheel motor 2808B. The first wheel may be driven directly by the first wheel motor and the second wheel may be driven directly by the second wheel motor. Additionally, the wheel may be driven independently, in some embodiments. The first wheel 2806A and the second wheel 2806B may be front wheels formed of a rubber material. In some embodiments, this rubber material may be a different material than that of rear wheels, which may be polyurethane in some embodiments.

As shown in FIG. 28, the robotic system includes a chassis mount 2810. The chassis mount may be like that shown and described with reference to FIG. 26, in some embodiments. In the depicted example, the chassis mount 2810 includes an axle 2812. The axle 2812 is connected on both ends to a vertical coupler 2814, one of which is shown through transparency. The vertical coupler 2814 is configured to slide along a vertical shaft 2816, which is attached to the chassis 2802. The axle 2812 may be configured to rotate in a roll direction 2900, for example about an axis into the page (e.g., parallel to a longitudinal axis of the robotic system). As the axle 2812 rotates in the roll direction 2900, one end of the axle may move upward and one downward in an opposite direction. Accordingly, one vertical coupler 2814 may move upward and the other may move downward. In some embodiments as shown in FIG. 29, the axle 2812 slides within support brackets 2818. Such a rotation may allow the chassis mount 2810 to accommodate rotation of the chassis 2802 in a chassis roll degree of freedom. As shown in FIG. 29, as the chassis rolls, the axle 2812 may also roll while allowing an associated conveyor to retain a fixed orientation. Roll of the chassis 2802 may be caused by irregularities in the floor 2824 of an operating environment, for example, bumps, holes, and non-level surfaces. Roll of the chassis 2802 may also be caused by differences in height of the first leg 2804A and the second leg 2804B.

In some embodiments as shown in FIGS. 28-29, a robotic system 2800 may include a vision sensor 2820 that is positioned below a segment 2822 of the robotic system as described with reference to other embodiments herein. Such an arrangement may allow the vision sensor 2820 to obtain images of a plurality of objects within a cargo carrier more easily with less obstruction from the segment 2822 and other components of the robotic system.

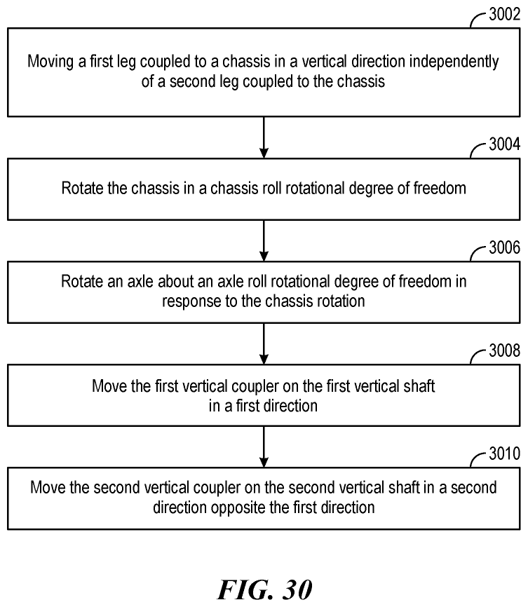

FIG. 30 is a flow diagram illustrating a process of operating a robotic system in accordance with one or more embodiments. At block 3002, the process includes moving a first leg coupled to a chassis in a vertical direction independently of a second leg coupled to the chassis. At block 3004, the process includes rotating the chassis in a chassis roll rotational degree of freedom. At block 3006, the process includes rotating an axle about an axle roll rotational degree of freedom in response to the chassis rotation. At block 3008, the process includes moving the first vertical coupler on the first vertical shaft in a first direction. At block 3010, the method includes moving the second vertical coupler on the second vertical shaft in a second direction opposite the first direction. The robotic system (e.g., the robotic system 1900 of FIG. 19) can use one or more controllers, such as the controllers 1938 of FIG. 19 the circuitry therein to operate the various actuation devices (e.g., actuators 1908, 1936, etc. of FIG. 19 and corresponding to the actuation device 212 of FIG. 2) to perform one or more actions described above.

Example EOATs for the Robotic system

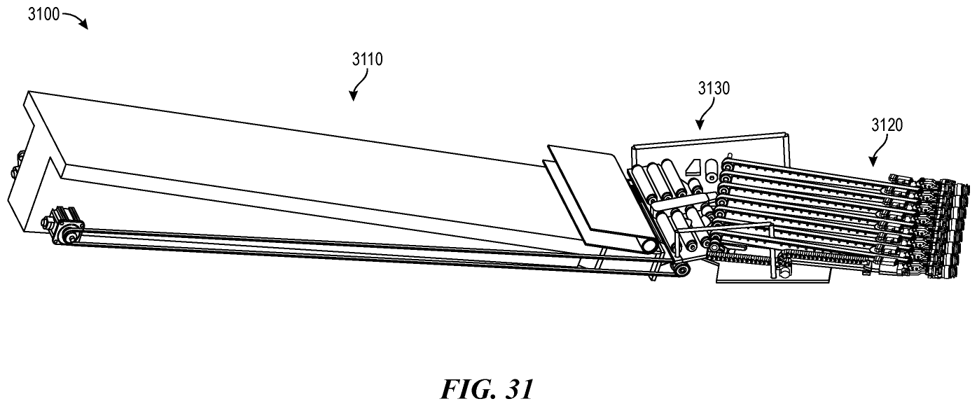

FIG. 31 is a partially schematic isometric view of a robotic system 3100 configured in accordance with some embodiments of the present technology. In the illustrated embodiment, the robotic system 3100 includes a movable arm 3110, an end effector 3120, and a distal joint 3130 operably coupled between the movable arm 3110 and the end effector 3120. The movable arm 3110 can be generally similar to any of the movable arms discussed above with reference to FIGS. 3-12F to position the end effector 3120 (sometimes also referred to herein as an “end-of-arm tool”) adjacent to one or more target objects (e.g., boxes in a cargo carrier, such as a shipping container and/or a truck). Additionally, or alternatively, the movable arm 3110 can establish a transfer pathway between the target objects and an offload unit (e.g., a warehouse conveyor system, a warehouse cart, a warehouse truck, and/or the like). As discussed in more detail below, the end effector 3120 and the distal joint 3130 can include various features that help pick up and/or otherwise grip target objects from a variety of locations. For example, the end effector 3120 can include features that allow the robotic system 3100 to at least partially lift individual target objects onto a conveyor system to pick up the individual target objects without disturbing (or with a reduced disturbance) surrounding target objects. In another example, the distal joint 3130 can include various features that help improve the range of motion for the robotic system 3100 and/or the end effector 3120 therein.

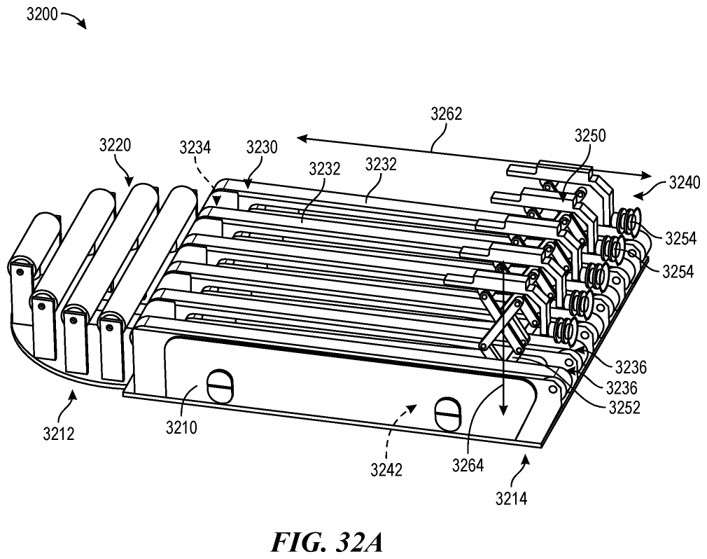

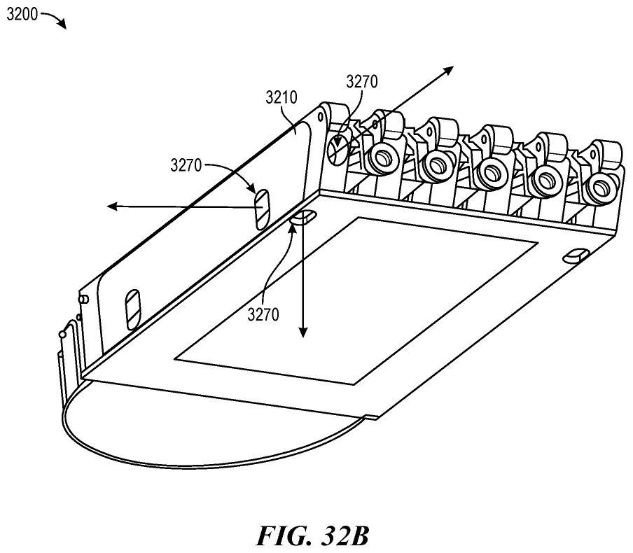

FIGS. 32A and 32B are partially schematic upper and lower side views of an end effector 3200 configured in accordance with some embodiments of the present technology. The end effector 3200 can be generally similar (or identical) to the end effectors (sometimes also referred to as an “end of arm tool,” a “gripper,” and/or the like) discussed above with reference to FIGS. 3-12F, FIG. 15, 19-21, etc. As illustrated in FIG. 32A, the end effector 3200 includes a frame 3210, a plurality of joint conveyors 3220, a plurality of frame conveyors 3230, and a gripping component 3240. The frame 3210 has a proximal end region 3212 that is couplable to a robotic system (e.g., via the distal joint 3130 of FIG. 31) and a distal end region 3214 opposite the proximal end region 3212. The plurality of joint conveyors 3220 are coupled to the proximal end region 3212 of the frame 3210. Each of the plurality of frame conveyors 3230 extends from the distal end region 3214 to the proximal end region 3212.

In the embodiment illustrated in FIG. 32A, the plurality of joint conveyors 3220 are rollers extending laterally along a transverse axis of the end effector 3200 while the plurality of frame conveyors 3230 include a plurality of individual conveyor belts 3232 extending along (or generally parallel to) a longitudinal axis of the end effector 3200. The individual conveyor belts 3232 are each operably coupled to a common drive component 3234 (e.g., a common drive pully, drive shaft, and/or the like) to operate each of the plurality of frame conveyors 3230 at the same (or generally the same) speed.

As further illustrated in FIG. 32A, each of the individual conveyor belts 3232 is spaced apart from the neighboring conveyor belts to define channels 3236 between the individual conveyor belts 3232. The gripping component 3240 (sometimes also referred to herein as a “gripping component”) includes a drive component 3242 that is carried by the frame 3210 and a plurality of gripping assemblies 3250 that includes an extendible component 3252 and a gripping element 3254 (sometimes also referred to herein as a “gripper element,” an “engagement element,” and/or the like) carried by the extendible component 3252. Each of the gripping assemblies (sometimes also referred to herein as “gripper assemblies”) is coupled to the drive component 3242 and positioned in one of the channels 3236. Accordingly, the drive component 3242 can move each of the plurality of gripping assemblies 3250 along a first motion path 3262 between the distal end region 3214 and the proximal end region 3212 (e.g., generally along the longitudinal axis of the end effector 3200) within and/or above a corresponding one of the channels 3236. Further, each of the extendible components 3252 can move a corresponding one of the gripping elements 3254 along a second motion path 3264

As discussed in more detail below, during a gripping operation with the end effector 3200, the gripping component 3240 can move between various positions to pick up (and/or otherwise grip) a target object beyond the distal end region 3214 of the frame 3210, place (and/or otherwise release) the target object on top of the frame conveyors 3230, and clear a path for the target object to move proximally along the frame conveyors 3230. Further, once a target object is placed on the plurality of frame conveyors 3230, the plurality of frame conveyors 3230 and the plurality of joint conveyors 3220 can move the target object in a proximal direction (e.g., toward a movable base component to unload a cargo carrier). Additionally, or alternatively, the plurality of joint conveyors 3220 and the plurality of frame conveyors 3230 can move a target object in a distal direction, then the gripping component 3240 can pick the target objects up and place them distal to the distal end region 3214 of the frame 3210 (e.g., to pack a cargo carrier, sometimes also referred to herein as a “shipping unit”).

As best illustrated in FIG. 32B, the end effector 3200 can also include one or more sensors 3270 (three illustrated in FIG. 32B). The sensors 3270 can include proximity sensors, image sensors, motion sensors, and/or any other suitable sensors to monitor an environment around the end effector 3200, to help identify one or more target objects, to help identify one or more placement locations for a target object, and/or the like. In a specific, non-limiting example, the sensors 3270 can include an imaging sensor that images a shipping unit to allow a suitable component (e.g., the processors 202 of FIG. 2 and/or another suitable component) to identify one or more target objects in the shipping unit and/or an operational plan to unpack the shipping unit. While unpacking the shipping unit, the sensors 3270 can then monitor the shipping unit and/or an environment around the end effector 3200 to prompt changes to the operational plan and/or detect changes in the environment. For example, the operational plan can be updated when one or more target objects shift (fall, tilt, rotate, and/or otherwise move) during the unpacking process. In another example, the sensors 3270 can detect and avoid hazards (e.g., a human or other living being, other robotic unit, movements in the shipping unit, and/or the like) in the environment around the end effector 3200.

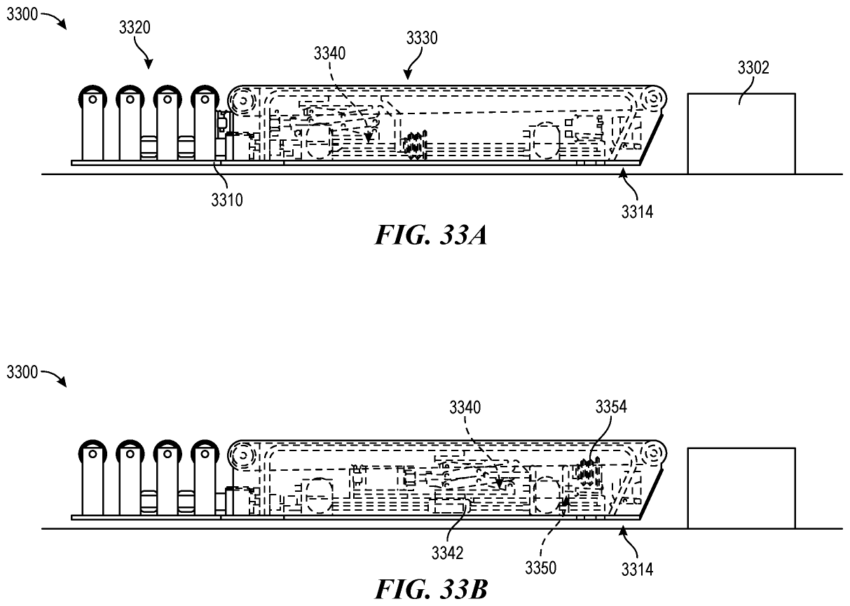

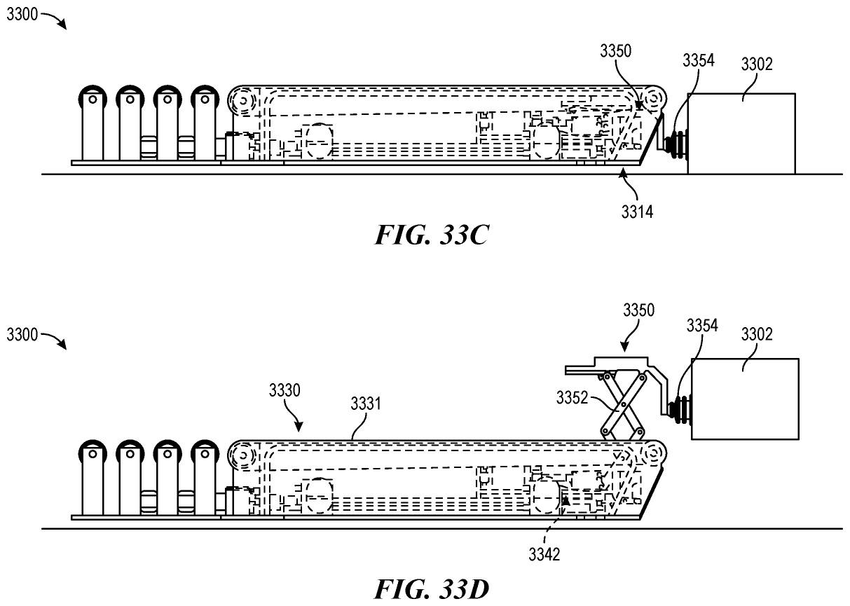

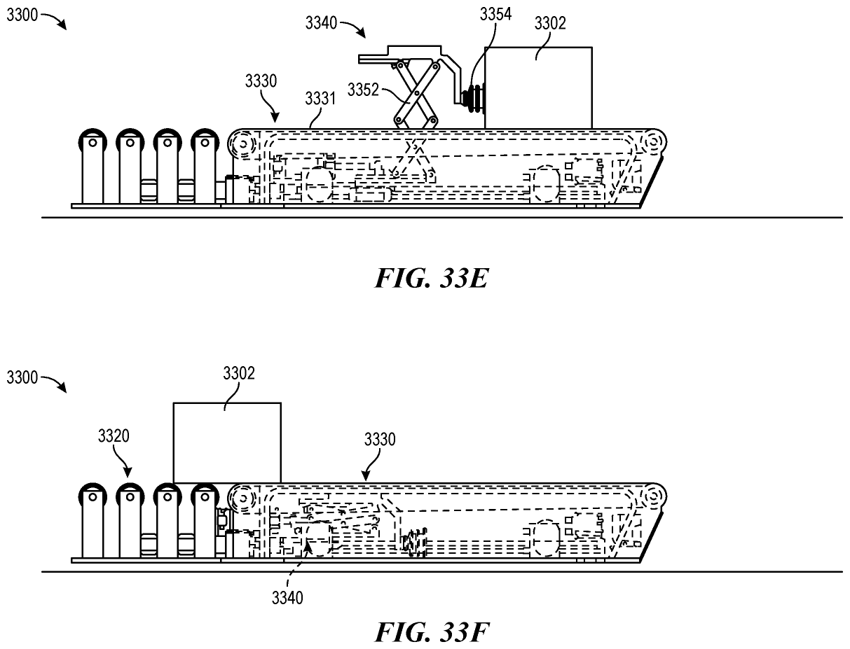

FIGS. 33A-33F are partially schematic side views of an end effector 3300 at various stages of a process for picking up a target object in accordance with some embodiments of the present technology. As illustrated in FIG. 33A, the end effector 3300 can be generally similar (or identical) to the end effector 3200 discussed above with reference to FIGS. 32A and 32B. For example, the end effector 3300 (sometimes also referred to herein as an end-of-arm tool) includes a frame 3310, a plurality of joint conveyors 3320, a plurality of frame conveyors 3330, and a gripper component 3340.

FIG. 33A illustrates the end effector 3300 after identifying a target object 3302 (e.g., using the sensors 3270 discussed above with reference to FIG. 32B and/or any other suitable sensors) and positioning the end effector 3300 adjacent to the target object 3302. In this position, the target object 3302 is distal to a distal end region 3314 of the frame 3310.

FIG. 33B illustrates the end effector 3300 while actuating the gripper component 3340 distally toward the distal end region 3314. In various embodiments, the end effector 3300 can actuate the gripper component 3340 by expanding (or contracting) an expandable component (e.g., a piston, a scissor mechanism, and/or the like), driving one or more carts along a guide track, driving a pully to move a belt and/or gear track coupled to the gripper component 3340, and/or any other suitable mechanism. As discussed in more detail below, the end effector 3300 can actuate the gripper component 3340 by moving a common drive component 3342 to move multiple gripping assemblies 3350 in tandem (e.g., concurrently, generally simultaneously, and the like). In turn, the concurrent movement of the gripping assemblies 3350 can help ensure that the gripping assemblies 3350 are aligned at their distal-most point, helping to ensure that gripping elements 3354 in the gripping assemblies 3350 can engage an object (e.g., the target object 3302) at the same time (or generally the same time).

FIG. 33C illustrates the end effector 3300 after the gripping element 3354 (sometimes also referred to herein as a “gripper element,” an “engagement element,” and/or the like) in one or more of the gripping assemblies 3350 is positioned distal to the distal end region 3314 and operated to engage the target object 3302 (sometimes referred to herein as a “first position,” a “pick-up position,” and “engagement position,” and/or the like). In various embodiments, the gripping elements 3354 can include a vacuum component (sometimes also referred to herein as a suction component), a magnetic component, a mechanical gripper component, and/or the like to engage (e.g., grip, pick up, and/or otherwise couple to) the target object 3302. In the illustrated embodiment, the gripping elements 3354 include vacuum components that use a vacuum (or suction) force to engage the target object 3302. Once engaged, the gripping assemblies 3350 can at least partially lift and/or move the target object 3302. In some embodiments, the robotic system can place the gripping assemblies 3350 on the CoM, the midpoint, and/or a lower half of the target object 3302. For example, the robotic system can align the bottom portion of the suction cup with a bottom edge of the target object 3302 or within a threshold distance from the bottom edge in gripping the target object 3302.

FIG. 33D illustrates the end effector 3300 after actuating extendible components 3352 in the gripping assemblies 3350 to move the gripping elements 3354, and the target object 3302 engaged thereby, at least partially above an upper surface 3331 of the plurality of frame conveyors 3330. In the illustrated embodiment, the extendible components 3352 (sometimes also referred to herein as “vertical actuation components”) include a scissor mechanism coupled between the gripping elements 3354 and the common drive component 3342. In various embodiments, the extendible components 3352 can include a shape-memory device, a piston, a telescoping component, a scissor mechanism, a linkage mechanism, and/or any other suitable expanding component that are movable between an extended configuration (e.g., as illustrated in FIG. 33D) and a collapsed configuration (e.g., as illustrated in FIG. 33C).

In some embodiments, the gripping assemblies 3350 can include a hinge that allows the gripping elements 3354 to rotate, thereby allowing the grasped object to tilt, such as having the front/grasped surface elevate upwards with a top portion of the front surface rotating away from the end effector 3300. Accordingly, the contacting surface between the grasped object and the supporting object below can decrease, such as to a bottom portion/edge of the grasped object away from the grasped surface.

Once the target object 3302 has been lifted at least partially above an upper surface 3331 of the plurality of frame conveyors 3330, the end effector 3300 can actuate the gripper component 3340 proximally, as illustrated in FIG. 33E. As a result, the gripper component 3340 moves the target object 3302 onto the upper surface 3331 of one or more of the plurality of frame conveyors 3330 (sometimes referred to herein as a “second position,” an “object drop-off position,” a “disengagement position,” and/or the like). Once the target object 3302 is movably carried by the upper surface 3331 of one or more of the plurality of frame conveyors 3330, the end effector 3300 can operate the gripping elements 3354 to disengage the target object 3302, then actuate the gripper component 3340 to clear a path for the plurality of frame conveyors 3330 to move the target object 3302 proximally. In some embodiments, disengaging from the target object can include providing a burst of fluid (e.g., air, argon gas, and/or another suitable fluid) to the gripping elements 3354 to counteract the vacuum and/or suction force therein, thereby releasing the target object 3302. Once disengaged, actuating the gripper component 3340 can include moving the common drive component 3342 proximally while collapsing the extendible components 3352. The drive component 3342 can move proximally more quickly than the plurality of frame conveyors 3330 move the target object 3302. As a result, the gripper component 3340 can move proximally more quickly than the target object 3302 to create some separation between the gripper component 3340 and the target object 3302 while positioning every component of the gripper component 3340 beneath the upper surface 3331 of the plurality of frame conveyors 3330.

FIG. 33F illustrates the end effector 3300 after the gripper component 3340 has been fully positioned beneath the upper surface 3331 of the plurality of frame conveyors 3330 to clear a path for the target object 3302 (sometimes referred to herein as a “third position,” a “lowered position,” a “standby position,” and/or the like). As illustrated in FIG. 33F, the plurality of frame conveyors 3330 can then move the target object 3302 proximally and onto the plurality of joint conveyors 3320. In turn, the joint conveyors can continue to move the target object 3302 proximally (e.g., toward a movable base component carrying the end effector 3300, such as the chassis 302 of FIG. 3).

In the embodiments of the end effector illustrated in FIGS. 33A-33F, the frame has a generally consistent thickness between the proximal end region and the distal end region. The consistent thickness can help improve a stability of the frame (and/or the end effector thereof). However, as illustrated in FIGS. 33A-33F, the consistent thickness can require that the gripper component 3340 can fully lift any objects targeted by the end effector in order to place them on the upper surface of the frame conveyors, which can limit the number of objects that an end effector of the type illustrated in FIGS. 33A-33F can, for example, unload from a shipping unit (e.g., from a truck, a shipping container, and/or the like). In various other embodiments, however, the frame can have different shapes that can help expand the usability of the end effector.

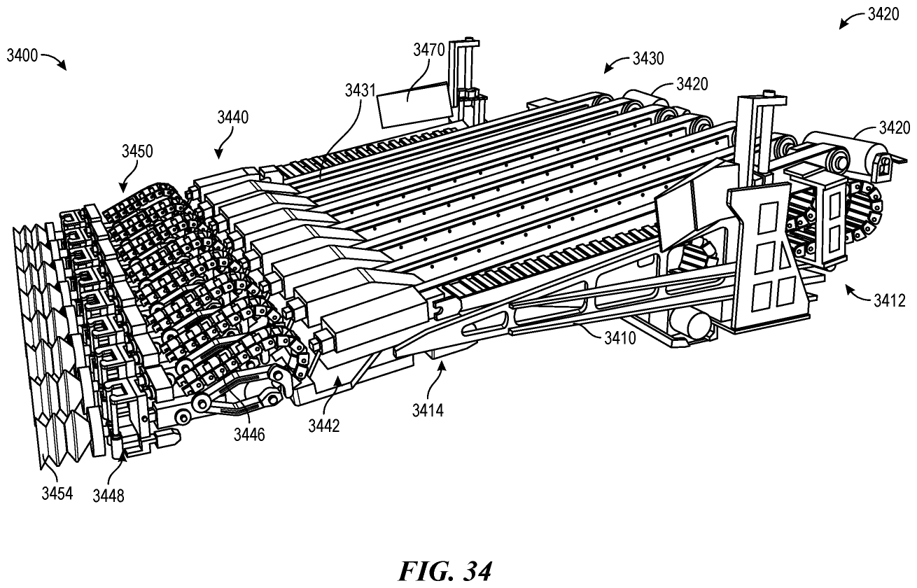

FIG. 34 is a partially schematic upper-side view of an end effector 3400 configured in accordance with some embodiments of the present technology. As illustrated in FIG. 34, the end effector 3400 is generally similar to the end effector 3200 discussed above with reference to FIGS. 32A and 32B. For example, the end effector 3400 (sometimes also referred to herein as an end-of-arm tool) includes a frame 3410, a plurality of joint conveyors 3420, a plurality of frame conveyors 3430, and a gripper component 3440. Further, the frame 3410 extends from a proximal end portion 3412 to a distal end portion 3414, the plurality of joint conveyors 3420 are carried by the proximal end portion 3412, and the plurality of frame conveyors 3430 extend from the distal end portion 3414 to the proximal end portion 3412. Still further, the gripper component 3440 includes a drive component 3442 and one or more gripping assemblies 3450 (eight illustrated in FIG. 34) coupled to the drive component 3442. Similar to the components discussed above, the drive component 3442 can move the gripping assemblies 3450 along a longitudinal axis of the end effector 3400. Further, the gripping assemblies 3450 can be actuated to move gripping elements 3454 in the gripping assemblies 3450 in an upward direction.

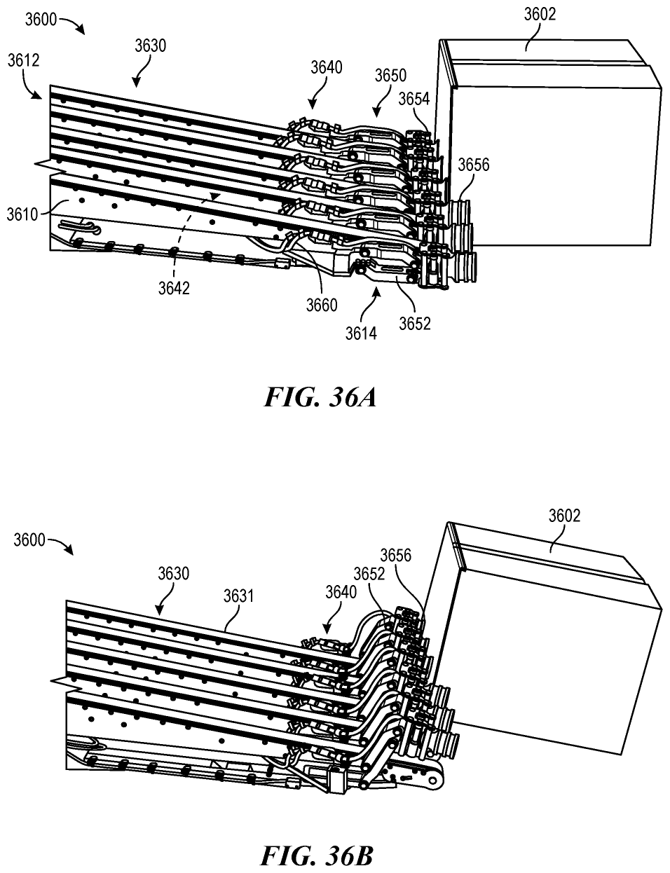

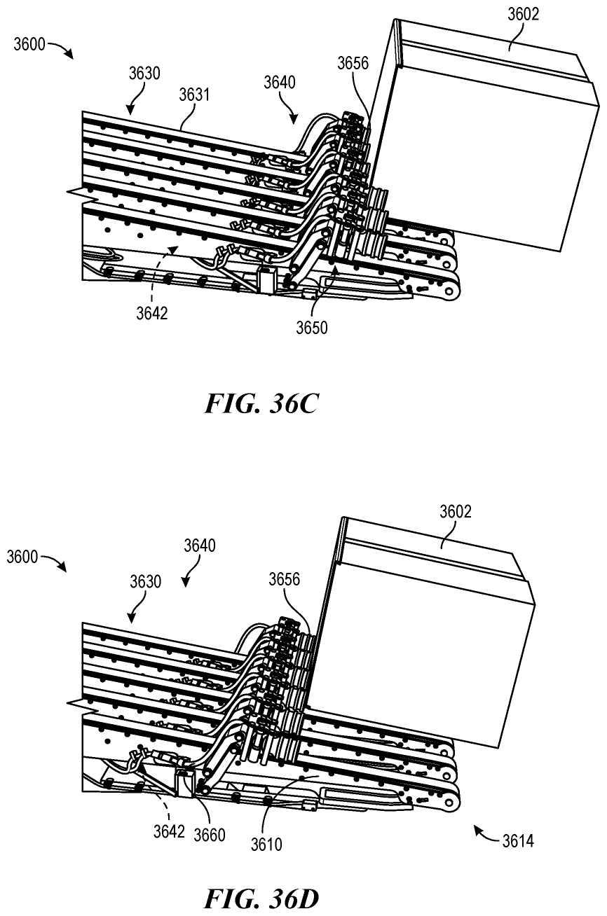

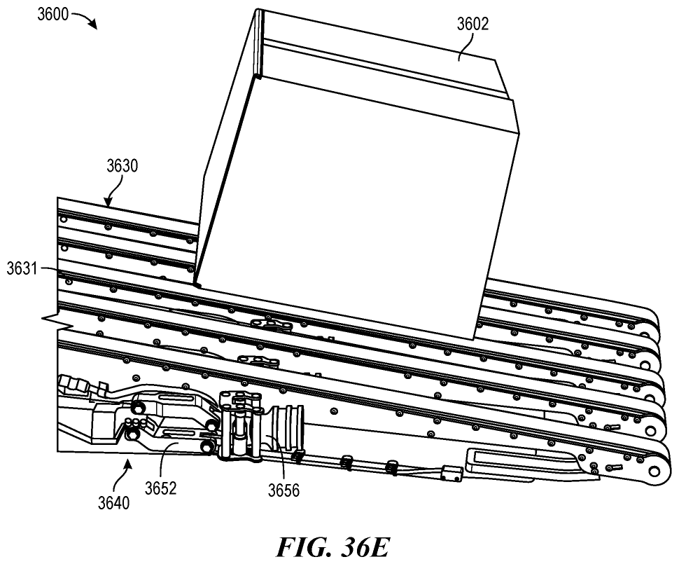

In the illustrated embodiment, however, the frame 3410 has a wedge-shaped construction with a smaller vertical thickness at the distal end portion 3414 than at the proximal end portion 3412. As illustrated and discussed in more detail with reference to FIGS. 36A-36E, the wedge-shaped construction can allow the gripping assemblies 3450 to place and/or otherwise position objects on at least a portion of an upper surface 3431 of the plurality of frame conveyors 3430 without needing to fully lift the objects. As a result, the end effector 3400 can be employed to unpack a variety of objects from a shipping unit, including objects that cannot be fully lifted by the gripper component 3440 (e.g., due to their weight).

As further illustrated in FIG. 34, the end effector 3400 can include one or more guide components 3470 (two illustrated in FIG. 34) coupled to the frame 3410. The guide components 3470 can be positioned to help direct an object on the upper surface 3431 of the plurality of frame conveyors 3430 toward a central portion of the upper surface 3431 as the plurality of frame conveyors 3430 move the object in a proximal direction. Said another way, the guide components 3470 can act as side rails to help prevent an object placed on the plurality of frame conveyors 3430 from falling off lateral sides of the end effector 3400 as it moves proximally.

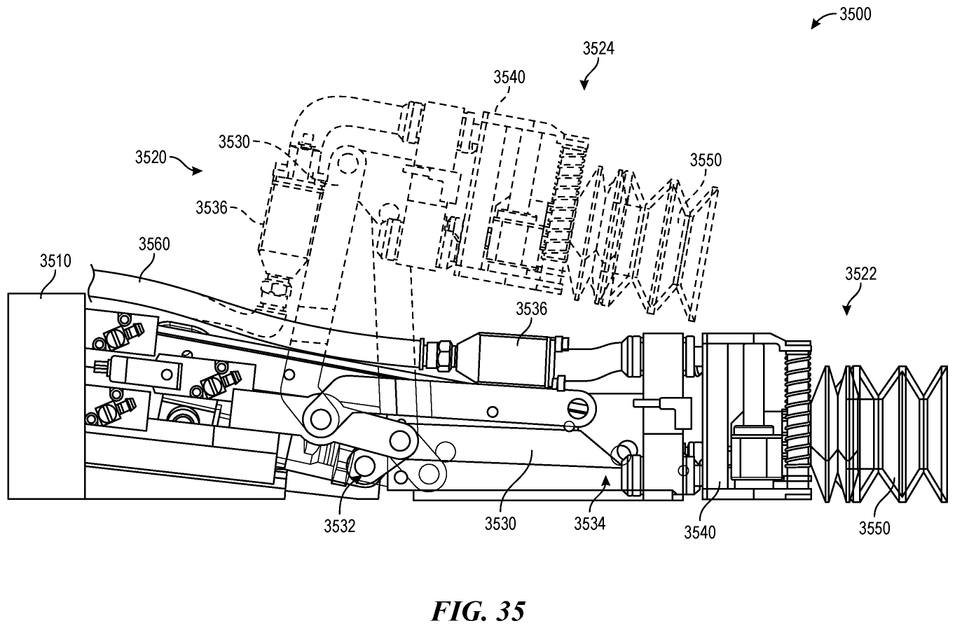

FIG. 35 is a partially schematic side view of a gripper component 3500 of the type illustrated in FIG. 34 in accordance with some embodiments of the present technology. That is, the gripper component 3500 illustrated in FIG. 35 can be generally similar to (or the same as) one of the gripper components 3440 of FIG. 34. In the illustrated embodiment, the gripper component 3500 (sometimes also referred to herein as a “gripping component”) includes a drive component 3510 and a gripping assembly 3520 operatively coupled to the drive component 3510. Although only a single gripping assembly 3520 is illustrated in FIG. 35, it will be understood that, in some embodiments, the drive component 3510 is operably coupled to a plurality of similar gripping assemblies to control a position of the gripping assemblies along an end effector in tandem (or generally in tandem). In the illustrated embodiment, the gripping assembly 3520 includes a pivotable link 3530, a connections housing 3540, and a gripping element 3550.

In the illustrated embodiment, the pivotable link 3530 (sometimes referred to herein as a “linkage mechanism”) includes a proximal end 3532 pivotably coupled to the drive component 3510 as well as a distal end 3534 pivotably coupled to the connections housing 3540. As a result, the pivotable link 3530 allows the gripping assembly 3520 to be actuated between a first position 3522 (shown in solid lines) and a second position 3524 (shown in broken lines).

As discussed and illustrated in more detail below, the transition between the first and second positions can allow the gripping assembly 3520 to engage and at least partially lift target objects onto an upper surface of an end effector (e.g., onto the upper surface 3331 of the plurality of frame conveyors 3330 of FIG. 33D, onto the upper surface 3431 of the frame conveyors 3430 of FIG. 34, and/or the like). For example, in the first position 3522, the gripping assembly 3520 can project beyond a distalmost end of a frame of an end effector to engage a target object. In the first position 3522, the gripping assembly can extend along a direction parallel with a bottom portion of the frame 3410 (e.g., bottom portion of the wedge). For example, bottom portions/surfaces of the gripping assembly can be coplanar with the bottom surface of the frame 3410. The first position 3522 can further have the bottom portion/surface of the frame 3410 oriented horizontally.

Once the suction cups engaged and the object is gripped, the gripping assembly 3520 can transition to the second position 3524 while at least partially lifting a target object (e.g., fully lifting, lifting one side of a target object, and/or the like). For example, the transition can cause the front/grasped surface of the object to rise with its top portion rotating away from the frame. Portions of the bottom surface on the grasped object and away from the grasped surface can remain contacting the below/supporting surface. Thus, the transition can reduce the contact area on the abutting surfaces of the grasped object and the supporting object by tiling/rotating the object, which can decrease the likelihood of contact between surface/contour features (e.g., surface irregularities that form vertical protrusions or depressions). Moreover, since tilting the object includes partially lifting (e.g., a front portion) of the grasped object, the weight of the grasped object as experienced/supported by the object below may be reduced. The reduced weight can provide a reduction in the friction force between the grasped object and the supporting object and thus reduce the likelihood of disrupting and moving the bottom supporting objects during the transfer of the grasped object.

The drive component 3510 can then move proximally to pull the target object onto the angled upper surface. Said another way, the pivotable link 3530 has a carrying configuration and a standby configuration (e.g., the first position 3522). In the carrying configuration, the pivotable link 3530 positions the gripping element 3550 such that the gripping element 3550 can hold a target object spaced apart from one or more conveyors while the linkage assembly rotates relative to the frame of the end effector. The rotation allows the gripping element 3550 to move the target object above the plurality of conveyors (e.g., into the second position 3524, above the upper surface 3331 of the plurality of frame conveyors 3330 of FIG. 33D). In the standby configuration, the pivotable link 3530 positions the gripper element within the end effector (e.g., beneath the upper surface 3331 of the plurality of frame conveyors 3330 of FIG. 33D).

As the drive component 3510 moves to pull the grasped object toward the frame 3410, the bottom surface of the grasped object can contact a front/distal portion of the frame 3410 (e.g., the front/corner of the wedge). Accordingly, the frame 3410 and the conveyor can provide lifting support, thereby reducing the load on the gripping assembly 3520. Additionally, by rotating the grasped object, its back corner is supported by the bottom surface. Thus, load experienced by/at the gripping assembly 3520 can be reduced to a weight less than that of the grasped object due to the support from the supporting object and/or the distal portion of the frame 3410. Further, the described configurations and operations can reduce or even eliminate the duration during which the gripping assembly 3520 supports the full weight of the grasped device. As a result, the configurations and the operations of the gripping assembly 3520 can provide increased maximum weight of the grasped and transferred objects.

In addition to the additional support, the distal end of the frame 3410 can interact with the angled/inclining direction of the conveyor (e.g., the top surface of the wedge) can allow the grasped object to be lifted from the support surface. The combination of the shape and pose of the frame 3410 and the movement direction of the conveyor and the gripping assembly can lift the grasped object immediately or within a threshold duration after the bottom surface of the grasped object contacts the distal portion/end of the frame 3410. Thus, in addition to reducing the contact surface and the corresponding friction with the supporting surface, the various configurations and operations can reduce the traveled distance of the grasped object while it is in contact with the supporting surface. In other words, the above-described features of the gripper assembly can reduce the distance and the duration while the grasped object is experiencing friction force with the supporting surface. As a result, the gripper assembly can reduce shifts in objects beneath and previously supporting the grasped/transferred object.

In some embodiments, movement between the first position 3522 and the second position 3524 is driven by a belt and pully system operably coupled to the pivotable link 3530 and/or the connections housing 3540. For example, returning to the description of FIG. 34, the gripper component 3440 can include a plurality of belts 3446 that are coupled to a connections housing 3448. When the plurality of belts 3446 are pulled backward (e.g., by rotation of a drive shaft and/or one or more pulleys), they pull on the corresponding connections housing 3448, thereby causing the gripper component 3440 to actuate (e.g., rotate, pivot, and/or otherwise move) to a raised position, such as the second position illustrated in FIG. 35. Returning to FIG. 35, in some embodiments, movement between the first position 3522 and the second position 3524 is driven by a rotor and/or other electric drive mechanism operably coupled to the pivotable link 3530. In some embodiments, the pivotable link 3530 is operatively coupled to an actuating mechanism common between multiple gripping assemblies to control movement between the first position 3522 and the second position 3524 generally simultaneously.

As further illustrated in FIG. 35, the pivotable link can include an anchor 3536 positioned between the proximal end 3532 and the distal end 3534. The anchor 3536 can help manage various connections 3560 (e.g., electrical wires, vacuum tubes, vacuum lines, fluid lines, and/or the like) extending between the drive component 3510 and the connections housing 3540. That is, the anchor 3536 provides a fixed point for the connections 3560 as the gripping assembly 3520 transitions between the first position 3522 and the second position 3524. As a result, for example, the anchor 3536 can help reduce the chance that the connections 3560 are caught on another part of the gripper component 3500, the end effector, and/or a surrounding environment. In turn, the management can help improve a speed and accuracy of the gripper component 3500 (e.g., the gripping assembly 3520 can transition between the first position 3522 and the second position 3524 more quickly when the chance of a snag is reduced).

The connections housing 3540 can then route the connections 3560 to an appropriate end location. For example, in some embodiments, the gripping element 3550 (sometimes also referred to herein as a “gripper element,” an “engagement element,” and/or the like) includes a vacuum component. In such embodiments, the connections housing 3540 can route a vacuum tube to an input for the vacuum component to provide a vacuum pressure (and/or positive pressure) to engage (and disengage) a target object. In another example, the gripping element 3550 includes a magnetic component. In this example, the connections housing 3540 can route electrical connections to the magnetic component to generate (and stop generating) a magnetic force to engage (and disengage) a target object. In yet another example, the gripping element 3550 includes a mechanical gripper component (e.g., a clamp). In this example, the connections housing 3540 can route electrical connections to the clamping to actuate the mechanical gripper component to engage (and disengage) a target object.

FIGS. 36A-36E are partially schematic side views of an end effector 3600 at various stages of a process for picking up a target object in accordance with some embodiments of the present technology. The end effector 3600 can be generally similar to (or identical to) the end effector 3400 discussed above with reference to FIG. 34. For example, as illustrated in FIG. 36A, the end effector 3600 (sometimes also referred to herein as an end-of-arm tool) includes a frame 3610, a plurality of frame conveyors 3630, and a gripper component 3640. Further, the frame 3610 extends from a proximal end portion 3612 to a distal end portion 3614, and the plurality of frame conveyors 3630 are positioned to move an object thereon between the distal end portion 3614 and the proximal end portion 3612.

As further illustrated in FIG. 36A, the gripper component 3640 can be generally similar (or identical) to the gripper component 3500 discussed with reference to FIG. 35. For example, the gripper component 3640 can include a drive component 3642 and one or more gripping assemblies 3650 (six illustrated in FIG. 36A) operably coupled to the drive component 3642. The gripping assemblies 3650 each include a pivotable link 3652, a connections housing 3654, and a gripping element 3656. Similar to the components discussed above, the drive component 3642 can be actuated to move the gripping assemblies 3650 along a longitudinal axis of the end effector 3600. For example, as illustrated in FIG. 36A, the gripper component 3640 (or another suitable controller) can move the drive component 3642 to position the gripping assemblies 3650 to a position distal to a distalmost end of the frame 3610 (sometimes referred to herein as a “first position,” a “pick-up position,” and “engagement position,” and/or the like). In this position, one or more of the gripping assemblies 3650 can be operated to engage a target object 3602 (three in the illustrated embodiment).

In the illustrated embodiment, the engagement can be accomplished by delivering a drive force to the gripping elements 3656 via connections 3660 individually coupled between the drive component 3642 and each of the gripping elements 3656. In various embodiments, the drive force can be a vacuum force (sometimes also referred to herein as a suction force, e.g., delivered by a vacuum tube), an electrical drive force (e.g., supplied to a magnetic component, a mechanical gripper component, and/or the like), a pneumatic force (e.g., delivered to a mechanical gripper component), and/or any other suitable force. The drive force allows each of the gripping elements 3656 to releasably engage (e.g., grip, pick up, and/or otherwise couple to) the target object 3602. The end effector 3600 can be in the first position as described above with the gripping elements extended in the distal direction and toward the target object 3602. The frame of the end effector 3600 can be oriented to have the top surface (e.g., the plurality of frame conveyors 3630) at an angle/incline.

As illustrated in FIG. 36B, after one or more of the gripping elements 3656 engages the target object 3602, the gripper component 3640 (or any other suitable controller) can actuate the pivotable links 3652 to raise the connections housings 3654 and the gripping elements 3656, thereby at least partially lifting the target object 3602. In the illustrated embodiment, the gripper component 3640 thereby tilts the target object 3602 onto a trailing edge, with the leading edge raised above an upper surface 3631 of the plurality of frame conveyors 3630. In other words, the end effector 3600 can transition from the first position to the second position. In some embodiments, the overall pose of the end effector 3600 or its frame can remain constant in space or move in the distal direction and/or along a vertical direction by predetermined amount(s) to offset or complement the transition.

Tilting the target object 3602 can have several benefits for the end effector 3600. For example, tilting the target object 3602 does not require that the gripping assemblies fully lift the target object 3602, which can be relatively difficult for heavier objects and/or objects that are otherwise difficult to engage with the gripping elements 3656. As a result, for example, the end effector 3600 can be used to unload a wider variety of objects from a shipping unit. Additionally, or alternatively, tilting the target object 3602 can reduce the surface area of the target object in contact with an underlying surface, thereby also reducing friction with the underlying surface. The reduction in friction, in turn, can lower the force required to pull the target object 3602 proximally onto the upper surface 3631 of them plurality of frame conveyors 3630 and/or reduce the chance pulling the target object 3602 will disrupt underlying objects (e.g., knock over a stack of underlying boxes that will be targeted next).

As illustrated in FIG. 36C, after the leading edge of the target object 3602 is raised above the upper surface 3631 of the plurality of frame conveyors 3630, the gripper component 3640 (or another suitable controller) can move the drive component 3642 to move the gripping assemblies 3650 proximally. As a result, the gripping assemblies 3650 can pull the target object 3602 onto the upper surface 3631 of the plurality of frame conveyors 3630 (sometimes referred to herein as a “second position,” an “object drop-off position,” a “disengagement position,” and/or the like).

As illustrated in FIG. 36D, as the drive component 3642 continues to move in a proximal direction, the gripper component 3640 (or another suitable controller) can actuate the gripping elements 3656 to disengage the target object. In some embodiments, the disengagement is accomplished by cutting off the drive force from the gripping elements 3656. In some embodiments, the disengagement includes delivering a disengagement force to the gripping elements 3656. For example, in embodiments using a vacuum force to engage the target object 3602, a vacuum pressure can continue to exist between the gripping elements 3656 and the target object 3602 after the vacuum force is cut off. In such embodiments, the gripper component 3640 can disengage the gripping elements 3656 by delivering a positive pressure (e.g., a burst of air, argon gas, and/or another suitable fluid) to the gripping elements via the connections 3660.

In some embodiments, the gripper component 3640 (or another suitable controller) causes the gripping elements 3656 to disengage the target object 3602 at a predetermined position between the distal end portion 3614 and the proximal end portion 3612 of the frame 3610. The predetermined distance can be configured such that the plurality of frame conveyors 3630 can move the target object 3602 proximally without the help of the gripper components 3640. In some embodiments, the end effector 3600 can include one or more sensors (see FIGS. 32A and 32B) that detect when the gripping elements 3656 and/or the target object 3602 reach the predetermined position. In some embodiments, the position of the gripper component 3640 and/or the gripping elements 3656 can be measured by monitoring a drive mechanism coupled to the drive component 3642 (e.g., by measuring rotations of a rotor coupled to the drive component 3642 to determine a position of the gripper component 3640).

Once the gripping elements 3656 disengage the target object 3602, the gripper component 3640 (or another suitable controller) can operate the drive component 3642 to move the gripping elements 3656 of the gripper component 3640 proximally more quickly than the plurality of frame conveyors 3630 move the target object 3602. As a result, the drive component 3642 can create some separation between the gripping elements 3656 and the target object 3602 to allow the gripping elements 3656 to be positioned beneath the plurality of frame conveyors 3630.

For example, as illustrated in FIG. 36E, after the gripping elements 3656 are separated from the target object 3602, the gripper component 3640 (or another suitable controller) can actuate the pivotable links 3652 to lower the connections housings 3654 and the gripping elements 3656 beneath the upper surface 3631 of the plurality of frame conveyors 3630. As a result, the gripper component 3640 is positioned fully outside of a proximal travel path for the target object 3602 along the plurality of frame conveyors 3630 (sometimes referred to herein as a “third position,” a “lowered position,” a “standby position,” and/or the like). The plurality of frame conveyors 3630 can then move the target object 3602 proximally (e.g., toward a movable base component) while (or before) the end effector 3600 is moved adjacent to the next target object.

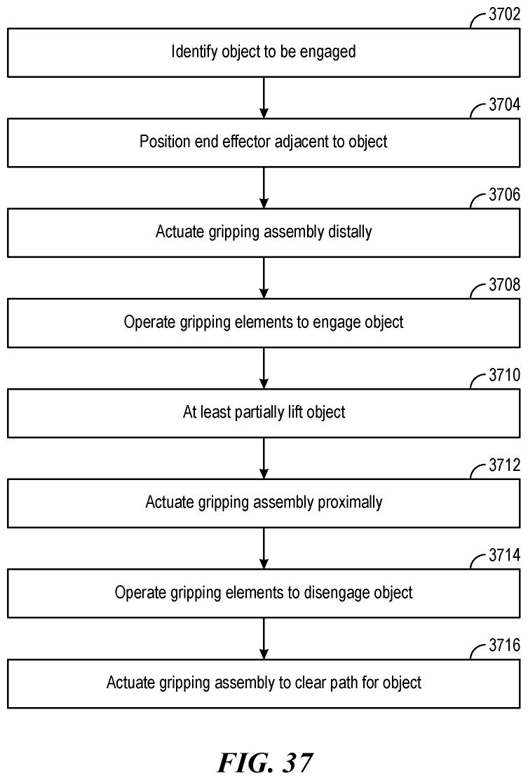

FIG. 37 is a flow diagram of a process for picking up a target object in accordance with some embodiments of the present technology. The process can be implemented by an end effector, components thereof, and/or various other components of a robotic system of the type discussed above with reference to FIGS. 3-31 to unload objects from a shipping unit (e.g., a shipping container, truck, and/or the like). Further, the process can be implemented, at least partially, using an end effector of the type discussed above with reference to FIGS. 32A-36E.

The process begins at block 3702 by identifying an object to be engaged. The identification process at block 3702 can be generally similar to (or identical to) one or more portions of the process discussed above with reference to FIG. 18. For example, the identification process can include detecting one or more target objects using sensors onboard the end effector and/or any other suitable sensors in the robotic system. Additionally, or alternatively, the identification process can include selecting one or more target objects previously detected using the sensors and/or otherwise known to the process (e.g., loaded from a map of target objects).

At block 3704, the process includes positioning the end effector adjacent to the identified object. In various embodiments, positioning the end effector can include moving and/or actuating chassis, a first segment, and/or distal joint of the robotic system. Once the end effector is positioned adjacent to the identified object (e.g., as illustrated in FIG. 33A), the identified object is distal to a distalmost end of the end effector. In positioning the gripper, the robotic system can have the frame conveyors 3630 at an incline for pulling and lifting the gripped object during an initial portion of the transfer.

At block 3706, the process includes actuating a gripping assembly in the end effector distally to position one or more gripping elements in the gripping assembly in contact with the identified object (e.g., as illustrated in FIG. 33B). As discussed above, actuating the gripping assembly can include actuating a drive component of the gripping assembly using a belt-and-pully system, a gear-and-track system, driving one or more carts along a track, operating one or more expandable components (e.g., pistons, telescoping elements, and/or the like), and/or the like.

At block 3708, the process includes operating the one or more elements to engage the identified object (e.g., as illustrated in FIGS. 33C and 36A). In various embodiments, as discussed above, the gripping elements can include a vacuum component (sometimes also referred to herein as a suction component), a magnetic component, a mechanical gripper component, and/or the like that are operated by delivering a drive force and/or a drive signal (e.g., a vacuum force, electrical power, command signals, and/or the like) to the gripping elements through connections in the gripping assembly.

At block 3710, the process includes at least partially lifting the identified object (e.g., as illustrated in FIGS. 33D and 36C). The lifting can be accomplished, for example via the extendible component 3252 of FIG. 32A, the pivotable link 3530 of FIG. 35, and/or the like. Further, as discussed above, the lifting process can reduce friction between the identified object and an underlying object and/or pick up the identified object completely to avoid (or reduce) disturbance to the underlying object while retrieving the identified object. In some embodiments, the process does not need to lift the identified object (e.g., when pulling the object proximally off a shelf). In such embodiments, the process can omit block 3710 and instead actuate one or more components in the gripping assembly (e.g., the extendible component 3252 of FIG. 32A, the pivotable link 3530 of FIG. 35, and/or the like) at block 3706 to raise the gripping elements before engaging the identified object.

In contacting and gripping the object, the robotic system can extend the one or more gripping elements toward the object. With the extended gripping elements, the robotic system can contact and grip the object through the actuation of the suction cups at the end of the extended one or more gripping elements. Once the gripper engages the object, the robotic system can rotatably retract the one or more pivotable link to raise the one or more gripping elements and the gripped object. In rotatably retracting the one or more pivotable link, the robotic system can effectively tilt the gripped object with a top portion of a gripped surface of the object rotating away from the EOAT and a vertical axis.

At block 3712, the process includes actuating the gripping assembly proximally to position the gripping elements above at least a first portion of a conveyor (e.g., frame conveyors) in the end effector (e.g., as illustrated in FIGS. 33E and 36D). In some embodiments, the process can implement block 3710 and block 3712 generally simultaneously to at least partially lift the identified object while also actuating the gripping assembly proximally. As the gripping assembly moves proximally, the gripping assembly pulls the identified object onto an upper surface of the end effector, where one or more conveyors can then move the identified object proximally toward the movable base of the robotic system. The robotic system can effectively move a bottom surface of the gripped object to contact a distal end portion of the EOAT, and the distal end portion can support the gripped object while it is moved completely onto the EOAT. The robotic system can pull the object onto the EOAT (e.g., the conveyor thereon) while maintaining a tilted pose of the gripped object for reducing a surface friction between the gripped object and a supporting object under and contacting the gripped object.

At block 3714, the process includes operating the gripping elements to disengage the identified object. As discussed above, in various embodiments, disengaging the identified object can include cutting off a drive force (e.g., stop delivering a vacuum force, stop delivering power and/or another electric drive signal, and/or the like) and/or delivering various other control signals. In some embodiments, disengaging the identified object can include delivering a disengaging force (e.g., a burst of air, argon gas, and/or another suitable fluid to overcome a vacuum pressure between the gripping elements and the identified object). Once disengaged, the identified object is fully placed onto the conveyors of the end effector. Further, as discussed above, disengaging the identified object can include moving the gripping assembly proximally more quickly than the conveyors of the end effector move the identified object. The movement can help create separation between the gripping assembly and the identified object that, for example, can provide space for the gripping element to be actuated into a lowered position.

At block 3716, the process includes actuating the gripping assembly to position the gripping elements below at least a second portion of the conveyors (e.g., as illustrated in FIGS. 33F and 36E). Similar to the lifting discussed above, the actuation can be accomplished, for example, via the extendible component 3252 of FIG. 32A, the pivotable link 3530 of FIG. 35, and/or the like. Further, in some embodiments, the actuation includes creating some separation between the gripping assembly and the identified object by moving the gripping assembly proximally more quickly than the conveyors move the identified object (e.g., when separation was not created at block 3714 and/or to increase the separation). Once beneath the second portion of the conveyors, the gripping assembly is positioned out of a proximal travel path along the conveyors. Subsequently, the process can include operating the conveyors to move the identified target object proximally toward the movable base of the robotic system.

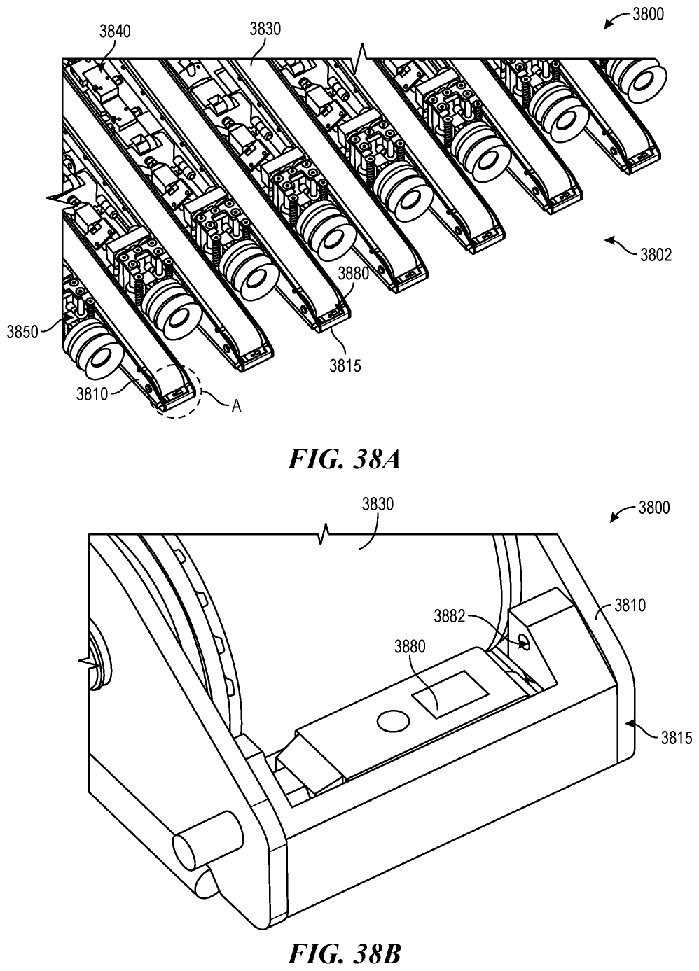

FIGS. 38A and 38B are partially schematic upper-side views illustrating additional features at a distal region 3802 of an end effector 3800 configured in accordance with some embodiments of the present technology. As best illustrated in FIG. 38A, the end effector 3800 can be generally similar to (or identical to) an end effector of the type discussed above with reference to any of FIGS. 32A-FIG. 36E. For example, in the illustrated embodiment, the end effector 3800 includes a frame 3810, a plurality of frame conveyors 3830, and a gripper component 3840 that includes a plurality of gripping assemblies 3850. Further, the end effector 3800 can include one or more sensors 3880 that are positioned to detect when the gripper component 3840 and/or an object engaged by the gripper component 3840 pass a predetermined position on the frame 3810 during a gripping operation. As discussed above, the predetermined position can be selected such that, beyond the predetermined position, the plurality of frame conveyors 3830 can carry and/or move the target object proximally. In some embodiments, the predetermined position accounts for a distance that the gripper component 3840 (and the target object engaged thereby) will travel before the gripper component 3840 can disengage the target object in response to signals from the sensors 3880. In the embodiment illustrated in FIG. 38A, the sensors 3880 are carried by a distalmost portion 3815 of the frame 3810. As a result, the end effector 3800 can rely on lag in the disengagement and/or momentum of the target object to ensure the target object is placed on the plurality of frame conveyors 3830.

FIG. 38B is a close-up view of a distalmost portion 3815 of the frame 3810 (e.g., a blown-up view of the circled region A). As illustrated in FIG. 38B, the sensors 3880 can include proximity sensors that detect when the target object crosses over the sensors 3880 and are thereby positioned above at least a portion of the plurality of frame conveyors 3830. However, the proximity sensors (and other sensors that can be used) can be sensitive to dust, dirt, and/or other contaminants. To help reduce interference with the sensors 3880, the end effector 3800 can include one or more outlet nozzles 3882 directed across the sensors 3880. The outlet nozzles 3882 can direct air (and/or any other suitable fluid) across the sensors 3880 periodically to help keep the proximity sensors clear of dust, dirt, and/or other contaminants. In some embodiments, the outlet nozzles 3882 can be fluidly couplable to the connections in the gripping assembly (e.g., the connections 3560 discussed above with reference to FIG. 35). In some such embodiments, the burst of air (and/or any other suitable fluid) used to disengage the gripping elements from the target object can be partially directed to the outlet nozzles 3882. As a result, the outlet nozzles 3882 can direct the portion of the burst across the sensors 3880 after each cycle through a gripping operation.

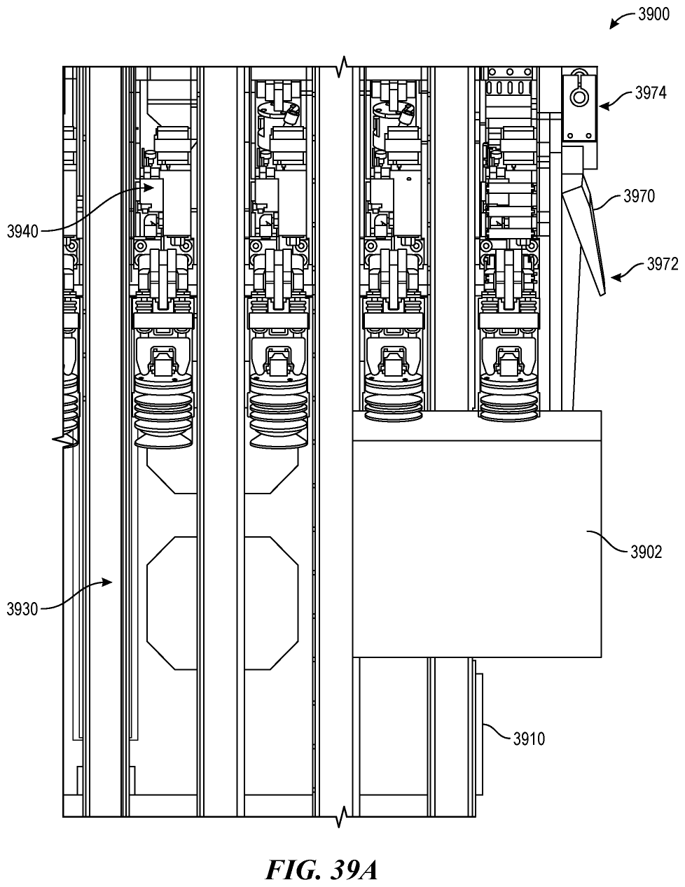

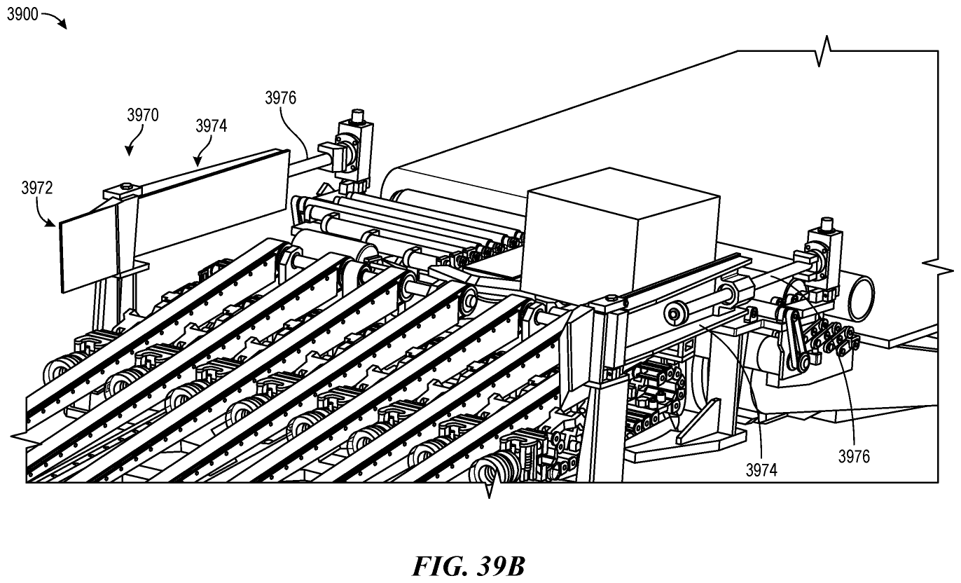

FIGS. 39A and 39B are partially schematic top and upper-side views, respectively, of an end effector 3900 configured in accordance with some embodiments of the present technology. In the illustrated embodiments, the end effector 3900 can be generally similar to (or identical to) any of the end effectors discussed above with reference to FIGS. 32A-36E, 38A, and 38B. For example, as illustrated in FIG. 39A, the end effector 3900 can include a frame 3910, a plurality of frame conveyors 3930, and a gripper component 3940. Further, similar to the end effector 3400 discussed above with reference to FIG. 34, the end effector 3900 can include one or more guide components 3970 positioned on lateral sides of the frame 3910.

As best illustrated in FIG. 39A, the guide components 3970 include an angled portion 3972 and a straight portion 3974. The angled portion 3972 slopes inward toward a central longitudinal axis of the end effector 3900. As a result, the angled portion 3972 can push (or otherwise force) a target object 3902 placed on a lateral side of the end effector 3900 toward the central longitudinal axis of the end effector 3900 as the plurality of frame conveyors 3930 move the target object 3902 proximally. The straight portion 3974 extends parallel to the longitudinal axis of the end effector 3900. As a result, the straight portion 3974 can act as a side rail along the remainder of the end effector 3900.

In some embodiments, as best illustrated in FIG. 39B, the straight portion 3974 can be movably coupled to a track 3976 (or another suitable component, such as a piston, telescoping component, and/or the like). The track 3976 allows the guide components 3970 to move distally and proximally along the longitudinal axis of the end effector 3900. As a result, for example, the guide components 3970 can adjust their position to maximize the object-guiding benefit of the guide components 3970 and/or to improve clearance around the end effector 3900. In a specific, non-limiting example, the guide components 3970 can be in a retracted (proximal) position while the end effector 3900 is positioned adjacent to one or more target objects to reduce the chance that the guide components 3970 catch on a surrounding environment during the motion. Once the end effector 3900 is in position, the guide components 3970 can be moved to an extended (distal) position to push target objects toward the central longitudinal axis of the end effector 3900 and/or help prevent them from falling off the lateral sides.

It will be understood that, although not explicitly discussed above with reference to FIGS. 31-39B, in some embodiments, the end effector can include a controller operably coupled to any of the components discussed herein. The controller can be communicably coupled to another controller (e.g., the processors 202 of FIG. 2 and/or any other suitable component) to help control the operation of any of the components of the end effector discussed above. Additionally, or alternatively, the controller can include a processor and a memory storing instructions that, when executed by the processor, cause the controller to implement any of the operations of the end effector discussed above.

Example Distal Joints for the Robotic system

FIG. 40 is a partially schematic upper-side view of a distal joint 4010 for a robotic system 4000 configured in accordance with some embodiments of the present technology. As illustrated in FIG. 40, the robotic system 4000 includes between a first segment 4002 (e.g., sometimes also referred to herein as a “movable arm” and/or the like), the distal joint 4010 (sometimes also referred to herein as a “wrist joint,” a “second joint,” an “end effector joint,” and/or the like) operably coupled to the first segment 4002, and an end effector 4004 operably coupled to the distal joint 4010. It will be understood that the first segment 4002 can be generally similar to (or identical to) any of the first segments discussed above with reference to FIGS. 3-12F. Similarly, end effector 4004 can be generally similar to (or identical to) any of the end effectors discussed above with reference to FIGS. 32A-39.

As illustrated in FIG. 40, similar to the discussion above with reference to FIGS. 15 and 16, the distal joint 4010 allows the end effector 4004 to rotate with respect to the first segment 4002 along both the third axis A₃ and the fourth axis A₄. Said another way, the distal joint 4010 provides two degrees of freedom for the end effector 4004 relative to the first segment 4002. In turn, the degrees of freedom can allow the end effector 4004 (and the robotic system 4000 more broadly) to be positioned in a variety of suitable configurations. As a result, the robotic system 4000 can unload a variety of shipping units without external assistance (e.g., human or robotic assistance).

In the illustrated embodiment, the distal joint 4010 includes a first drive system 4020 that rotatably couples the distal joint 4010 to the first segment 4002. As discussed in more detail below, the first drive system 4020 can include various components that can rotate the distal joint 4010 (and the end effector 4004 coupled thereto) about the fourth axis A₄ with respect to the first segment 4002. For example, in the embodiment illustrated in FIG. 40, the first drive system 4020 (sometimes also referred to herein as a “first drive mechanism”) includes a pivotable link 4022 that helps support the weight of the distal joint 4010 and/or the end effector 4004 at a variety of angles with respect to the first segment 4002. In some embodiments, as discussed in more detail below, the first drive system 4020 can be operably coupled to the pivotable link 4022 to help drive the rotation of the distal joint 4010 about the fourth axis A₄. In the illustrated embodiment, the robotic system 4000 also includes a second drive system 4030 (shown schematically) that rotatably couples the distal joint 4010 to the end effector 4004. As discussed in more detail below, the second drive system 4030 can include a mechanism to rotate the end effector 4004 about the third axis A₃ with respect to the distal joint 4010. In a specific, non-limiting example discussed, the second drive system 4030 can include a rotary motion joint (sometimes also referred to herein as a rotary union) with a central passthrough for connections.

As further illustrated in FIG. 40, the distal joint 4010 can include a plurality of joint conveyors 4012 (e.g., rollers) that are positioned to receive a target object 4006 from the end effector 4004 and move the target object 4006 in a proximal direction (e.g., toward and/or onto the first segment 4002). The distal joint 4010 can also include one or more fixed support plates 4014 (one illustrated in FIG. 40) that help support the target object 4006 along the motion path, allow drive mechanisms (e.g., belts, servomotors, gears, and/or the like) to be coupled to the joint conveyors 4012, and/or help match the distal joint 4010 to one or more conveyors on the end effector 4004 (e.g., the plurality of joint conveyors 3220 of FIG. 32A, the plurality of joint conveyors 3420 of FIG. 34, and/or the like). Further, the distal joint 4010 can include one or more retractable elements 4044 (one illustrated in FIG. 40) that are operably coupled to a retraction system 4042. The retractable elements 4044 can include additional conveyors, passive rollers, support plates (and/or other low-friction elements), and/or the like. As discussed in more detail below with reference to FIGS. 42A-43C, the retraction system 4042 can raise (and lower) the retractable elements 4044 to fill gaps (and open space) between the distal joint 4010 and the end effector 4004 as the end effector 4004 rotates about the third axis A₃. For example, in various embodiments, the retraction system 4042 can include various telescoping components, pneumatic actuators, pistons, shape memory devices, scissor components, and/or the like. In the specific, non-limiting example illustrated in FIG. 40, the retraction system 4042 includes a stepped track that rotates along with the end effector 4004 to automatically raise (and lower) the retractable elements 4044 as the end effector 4004 rotates.

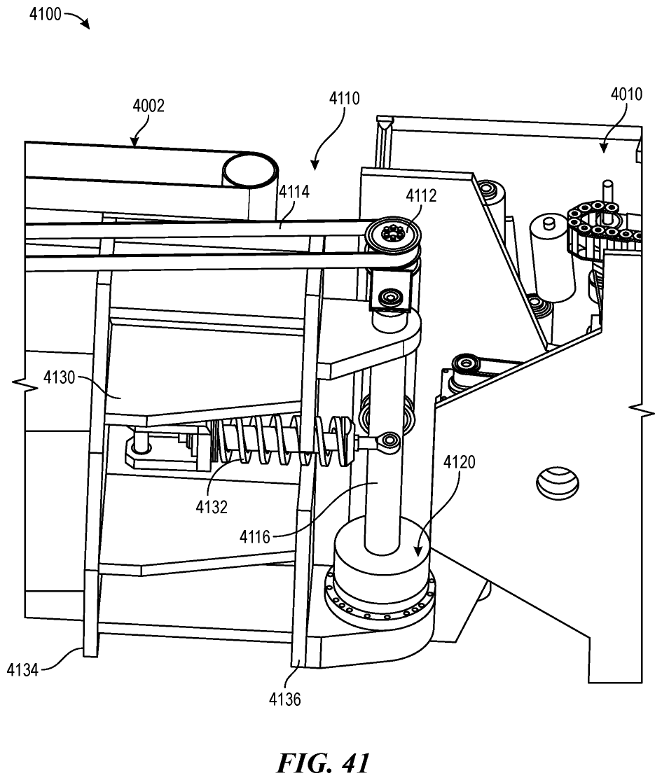

FIG. 41 is a partially schematic bottom view of a distal joint 4100 for a robotic system configured in accordance with some embodiments of the present technology. The distal joint 4100 can be generally similar (or identical) to the distal joint 4010 discussed above with reference to FIG. 40. For example, the distal joint 4100 can be operably coupled between a first segment 4002 and an end effector 4004. FIG. 41, however, illustrates additional details on a first drive mechanism 4110 in the distal joint 4100 to control rotation of the distal joint 4100 with respect to the first segment 4002 (e.g., along the fourth axis A₄ illustrated in FIG. 40). In the illustrated embodiment, the first drive mechanism 4110 includes a linking pully 4112, a linking belt 4114 and a drive shaft 4116 each operably coupled to the linking pully 4112, and a reducer system 4120 operably coupled to the drive shaft 4116. The linking belt 4114 extends from the linking pully 4112 to a pully at a proximal joint (e.g., to the actuators 336 discussed above with reference to FIG. 3) such that when the first segment 4002 rotates with respect to the proximal joint (e.g., rotates about the second axis A₂ of FIG. 3), the linking belt 4114 translates motion to the linking pully 4112. In turn, the linking pully 4112 can translate the motion into the drive shaft 4116, which translates the motion through the reducer system 4120.

The reducer system 4120 can include a pully reducer and/or other breaking mechanism (e.g., resistive breaking mechanism) and/or an accelerating mechanism (e.g., a gear increase). As a result, the reducer system 4120 can help smooth and/or translate motion from the linking belt 4114 to the rotation of the distal joint 4100 such that rotation in the proximal joint (e.g., about the second axis A₂ of FIG. 3) is matched by rotation in the distal joint (e.g., about the fourth axis A₄ of FIGS. 3 and 40). The general match in the motion, in turn, helps maintain the end effector 4004 in a generally level configuration such that target objects engaged thereby can be moved by one or more conveyors in the end effector 4004 (e.g., to maintain a generally flat upper surface 3331 of the plurality of frame conveyors 3330 of FIG. 33D and/or to generally maintain a predetermined slope in the upper surface 3431 of the plurality of frame conveyors 3430 of FIG. 34).

In some embodiments, the reducer system 4120 includes one or more servomotors to help smooth the motion from the linking belt 4114 and/or to help translate the motion to various other components in the first drive mechanism 4110. In a specific, non-limiting example discussed in more detail below, the reducer system 4120 can translate the motion from the linking belt 4114 to a pivotable link of the type discussed above with reference to FIG. 40.

In the embodiment illustrated in FIG. 41, the distal joint 4100 also includes a floating joint 4130 operably coupled between the first drive mechanism 4110 and the first segment 4002. The floating joint 4130 includes a compression component 4132, a proximal reference 4134 coupled between the compression component 4132 and the first segment 4002, and a distal reference 4136 coupled between the compression component 4132 and the first drive mechanism 4110. The compression component 4132 can compress and/or expand in response to the rotation of the distal joint 4100 relative to the first segment 4002 (e.g., along the fourth axis A₄ of FIG. 40). As a result, the floating joint 4130 can help maintain a predetermined distance between the distal joint 4100 and the first segment 4002. As a result, the floating joint 4130 can help avoid interference between conveyors in the distal joint 4100 and the conveyors in the first segment 4002 and/or help avoid too large of a gap forming between the distal joint 4100 and the first segment 4002.

FIGS. 42A and 42B are partially schematic side views of a distal joint 4210 of a robotic system 4200 configured in accordance with further embodiments of the present technology. More specifically, FIGS. 42A and 42B illustrate additional details on a first drive system 4220 in the distal joint 4210 according to some embodiments of the present technology. In the illustrated embodiments, the distal joint 4210 is generally similar (or identical) to the distal joints 4010, 4100 discussed above with reference to FIGS. 40 and 41. For example, the distal joint 4210 can be operably coupled between a first segment 4202 and an end effector 4204.

Further, the first drive system 4220 is coupled between the distal joint 4210 and the first segment 4202. As illustrated in FIGS. 42A and 42B, the first drive system 4220 can include a reducer system 4222 carried by the distal joint 4210, as well as a pivotable link 4224 and an expandable component 4226 each coupled between the distal joint 4210 and the first segment 4202. As discussed above, the reducer system 4222 can help translate rotation in a proximal joint of the robotic system to an opposite rotation in the distal joint 4210. More specifically, the reducer system 4222 can drive rotation in the pivotable link 4224, thereby causing the distal joint 4210 to rotate about the fourth axis A₄ with respect to the first segment 4202. For example, FIG. 42A illustrates the robotic system 4200 in a lowered configuration while FIG. 42B illustrates the robotic system 4200 in a raised configuration. To move between the lowered configuration and the raised configuration, the reducer system 4222 can drive the pivotable link 4224 clockwise around the fourth axis A₄, thereby also rotating the distal joint 4210 with respect to the first segment 4202. As further illustrated in FIG. 42A, the fourth axis A₄ can be generally orthogonal to a longitudinal plane of the end effector 4204 (e.g., the third plane P₃). Additionally, or alternatively, the fourth axis A₄ can be generally orthogonal to a transverse plane of the end effector 4204 (e.g., the fourth plane P₄ illustrated in FIG. 42A).

In some embodiments, the expandable component 4226 can help drive the rotation of the pivotable link 4224 and/or the distal joint 4210. For example, the expandable component 4226 can be coupled to a controller to expand and/or contract in response to signals from the controller, thereby causing the distal joint 4210 (and the pivotable link 4224) to rotate about the fourth axis A₄. Additionally, or alternatively, the expandable component 4226 can help stabilize the rotation of the distal joint 4210 and/or help support the distal joint 4210 and/or the end effector 4204 during operation. For example, because the expandable component 4226 is coupled between the distal joint 4210 and the first segment 4202, the expandable component 4226 provides an additional anchor therebetween. The additional support can be useful, for example, to help reduce noise at the end effector 4204 while target objects of varying weights are engaged and loaded onto the end effector 4204. One result, for example, is that the end effector 4204 and/or the distal joint 4210 can drop fewer objects as a result of noise during operation and/or movement between configurations.

FIGS. 43A-43C are partially schematic top views of a distal joint 4310 for a robotic system 4300 configured in accordance with some embodiments of the present technology. As illustrated in FIG. 43A, the distal joint 4310 can be generally similar (or identical) to the distal joints discussed above with reference to FIGS. 40-42B. For example, the distal joint 4310 can be operably coupled between a first segment 4302 and an end effector 4304 of the robotic system 4300. Further, the distal joint 4310 includes a second drive system 4330 that helps control a rotation of the end effector 4304 about the third axis A₃ with respect to the distal joint 4310. As illustrated in FIG. 43A, the third axis A₃ can be generally orthogonal to the transverse plane of the end effector 4204 (e.g., the fourth plane P₄).

As further illustrated in FIG. 43A, the distal joint 4310 can include features that help bridge gaps between the distal joint 4310 and the end effector 4304 as the end effector 4304 rotates. For example, FIG. 43A illustrates the robotic system 4300 with the distal joint 4310 and the end effector 4304 in an aligned (e.g., non-rotated) configuration. In this state, there is not a significant gap between one or more first conveyors 4312 (e.g., rollers and/or the like) in the distal joint 4310 and one or more second conveyors 4305 in the end effector 4304 (e.g., the frame conveyors and/or joint conveyors discussed above with reference to FIGS. 32A and 34, such as conveyor belts, one or more rollers, and/or the like). As a result, the second conveyors 4305 can transfer target objects to the first conveyors 4312 without additional support. Accordingly, a first retractable system 4313 and a second retractable system 4316 can be in a retracted and/or lowered position beneath the one or more first conveyors 4312 (sometimes referred to herein as “lowered position,” a “standby position,” a “retracted position,” and/or the like).

As illustrated in FIG. 43B, as the end effector 4304 rotates counterclockwise along the third axis A₃ with respect to the distal joint 4310, the first conveyors 4312 move away from the second conveyors 4305, thereby forming a gap that may be too big for the target objects to traverse without additional support. Accordingly, as the end effector 4304 rotates counterclockwise, the first retractable system 4313 can transition (e.g., raise) into an extended and/or raised position to provide additional support (sometimes referred to herein as “raised position,” a “convey position,” an “active position,” and/or the like). In the illustrated embodiment, the first retractable system 4313 includes a first retractable conveyor 4314 and a first retractable support surface 4315. The first retractable conveyor 4314 can be a roller (passive or drive) and/or any other suitable conveyor. The first retractable support surface 4315 can be any surface that allows the target objects to continue to move (e.g., slide) in a proximal direction, such as a low-friction plastic and/or metal surface.

Similarly, as illustrated in FIG. 43C, as the end effector 4304 rotates clockwise along the third axis A₃ with respect to the distal joint 4310, the first conveyors 4312 move away from the second conveyors 4305, thereby forming a gap on the opposite transverse side of the of the distal joint 4310. Accordingly, as the end effector 4304 rotates clockwise, the second retractable system 4316 can transition (e.g., raise) into an extended and/or raised position to provide additional support. Similar to the first retractable system 4313, the second retractable system 4316 can include a second retractable conveyor 4317 and a second retractable support surface 4318. The second retractable conveyor 4317 can be a roller (passive or drive) and/or any other suitable conveyor. The second retractable support surface 4318 can be any surface that allows the target objects to continue to move (e.g., slide) in a proximal direction, such as a low-friction plastic and/or metal surface.

As further illustrated in FIGS. 43A-43C, the rotation of the end effector 4304 with about the third axis A₃ (respect to the distal joint 4310) changes an angle of the first and second conveyors 4312, 4305 with respect to each other. For example, in FIG. 43A, the first and second conveyors 4312, 4305 are positioned to convey (e.g., move) a target object in the same direction. However, in FIGS. 43B and 43C, the first conveyors 4312 are positioned to convey the target object in a first direction while the second conveyors 4305 are positioned to convey the target object in a second direction that is at an angle to the first direction. Said another way, the conveyors in the distal joint 4310 are configured to alter the direction of conveyance to account for the rotation of the end effector 4304 about the third axis A₃.

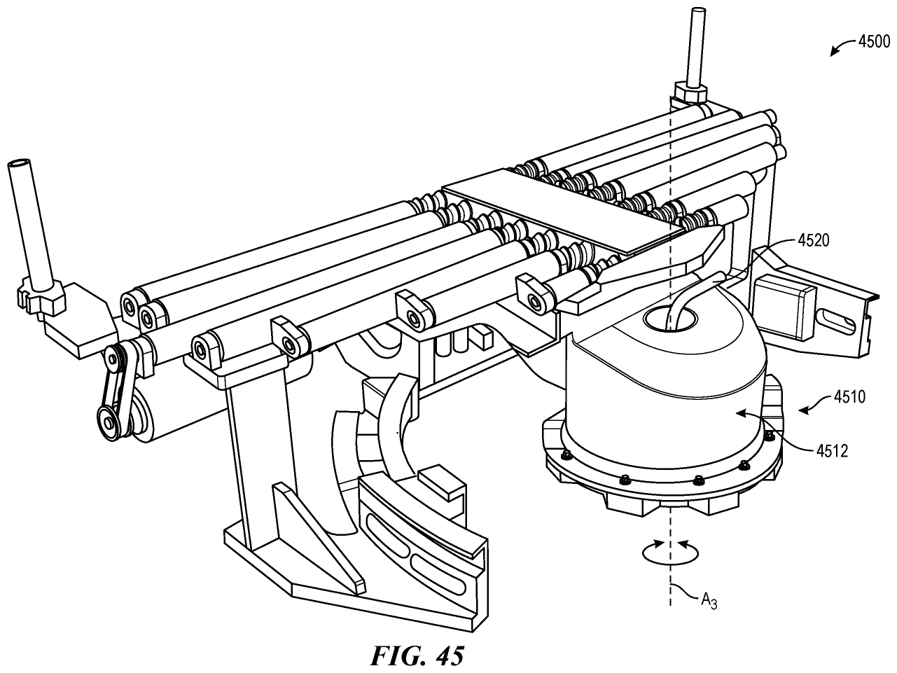

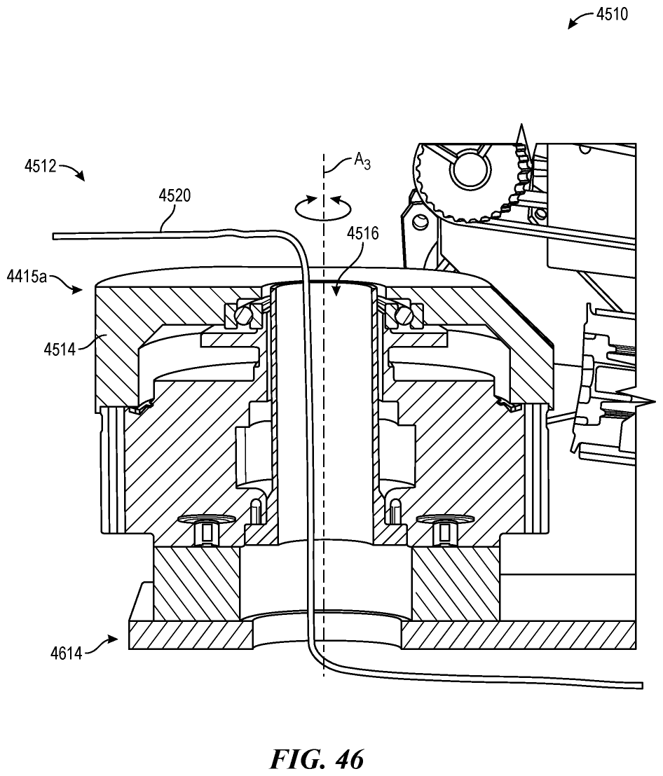

FIG. 43D is a partially schematic bottom view of the distal joint 4310 of FIGS. 43A-43C in accordance with some embodiments of the present technology. More specifically, FIG. 43D illustrates additional details on the second drive system 4330 in the distal joint 4310. For example, in the illustrated embodiment, the second drive system 4330 includes a rotary motion joint 4332 (sometimes also referred to herein as a rotary union) that includes shaft 4334, one or more bearings 4336 (shown schematically in FIG. 43D), a housing 4338, and a retaining component 4340. The shaft 4334 is coupled to a frame 4311 of the distal joint 4310 while the housing 4338 is coupled to the end effector 4304. The bearings 4336 are coupled between the shaft 4334 and the housing 4338, thereby allowing the housing 4338 (and the end effector 4304) to rotate with respect to the frame 4311 (and the distal joint 4310). The retaining component 4340 is coupled to a distal end of the frame 4311 to help keep the second drive system 4330 together. In the illustrated embodiment, the rotary motion joint 4332 also includes a central opening 4342. As discussed in more detail below with reference to FIGS. 45 and 46, the central opening 4342 can allow one or more connections to pass from the distal joint 4310 to the end effector 4304 without risking being pinched, snagged, and/or otherwise caught during the rotations.

In some embodiments, the bearings 4336 are electronic bearings that can control a rotation of the housing 4338 (and the end effector 4304) with respect to the frame 4311 (and the distal joint 4310). In some embodiments, the bearings 4336 are passive and the second drive system 4330 includes one or more expandable components (e.g., pistons, telescoping components, and/or the like) coupled to transverse sides of the end effector 4304 and the distal joint 4310 to control rotation about the bearings 4336. Additionally, or alternatively, the housing 4338 can be coupled to a belt (or other suitable component, such as a gear track) carried by the distal joint 4310 to drive rotation about the bearings 4336. Additionally, or alternatively, the housing 4338 can include a cart and/or other drive mechanism to drive rotation with respect to the shaft 4334.

As further illustrated in FIG. 43D, and as introduced above, the end effector 4304 can include a drive mechanism 4306 that is operably coupled to each of the second conveyors 4305 (FIG. 43A). For example, in the illustrated embodiment, the drive mechanism 4306 includes a servomotor 4307 that is coupled to each of the second conveyors 4305 (FIG. 43A) through a series of common shafts and belts. Because the drive mechanism 4306 drives each of the second conveyors 4305 (FIG. 43A) at the same time, the robotic system 4300 can create generally uniform motion in the second conveyors 4305 (FIG. 43A) without synchronizing multiple drive components (e.g., multiple servomotors). As a result of the generally uniform motion, as discussed above, the end effector 4304 can transport target objects without rotating them and/or driving the target objects toward transverse sides of the end effector 4304.

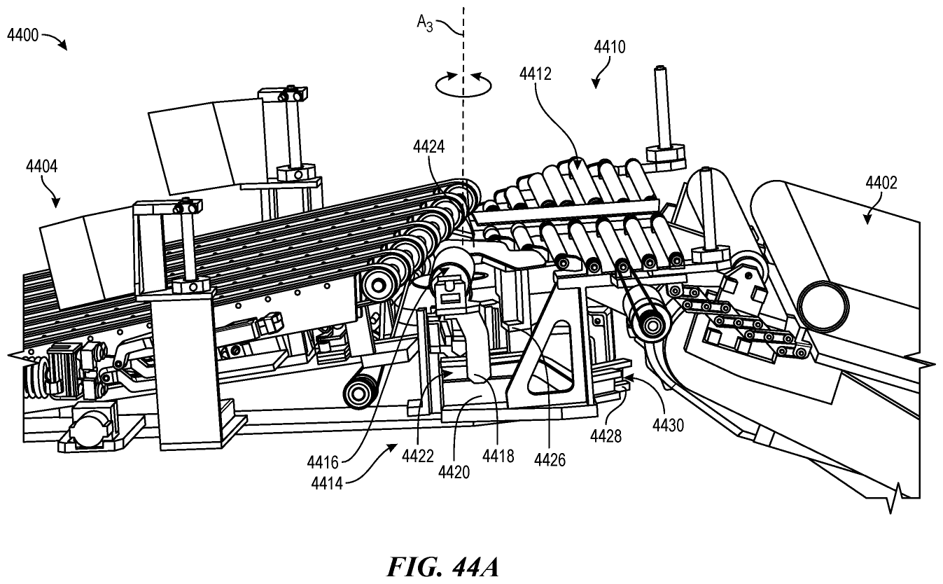

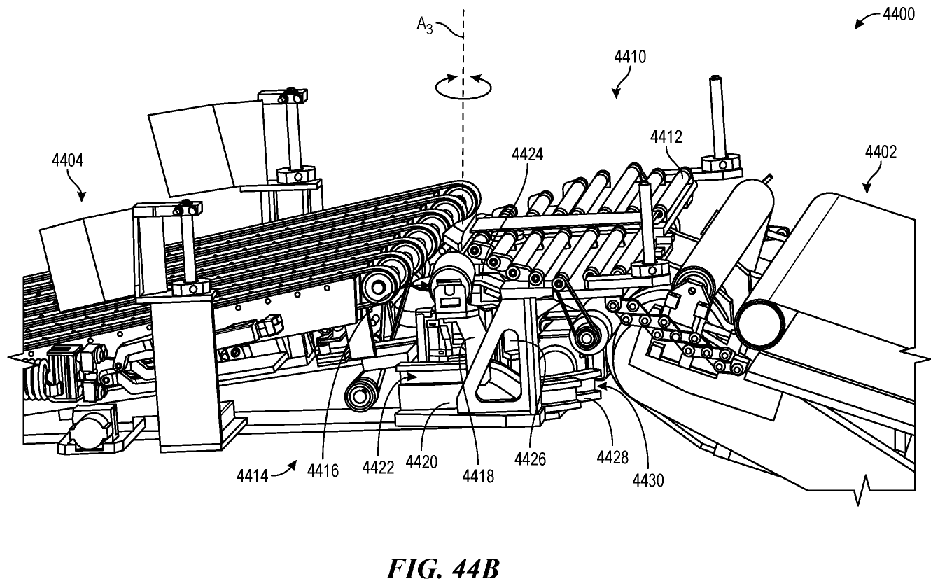

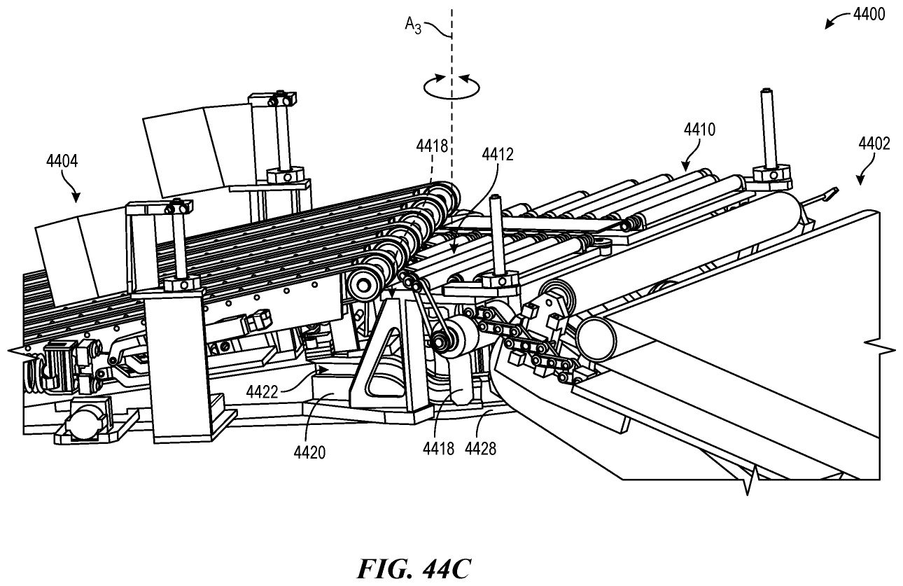

FIGS. 44A-44C are partially schematic side views of a distal joint 4410 of the type illustrated in FIGS. 43A-43D configured in accordance with some embodiments of the present technology. For example, as illustrated in FIG. 44A, the distal joint 4410 is operably coupled between a first segment 4402 and an end effector 4404 of a robotic system 4400. Further, the distal joint 4410 includes a plurality of first conveyors 4412 (e.g., rollers) and a retractable system 4414. As discussed above, the retractable system 4414 is movable between a raised position (e.g., as illustrated in FIG. 44A) and a lowered position (e.g., as illustrated in FIG. 44C). In the raised position, the retractable system 4414 can help fill a gap between the distal joint 4410 and the end effector 4404 to help support target objects moving in the proximal direction. In the lowered position, the retractable system 4414 is positioned beneath the first conveyors 4412, allowing the first conveyors 4412 to be positioned adjacent to the end effector 4404.

In the embodiments illustrated in FIGS. 44A-44C, the retractable system 4414 can automatically move between the raised position and the lowered position as the end effector 4404 rotates about the third axis A₃. For example, as illustrated in FIGS. 44A-44C, the retractable system 4414 can include a first retractable component 4416 that is carried by a first arm 4418, as well as a first guide component 4420 that is carried by the end effector 4404. The first guide component 4420 includes a first track 4422 that has a sloped step. The first arm 4418 is slidably coupled to the first track 4422. The first guide component 4420 is coupled to the end effector 4404 such that the first guide component 4420 rotates when the end effector 4404 rotates. In contrast, the first arm 4418 is coupled to the distal joint 4410 such that the first arm 4418 does not rotate. Instead, the first arm 4418 slides along the first track 4422. As a result, the first arm 4418 can slide down (or up) the step in the first track 4422 as the end effector 4404 rotates, thereby causing the first retractable component 4416 to move from the raised position (FIG. 44A) to the lowered position (FIG. 44C) and/or vice versa.

As further illustrated in FIGS. 44A-44C, the retractable system 4414 can also include a second retractable component 4424 that is carried by a second arm 4426, as well as a second guide component 4428 that is carried by the end effector 4404. Similar to the discussion above, the second arm 4426 is coupled to the distal joint 4410 while the second guide component 4428 is carried by the end effector 4404. Further, the second guide component 4428 includes a second track 4430 that has a sloped step and the second arm 4426 is slidably coupled to the second track 4430. As a result, similar to the discussion above, the second arm 4426 can slide down (or up) the step in the second track 4430 as the end effector 4404 rotates, thereby causing the second retractable component 4424 to move from the raised position (FIG. 44A) to the lowered position (FIG. 44C) and/or vice versa.

As best illustrated in FIG. 44B, the retractable system 4414 can raise and/or lower the first and second retractable components 4416, 4424 at separate times. For example, in the illustrated embodiments, the second guide component 4428 is rotated about the third axis A₃ with respect to the first guide component 4420 such that the step in the second track 4430 is offset around the third axis A₃ from the step in the first track 4422. As a result, as the end effector 4404 rotates, the second arm 4426 reaches the step in the second track 4430 before the first arm 4418 reaches the step in the first track 4422. Accordingly, as illustrated in FIG. 44B, the second retractable component 4424 is lowered before the first retractable component 4416.

In the embodiments illustrated in FIGS. 44A-44C, the first retractable component 4416 includes a roller (e.g., an active conveyor and/or a passive roller) and the second retractable component 4424 includes a low friction support surface. In various other embodiments, however, the retractable system 4414 can include various other elements. Purely by way of example, both of the first and second retractable components 4416, 4424 can include a roller. In another example, both of the first and second retractable components 4416, 4424 can include a low friction support surface. In yet another example, either of the first and second retractable components 4416, 4424 can include any other suitable component (e.g., another conveyor and/or the like). Further, in various other embodiments, the retractable system 4414 can include any other suitable number of retractable components (e.g., one, three, four, five, and/or any other suitable number of retractable components) to help fill the gap between the end effector 4404 and the distal joint 4410 as the end effector 4404 rotates.

Still further, it will be understood that the retractable system 4414 can include other suitable systems to raise and/or lower the retractable components. Purely by way of example, the retractable system 4414 can include one or more drivable pistons, telescoping elements, scissor elements, and/or the like that are actuatable to raise and/or lower the retractable components. In some such embodiments, the retractable system 4414 is controllable independent from the end effector 4404, thereby requiring the retractable system 4414 to be actuated in addition to rotating the end effector 4404 to help fill the gaps.

FIGS. 45 and 46 are a partially schematic upper-side view and a partially schematic cross-sectional view, respectively, of a distal joint 4500 of the type illustrated in FIGS. 40-43C in accordance with some embodiments of the present technology. As best illustrated in FIG. 45, the distal joint 4500 includes a drive system 4510 that can control rotation of an end effector about the third axis A₃. The drive system 4510 can be generally similar to the second drive system 4330 discussed above with reference to FIG. 43D. For example, in the illustrated embodiment, the drive system 4510 includes a rotary motion joint 4512 that allows one or more connections 4520 to pass through the distal joint 4500 to the end effector without needing to rotate and/or with minimal risk of catching as the end effector rotates.

For example, as best illustrated in FIG. 46, the rotary motion joint 4512 includes a shaft 4514 that has an opening 4516 extending from an upper end 4415a of the shaft 4514 to a lower end 4415b. The opening 4516 allows the connections 4520 to be routed through a central portion of the drive system 4510. Because the end effector rotates around the distal joint 4500 via the drive system 4510, the connections 4520 are routed through a center of the rotational motion. As a result, the connections do not require slack to accommodate the rotational motion that may otherwise be catchable during the end effector's motion and/or without a more complicated system to route the connections 4520 through the distal joint 4500.

### Additional Examples of the Drive Component in the End Effector

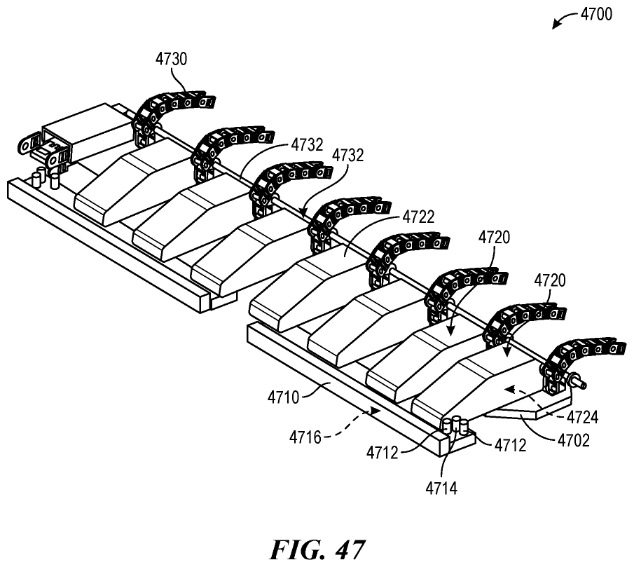

FIG. 47 is a partially schematic isometric view of a drive component 4700 configured in accordance with some embodiments of the present technology. The drive component 4700 illustrated in FIG. 47 can be integrated with any of the gripping components in the end effectors discussed above with reference to FIGS. 31-39B to help control the position of one or more gripping elements. In the illustrated embodiment, the drive component 4700 includes a frame 4702, an input and output (“I/O”) board 4710 coupled to the frame 4702, and one or more grip-generation units 4720 (eight illustrated in FIG. 47) coupled to the I/O board 4710. The I/O board 4710 includes a plurality of input nodes 4712 (one labeled in FIG. 47), a plurality of output nodes 4714 (one labeled in FIG. 47), and a redistribution network 4716 internal to the I/O board 4710. The I/O board 4710 (sometimes also referred to herein as a “branching component,” a “branching board,” and/or the like) can route inputs (e.g., electrical signals, pneumatic pressure, vacuum pressure, and/or the like) from another component in a robotic system (e.g., the robotic system 300 of FIG. 3) to the grip-generation units 4720. The grip-generation units 4720 can then use the inputs to provide a drive force (e.g., a vacuum force, magnetic force, actuation force, and/or the like) to each of the gripping elements in the gripping component.

In the embodiments illustrated in FIG. 47, for example, the redistribution network 4716 is an electronic redistribution network that can route input signals from the input nodes 4712 to one or more of the grip-generation units 4720 through the output nodes 4714. In turn, electronics 4724 within the grip-generation units 4720 that received the input signals can generate the drive force and provide the drive force to an individual and/or corresponding gripping elements in the gripping component. In this example, the drive force (e.g., vacuum pressure, magnetic force, actuation force, and/or the like) is generated locally in the drive component 4700, and therefore fully within the end effector. As a result, for example, the connections arriving at the input nodes 4712 can be only electrical connections, rather than, for example, vacuum tubes and/or the like. In turn, the connections can be relatively easy to manage because the electrical connections are not as sensitive to bends, kinks, reductions in slack, coiling, and/or the like.

Additionally, or alternatively, the local generation of the drive force in the electronics 4724 (e.g., at the scale of individual gripping elements) can reduce the magnitude of the drive force communicated via any communication line. For example, when a vacuum force is generated proximal to the end effector, the connections leading to the I/O board 4710 must communicate a vacuum force with sufficient magnitude to be divided among each of the gripping elements that will engage the target object. Further, that force must be routed through a distal joint with multiple degrees of freedom in rotation. In contrast, the local generation in the electronics 4724 allows the vacuum force to have a fraction of the magnitude and avoid a long route line.

As further illustrated in FIG. 47, the electronics 4724 in each of the grip-generation units 4720 can be at least partially contained within a housing 4722. The housing 4722 can help limit the amount of dust and other contaminants that reach the electronics 4724. Additionally, or alternatively, the housing 4722 can help protect the electronics 4724 from impacts (e.g., from target objects, an environment around the end effector during operation, other objects, and/or the like).

FIG. 47 also illustrates additional details on how the drive component 4700 helps actuate the gripping assemblies in the gripping component (see, e.g., FIGS. 32A and 34). For example, in the illustrated embodiment, the drive component 4700 includes a plurality of belts 4730 operably coupled to a single, shared drive shaft 4732. Each of the belts 4730 can be coupled to a suitable mechanism in the gripping assemblies to control actuation between a raised position and a lowered position (e.g., to rotate the pivotable link 3530 of FIG. 35). Because each of the belts 4730 is coupled to the drive shaft 4732, the drive component 4700 can control the actuation of each of the gripping assemblies at once, thereby keeping the gripping assemblies in sync as they lift a target object. Further, each of the gripping assemblies can be coupled to the frame 4702 of the drive component 4700 to simultaneously control a longitudinal position of each of the gripping assemblies.

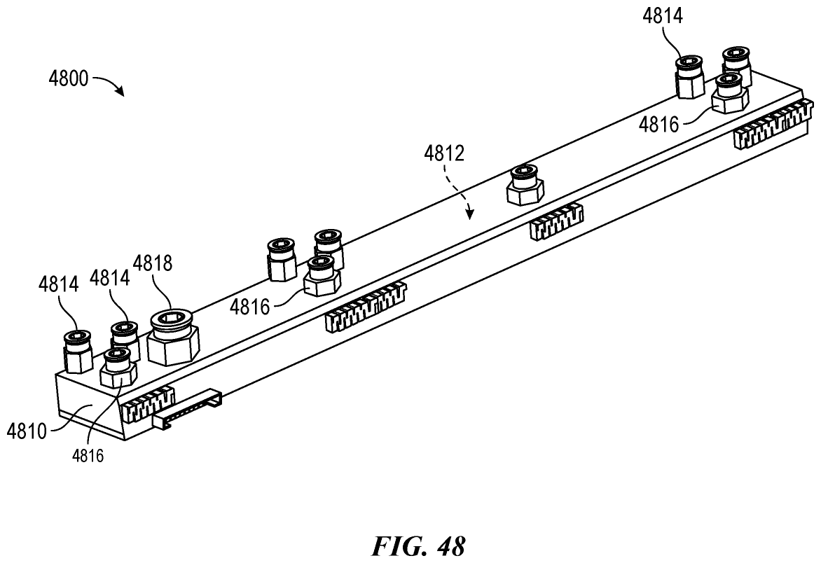

FIG. 48 is a partially schematic isometric view of a branching component 4800 of a drive component configured in accordance with some embodiments of the present technology. As illustrated in FIG. 48, the branching component 4800 can be generally similar to the I/O board 4710 discussed above with reference to FIG. 47. For example, in the illustrated embodiment, the branching component 4800 includes a housing 4810, a redistribution network 4812, a plurality of first input nodes 4814, and a plurality of output nodes 4816. Each of the plurality of first input nodes 4814 can receive and couple one or more connections to the redistribution network 4812. For example, each of the plurality of first input nodes 4814 can couple an electrical line (e.g., a power line, signal-routing line, and/or the like) to the redistribution network 4812. In turn, the redistribution network 4812 can route inputs (e.g., power, control signals, drive forces, and/or the like) to any (and/or all) of the plurality of output nodes 4816. In turn, the plurality of output nodes 4816 can be coupled to one or more connection lines in the drive component to, for example, couple the redistribution network 4812 to grip-generation units, gripping assemblies, and/or the like.

In some embodiments, the redistribution network 4812 can route inputs received at the plurality of first input nodes 4814 to a subset of the plurality of output nodes 4816. For example, first control signals received at the plurality of first input nodes 4814 can be routed to a first subset of the plurality of output nodes 4816 while second control signals received at the plurality of first input nodes 4814 can be routed to a second subset of the plurality of output nodes 4816. The first subset of the plurality of output nodes 4816 can then route the first control signals to a first subset of grip-generation units, gripping assemblies, and/or the like to grip a first target object. Similarly, the second subset of the plurality of output nodes 4816 can then route the second control signals to a second subset of grip-generation units, gripping assemblies, and/or the like to grip a second target object. As a result, for example, different subsets of grip-generation units and/or gripping assemblies can be operated to grip different target objects (e.g., to grip target objects of varying sizes and/or aligned with different subsets of an end effector).

As further illustrated in FIG. 48, the branching component 4800 can also include one or more second input nodes 4818 (one illustrated in FIG. 48). Similar to the plurality of first input nodes 4814, the second input node(s) 4818 can route couple one or more connections to the redistribution network 4812. However, as further illustrated in FIG. 48, the second input node(s) 4818 can have a different size and/or shape from the plurality of first input nodes 4814. As a result, the connections received at the second input node(s) 4818 can be different from the connections received at the plurality of first input nodes 4814. In a specific, non-limiting example, the plurality of first input nodes 4814 can receive connections related to the control and/or operation of various components in the gripping component while the second input node(s) 4818 receive connections that provide power for the components in the gripping component. In another specific, non-liming example, the plurality of first input nodes 4814 can receive connections related to the control and/or the plurality of gripping assemblies coupled to the drive component while the second input node(s) 4818 receive connections that are related to the control and/or operation of the drive component.

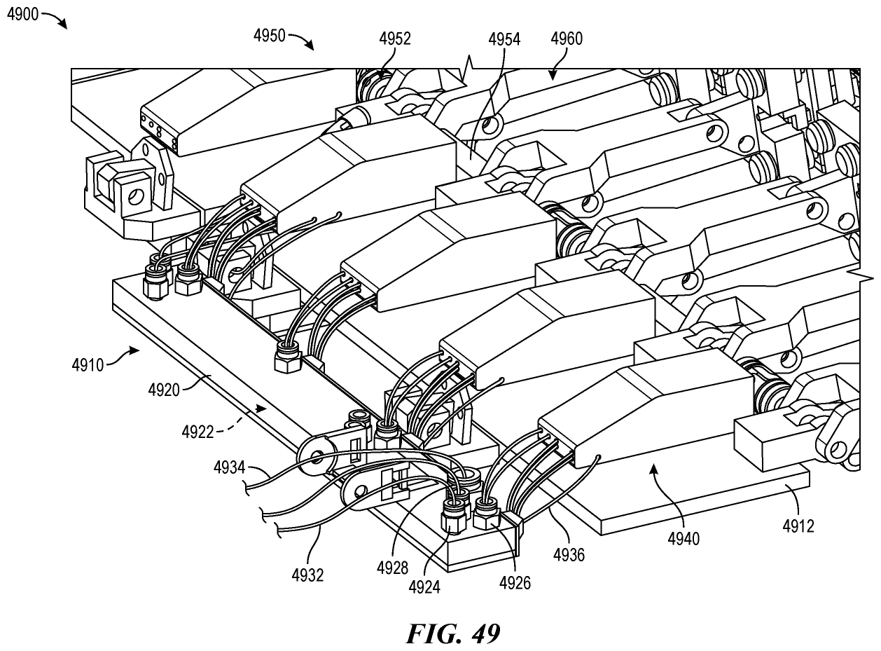

FIG. 49 is a partially schematic isometric view illustrating additional details on various components of a gripping component 4900 in accordance with some embodiments of the present technology. In the illustrated embodiment, the gripping component 4900 includes a drive component 4910, an assembly actuation component 4950 coupled to the drive component 4910, and a plurality of gripping assemblies 4960 coupled to the assembly actuation component 4950.

The drive component 4910 can be generally similar (or identical) to the drive component 4700 discussed above with reference to FIG. 47. For example, as illustrated in FIG. 49, the drive component 4910 can include a frame 4912, a branching component 4920 coupled to the frame 4912, and one or more grip-generation units 4940 (five illustrated in FIG. 49) coupled to the branching component 4920. As further illustrated in FIG. 49, the branching component 4920 can be generally similar (or identical) to the branching component 4800 discussed above with reference to FIG. 48. For example, the branching component 4920 can include a redistribution component 4922, a plurality of first input nodes 4924, a plurality of output nodes 4926 (one labeled in FIG. 47), and one or more second input nodes 4928.

Similar to the discussion above, the plurality of first input nodes 4924 can couple a plurality of first connections 4932 to the redistribution component 4922. In turn, the redistribution component 4922 can route inputs (e.g., power inputs, control inputs, force inputs, and/or the like) from the first connections 4932 to one or more of the plurality of output nodes 4926. The plurality of output nodes 4926 couple the redistribution component 4922 to a plurality of third connections 4936 that extend from the branching component 4920 to the grip-generation units 4940. More specifically, each of the plurality of third connections 4936 extend from a corresponding one of the plurality of output nodes 4926 to the grip-generation units 4940. As a result, the redistribution component 4922 can route the inputs (e.g., power inputs, control inputs, force inputs, and/or the like) to an appropriate destination during a gripping operation using the gripping component 4900. Each of the grip-generation units 4940 can then generate (or route) a drive force (e.g., a suction force, magnetic force, and/or any other suitable force) to a corresponding one of the plurality of gripping assemblies 4960.

Further, the second input nodes 4928 on the branching component 4920 can couple one or more second connections 4934 to the redistribution component 4922. As discussed above, inputs received via the second connections 4934 can be different from the inputs received from the plurality of first connections 4932. For example, the inputs received via the plurality of first connections 4932 can be related to controlling and/or powering the grip-generation units 4940 while inputs received via the second connections 4934 can be related to controlling and/or powering other components of the gripping component 4900 (e.g., the assembly actuation component 4950 and/or the plurality of gripping assemblies 4960).

As further illustrated in FIG. 49, the assembly actuation component 4950 can include one or more rotational drive mechanisms 4952 (e.g., a servo motor, a pulley and drive belt, a gear and track, and/or any other suitable mechanism) and a drive shaft 4954 coupled to the rotational drive mechanisms 4952. Further, each of the plurality of gripping assemblies 4960 can be operably coupled to the drive shaft 4954 (sometimes also referred to herein as a “common drive shaft,” a “shared drive shaft,” and/or the like). As a result, the drive shaft 4954 can help actuate each of the plurality of gripping assemblies 4960 simultaneously (or generally simultaneously) to help sync the motion of the gripping component 4900 during a gripping operation. In a specific, non-limiting example, the proximal end of a pivotable link of the type discussed above with reference to FIG. 35 can be coupled to the drive shaft 4954 to rotate between a first, lowered position and a second, raised position during the gripping operation. In another specific, non-limiting example, an expandable component of the type discussed above with reference to FIG. 32A can be operably coupled to drive shaft 4954 to raise and lower in response to the rotation of the drive shaft 4954.

### Example Vision Processing for an Arrangement of Objects

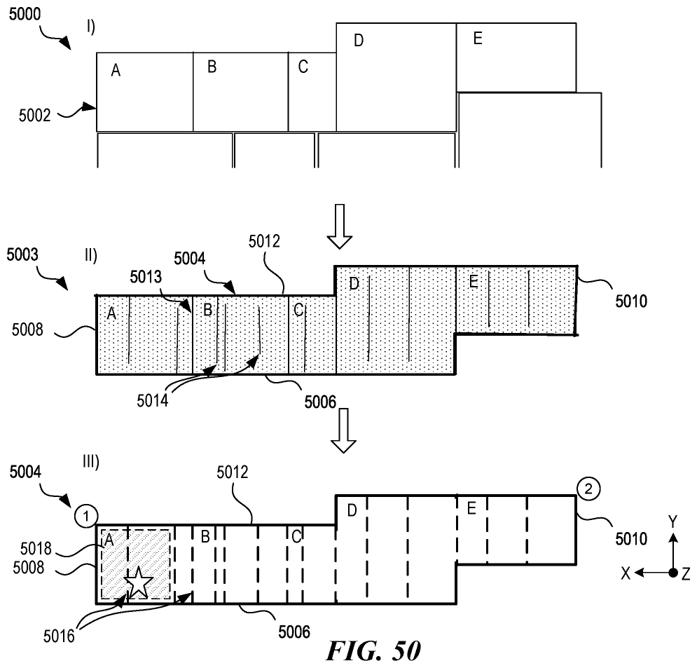

FIG. 50 shows various images illustrating vision processing of an arrangement of objects in accordance with one or more embodiments. The processing illustrated in FIG. 50 are directed toward deriving a grip location for grasping and transferring an object. In some embodiments, the object may be an unrecognized object having an unknown size in and arrangement relative to one or more objects. For the embodiments for the unrecognized objects, deriving the grip location includes deriving an initial grip location based on an MVR for the object (e.g., corresponding to MVR 1704 in FIG. 17A). Based on the initial grip location, the object can be lifted and dimensions for the object can be derived, as is described with the processes illustrated in FIGS. 17A-17F. Accordingly, the previously unrecognized object can be recognized, verified, registered, and/or transferred as a result.

In some embodiments, the robotic system can detect (e.g., identify and verify) objects as registered objects without deriving an MVR. For example, one or more of the objects in the arrangement can be compared and matched with the registration information in the master data. Based on the match, the robotic system can derive a grip location for removal of the matching objects. The robotic system can derive the grip location for the transfer according to physical attributes, such as known dimensions, known COM location, and/or a predetermined grip location, in the matching registration data.

Additionally or alternatively, the robotic system can further or partially identify objects that may not match registered objects without utilizing the initial lift. For portions of the image 5000 that do not match the registered objects or known traits thereof, the robotic system can compute with a high degree of certainty, without the initial lift, that the depicted portion corresponds to a single object. For such determinations, the robotic system can analyze depicted features according to predetermined rules that reflect various logical bases. For example, the robotic system can assess the height of the depicted portion relative to the container floor. When the assessed height of the region is equal to or less than a maximum known height or a corresponding threshold, the robotic system can determine that the region corresponds to one row of objects (e.g., without other objects stacked below or above the row). Also, for example, the robotic system can determine the last or most peripheral box in a row when the corresponding edges have edge confidence levels higher than a predetermined threshold.

The images shown in FIG. 50 are representative of an image 5000 (e.g., a visual 2D representation, such as a color or grayscale image, a 3D representation, or a combination thereof) and how that image is processed for picking up objects by a gripper (e.g., the gripper 306 of FIG. 3, 806 of FIG. 8, 1500 of FIG. 15, etc.) to remove the objects from the arrangement, such as a stack or a row, of objects in a reliable and efficient manner. The image 5000 (e.g., 2D and/or 3D depiction of the stack of objects or a portion thereof) may be taken along a horizontal direction perpendicular to a vertical plane in which the objects A-E are arranged (e.g., a plane generally parallel to a coronal and/or frontal plane of the cargo carrier, such as the x-y plane). The image 5000 may be obtained from one or more vision sensors (e.g., upper and/or lower vision sensors described above, such as in FIG. 3, FIG. 8, etc.). In Section I of FIG. 50, the image 5000 can depict a portion of an object arrangement 5002 including multiple objects stacked on top of each other. The object arrangement 5002 includes at least objects A, B, C, D, and E. The objects A, B, C, D, and E may include boxes, for example, of mixed sizes (e.g., mixed stock keeping units (SKU)) disposed in a cargo carrier.

For illustrative purposes, Section I of FIG. 50 shows a stack of mixed SKUs. However, it is understood that the robotic system can apply the described operations, processes, methods, etc. to other arrangements or conditions. For example, the objects may correspond to a common or uniform size and shape, such as for single or unified SKU. Moreover, the robotic system can process the object arrangement that accounts for a single object, multiple objects arranged in a row, one or more objects on the floor or another type of non-removable or non-applicable structure, or the like.

Section II of FIG. 50 illustrates a detection region 5003, which is identified from the image 5000. The detection region 5003 can be a portion of the image 5000 identified or targeted by the robotic system for object detection process, such as for identifying target objects.

In some embodiments, the robotic system can process the image 5000 based on identifying/segregating portions therein and then further detecting objects therein. For example, the robotic system (via, e.g., the processors described above) can identify the detection region 5003 based on identifying an enclosed region defined by a continuous/connected set of detected edges. In processing the image 5000 to initially detect object depicted therein, such as for identifying the type of the depicted object and/or the corresponding real-world location, the robotic system can detect 2D and/or 3D edges from the image 5000, such as using a Sobel filter or the like. The robotic system can further detect 2D and/or 3D corners or junctions where the edges intersect. Using the detected corners, junctions, and edges, the robotic system can identify separate surfaces or bounded segments that each represent one or more vertical surfaces or portions thereof within the image 5000. The robotic system can follow the edges across the connections to identify an enclosing boundary and then set each enclosing boundary as the detection region 5003.

The robotic system can compare the vertical surface and/or portions of the detection region 5003 to registration information, such as known sizes and shapes of registered objects and/or the texture (e.g., visual characteristics on the depicted surface(s)) to known texture of the registered objects to generate a verified detection. The robotic system can compute a score or a measure of matches or overlaps between the detection region 5003 and the registration information. When the computed score/measure for the corresponding portion of the detection region 5003 exceeds a detection threshold, the robotic system can detect that corresponding portion of the detection region 5003 depicts the matching object. Accordingly, the robotic system can identify the depicted object and verify the location/boundaries of the depicted object based on the detection. The robotic system can identify one object, a set of matching objects, or multiple different objects within a given detection region.

In some embodiments, the detection region 5003 can include an unrecognized region 5004. The unrecognized region 5004 can be a portion of the detection region 5003 where the robotic system does not detect or identify objects that match or correspond with registration information. The unrecognized region 5004, for example, can represent a portion of the image 5000 having an unknown number of vertical surfaces (e.g., the surfaces facing the one or more vision sensors) that cannot be matched to registered objects. The robotic system can determine each continuous region (e.g., an area encircled by a continuous/connected set of edges) that does not match the registered objects with at least a threshold amount of confidence value as the unrecognized region 5004. Stated differently, the robotic system can perform the initial detection as described above, and then identify the remaining portions of the image 5000 or the detection region 5003 as the unrecognized region 5004. The robotic system thereby identifies the possibility that the corresponding region can include one or more or initially unknown number of objects that may not be distinguished from the image 5000 based on the initial object detection process.

The unrecognized region 5004 can correspond to multiple objects having vertical surfaces that are aligned within a threshold depth (e.g., none of the objects is positioned in front of another object) from each other. For example, the vertical surfaces can be aligned within a threshold sensitivity of the one or more sensors, (e.g., 0.01 centimeter, 2 centimeters, 5 centimeters, or 10 centimeters of each other). Accordingly, the robotic system may be unable to distinguish the individual surfaces with the necessary confidence value and classify the corresponding region as the unrecognized region 5004.

In some embodiments, the robotic system can process the detection region 5003 by determining or estimating that multiple objects, rather than a single object, are depicted therein. The robotic system can determine the likely depiction of multiple objects based on one or more traits associated with the detection region 5003, such as the number of corners, relative angles of the corners (e.g., protruding corners in comparison to indented or concave corners) the overall shape, lengths of boundary edges, or the like. For the example illustrated in Section II of FIG. 50, the robotic system can determine the likely multiple objects since (1) the overall shape of the region is different from a rectangle, (2) the region includes more than four right-angle corners, (3) the region includes at least one concave corner, (4) the bottom edge 5006 exceeds a maximum edge length amongst registered objects, or a combination thereof. For the illustrated example, the unrecognized region 5004 can correspond to a depiction of objects A-E or a portion thereof that are adjacent to each other and being within threshold distances from each other. In some embodiments, the robotic system can process the detection region 5003 to identify objects that correspond with registration information of registered objects. In some embodiments, the depicted surfaces of the objects may have negligible differences (e.g., less than an edge detection threshold/capability) in depth and gaps between each other. Even if the assumption of multiple objects is inaccurate, the region may include a single object that has a size and/or shape that does not match to any registered object. In either case, the robotic system can determine that further processing is required to be able to pick up an object from that region.

The robotic system can further process the image 5000 by identifying edges within the detection region 5003. In some embodiments, the robotic system can identify one or more validated edge 5013 which can be 2D and/or 3D edges with sufficient edge detection confidence values, to generate a verified detection. For example, the robotic system 100 can determine whether the detected edges, the validated edges 5013, or a combination thereof correspond with edges for registration information for registered objects.

As illustrated in Section II, the robotic system 100 can process the detection region 5003 to determine that the area bound by vertical edge 5008, top edge 5012, bottom edge 5006, and validated edge 5013 corresponds with registration information for object A. In some situations, the robotic system may not be able to identify the validated edges 2013 in the image 5000 but can identify candidate 2D and/or 3D edges from the initial detection process that did not have sufficient edge detection confidence values and/or failed to intersect with other edges. Amongst such candidate edges, the robotic system can identify the edges located within the unrecognized region 5004 as illustrated in Section III of FIG. 50. In some embodiments, the initial detection can be performed based on 3D data (e.g., a depth map) of the image 5000, and the subsequent edge identification within the unrecognized region 5004 can be performed by detecting edges within the corresponding portions of the 2D or visual data of the image 5000.

In the situations where the robotic system does not fully generate the verified detections from the image 5000 (e.g., portions of depths corresponding to unknown number of surfaces remaining undetected), the corresponding unrecognized region 5004 in Section II of FIG. 50 can include an area defined by a continuous boundary formed by a set of intersecting detected edges. For example, the unrecognized region 5004 can have a top edge 5012 and a bottom edge 5006. The unrecognized region 5004 can be between vertical edges 5008 and 5010. The vertical edges 5008 and 5010 can be positioned opposite each other and intersecting the top edge 5012, thereby forming 3D corners with the top edge 5012. Thus, vertical edges 5008 and 5010 can be determined as outermost edges of the unrecognized region 5004.

In some embodiments, the top edge 5012 can be identified from the image 5000 as being the topmost 3D edge or known edge of the arrangement 5002. The bottom edge 5006 can be identified as one or more detected lateral edges immediately below the top edge 5012 (e.g., without any other lateral edges disposed between). In some instances, the bottom edge 5006 can be identified as being within a threshold distance range from the top edge 5012. The threshold distance range can correspond to a maximum dimension (e.g., height) amongst the registered objects.

The robotic system can use (1) the top edge 5012 and bottom edge 5006 (the highest and the lowest edges in the unrecognized region 5004) as reference lateral edges and (2) the edges 5008 and 5010 (e.g., outermost vertical edges) as reference vertical edges. The robotic system can use the reference edges to estimate potential locations of the objects within the unrecognized region 5004.

Estimating the potential locations of the objects can include computing hypotheses for location of vertically extending edges within the unrecognized region 5004. In other words, for the purposes of the estimation, the robotic system can assume that the reference lateral edges represent top and bottom edges of one or more objects depicted in the unrecognized region 5004, and the reference vertical edges can represent one peripheral/vertical edge of a corresponding object depicted in the unrecognized region 5004. The vertical edge hypotheses can represent locations of potential vertical edges along the lateral axis (e.g., the x-axis) and between the vertical reference edges. The vertical hypotheses can be computed by deriving potential vertical edges from the 2D and 3D image data of FIG. 5000 that are parallel (parallel within a threshold confidence) with the reference vertical edges 5008 and 5010. The vertical hypotheses can include potential edges having lower than threshold edge-detection confidence values and/or edges having at least one end separated from (e.g., not intersecting) lateral edges. Additionally or alternatively, the vertical hypotheses can include 2D features. The potential vertical edges can extend at least partially between the bottom edge 5006 and the top edge 5012. The robotic system can assume that one or more of the potential vertical edges can represent gaps between respective objects in the object arrangement 5002. The potential vertical edges can also represent other vertical features identified from the image 5000, such as deformations on an object surface or visual features (e.g., printed designs) on the object surface.

For the example illustrated in FIG. 50, Section III can show vertical hypotheses 5016 derived from potential vertical edges 5014 in Section II. The robotic system can compute the vertical hypotheses 5016 overlapping the potential vertical edges 5014 and extending to intersect the top edge 5012 and the bottom edge 5006. In a similar manner, the robotic system can be configured to compute lateral hypotheses for the unrecognized region 5004 based on the lateral reference edges (e.g., the top edge 5012 and the bottom edge 5006), in addition to or instead of the vertical hypotheses 5016.

In some embodiments, the process further includes identifying a potential 3D corner for an object in the object arrangement 5002 based on the reference lateral edges (e.g., the top edge 5012 and the bottom edge 5006) and reference vertical edges (e.g., the edges 5008 and 5010). For the example illustrated in FIG. 50, the robotic system can compute the potential 3D corner 1 as an intersection of the edge 5008 and the top edge 5012 and the potential corner 2 as an intersection of the edge 5010 and the top edge 5012. When expecting rectangular/cube shaped boxes, the robotic system can estimate that Corner 1 represents a portion of the unrecognized region 5004 that belongs to a single object (e.g., the object A), and corner 2 represents a portion that logically belongs to a single object (e.g., the object E). In other words, given the expected objects, the robotic system can assume that each 3D corner corresponds to a surface that is sufficiently likely to belong to one object. Accordingly, the robotic system can use the 3D corner as a reference for estimating and hypothesizing size, location, boundaries, etc. of an object. In some embodiments, the robotic system can use intersections of key 3D edges, such as top lateral edge and outer-most vertical edges, of the unrecognized region 5004 as reference 3D corners for subsequently hypothesizing and locating corresponding objects.

In estimating locations of objects depicted in the unrecognized region 5004, the robotic system can use the reference 3D corners and the vertical hypotheses 5016 to compute one or more MVRs within the unrecognized region 5004. The MVR refers to a portion of a surface of an object that is estimated or logically likely to belong to a single object. In some embodiments, the robotic system can compute each MVR as an axis-aligned boundary box (AABB) aligned with a corresponding top reference corner and extended out to the bottom edge and the nearest vertical hypothesis. The robotic system can ignore or discount the vertical hypotheses 5016 when the corresponding MVR has a dimension that is (1) less than a minimum dimension of registered objects or (2) greater than a maximum dimension of registered objects. Additionally or alternatively, the robotic system can compare the candidate MVR to shape templates of registered objects for verification.

The robotic system can use the MVR for identifying a grip location for the corresponding estimated object. For the example illustrated in Section III of FIG. 50, the robotic system can compute an MVR 5018 for an object that logically corresponds to/includes corner 1 (e.g., object A). As described above, the robotic system can compute the MVR 5018 based on the information derived for the unrecognized region 5004, including the corner 1, the top edge 5012, the bottom edge 5006, the edge 5008, and the vertical hypotheses 5016. In the illustrated example, the robotic system can ignore the first vertical hypothesis since the corresponding MVR would have a width less than the minimum dimension of registered objects. Accordingly, the robotic system can extend the MVR out to the next/second hypothesis. Based on the MVR 5018, the robotic system can derive an initial grip location (indicated with a star in Section III of FIG. 50) for object A based on a predetermined rule, such as for placing the gripper/suction cups at or within a threshold distance the bottom edge of the MVR 5018.

After deriving the initial grip location, the robotic system can perform the processes described above with respect to FIGS. 17A-18. The robotic system can generate and implement initial lift commands for operating a gripper (e.g., the gripper 306 in FIG. 3) to contact and grip object A at the initial grip location and to lift the grasped object A, thereby separating the lifted object A from supporting object(s) in the arrangement 5002.

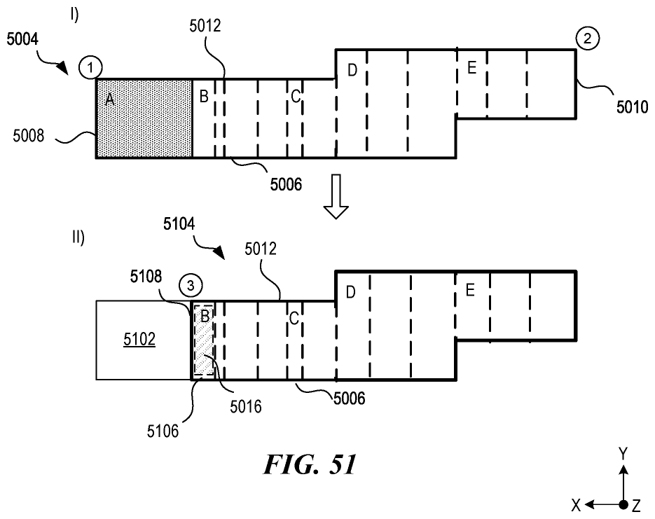

FIG. 51 shows various images illustrating vision processing of unrecognized objects after removal of an object (e.g., a previously unrecognized object) in accordance with one or more embodiments. Section I of FIG. 51 illustrates the unrecognized region 5004 after object A has been removed. Referring back to the previous example, the robotic system can implement an initial lift operation on the object A using the initial grip location within the MVR 5018. Through the initial lift, the robotic system can verify the actual dimensions of the object A and then implement the transfer of the object using the actual/verified dimensions.

Subsequent to the removal of object A, the robotic system can identify a portion of the unrecognized region 5004 that corresponds to the removed object, such as using a mask to overlay the portion of the unrecognized region 5004 previously depicting the removed object A. The robotic system can re-categorize the masked portion as an empty region 5102 as shown in Section II of FIG. 51. In some embodiments, the robotic system can reclassify the edge of the empty region 5102 abutting the remaining unrecognized region 5004 as a detected 3D edge. Additionally or alternatively, the robotic system can adjust the 3D depth measures and/or update the 2D visual image such that the empty region 5102 represents a different texture and/or a surface farther away from the sensor (by, e.g., increasing the depth measures by a predetermined value).

Accordingly, the robotic system can update the unrecognized region 5004 to exclude the portion corresponding to the empty region 5102 or the portion corresponding to the transferred object (e.g., object A). As a result, the robotic system can generate an adjusted unrecognized region 5104 without recapturing the image and/or without re-detecting the objects within the image. Using the empty region 5102, the robotic system can generate an edge 5108 for the adjusted unrecognized region 5104 that is adjacent to the empty region 5102. The robotic system can set the edge 5108 as a reference vertical edge and process the adjusted unrecognized region 5104 as described above with respect to FIG. 50. For example, the robotic system can identify an MVR that corresponds to the next top-peripheral object (e.g., an MVR 5106 corresponding to object B), (1) aligned to a 3D corner 3 that corresponds to the edge 5108 and the top edge 5012 and extending to one of (e.g., nearest of) the vertical hypotheses 5016. In some embodiments, the robotic system can perform redetection on the adjusted unrecognized region 5104 to potentially identify one or more of the validated detections. For example, in some situations, the removal of an object can increase the confidence for candidate detections that may not have met a detection threshold. Accordingly, the robotic system can leverage the aftereffects of the removed objects to detect objects that were previously unrecognized. Additionally or alternatively, as described in detail below, the robotic system can (1) register the removed object with obtained sensor measurements or portion of the image corresponding to the empty region 5102 and (2) use the registered information to detect matching objects in the adjusted unrecognized region 5104.

In some embodiments, the robotic system can repeat the process of computing an MVR for an object, verifying the dimensions of the object after initial lift, removing the object from the stack, and updating the unrecognized region 5004 according to the removed object. Accordingly, the robotic system can iteratively remove objects (e.g., objects B, C, D, and E) that were depicted in the unrecognized region 5004 from the stack. As mentioned above, the robotic system can process and transfer the objects depicted in the unrecognized region 5004 using one initial image (e.g., without re-taking the image) and/or without redetecting the objects depicted in the initial image. It is noted that computing MVRs for the subsequent objects can be performed with the initially obtained image (e.g., image 5000) and does not require further images to be collected (e.g., by upper and/or lower vision sensors described above, such as in FIG. 3, FIG. 8, etc.). Moreover, the robotic system can transfer the unrecognized objects without re-detecting the objects depicted in the initially provided image.

In an instance that the system derives that an adjusted unrecognized region is less than a threshold area for identifying the subsequent MVR, the system can obtain additional sensor data and/or disqualify the hypothesis (e.g., by extending the MVR to the next vertical hypothesis). The system can then repeat the processes described with respect to FIGS. 50 and 51 to identify an additional unrecognized region, which has dimensions exceeding the minimum dimension of expected objects to qualify as the subsequent MVR.

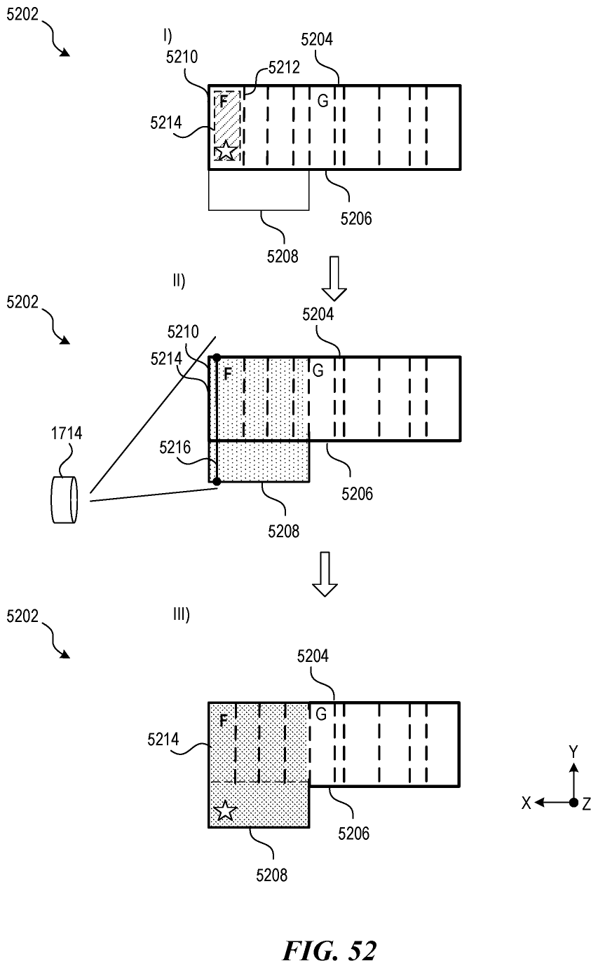

FIG. 52 shows various images illustrating vision processing of verifying unrecognized objects in accordance with one or more embodiments. FIG. 52, in particular, illustrates an instance where an object has a dimension that is different from a hypothesized dimension. Section I of FIG. 52 illustrates an unrecognized region 5202 defined by a boundary including a top edge 5204, a bottom edge 5206, and a side edge 5210. The unrecognized region 5202 can be computed with the processes described above with respect to FIGS. 50 and 51. The unrecognized region 5202 can represent an area of a stack of objects including object F and G.

The robotic system can derive (1) an MVR 5214 that effectively corresponds to the object F and (2) an initial grip location (indicated with a star) within the MVR 5214. However, as indicated in the example of Section I of FIG. 52, object F has an actual bottom edge 5208 that is different from the estimated/hypothesized bottom edge 5206 derived from the unrecognized region 5202.

Section II of FIG. 52 illustrates implementation of the initial lift and a corresponding measurement by the distance sensor 1714. The process for performing such measurement is described above with respect to FIGS. 17A-17F. As shown, the robotic system can use the distance measurement in the vertical direction (e.g., along the y-axis) to verify that the lifted object (e.g., object F) has an actual edge different from (e.g., lower than) the estimated edge and a greater height 5216 between the top edge 5204 and the verified bottom edge 5208. Thus, the system derives that the verified bottom (i.e., the actual bottom) 5208 is lower than the bottom edge 5206 estimated based on the unrecognized region 5202.

The robotic system can further adjust the grip location based on the verified bottom edge. For example, the robotic system can adjust the grip location according to the same rule/parameters as the grip location for the initial lift, so that the adjusted grip location abuts or is within a threshold gripping distance from the verified bottom edge of the one object.

### Example Target Selection for Unrecognized Objects

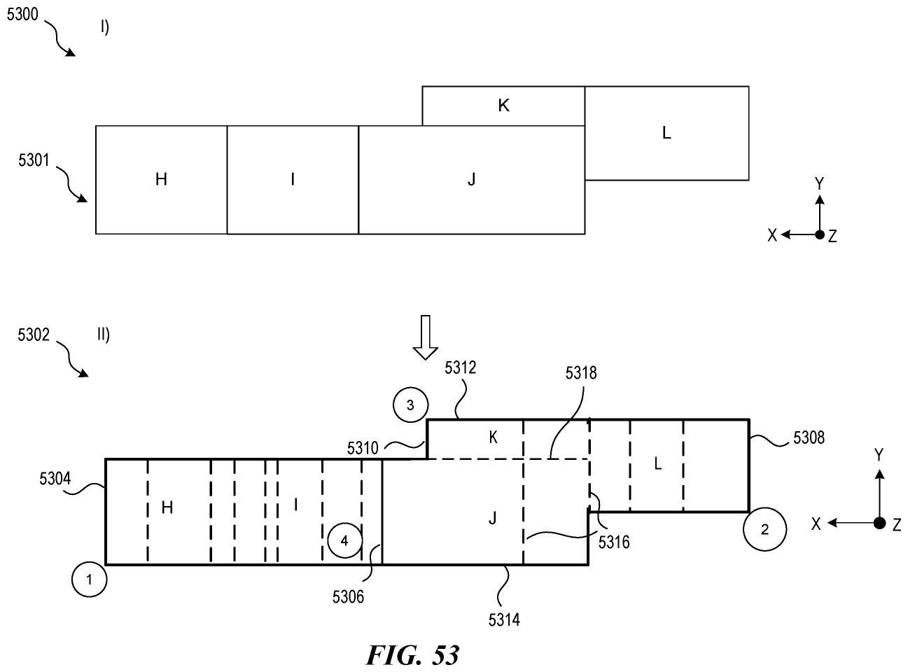

FIG. 53 shows various images illustrating target selection for unrecognized objects in accordance with one or more embodiments. The process described with respect to FIG. 53 is directed to selecting an estimated object, from among multiple potential objects in a stack of objects, to be lifted. In other words, the robotic system can determine which portion (e.g., corner and/or corresponding MVR) of the unrecognized region to first verify using the process illustrated and described with respect to FIG. 53.

Section I of FIG. 53 illustrates an image 5300. Similarly, as described with respect to image 5000 of FIG. 50, the image 5300 is a visual 2D representation, such as a color or grayscale image, a 3D representation, or a combination thereof depicting a stack 5301 of objects including objects H, I, J, K, and L in the real-world. The objects H, I, J, K, and L may be representative of boxes, for example, of mixed sizes (e.g., mixed stock keeping units (SKU)) disposed in a cargo carrier.

Section II of FIG. 53 includes an unrecognized region 5302 derived from the image 5300 based on the processes described with respect to FIG. 50. For example, the unrecognized region 5302 is defined by edges 5304, 5308, 5312, 5310, and 5314. Further, the unrecognized region 5302 includes an edge 5306, which represents a gap between objects I and J. For example, the system has identified a gap between objects I and J from the 3D representation in the image 5300 with a sufficiently high probability and has categorized the gap as the edge 5306 in the middle of the stack 5301. Based on the identified edges, the system can identify multiple 3D corners (e.g., corners 1, 2, 3, and 4) that are predicted to correspond to multiple objects within the unrecognized region 5302. These multiple corners could be used for computing MVRs and initial lift locations for the different objects.

The robotic system can be configured to compute the implementation order of the initial lift and effectively determine which object should be lifted first. To reduce disturbance to the stack 5301 (e.g., to prevent neighboring objects from be damaged or displaced), the system can prioritize 3D corners of outermost objects within the unrecognized region 5202 over 3D corners of objects located in a central portion of the unrecognized region 5302. For example, the robotic system can select corners/MVRs to lift (1) the leftmost object (e.g., object H) based on corner 1 or (2) the rightmost object (e.g., object L) based on corner 2 over selecting corners corresponding to inner objects I or K. Additionally or alternatively, the robotic system can consider the inner corners if the lateral separation between the targeted surface/MVR and the adjacent surface exceeds a separation threshold.

In some embodiments, the robotic system can derive the lifting priority for the candidate objects (e.g., outermost or surfaces having sufficient separation) based on a relative location of the gripper (e.g., the gripper 306 in FIG. 3) to each of the candidate objects, such as to reduce the time required for the gripper to move between lifts. For example, in an instance that the gripper is positioned closer to object H on the left-hand side of the stack 5301 than object L, the robotic system can select the MVR corresponding to object L first for the initial lift. Furthermore, after object L has been removed, the robotic system can determine to lift the object I next since the gripper will be positioned closer to object I than object L.

The system can lift an object having a topmost position prior to lifting objects having lower positions in the stack 5301. For example, the robotic system can lift object K based on corner 3 prior to lifting objects H, I, J, or L. In particular, the robotic system can compute multiple vertical hypotheses 5316 as well as a lateral hypothesis 5318. Based on corner 3 and the positions of the hypotheses 5316 and 5318, the robotic system can compute an MVR for object K that is adjacent to corner 3. The robotic system can have a predetermined hierarchy or sequence for processing multiple selection rules. For example, the system can prioritize highest MVR over outermost MVRs.

### Example Grasp Computation for Unrecognized Objects

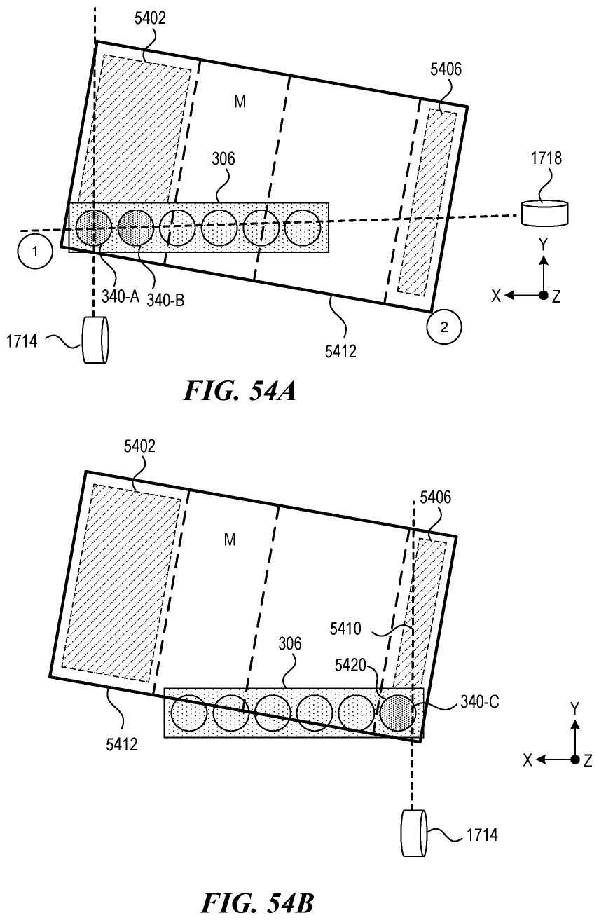

FIGS. 54A-B show images illustrating grasp computation for rotated objects in accordance with one or more embodiments. The illustrated grasp computation can apply to unrecognized and/or detected objects. In some instances, the robotic system derives that a set of edges (e.g., the unrecognized region 5004 described with respect to FIG. 50) corresponds to a rotated pose of an object (e.g., rotated about the z-axis). As shown in FIGS. 54A-B, object M having a potential bottom edge 5412 is in a rotated pose (or a tilted pose) so that the left-side bottom corner (corner 1) of object M is positioned higher (e.g., along the y-axis) than the right-side bottom corner (corner 2). The robotic system can detect such rotated pose based on detecting a set of intersecting edges in the 2D and/or 3D image data that deviate from vertical/horizontal axis by complementary angles.

Based on the tilted or angled edges, the robotic system can compute one or more MVRs for the object that are also in a rotated pose. For example, an MVR 5402 associated with corner 1 and an MVR 5406 associated with corner 2 are in rotated poses in accordance with the rotated pose of object M.

In FIG. 54A, based on detecting the rotated pose, the robotic system can compute an initial grip location according to a corresponding rule. In some embodiments, the robotic system can deviate from the deriving lowest grip location and derive a grip location targeting rotated objects. For example, to account for the downward facing verification sensor, the robotic system can identify the second lowest corner (e.g., corner 1, which is positioned higher than corner 2 along the y-axis) as a reference for the rotated grip location. As a result, the corresponding initial lift can show changes around the edge extending between the two lowest corners of the MVR and the likely separation from the supporting object. Also, for example, the robotic system can select the corner having the widest dimension for the hypothesis. As illustrated in FIG. 54A, two suction cups (e.g., suction cups 340-A and 340-B) of the gripper 306 can grip the lower portion of MVR 5402 to lift object M.

During the lift, a distance measurement can be performed with one or two distance sensors (e.g., the distance sensors 1714 and 1418 described with respect to FIGS. 17A-17F) to verify dimensions and/or the location of the bottom edge 5412 of object M. In particular, when the object is lifted at the initial grip location at the MVR 5402, a lateral distance measurement by the distance sensor 1718 can be used to verify the width of object M and a vertical distance measurement by the distance sensor 1714 can be used to verify the height and/or the position of the tilted bottom edge 5412 of object M.

After the verification of the dimensions and/or the bottom edge 5412 of object M, the robotic system can generate a transfer grip location 5420 to be within the MVR 5406 and abutting or within a threshold gripping distance from the lowest portion of the verified surface (e.g., corner 2, as is illustrated in FIG. 54B). As described above, a lower grip position for the transfer grip location 5420 is preferred by the robotic system so that the gripper 306 can grip and lift an object onto a conveyor over the EOAT (e.g., the conveyor 305 via the first joint rollers 309 illustrated in FIG. 3). In FIG. 54B, a single suction cup (e.g., a suction cup 340-C) of the gripper 306 can grip the lower portion of the MVR 5402 to lift object M.

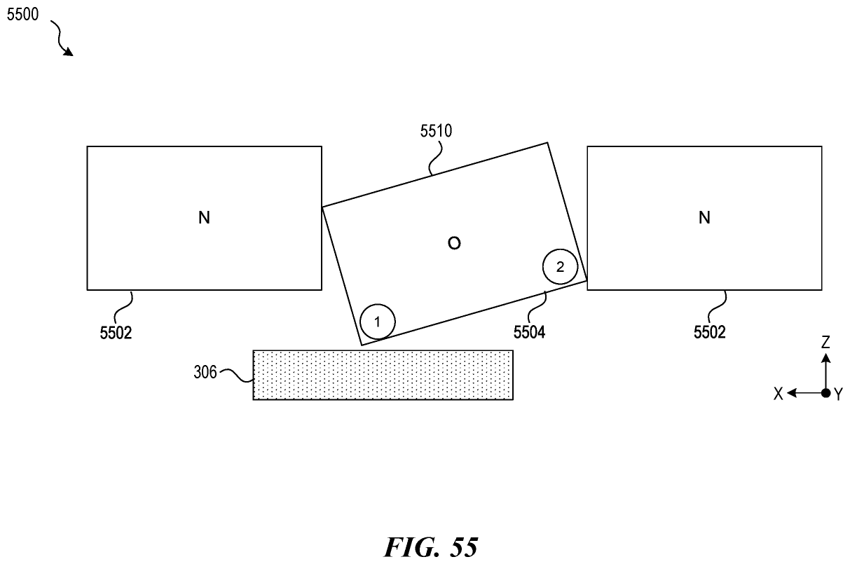

FIG. 55 is a top view of an environment for illustrating alignment of rotated unrecognized objects in accordance with one or more embodiments. FIG. 55 includes a top-view (e.g., the x-z-plane view) image of a stack 5500 that includes objects N and object O. As shown, objects N are aligned with each other with that their front edges (e.g., edges 5502 facing the robotic system and the gripper 306 in FIG. 55) are positioned within a threshold distance from each parallel to the z-axis. Object O can correspond to a skewed object 5510 that is rotated about the y-axis so that one of the corners/peripheral sides (e.g., the corner 1 of object O) is positioned closer to the robotic system (e.g., the gripper 306) than the opposing corner/peripheral side (e.g., the corner 2).

The robotic system can detect such rotation based on the image data depicting the stack 5500. For example, the robotic system can detect objects rotated about the y-axis based on detecting skewed surfaces, such as based on detecting that (1) one corner is closer than another and (2) the depth measures between the two corners follow a linear pattern corresponding to a continuous and planar surface.

In order to process image data depicting the stack 5500 and prepare for grasping the object, the robotic system can generate and implement commands for the gripper 306, locomotors, etc. to contact and push the protruding corner (e.g., corner 1 of object O). The robotic system can be configured to push the protruding corner according to a difference in depths between the protruding and recessed corners of the rotated surface. The robotic system can be configured to push the protruding corner such that the two corners are at the same depth and/or aligned with the edges 5502 of the objects N. As an illustrative example, the robotic system can position the EOAT aligned (e.g., at the same x-y coordinates) with the protruding corner and then move the chassis forward until the suction cups contact the protruding surface and then further forward by the targeted push distance (e.g., half or all of the difference in depths of two corners). Accordingly, the robotic system can position the previously rotated object such that the exposed surface is generally parallel to the opening of the container and/or orthogonal to the z-axis relative to the chassis. The robotic system can push the rotated object prior to performing the vision processing described with respect to FIGS. 50-53.

In some embodiments, the suction cups 340 can be configured to have flexibility to deform during gripping and lifting. In such embodiments, the suction cups 340 can be configured to deform to grip the rotated surface object O by contacting with the edge 5504. Accordingly, the suction cups 340 can account for surface irregularities and/or rotations within a threshold range.

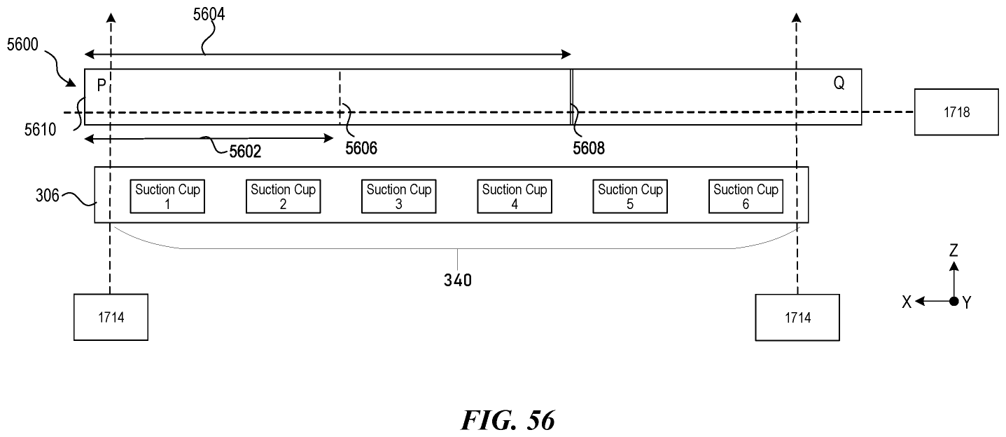

FIG. 56 is a top view of an environment for illustrating a grasp computation for objects in accordance with one or more embodiments. FIG. 56 illustrates a top-view (e.g., the x-z-plane view) of a gripper (e.g., the gripper 306) positioned to lift an object. For the illustrated example, the robotic system can effectively target lifting object P from a stack 5600 including object P and object Q. The gripper 306 can include suction cups 340 (e.g., including six suction cups laterally aligned on the gripper 306). In accordance with the vision processing described above, the robotic system can identify an MVR 5602 for object P (e.g., based on an edge 5610 and a vertical hypothesis 5606) and an initial grip location within the MVR 5602. Accordingly, the robotic system can generate initial lift commands for the gripper 306 to grip and lift object P.

The initial lift commands can include moving the gripper 306 so that a lateral edge of the gripper is aligned with an edge of the targeted object, such as having a left edge of the gripper 306 aligned with the edge 5610 of object P. The edge of the gripper 306 can be aligned with the corresponding edge of the targeted object when they are within a threshold distance from each other in the x-direction. Based on a width of the MVR 5602, the initial lift commands can include activating a number of (e.g., two leftmost) suctions cups (e.g., Suction Cup 1 and Suction Cup 2) located within the MVR 5602 to grasp the targeted object.

During the initial lift, the robotic system can perform a scan with a vertical distance sensor (e.g., the distance sensor 1714). As described with respect to FIGS. 17A-17F, the scan with the distance sensor 1714 can be used to verify the bottom edge of the lifted object, which has been separated from the previously supporting object via the initial lift. Based on locating the bottom edge, the robotic system can compute a height of the lifted object P. If the bottom of object P is within an expected range (e.g., in comparison to registered objects), the robotic system can generate transfer commands based on the verified bottom position and/or height of the lifted object P. For example, the robotic system can continue to transfer the object, such as by pulling the suction cups and activating the conveyors, immediately following the initial lift and without setting the object down. Alternatively, the robotic system can lower the object back down to the initial location and then recompute the motion plan, regrip the object, or a combination thereof based on the verified data. Accordingly, the robotic system can transfer the object after placing the initially lifted back down to its original position.

The robotic system may further perform a scan with a lateral distance sensor (e.g., the distance sensor 1718). As described with respect to FIGS. 17A-17F, the distance measurement with the distance sensor 1718 can be used to verify a width of the initially lifted object P. For example, as shown in FIG. 56, object O has an actual width 5604 extending between the edge 5610 and a vertical hypothesis 5608 (e.g., the vertical hypothesis 5608 corresponding to a gap between objects P and Q). The robotic system can use the verified width 5604 of object P to generate transfer commands. The transfer commands can include gripping the object with additional suction cups (e.g., Suction Cup 3 and Suction Cup 4) that fit within the verified width 5604. The distance measurements by the distance sensors 1714 and 1718 can also be used to verify, during the initial lift, that only a single object has been lifted (e.g., no multi-package lift) and that the activated suction cups fit within the target grip location.

### Flowchart

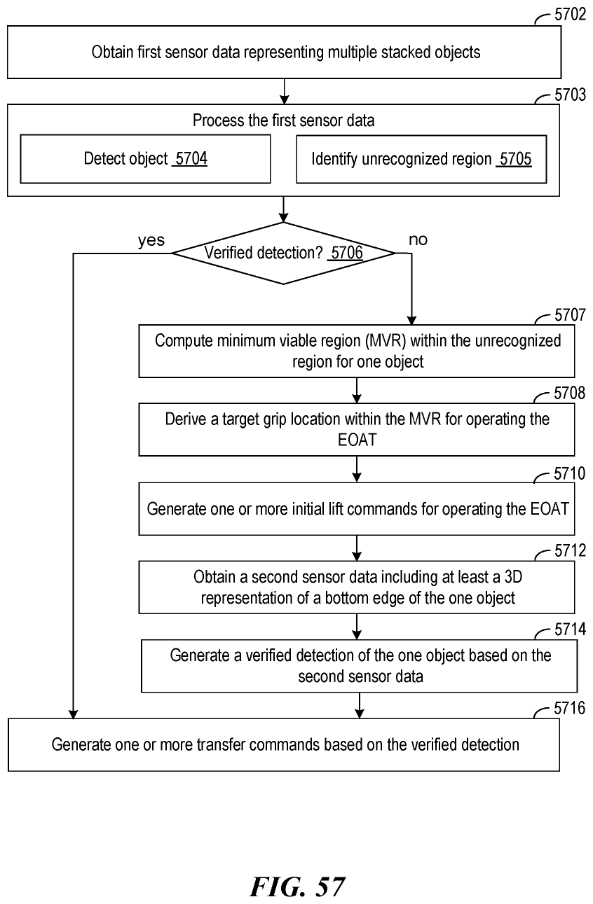

FIG. 57 is a flow diagram of a method for picking up a target object in accordance with some embodiments of the present technology. The method can be implemented by operating an end effector, components thereof, and/or various other components of a robotic system of the type discussed above with reference to FIGS. 3-49. The method can be implemented to unload objects from a shipping unit (e.g., a shipping container, a truck bed, and/or the like).

The method can begin at block 5702 by obtaining first sensor data (e.g., the image 5000 in Section I of FIG. 50) that includes a two-dimensional (2D) visual representation and/or a three-dimensional (3D) representation from a first sensor. The first sensor data can correspond to the output of sensors located between the chassis and the EOAT (e.g., the sensors 824 or the like) and depict the cargo area (e.g., inside of the container, including the space beyond the EOAT). Accordingly, the first sensor data can depict multiple objects at a start location (e.g., the arrangement 5002). The first sensor data can represent multiple objects stacked on top of each other located within a cargo space of a carrier vehicle. The first sensor data can represent a front view of the arrangement 5002 and the corresponding side views of the one or more objects.

At block 5703, the method includes processing the first sensor data. In some embodiments, the robotic system can process the first sensor data to identify one or more detection regions (e.g., the detection region 5003 of FIG. 50) in the first sensor data. For example, the robotic system can detect edges, and then use the detected edges to identify enclosed regions. The robotic system can iteratively select one enclosed region as the detection region, such as according to one or more predetermined rules (e.g., region having the highest height measures, nearest depth measures that are within a threshold range of each other, etc.).

Within the selected detection region, the robotic system can detect one or more objects as shown at block 5704. As described above, the robotic system can detect objects based on comparing the features within the detection region to the features of registered objects as listed in the master data. When the compared features provide sufficient match/overlap (e.g., according to predetermined thresholds), the robotic system can generate verified detection of an object depicted in a corresponding portion of the first sensor data.

In some embodiments, the robotic system can detect that two or more adjacent objects satisfy a multi-pick condition that allows the EOAT to simultaneously grasp and transfer two or more objects. For example, the robotic system can detect that two adjacently arranged objects satisfy the multi-pick condition when (1) the object locations correspond to heights that are within a threshold height range, (2) the object surfaces are at depths that are within a threshold common depth range, (3) the lateral edges of the adjacent objects are within a threshold separation range, (4) lateral dimensions of the objects are less than a maximum width (e.g., collectively corresponding to a width of the EOAT, (5) the grip locations, (6) the object weights, (7) the CoM locations, and/or the like.

At block 5705, the robotic system can identify an unrecognized region (e.g., the unrecognized region in Section II of FIG. 50) within the first sensor data. The unrecognized region can represent one or more vertical and adjacent object surfaces (e.g., surfaces of objects A through E) that are within threshold depths of each other, thereby having essentially coplanar surfaces.

The robotic system can identify the unrecognized region as a result of using the detected edges to identify surfaces, detecting objects depicted in the first sensor data, or a combination thereof as described above. In some embodiments, the unrecognized region can represent one or more vertical and adjacent surfaces having insufficient confidence levels of matching registered objects. The unrecognized region can be defined by a continuous boundary having four or more corners, wherein each corner is within a predetermined range of 90 degrees.

In some embodiments, identifying the unrecognized region includes detecting 3D edges based on the 3D representation of the first sensor data (e.g., the top edge 5012, the bottom edge 5006, and the edges 50008 and 5010 in Section III of FIG. 50). Identifying the unrecognized region can also include identifying 3D corners (e.g., corner One and corner Two) that correspond to intersections between the 3D edges. Identifying the unrecognized region can include identifying a bounded area based on detecting a set of the 3D edges and a set of the 3D corners forming a continuously enclosing boundary (e.g., as shown for the unrecognized region 5004). The robotic system can identify the bounded area as the unrecognized region when the bounded area (1) includes more than four 3D corners, (2) includes a dimension exceeding a maximum dimension among expected objects registered in master data, (3) includes a dimension less than a minimum dimension among the expected objects, (4) has a shape different than a rectangle, or a combination thereof.

Identifying the unrecognized region can further include detecting edges (e.g., 2D edges or other types of 3D edges) based on the first sensor data and identifying lateral edges and vertical edges from the detected edges. The vertical edges can (1) represent peripheral edges (e.g., the edges 5008 and 5010 of the unrecognized region 5004) of and/or spacing between laterally adjacent surfaces. In some embodiments, the robotic system can provide higher confidence, preference, or weights for vertical edges than lateral edges based on the environment. For example, the robotic system can have preferences for vertical edges in operating on stacked boxes that show peripheral sides/surfaces to the laterally oriented sensors. Such peripheral surfaces can typically be continuous and uninterrupted, unlike top/bottom sides of boxes that often have halves or flaps that are separated and may present as edges. Accordingly, the robotic system can place higher preference on vertical edges in contrast to lateral edges and/or in comparison to top-down detection schemes. The higher certainties can also correspond to naturally occurring higher confidence values (e.g., the vertical edges are easier to identify from the captured sensor data).

At decision block 5706, the robotic system can confirm whether the first sensor data or targeted portion(s) therein correspond to verified detection. When the processing results indicate verified detection, the method can proceed to block 5716.

When the processing results do not correspond to verified detection as illustrated at block 5707, the method includes computing a minimum viable region (MVR) within the unrecognized region (e.g., the MVR 5018 in Section III of FIG. 50). The MVR can represent a continuous surface or a portion thereof that logically corresponds to one object or having a sufficient likelihood (e.g., exceeding an MVR threshold) of corresponding to one object. The MVR can effectively estimate at least a portion of a continuous surface belonging to one object (e.g., object A) located in the unrecognized region.

In some embodiments, the robotic system can compute the MVR by computing one or more vertical hypotheses for a potential object location for the one object (e.g., vertical hypotheses 5016 in Section III of FIG. 50). The one or more vertical hypotheses can be computed based on first identifying from the first sensor data a reference vertical edge and/or a reference lateral edge. The robotic system can identify the reference edges as outer-most edges (e.g., highest laterally extending edge, left/right peripheral and vertically extending edge).

Using the reference edges, the robotic system can further compute the one or more vertical hypotheses by deriving one or more potential vertical edges and/or one or more potential lateral edges within the unrecognized region from the first sensor data. The one or more potential vertical edges can be parallel to and/or opposite the reference vertical edge (e.g., the edge 5008), and the one or more potential lateral edges are parallel to and/or opposite the reference lateral edge (e.g., the top edge 5012). The one or more vertical hypotheses can be further computed relative to a potential 3D corner (e.g., corner 1) that corresponds to the reference edges. The potential 3D corner can represent a portion logically belonging to the one object. The MVR at block 5706 can be computed based on the one or more vertical hypotheses, such as an area enclosed by the reference edges and a set of hypothesized edges that oppose/complement the reference edges.

In some embodiments, the first sensor data includes depth sensor data. The one or more potential vertical edges and/or the one or more potential lateral edges can be identified by identifying gap features between respective objects within the unrecognized region.

At block 5708, the method includes deriving a target grip location within the MVR (e.g., indicated with the star within MVR 5018 in Section III of FIG. 50) for operating the EOAT of the robotic system to contact and grip the one object. In some embodiments, the robotic system can derive the target grip location based on aligning bottom edge(s) of the suction cups on the bottom edge of the MVR 5018 or within a threshold distance from the bottom edge. Moreover, the robotic system can derive the target grip location based on maximizing a number of suction cups within the MVR 5018. Additionally or alternatively, the robotic system can derive the target grip location based on ensuring that the maximum number of suction cups are distributed about or essentially centered around a center portion (e.g., mid width) of the MVR 5018.

At block 5710, the method can include generating one or more initial lift commands for operating the EOAT to (1) grip at the one object at the target grip location and (2) perform an initial lift to separate the one object from a bottom supporting object and/or a laterally adjacent object. The process for implementing the initial lift is described above, such as with respect to FIG. 17A-17F.

At block 5712, the method can include obtaining a second sensor data from a second sensor location different from a capturing location of the first sensor data. For example, the second sensor data can include data captured by distance sensor located closer to the objects than the first sensor and/or on the EOAT, such as for sensors 1714 and/or 1718 in FIGS. 17C and 17E, respectively.

The second sensor data can include at least a 3D representation/measurement of space below the suction cups, thereby depicting a bottom edge of the one object separated from the bottom supporting object due to the initial lift. In other words, the first sensor data can represent an outer image, and the second sensor data can represent an inner image (e.g., an output of the second sensor). For example, the first sensor data can be captured by one or more upper vision sensors 824 and one or more lower vision sensors 825 described with respect to FIG. 8, and the second sensor data can be captured by the distance sensors 1518 and/or 1608 described with respect to FIG. 15 and FIG. 16.

At block 5714, the method can include generating a verified detection of the one object based on the second sensor data. The verified detection can include a verified bottom edge and/or a verified side edge of the one object. Generating the verified detection can include deriving a height and/or a width for the one object based on the second sensor data and comparing the height and/or the width with respective heights and/or widths of registered objects to verify the detection of the one object. The robotic system can reidentify or redetect the object when the verified dimensions uniquely match a registered object. Otherwise, when the verified dimensions are different from those of registered objects, the robotic system can register the initially lifted object and store the verified dimensions in the mater data. The robotic system can use newly registered object and dimensions to further simplify the transfer process as described in detail below.

In some embodiments, the one or more potential lateral edges include a potential bottom edge of the one object (e.g., object F having the potential bottom edge 5206 in FIG. 52). The target grip location (e.g., indicated with the star in Section I of FIG. 52) can abut or be within a threshold gripping distance from the potential bottom edge of the one object. In some instances, the MVR can correspond to an inaccurate estimate of the objects bottom edge, and the verified bottom edge (e.g., the verified bottom edge 5208 in Section III of FIG. 52) can be lower than the potential bottom edge of the one object. When the verified edge is lower than the bottom edge of the MVR, the robotic system can adjust the target grip location based on the verified bottom edge so that the adjusted target grip location (e.g., indicated with the star in Section III in FIG. 52) abuts or is within a threshold gripping distance from the verified bottom edge of the one object.

At block 5716, the method can include generating one or more transfer commands based on the verified detection for operating the robotic system. The robotic system can generate the transfer commands to transfer the one object from the start location toward an interfacing downstream robot or location (e.g., an existing conveyor within the warehouse/shipping hub). The transfer can be over the EOAT (e.g., the gripper 306 in FIG. 3) and one or more subsequent segments (e.g., the conveyor 305 via the first joint rollers 309 illustrated in FIG. 3).

In transferring the objects, the robotic system can further obtain and process the second sensor data. For example, the robotic system can obtain the second sensor data similarly as block 5712 and process the second sensor data to confirm that the bottom edge of the grasped/lifted object is at an expected location. Accordingly, the robotic system can leverage the existing processes to check for unexpected errors, such as a safeguard measure. The robotic system can apply such process checks when transferring detected objects and/or previously unrecognized objects.

When the robotic system identifies the multi-pick condition as described above for block 5704, the robotic system can generate the one or more transfer commands for grasping and transferring the corresponding set of objects based on a single position of the EOAT (e.g., without repositioning for each object). For example, the robotic system can assign groupings of suction cups to each object in the multi-pick set. The robotic system can position the EOAT such that the assigned groupings of the suction cups are facing the grip location of each object. Based on such positioning, the robotic system can operate the suction cups and the corresponding assemblies to grasp the objects within the multi-pick set. In some embodiments, the robotic system can simultaneously grasp the multiple objects in the multi-pick set and transfer them onto the conveyors local to or on the EOAT. The robotic system can simultaneously operate the local conveyors to transfer the objects together (e.g., side-by-side). Alternatively, the robotic system can sequentially operate the EOAT conveyors to transfer the objects separately/sequentially. In other embodiments, the robotic system can perform the multi-pick by operating the gripper assemblies to sequentially grasp the multiple objects while maintaining the overall position/pose of the EOAT.

In some embodiments, the robotic system can identify a removed portion based on adjusting the MVR according to the verified detection (e.g., FIG. 51). The removed portion represents a portion of the unrecognized region that corresponds to the one object that has been transferred away from the start location. The robotic system can adjust the unrecognized region based on reclassifying the removed portion of the unrecognized region as open space (e.g., empty region 5102 in Section II of FIG. 51). The adjusted unrecognized region can be used to (1) identify a subsequent MVR (e.g., the MVR 5106) corresponding to a subsequent object (e.g., object B) depicted in the adjusted unrecognized region and (2) transfer the subsequent object. The subsequent object can be positioned adjacent to the removed portion. The subsequent MVR is identified from the first sensor data without acquiring further data from the first sensor. As an illustrative example, the robotic system can use the removed portion to reclassify the edge/corner of object B, which was previously abutting the removed object, as a 3D edge/corner without obtaining a new outer sensor data.

In some embodiments, the method further includes determining that the unrecognized region within the first sensor data is less than a threshold area for identifying the subsequent MVR after the reclassification of the removed portion. In response to the determination, the process can include obtaining additional sensor data for identifying an additional unrecognized region such that the additional unrecognized region has sufficient area for identifying the subsequent MVR. The method can further include adjusting the target grip location based on the verified detection for transferring the one object. The target grip location can be lower based on the verified detection. For example, the target grip location abuts or is within a threshold gripping distance from a verified bottom edge of the one object.

In some embodiments, the method can include determining that at least a portion of the unrecognized region corresponds to a rotated pose of a rectangle (e.g., FIGS. 54A-54B). The MVR (e.g., the MVRs 5402 and 5406) can be computed to have the rotated pose. The target grip location for the initial lift can be based on a higher corner corresponding to a hypothesized bottom edge (e.g., edge 5412 in FIG. 54A). The one or more verified transfer commands are for transferring the one object based on gripping relative to a lower corner corresponding to a verified bottom edge (e.g., FIG. 54B).

In some embodiments, the method includes deriving an additional target grip location for an additional object within the unrecognized region. Generating the one or more initial lift commands can include determining an order for the EOAT to grip the one object and the additional object based on a relative position of the EOAT to the target grip location and the additional target grip location. The process can include identifying 3D corners (e.g., corners a through 4 in Section II of FIG. 53) in the outline of the unrecognized region. Each of the 3D corners represents a portion uniquely corresponding to one associated object. The process can include determining a current location of the EOAT and selecting one of the 3D corners closest to the current location. The MVR is computed based on the selected 3D corner. In some embodiments, the method includes deriving that the one object is an outermost object within the unrecognized region and the additional object is a central object within the unrecognized region (e.g., objects H and L are outermost object in the stack 5301 in FIG. 53). Generating the one or more initial lift commands can include prioritizing that the one object is to be gripped by the EOAT before gripping the additional object.

### Example Support Detection for Unrecognized Objects

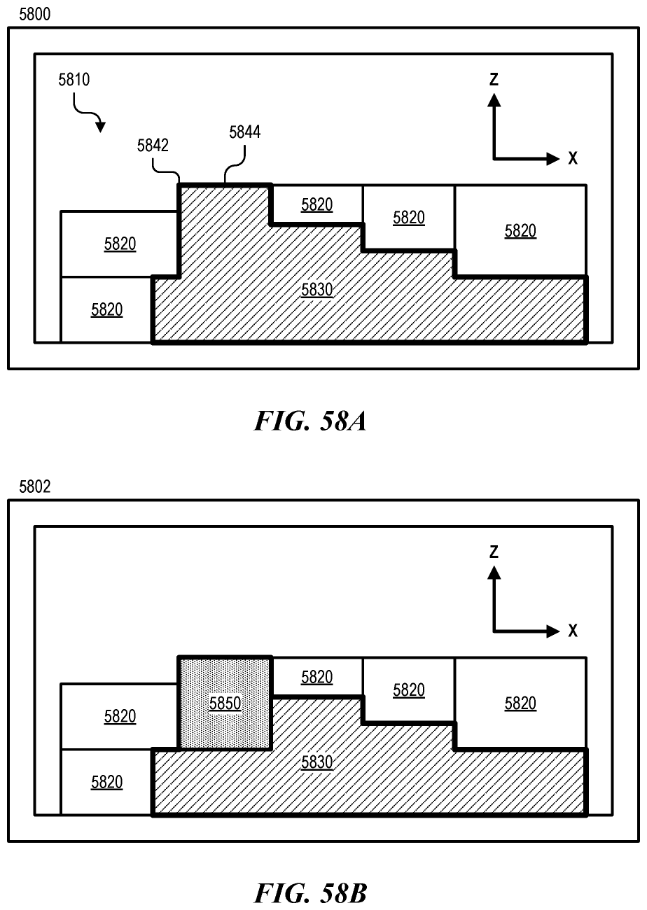

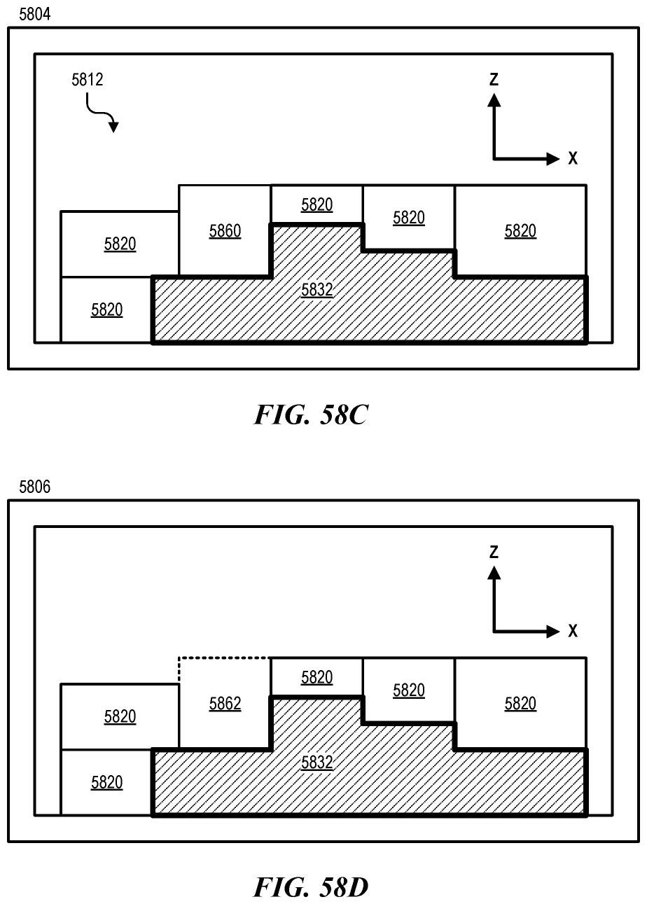

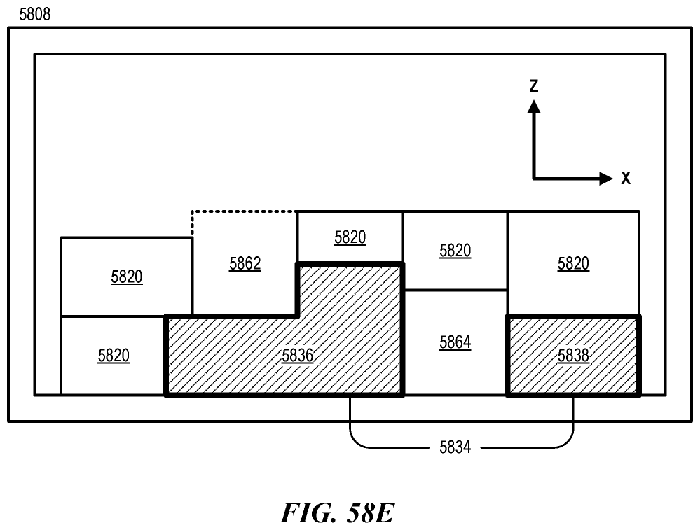

FIGS. 58A-E are example illustrations of support detection processes for unrecognized objects in accordance with one or more embodiments. The process described with respect to FIGS. 58A-E is generally directed toward detecting objects from an unrecognized region 5830, 5834 (e.g., sensor-based image data) using updated object registration records.

FIG. 58A illustrates an initial sensor-based image data 5810 generated from vision sensors of the robotic system. For the example illustrated in FIG. 58A, the image data 5810 can depict or correspond to a set of detected objects 5820 (e.g., objects registered in a master data) and an unrecognized region 5830. Based on the image features of FIG. 58A, the robotic system can generate an MVR 5850 located within the unrecognized region 5830 as shown in FIG. 58B and described above.

The robotic system can use the EOAT to displace a vertical surface corresponding to the MVR 5850 and obtain additional sensor data (e.g., new exposed corners and/or edges). The robotic system can use the additional sensor data to verify a new detected object 5860 from the unrecognized region 5830, as illustrated in FIG. 58C. The robotic system can register the new detected object 5860, such as by creating a new object registration in the master data and storing one or more physical attributes therein. Some examples of the stored attributes can include dimensions of the object (e.g., as computed using the verified edges), weight of the object as measured during transfer, a verified COM measured during the initial lift, a texture (e.g., the portion of the unverified region corresponding to the removed object), or a combination thereof.

FIG. 58D illustrates an updated image data after the robotic system extracts the new detected object 5860 from the container. As described above, the robotic system can generate and overlay a mask 5852 over the portion of the unrecognized region 5830 corresponding to the new detected object 5860. Further, FIG. 58E illustrates detection of objects 5864 that match the new detected object 5860 found within the updated unrecognized region 5832.

As an illustrative example, FIG. 58A can depict an initial sensor-based image data 5810 of objects within a container (e.g., cargo container). For example, the sensor-based image data 5810 represents detected objects 5820 and unrecognized regions 5830 of image data features (e.g., point clouds, surfaces) collected from vision sensors. The unrecognized region 5830 can include at least a portion of the initial image data 5810 that do not match known object features and/or characteristics (e.g., corners, edges, geometry, size recorded in the master data). Further, the unrecognized region 5830 can include image features with the shortest depth distance from (e.g., nearest to) the vision sensor. The robotic system can analyze the unrecognized region 5830 of the initial image data 5810 to identify or detect additional image data features, such as exposed corners 5842 and/or edges 5844, that can correspond to the object(s) within the unrecognized region 5830. Although the unrecognized region 5830 of FIG. 58A is depicted as a single, connected area, the unrecognized region 5830 of the initial sensor-based image data 5810 can include one or more regions of unrecognized image data features.

FIG. 58B illustrates an example identification 5802 of an MVR) 5850 within the unrecognized region 5830 as part of the process for identifying new objects within the unrecognized region 5830. For example, the robotic system can identify the MVR 5850 based on the image features of the unrecognized region 5830 from the initial image data 5810 as illustrated in FIG. 58A. In particular, the robotic system can process 2D and/or 3D features associated with the unrecognized region 5830 to identify a reference feature, such as the exposed 3D corner 5842 and its corresponding edges 5844. Using the reference feature, the robotic system can overlay an initial rectangular area (e.g., an AABB representing an initial MVR hypothesis) that is aligned to the reference corner and/or edge. Additionally, the robotic system can extend the AABB of the MVR to the hypothesized edges as described above. The robotic system can use the MVR to grasp the object and perform an initial lift of the vertical surface. Based on the initial lift, the robotic system can verify the bottom edge of the lifted object, as discussed in further detail above. Although one MVR 5850 is depicted in FIG. 58B, the robotic system can identify multiple MVRs 5850 (e.g., one for each 3D corner) within the unrecognized region 5830.

FIG. 58C illustrates a verified detection 5804 of a new object 5860 corresponding to the MVR 5850 generated in FIG. 58B. As discussed above, the robotic system can verify a detection of the new object 5860 from the unrecognized region 5830 by performing an initial displacement (e.g., vertical lift). Upon verification, the robotic system can register the verified object along with its physical attributes, such as the image features and/or characteristics (e.g., size, shape, geometry, edges, corners) of the new object 5860, into the master data. For example, the robotic system can search the master data for an existing record having attributes matching those of the new object 5860, and subsequently add a new record (e.g., characteristics and/or features) of the new object 5860 into the master data upon a failed match.

Additionally, as illustrated by the adjusted unrecognized region 5832, the robotic system may adjust the unrecognized region 5830 to generate an adjusted image data 5812 that excludes the set of image features or the image portion corresponding to the new object 5860. In other embodiments, the robotic system may generate the adjusted unrecognized region 5832 after extraction of the new object 5860 as depicted in FIG. 58D.

FIG. 58D illustrates a removal 5806 of the new object 5860 and replacing the image features 5810 corresponding to the new object 5860. For example, the robotic system can use the EOAT to grip onto the vertical surface of the new object 5860 and extract the new object 5860 from the container. As discussed above, the robotic system can generate an adjusted image data 5812 that excludes or masks the set of image features corresponding to the extracted new object 5860 in the adjusted unrecognized region 5832. Further, the robotic system can generate a second adjusted image data 5814 that excludes or masks the set of image features of the new object 5860 entirely. In some embodiments, the robotic system can replace the image features of the new object 5860 with the mask (e.g., representing empty space) 5862 and/or vertical surfaces located at a farther depth than the initial depth of the vertical surface of the new object 5860 found in the initial image data 5810.

FIG. 58E illustrates a detection 5808 of objects 5864 in the adjusted unrecognized region 5832. The detection 5808 can correspond to identifying the objects 5864 matching (e.g., having a measure of overlap or correspondence exceeding a predetermined match threshold) the new object 5860 in the updated master data. For example, the robotic system can compare the image features of the new object 5860 (e.g., as stored in the master data) with image features of the adjusted unrecognized region 5832 to identify a set of image features that match the newly registered characteristics and/or features (e.g., size, shape, geometry, surface area, etc.). Based on the set of matching image features, the robotic system can determine a second detected object 5864 within the adjusted unrecognized region 5832. The second detected object 5864 can share a significant proportion (as defined by corresponding ranges or thresholds) of characteristics and/or features with the first detected object 5860 and can be considered another instance (e.g., a copy or a matching type) of the first detected object 5860.

Using the second detected object 5864, the robotic system can generate an updated unrecognized region 5834 from the adjusted unrecognized region 5832 by excluding the image features corresponding to the second detected object 5864 in a manner similarly described above with respect to the first detected object 5860. With respect to FIG. 58E, the updated unrecognized region 5834 can include two smaller unrecognized regions 5836, 5838 created by exclusion of the image features corresponding to the second detected object 5864. Accordingly, the robotic system can use information obtained about a previously unrecognized object to trigger a new detection within the unrecognized region. The new detection can further recognize other previously unrecognized object matching the removed object, thereby further reducing the unrecognized region and simplifying the transfer of the stack using the existing image data.

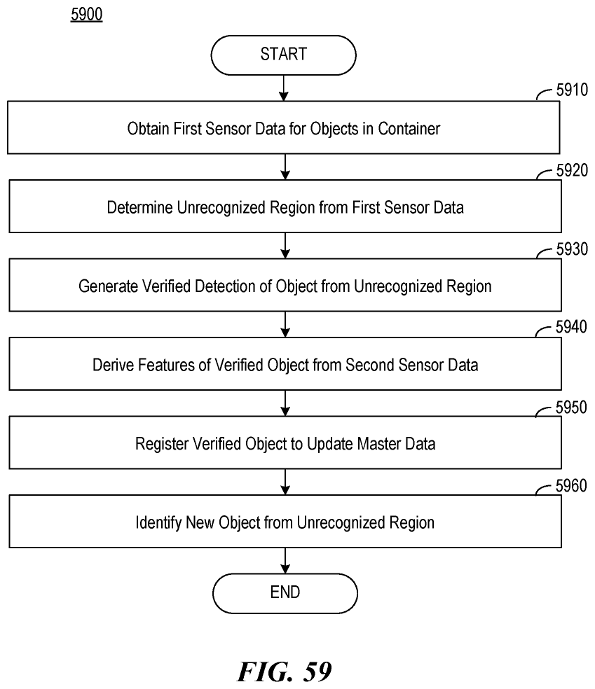

FIG. 59 is a flow diagram of a method for detecting new objects from unrecognized regions in accordance with some embodiments of the present technology. The method can be implemented based on executing, using one or more processors, the instructions stored on one or more storage devices. The processors can control various components of a robotic system of the type discussed above to unload objects from a shipping unit (e.g., a shipping container, truck, and/or the like). For example, the processors can send commands, settings, and/or other communications that effectively control an end effector discussed above, and other components of the robotic system.

Starting at block 5910, the robotic system can obtain a first image data 5810 depicting one or more objects in a container. For example, the robotic system can use one or more vision sensors to scan the inside of the container to generate the image data (e.g., 2D and/or 3D surfaces, 3D point clouds).

In some embodiments, the robotic system can implement object detection to detect one or more objects 5820 depicted in the first image data 5810 based, such as by comparing portions of the first image data 5810 to recorded object characteristics and/or features in a master data. For example, the robotic system can match image features (e.g., corners, edges, size, shape) from the first image data to one or more patterns of image features corresponding to a recorded object in the master data. As such, the robotic system can group the matched image features as a detected object 5820. In additional embodiments, the robotic system can update the first sensor-based image data to categorize the image features corresponding to the detected objects 5820 as known features. The robotic system can use the detection results to locate and verify boundaries/edges of the detected objects.

At block 5920, the robotic system can determine an unrecognized region 5830 from a portion of the first image data 5810. For example, the robotic system can determine the unrecognized region 5830 as the portion of the first image data 5810 that failed to match the known characteristics and/or features of objects. In response to a failed identification, the robotic system can assign the unrecognized image features as part of the unrecognized region 5830 of image features. In some embodiments, the unrecognized region 5830 can include an initially unknown number of surfaces (e.g., vertical surfaces of objects having depths within proximity threshold of each other) from the first image data 5810. The robotic system can determine the unrecognized region 5830 corresponding to the shortest depth measures from the vision sensors.

At block 5930, the robotic system can generate a verified detection of at least one (previously unrecognized) object 5860 from the unrecognized region 5830. For example, the robotic system can generate an MVR region 5850 that is aligned with a reference point (e.g., an exposed corner/edge) of the unrecognized region 5830. Using the identified MVR 5850, the robotic system can position and operate the EOAT to grab the corresponding vertical surface of the targeted object 5860, perform an initial lift, and retrieve a set of sensor readings for the grasped object 5860 through a second image data.

Based on the second image data, the robotic system can determine a verified detection of the unrecognized object by identifying a verified bottom edge of the unrecognized object 5860. In some embodiments, the robotic system can iteratively adjust the MVR 5850 and retrieve new sets of image features until a verified detection of the unrecognized object 5860 is complete.

Also, at block 5930, the robotic system can update the unrecognized region 5830 by adjusting the assignment of image features corresponding to the unrecognized object 5860. For example, the robotic system can update the unrecognized object 5850 by noting/masking the removed object within the initial first image data and/or the unrecognized object 5850 as described above.

At block 5940, the robotic system can derive one or more characteristics of the unrecognized object 5860 from a second image data and/or other sensor data (e.g., weight/torque sensor, object depth sensor, etc. For example, the robotic system can retrieve one or more image features (e.g., corners, edges, size, shape) from the second image data. The robotic system can use the second image data to compute the height and/or the width of the grasped object. In other embodiments, the robotic system can use the EOAT to scan additional image features for the unrecognized object 5860 before transferring the object 5860 from the container. Additionally, the robotic system can use other sensors, such as line/crossing sensors, weight or torque sensors, other image sensors, or the like to obtain further characteristics, such as depth, weight, COM, images of other surfaces, or the like.

At block 5950, the robotic system can register the unrecognized object 5860 to update the master data. In some embodiments, the robotic system can first perform a search the master data for characteristics and/or image features matching those of the newly acquired characteristics of the previously unrecognized object 5860. In response to a failed search, the robotic system can add a new record representative of a new object and store the newly acquired characteristics and/or features of the unrecognized object 5860.

At block 5960, the robotic system can identify a new object 5864 from the adjusted unrecognized region 5832. For example, the robotic system can trigger a redetection using the updated master data and/or the new object data therein. In some embodiments, the robotic system can perform the new detection process for the adjusted unrecognized region and/or other unrecognized region(s) instead of the first image data in its entirety. Accordingly, the robotic system can compare one or more image features of the adjusted unrecognized region 5832 to image features of recorded objects stored in the updated master data.

Based on the comparison with the updated master data, the robotic system can identify a set of image features from the adjusted unrecognized region 132 that correspond to or match characteristics and/or features of a recorded object. As such, the robotic system can associate the identified set of image features with a new object 5864. Further, the robotic system can unassign image features corresponding to the new object 5864 from the adjusted unrecognized region 5832 to generate an updated unrecognized region 5834.

The robotic system can repeat the above-described processes each time an unrecognized object 5860 is detected and verified from the unrecognized region 5830, 5832, 5834. In some embodiments, the robotic system can execute the process as described above after a new registration of the unrecognized object 5860 into the master data. In other embodiments, the robotic system can repeat the above-described process until it is not possible to detect a new MVR within the unrecognized region 5830, 5832, 5834 (e.g., from the initial first image data). A person having ordinary skill in the art will appreciate that this process enables the robotic system to iteratively update the sensor-based detection of objects without requiring a full replacement scan of the container, and thus reducing the required number of sensor-based image data captures and improving time efficiency of the robotic system.

### Example Support Target Selection for Objects

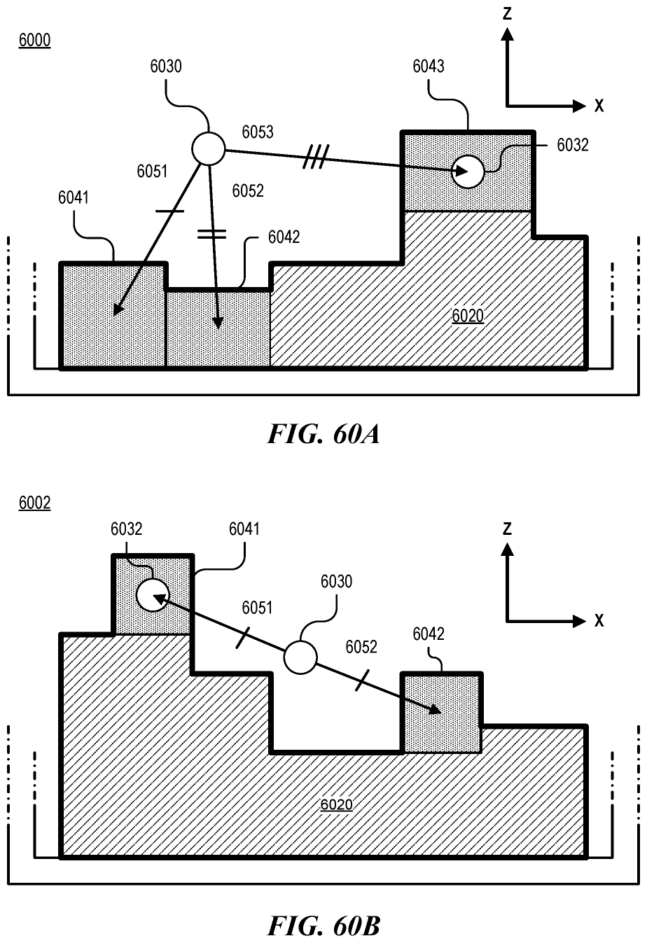

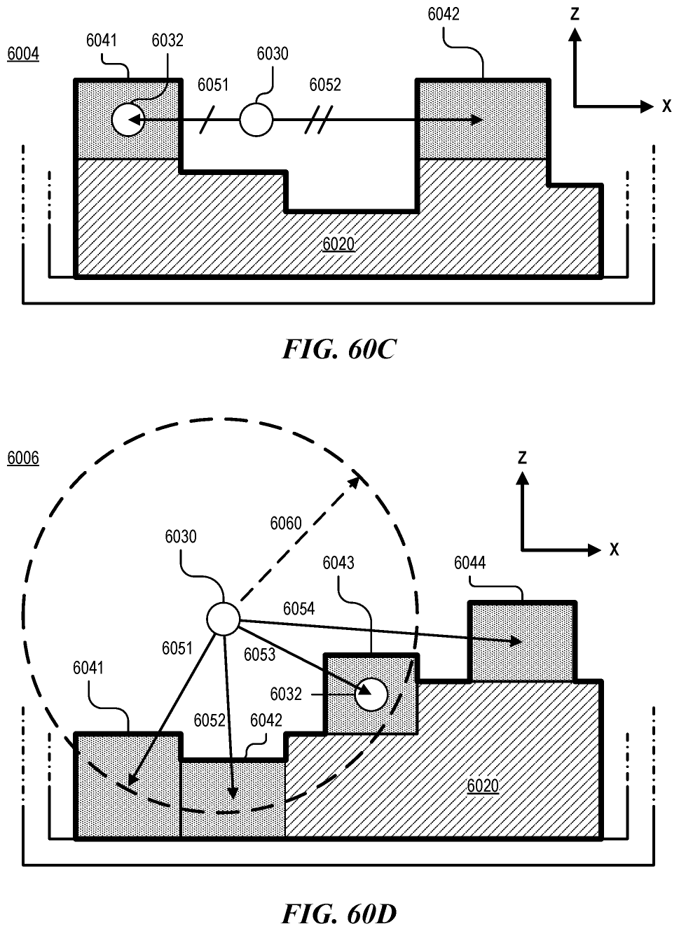

FIGS. 60A-D are example illustrations of target object selection rules in accordance with one or more embodiments of the present technology. FIGS. 60A-D can illustrate various object location evaluation criteria that correspond to the different target object selection rules.

In selecting between detection results or estimates thereof (e.g., detected/verified objects and/or MVRs for initial lift), the robotic system can be configured to select a next target object for the EOAT based on the illustrated target object selection rules. For example, the robotic system can select a target object with a location 6032 (e.g., COM, the grip location, or a similar reference location) that satisfies one or more of the illustrated object location evaluation criteria. FIGS. 60A-D can each demonstrate a criteria for evaluating one or more candidate objects based on their corresponding locations relative to a starting location 6030 (e.g., a current location or a projected location after completing a current/last scheduled task) of the EOAT. Further, the robotic system can be configured to apply the selection criteria of FIGS. 60A-D as individual rules or a combination of rules for selecting the next target object.

FIG. 60A illustrates an object location evaluation criterion based on horizontal alignment of the object location to a start location 6030 for the EOAT (e.g., current position of the EOAT relative to the container). For example, FIG. 60A illustrates three selectable regions 6041, 6042, 6043 (e.g., verified detection result, MVR identified from an unrecognized region 6020, or a combination thereof), each corresponding to a vertical surface of a candidate object. Based on the selectable regions, the robotic system can select a reference point (e.g., the COM or the grip location of the detected result, center of MVR or the corresponding grip location, etc.) for each selectable region and generate a distance vector from the start location 6030 to the reference point. As shown, FIG. 60A includes three distance vectors 6051, 6052, 6053 each respectively corresponding to the three selectable regions 6041, 6042, 6043. With respect to FIG. 60A, the three distance vectors 6051, 6052, 6053 are of different distance measures (e.g., indicated by different number of vector tick marks). In some instances, the generated distance vectors can correspond to potential motion plans for positioning the EOAT from the start location 6030 to the reference location corresponding to the distance vector (e.g., head of the vector).

For each of the generated distance vectors, the robotic system can determine an alignment measure relative to a horizontal axis. In some embodiments, the robotic system can estimate an angular magnitude between the distance vector and the horizontal axis. In other embodiments, the robotic system can determine the distance vector with a horizontal vector component larger than the horizontal vector component of other distance vectors as the distance vector with best alignment to the horizontal axis. In additional or alternative embodiments, the robotic system can determine the alignment measure for each distance vector based on an alternate reference axis (e.g., vertical axis, angled axis). The robotic system can be configured to select the candidate object 6043 with a corresponding distance vector 6053 closest to the horizontal axis as the next target object. As such, the robotic system can determine a motion plan for positioning the EOAT from the first location (e.g., start location) 6030 to the second location 6032 corresponding to the reference location of the selected candidate object.

FIG. 60B illustrates an object location evaluation criterion based on height of the object location to a start location 6030 for the EOAT (e.g., current position of the EOAT relative to the container). For example, FIG. 60B illustrates two selectable regions 6041, 6042 identified from an unrecognized region 6020, each corresponding to a vertical surface of a corresponding candidate object.

Based on the selectable regions, the robotic system can select a reference point (e.g., the COM or the grip location of the detection result, center of MVR, bottom edge/corner of the MVR) for each selectable region and generate a distance vector from the start location 6030 to the reference point. As shown, FIG. 60B includes two distance vectors 6051, 6052 each respectively corresponding to the two selectable regions 6041, 6042. With respect to FIG. 60B, the two distance vectors 6051, 6052 are of same distance measures (e.g., indicated by same number of vector tick marks).

Using the generated distance vectors, the robotic system can determine a height measure for each distance vector with respect to the start location 6030. In particular, the robotic system can be configured to assign a positive height measure for locations above the start location 6030 and a negative height measure for locations below the start location 6030. As shown in FIG. 60B, the robotic system can be configured to select the candidate object 6041 with a corresponding distance vector 6051 with the most positive height measure as the next target object. As such, the robotic system can determine a motion plan for positioning the EOAT from the first location (e.g., start location) 6030 to the second location 6032 corresponding to the reference location of the selected candidate object.

FIG. 60C illustrates an object location evaluation criterion based on distance between the object location and a start location 6030 for the EOAT (e.g., current position of the EOAT relative to the container). For example, FIG. 60C illustrates two selectable regions 6041, 6042 identified from an unrecognized region 6020 and identify corresponding reference points. Based on the selectable regions, the robotic system can generate a distance vector from the start location 6030 to the reference point. As shown, FIG. 60C includes two distance vectors 6051, 6052 each respectively corresponding to the two selectable regions 6041, 6042. With respect to FIG. 60C, the two distance vectors 6051, 6052 are equally aligned to the horizontal axis (e.g., both distance vectors are horizontal).

Using the generated distance vectors, the robotic system can be configured to select the candidate object 6041 with a shortest distance vector 6051 (e.g., smallest distance magnitude) as the next target object. As such, the robotic system can determine a motion plan for positioning the EOAT from the first location (e.g., start location) 6030 to the second location 6032 corresponding to the reference location of the selected candidate object.

FIG. 60D illustrates an object location evaluation criterion based on a distance threshold 6060 between the object location and a start location 6030 for the EOAT (e.g., current position of the EOAT relative to the container). For example, FIG. 60D illustrates four selectable region 6041, 6042, 6043, 6044 identified from an unrecognized region 6020, each corresponding to a vertical surface of a candidate object. Based on the identified regions, the robotic system can select reference points and generate corresponding distance vectors as described above. As shown, FIG. 60D includes four distance vectors 6051, 6052, 6053, 6054 each respectively corresponding to the four selectable regions 6041, 6042, 6043, 6044.

Using the generated distance vectors, the robotic system can be configured to filter candidate objects based on the distance between the start location 6030 and each reference location. In particular, the robotic system can select a set of valid candidate objects 6041, 6042, 6043 that each have distance vectors 6051, 6052, 6053 within a specified distance threshold 6060. As shown, the distance vector 6054 of the candidate object 6044 exceeds the radial distance threshold 6060 centered at the start location 6060 and is excluded from consideration by the robotic system. Although the distance threshold 6060 illustrated in FIG. 60D is depicted as a radial distance threshold, alternative distance thresholds, such as a set of distance ranges, and/or directional constraints can be applied.

From the set of valid candidate objects, the robotic system can be configured to apply other object location evaluation criteria to select the next target object. In the scenario illustrated in FIG. 60D, the robotic system can be configured to apply the criteria shown in FIG. 60A, FIG. 60B, FIG. 60C and/or any combination thereof. As such, the robotic system can determine a motion plan for positioning the EOAT from the first location (e.g., start location) 6030 to the second location 6032 corresponding to the reference location of the selected candidate object.

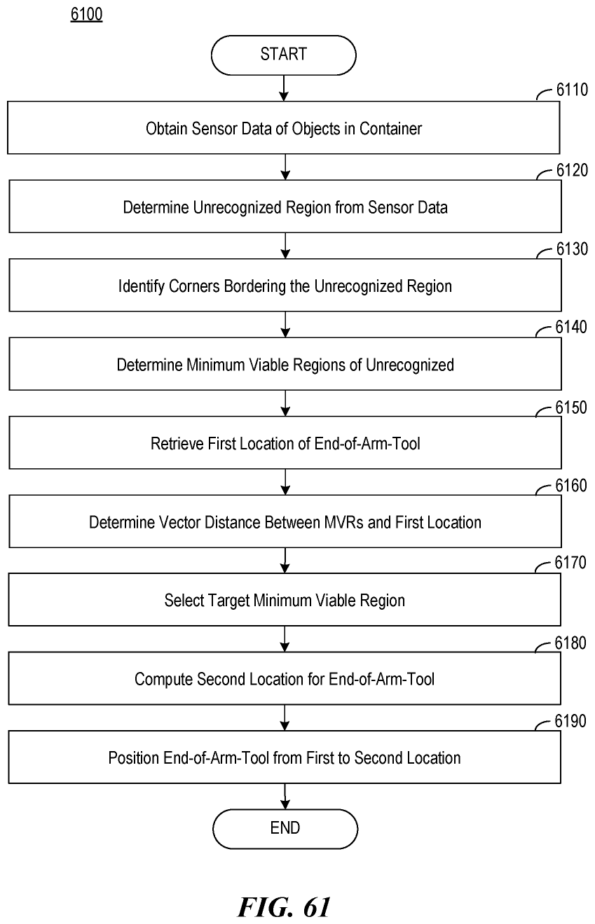

FIG. 61 is a flow diagram of a method for evaluating selection criteria for picking up objects in accordance with some embodiments of the present technology. The process can be implemented based on executing the instructions stored on one or more storage devices with one or more processors. The processors can control various components of a robotic system of the type discussed above to unload objects from a shipping unit (e.g., a shipping container, truck, and/or the like). For example, the processors can send commands, settings, and/or other communications that effectively control and operate an end effector and other components of the robotic system described above.

The method can include obtaining sensor data of objects in container, determining unrecognized region from the sensor data, identifying corners in the unrecognized region, and determining MVRs in the unrecognized regions as illustrated in blocks 6110, 6120, 6130, and 6140, respectively. The represented processes have been described above. As a result, the robotic system can identify multiple MVRs for a given first sensor data and/or the corresponding unrecognized region(s).

At block 6150, the robotic system can retrieve a start location 6030 representative of the location of the EOAT immediately prior to selecting and operating on a targeted object/MVR. In some embodiments, the start location 6030 can include the current location of the EOAT, a projected location at the end of the current maneuver/operation, or a projected location at the end of the currently planned/queued set of operations. The robotic system can determine the current location of the EOAT with respect to the container based on a sequence of known relative orientations (e.g., location of EOAT with respect to a local controller, location of local controller with respect to the container). In alternative embodiments, the robotic system can retrieve the current location as stored information on one or more processors and/or memory of local controllers as discussed above with reference to FIGS. 2-3.

At block 6160, the robotic system can determine distance measurements (e.g., vectors) between the start location 6030 of the EOAT and the set of MVRs. For example, the robotic system can determine a directional vector for each MVR with respect to the start location 6030. For each MVR, the robotic system can identify a common reference location (e.g., a corner, a midpoint of an edge/surface, a center-of-mass, a grip location) on the MVR. As such, the robotic system can generate distance vectors from the start location 6030 to the common reference locations of each MVR. In additional embodiments, the robotic system can use the distance vectors to filter one or more invalid MVRs from the set of MVRs. For example, the robotic system can select valid MVRs with a corresponding distance vector within a specified distance threshold 6060 of the start location 6030 as described above.

At block 6170, the robotic system can select a target MVR from the set of MVRs based on one or more object location evaluation criteria. For example, the robotic system can select an MVR corresponding to a distance vector closest to the horizontal axis/alignment. In some embodiments, the robotic system can determine an alignment measure for each distance vector based on an angular magnitude between the distance vector and the horizontal axis. In other embodiments, the robotic system can determine the distance vector with a horizontal vector component larger than the horizontal vector component of other distance vectors as the distance vector with best alignment to the horizontal axis.

In some embodiments, the robotic system can select an MVR based on a separation distance with surfaces adjacent to the MVR as described above. For example, the robotic system can determine one or more adjacent surfaces to an MVR based on detected surfaces from the sensor-based image data that are within a separation threshold of the MVR (e.g., at the reference location). In other embodiments, the robotic system can determine one or more adjacent surfaces that are coplanar to the vertical surface corresponding to the MVR. Using the adjacent surfaces, the robotic system can calculate a lateral distance measure between each adjacent surface and the MVR (e.g., at the reference location). Further, the robotic system can select the MVR with the largest lateral distance measure with adjacent surfaces.

In other embodiments, the robotic system can select an MVR corresponding to a distance vector with the tallest reference location height as described above. For example, the robotic system can select an MVR corresponding to a vertical surface with the tallest bottom edge elevation. In alternative embodiments, the robotic system can select an MVR corresponding to a distance vector with the shortest length between the start location 6030 and the reference location. Further, the robotic system can select the target MVR by applying one or more of the above-described object location evaluation criteria individually or in combination. In other embodiments, the robotic system can be configured to consider additional methods of prioritizing MVR selection beyond the object location evaluation criteria listed above.

At block 6180, the robotic system can determine an end location 6032 based on the selected MVR, representative of a destination location for positioning the EOAT before/facing a vertical surface of the target object. For example, the robotic system can determine the end location 6032 as the reference location (e.g., a corner, a midpoint edge/surface, center-of-mass, grip location) of the selected MVR. In some embodiments, the robotic system can select a location on the vertical surface corresponding to the selected MVR that maximizes the number of suction cups of the EOAT directly contacting the vertical surface.

At block 6190, the robotic system can position the EOAT before the target object using the start location 6030 and the end location 6032. For example, the robotic system can compute a motion plan for the EOAT to move from the start location 6030 to the end location 232 before the vertical surface corresponding to the target object. Further, the robotic system can instruct the EOAT to contact the vertical surface, grasp the vertical surface by activating one or more suction cups, and pull the target object onto the EOAT. The robotic system can subsequently plan for and operate the conveyors so that the grasped target object is transferred out of the container.

For illustrative purposes, the method is described with respect to selecting between MVRs. However, it is understood that the method can be adjusted and/or applied to selecting between detection results or other representations/estimations of object surfaces. For example, the method can generate detection results instead of determining the unrecognized region. The detection results can be used instead of or in addition to the MVRs to determine the vector distances. Using the above-described selection criteria, the robotic system can select the detection result amongst a set of detection results, MVRs, or a combination thereof.

### Example Support Grasp Computation for Objects

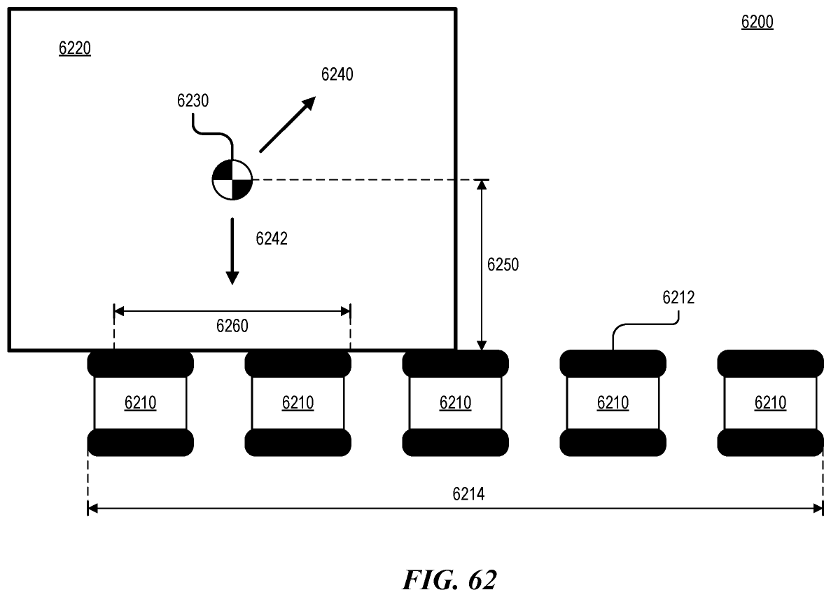

FIG. 62 is a front view of an environment for illustrating a support grasp computation for objects in accordance with one or more embodiments. Specifically, FIG. 62 illustrates a grip pose 6200 of an EOAT that enables a stable transfer of a target object 6220 from the container during one or more processes as described in the foregoing embodiments. The robotic system can compute a zero moment point range 6260 representative of one or more support locations (e.g., a horizontal range) on the vertical surface and/or the object depiction region where reactionary forces (e.g., lateral acceleration) on the target object 6220 may be balanced during or improved for transfer.

As shown in FIG. 62, the robotic system can determine a stable grip pose 6200 of the EOAT by ensuring the range of gripping elements 6214 of the EOAT sufficiently overlaps the zero moment point range 6260 of the target object 6220. In other embodiments, the robotic system can determine a stable grip pose 6200 based on a measure of overlap between the zero moment point range 6260 and a suction cup array of the EOAT as discussed above with reference to FIG. 3.

As mentioned above, the zero moment point range 6260 represents a targeted portion of a width of an exposed surfaces of a target object 6220. For example, the zero moment point range 6260 can correspond to support locations where, when the location overlaps with the gripper locations, one or more reactionary forces (e.g., lateral acceleration, gravitational forces, friction, and/or the like) may be balanced, or have high likelihood of remaining balanced, during transfer of the target object 6220. The zero moment point range 6260 can be a range of valid support locations aligned to a bottom edge of the target object 6260 and centered at the horizontal location for the COM. In additional embodiments, the zero moment point range can be aligned to a range of gripping elements 6214 of the EOAT and/or a predetermined axis (e.g., horizontal axis).

The robotic system can calculate the zero moment point range 6260 of the target object 6220 based on various characteristics and/or features of the target object 6220. For example, the robotic system can use size, shape, length, height, weight, and/or the estimated (COM) 6230 of the object 6220 to estimate the one or more reactionary forces for potential movements according to one or more known external forces (e.g., gravitational force). For example, the zero moment point range 6260 of FIG. 62 is calculated based on a height measure 6250 of the target object 6220, a cumulative acceleration measure 6240 representative of total reactionary forces caused by the robotic system (e.g., a maximum acceleration or a known worst-case movement scenario), and a known gravitational acceleration 6242 acting on the COM 6230 of the target object 6220. With respect to FIG. 62, the cumulative acceleration measure 6240 can correspond to one or more acceleration forces caused by a rotation from the EOAT, a movement of an arm segment jointly connected to the EOAT, an acceleration of one or more conveyor belts 6212 contacting a bottom edge of the target object 6220, and/or any combination thereof.

In some embodiments, the cumulative acceleration measure 6240 can correspond to one or more reactionary forces of the robotic system that are not described with respect to FIG. 62. For example, the robotic system can use a suction cup array component of the EOAT to grip the vertical surface of the target object 6220 and exert a pulling force onto the object 6220 that contributes to the cumulative acceleration measure 6240. In additional or alternative embodiments, the zero moment point range 6260 can be further adjusted from the initial set of support locations calculated in the manner discussed above. For example, the robotic system can reduce the number of valid support locations from the initial zero moment point range 6260 (e.g., reducing length of the range) to restrict the number of valid grasp poses generated by the robotic system.

In other embodiments, the robotic system can use the zero moment point range 6260 to identify stable grasp poses for the EOAT to grip and transfer the target object 6220 from a container. For example, the robotic system can determine if a candidate grasp pose for the target object 6220 is stable based on an overlap measure between the zero moment point range 6260 and the range of gripping elements 6214 of the EOAT. With respect to FIG. 62, the robotic system can determine the overlap measure as a horizontal intersection between the zero moment point range 6260 and the range of gripping elements 6214 including one or more conveyor belt modules 6210. In other embodiments, the range of gripping elements 6214 can include an array of suction cups in the EOAT as discussed above.

Further, the robotic system can determine that the candidate grasp pose is a stable grasp pose based on the overlap measure being within an overlap threshold. In some embodiments, the overlap threshold can correspond to the entire zero moment point range 6260, and thus requiring candidate grasp poses to have complete overlap between the zero moment point range 6260 and the range of gripping elements 6214. In other embodiments, the overlap threshold can correspond to a proportion of the zero moment point range 6260, representing a minimum overlap range between the zero moment point range 6260 and the range of gripping elements 6214 for stable grasp poses. Additionally or alternatively, the robotic system can determine the stable grasp pose as (1) having at least one activated/grasping suction cup on opposites sides of the COM and within the zero moment point range 6260 and/or (2) maximizing the number of suction cups within the zero moment point range 6260.

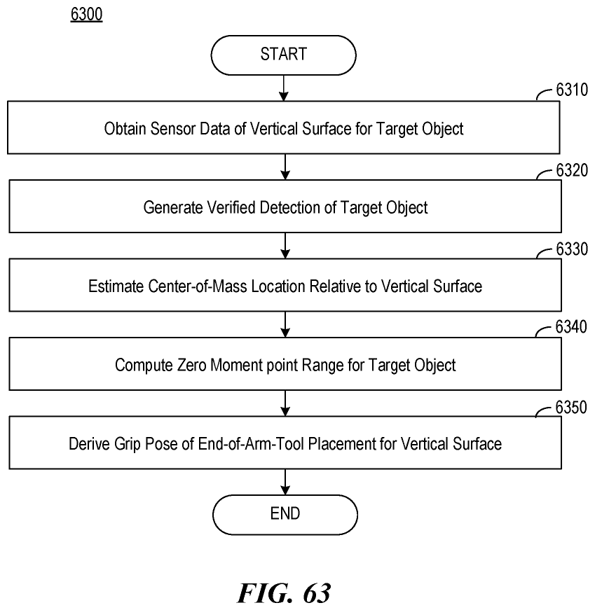

FIG. 63 is a flow diagram of a method for deriving stable grip poses for transporting objects in accordance with some embodiments of the present technology. The process can be implemented based on executing the instructions stored on one or more storage devices with one or more processors. The processors can control various components of a robotic system of the type discussed above to unload objects from a shipping unit (e.g., a shipping container, truck, and/or the like). For example, the processors can send commands, settings, and/or other communications that effectively control an end effector of the type discussed above, and other components of the robotic system.

Starting at block 6310, the method can include obtaining sensor data of objects (vertical surfaces) in container. The robotic system can obtain and process the sensor data as described above, such as by detecting objects, determining unrecognized regions, determining MVRs in the unrecognized regions, and so on. Further, at block 6320, the method can include generating the verified detection of the depicted objects. For example, the robotic system can generate the verified detection of recognized objects through matching image features and/or initial lift. Also, the robotic system can generate the verified detection of previously unrecognized object through the initial lift and second image data, as described above.

At block 6330, the robotic system can estimate a COM 6230 location of the target object based on the image data associated with the verified detection of the target object. For example, for previously unrecognized objects, the robotic system can select a midpoint (e.g., a middle portion across the width and/or the height) of the vertical surface corresponding to the target object as the estimate COM 6230. Also, the robotic system can use the torque/weight information obtained from the initial lift and the grip location relative to the verified edge to estimate the COM 6230.

For detected objects, the robotic system can estimate the COM based on predetermined information stored in the master data. In some embodiments, the robotics system can compare image features of the target object to image features of recorded objects stored in a master data to estimate the COM 6230. For example, the robotic system can match image features (e.g., corners, edges, size, shape) of the target object to one or more patterns of image features corresponding to recorded objects in the master data. As such, the robotic system can estimate the COM 6230 for the target object based on characteristics and/or features (e.g., size, geometry, weight) of recorded objects in the master data that are similar to the target object.

At block 6340, the robotic system can compute a zero moment point range 6260 for a stable grip and transfer of the target object. For example, the robotic system can determine the zero moment point range 6260 based on physical features (e.g., length, height, weight) of the target object, an acceleration measure representative of the total reactionary forces acting on the target object, and known external forces (e.g., gravitational acceleration) acting on the target object. In some embodiments, the robotic system can determine the geometric features of the target object based on the image features (e.g., edges and/or surfaces) corresponding to the target object. In other embodiments, the robotic system can determine the acceleration measure based on one or more acceleration forces caused by a rotation from the EOAT, a movement of an arm segment jointly connected to the EOAT, an acceleration of one or more conveyor belts 6212 contacting a bottom edge of the target object 6220, and/or any combination thereof. The acceleration measure can correspond to a maximum acceleration, a motion plan corresponding to the object, and/or a predetermined set of (e.g., worst-case) maneuvers for the robotic system. In additional embodiments, the robotic system can calculate the zero moment point range 6260 based on a predefined relationship between the geometric features, the acceleration measure, and the known external forces. For example, the robotic system can determine the zero moment point range 6260 as the value of (h*a)/(g−a), where h corresponds to a height measure of the target object, a corresponds to the acceleration measure, and g corresponds to a gravitational acceleration constant.

At block 6350, the robotic system can derive a stable grip pose for the EOAT to grip and transfer the target object from the container. For example, the robotic system can compute and/or adjust a grip pose and generate a motion plan for positioning the EOAT before the vertical surface of the target object such that the gripping elements of the EOAT are at least partially overlapping the zero moment point range 6260. In other words, the robotic system can identify a targeted set of suction cups for activation and compute a more detailed position for each of the targeted set of suction cups relative to the targeted object. In some embodiments, the robotic system can validate a grip pose based on an overlap measure between the zero moment point range 6260 and the gripping elements of the EOAT exceeding a specified overlap threshold.

A person of ordinary skill in the art will appreciate that the above-described process for determining the zero moment point range 6260 enables the robotic system to pre-emptively determine stable grips and/or motion plans for the EOAT to handle objects during transfer from the container. Additionally, the above-described process for determining the zero moment point range 6260 provides numerous benefits including, but not limited to, a reduction of grip adjustments caused by an unstable initial grip, a consistent method for determining a stable grip, and extended durability of robotic system components. For example, an unstable grip of the target object can result in an imbalance of reactionary forces and an induced torque on the target object. As a result, the robotic system may strain the EOAT and/or other system components beyond safe operating thresholds to compensate for the imbalanced forces, resulting in significant degradation to system components over time. Thus, the robotic system can effectively extend the durability of system components by using the zero moment point range 6260 to consistently determine stable grips.

### Example Support Target Validation for Object Transfer Processes

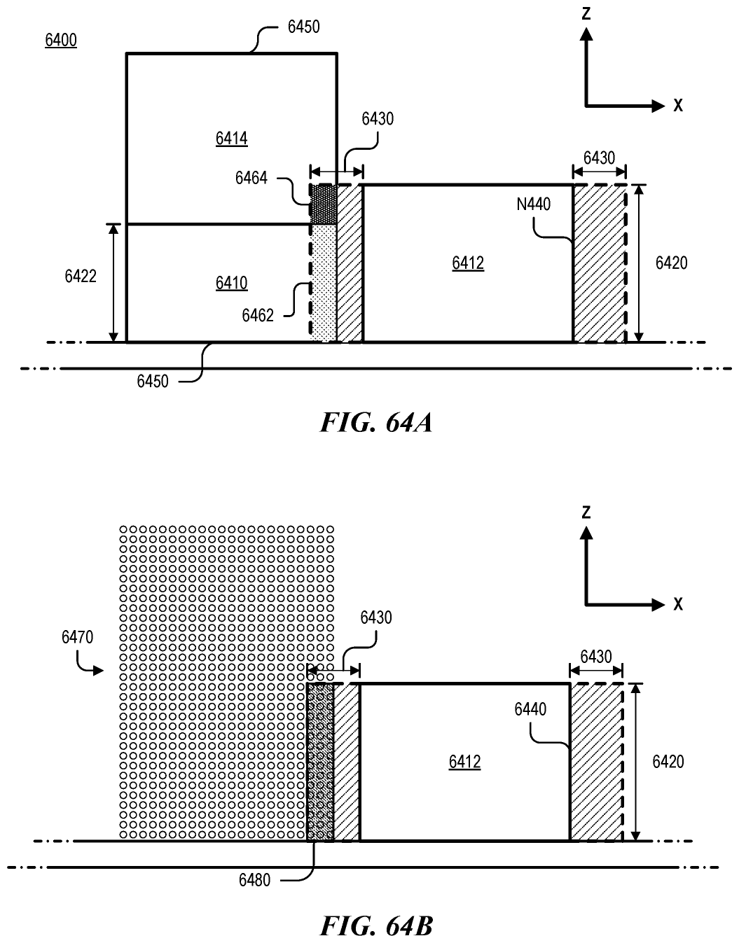

FIGS. 64A-B are example illustrations of support target validation for object transfer processes in accordance with one or more embodiments. In particular, FIGS. 64A-B illustrate example spatial environments of a target object selected for extraction from a container.

The robotic system can analyze the spatial environment, as depicted in the image data, and validate the selection of the target object based on one or more spatial clearance conditions. For example, the robotic system can generate a padded target surface representative of spatial clearance required to extract the target object from the container. The padded target surface can correspond to lateral and/or vertical extension(s) of the verified surface or dimensions of the targeted object. Further, the robotic system can identify one or more overlapping areas between the padded target surface and adjacent surfaces 6410, 6414 and/or point cloud data 6470 to determine potential obstructions for extracting the target object. In other words, the robotic system can extend the surface of the targeted object as a buffer that accounts for operational errors, control granularities, remaining portions of the EOAT, or a combination thereof. The robotic system can select the target object having the least or no overlap between the padded target surface and adjacent object(s).

FIG. 64A illustrates an example spatial environment corresponding to an overlap between a padded target surface and surfaces 6410, 6414 of adjacent objects 6450. FIG. 64B illustrates an example spatial environment corresponding to point clouds 6470 that overlap with a similar padded target surface of the target object as depicted in FIG. 64A.

Referring to FIGS. 64A and 64B together, the robotic system can derive the padded target surface based on a vertical surface 6412 of the target object and padded surface areas 6440 that extend laterally from the vertical surface 6412. In some embodiments, the lateral padded surface areas 6412 of the padded target surface can include a rectangular surface 6440 of a pad length 6430 and a height measure 6420 (e.g., predetermined measures/lengths and/or lengths corresponding to remaining width/height of the EOAT). With respect to FIG. 64A, the robotic system can use the height of the vertical surface 6412 as the height measure 6420 for the padded surface areas 6440. In other words, the robotic system can compute the buffer area as having the same height as the vertical surface as the corresponding object.

In some embodiments, the robotic system can use the padded target surface to identify nearby obstructions for extracting the target object from the container. For example, the robotic system can identify overlap regions 6462, 6464 of the padded surface areas 6440 corresponding to intersecting areas between the padded target surface and surfaces 6410, 6414 of adjacent objects 6450. In other embodiments, the robotic system can identify overlap regions 6480 when the padded surface areas 6440 intersects the point cloud data 6470, as depicted in FIG. 64B. As an illustrative example, the robotic system can analyze the overlap with the point cloud to avoid contacting/crushing objects (e.g., side portions thereof) that may be located closer/shallower relative to the chassis.

In additional embodiments, robotic system can determine surfaces 6410, 6414 of adjacent objects 6450 and/or point cloud data 6470 as potential obstructions to the target object when the overlap regions 6462, 6464, 6480 exceed a specified surface overlap threshold. In some embodiments, the overlap threshold can be proportional to a surface area of the vertical surface 6412 of the target object.

In some embodiments, the robotic system can apply a unique overlap threshold for each identified overlap region 6462, 6464, 6480 when determining potential obstructions to the target object. For example, the robotic system can apply lower overlap thresholds for overlap regions 6462, 6464, 6480 corresponding to higher base heights. With respect to FIG. 64A, the robotic system can apply a lower overlap threshold for the top overlap region 6464 and a higher overlap threshold for the bottom overlap region 6462, as the top overlap region 6464 corresponds to a higher base height 6422.

Using the validated spatial conditions, the robotic system can prioritize removal objects having greater clearance or separation from surrounding objects. As more objects are removed, the clearance for the remaining objects can increase. Effectively, the robotic system can use the validated spatial conditions to dynamically derive a removal sequence of the verified objects. Thus, the robotic system can decrease the likelihood of collisions with or disturbance of surrounding objects. The decreased collision and disturbance can further maintain the reliability of the first image data in iteratively processing and transferring objects in the unrecognized region. Moreover, in some embodiments, the robotic system can use the validated spatial condition to sequence the removal, thereby lessening the burden for the initial planning computation.

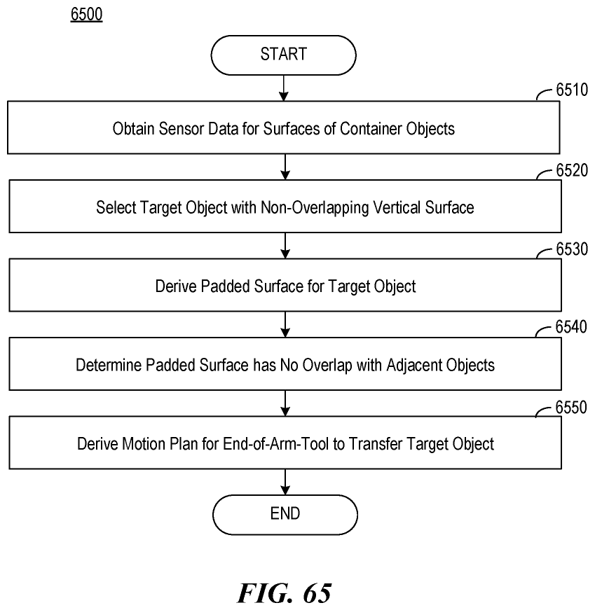

FIG. 65 is a flow diagram of a method for validating spatial conditions for picking up objects in accordance with some embodiments of the present technology. The method can be implemented based on executing the instructions stored on one or more storage devices with one or more processors. The processors can control various components of a robotic system of the type discussed above to unload objects from a shipping unit (e.g., a shipping container, truck, and/or the like). For example, the processors can send commands, settings, and/or other communications that effectively control an end effector and other components of the robotic system as described above.

Starting at block 6510, the robotic system can obtain image data for objects located within a container, similarly as described above. Additionally, the robotic system can obtain initial detection results and/or estimates for objects, such as using MVRs, as described above.

At block 6520, the robotic system can generate a verified detection of a target object. For detected objects, the robotic system can verify using additional features and/or initial lift. For previously unrecognized objects, the robotic system can verify based on the generated MVR and the initial lift as described above.

At block 6530, the robotic system can derive a padded target surface representative of a spatial clearance area for the target object as described above. For example, the robotic system can derive the padded target surface by extending the vertical surface of the target object laterally by a specified pad length 6430. In some embodiments, the robotic system can derive the pad length 6430 based on a lateral dimension of an EOAT component for gripping the target object. For example, the robotic system can determine the pad length 6430 based on a proportional measure of the lateral surface length of conveyor belts lining the EOAT. In additional embodiments, the robotic system can use the padded target surface as a targeted clearance gap between laterally adjacent objects to the target object. For example, the robotic system can identify an overlap region between the padded target surface and surfaces corresponding of adjacent objects.

At block 6540, the robotic system can determine that, in some cases, the padded target surface has no significant overlap with surfaces of adjacent objects. For example, the robotic system can determine that no portion or less than a threshold portion of the padded target surface intersects with a surface of an adjacent object. In some embodiments, the robotic system can determine that the size of overlap (e.g., surface area of overlap region) between padded target surface and adjacent objects is within a clearance threshold representative of a tolerable amount of overlap between the clearance area of the target object and adjacent objects. The robotic system can determine the clearance threshold based on a proportion of the padded target surface area and/or the vertical surface area of the target object.

In some embodiments, the robotic system can apply different clearance thresholds based on heights associated with the overlapping regions. For example, the robotic system can evaluate an elevated overlap region (e.g., elevated bottom edge of overlap region) of the padded target surface based on a smaller clearance threshold. A person having ordinary skill in the art will appreciate that applying variable clearance thresholds based on heights of overlap regions enables the robotic system to dynamically consider stability of higher elevated objects. For example, an elevated object that is adjacent to the target object can be partially supported by the target object. As such, the robotic system may need to be careful of handling target objects that can destabilize adjacent objects (e.g., higher elevated objects). Thus, the robotic system can perform a finer clearance evaluation for a target object by applying different clearance thresholds for overlap regions of varying heights.

At block 6550, the robotic system can derive a motion plan for moving and operating the EOAT to grasp and transfer the object. For example, upon determining that the padded target surface has no significant overlap with adjacent objects, the robotic system can generate a motion plan to position the EOAT before the vertical surface of the target object, grip onto the target object, and transfer the target object onto the EOAT.

### Example Support Real-Time Compensation for Object Transfer Processes

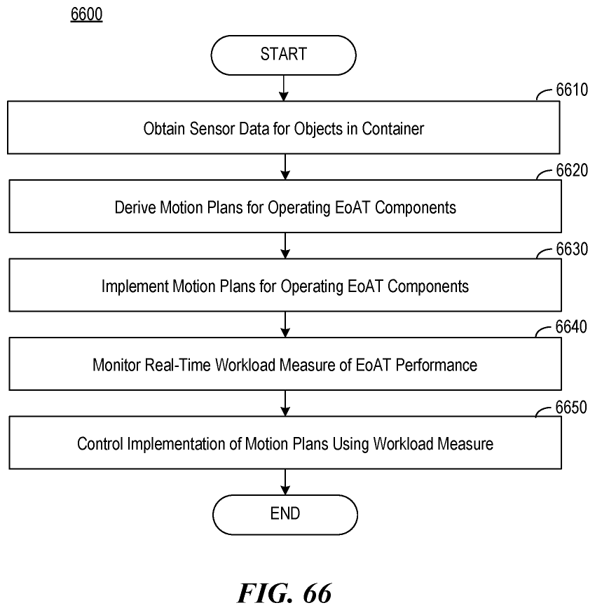

FIG. 66 is a flow diagram of a method for monitoring real-time performance for picking up objects in accordance with some embodiments of the present technology. The method can be implemented based on executing the instructions stored on one or more storage devices with one or more processors. The processors can control various components of a robotic system of the type discussed above to unload objects from a shipping unit (e.g., a shipping container, truck, and/or the like). For example, the processors can send commands, settings, and/or other communications that effectively control an end effector and other components of the robotic system described above.

Starting at block 6610, the robotic system can obtain image data for objects located within a container as described above. Additionally, the robotic system can obtain initial detection results and/or estimates for objects, such as using MVRs. Using the initial detection results and/or the MVRs, the robotic system can implement an initial lift and verify the object as described above. In response to the verified detection, the robotic system can select the unrecognized object as the target object.

At block 6620, the robotic system can derive motion plans for the EOAT and/or other components of the robotic system to transfer the target object from the container. For example, the robotic system can derive motion plans for operating the EOAT, a moveable segment attached to the EOAT, a set of conveyors lining a base surface of the EOAT, the chassis, and/or any combination thereof. The robotic system can derive a motion plan for the moveable segment to position the EOAT before a vertical surface of the target object and at the grip location. Further, the robotic system can derive a motion plan for the EOAT to extend an array of gripper elements (e.g., suction cups) to contact the vertical surface of the object at the grip location, grasp the vertical surface and transfer the target object onto the top surface/conveyor of the EOAT. Additionally, the robotic system can derive motion plans for the set of conveyors to transport the target object.

At block 6630, the robotic system can implement the derived motion plans for the EOAT and/or other components. Accordingly, the robotic system can generate and execute commands/settings corresponding to the motion plan to operate the corresponding components (e.g., actuators, motors, etc.) of the robotic system to grasp and transfer the target object from the container. For example, the robotic system can execute one or more of the above-described motion plans for the moveable segment, the EOAT, and the set of conveyors in a predetermined instruction sequence.

At block 6640, the robotic system can monitor a real-time workload measure of the EOAT and/or other components of the robotic system during transfer of the target object. Based on the real-time workload measure, the robotic system can control the real-time execution/operation of the components. For example, the robotic system can identify when the workload measure is approaching a performance capacity (e.g., a safety limit for a component of the robotic system) and take corrective actions.

The robotic system can monitor the real-time workload measure in a variety of ways. In some implementations, the robotic system can monitor a measure of heat generated by motors/actuators of the EOAT, and/or other components of the robotic system, and determine when the measured temperature reaches a heat limit. In another embodiment, the robotic system can monitor the weight and/or quantity of objects loaded on or lifted by the EOAT and/or other components of the robotic system. For example, the robotic system can monitor a weight measure exerted on the EOAT during transfer of the target object and determine when the weight measure exceeds a maximum weight capacity of the EOAT.

At block 6650, the robotic system can take corrective action and adjust the implementation of motion plans according to the workload measure. For example, the robotic system can determine that the workload measure (e.g., heat levels, weight of object) is exceeding, or will soon exceed, a corresponding performance capacity. In response to the determination, the robotic system can perform one or more corrective actions to adjust the implementation of motion plans. For example, the robotic system can pause the pickup motion of the EOAT in response to determining that a heat measure of one or more motors of the EOAT is exceeding safe thresholds. In other embodiments, the robotic system can modify the speed (e.g., increase intake speed) of the conveyor belts in response to determining that a weight measure of the target object exceeds a weight capacity for the EOAT.

### Examples

The present technology is illustrated, for example, according to various aspects described below. Various examples of aspects of the present technology are described as numbered examples (1, 2, 3, etc.) for convenience. These are provided as examples and do not limit the present technology. It is noted that any of the dependent examples can be combined in any suitable manner, and placed into a respective independent example. The other examples can be presented in a similar manner.

1. A method for operating a robotic system, the method comprising:
obtaining sensor data representative of an object at a start location; and
generating one or more commands for operating a robotic arm one or more segments and an End-of-Arm-Tool (EOAT) to transfer the object from the start location toward a target location along a set of conveyors that are over the EOAT and the one or more segments robotic arm, wherein generating the one or more commands includes:
positioning the EOAT to grip the object with one or more gripping elements, wherein the EOAT is positioned with its local conveyor at an incline to for pulling and lifting the gripped object during an initial portion of the transfer.

2. The method of one or more examples herein, one or more portions thereof, or a combination thereof, wherein the one or more commands are for operating one or more pivotable links of the EOAT, the one or more pivotable links operably coupled to the one or more gripping elements and configured to:
extend the one or more gripping elements toward the object,
grip the object using the extended one or more gripping elements,
rotatably retract the one or more pivotable link to raise the one or more gripping elements and the gripped object.

3. The method of one or more examples herein, including example 2, or one or more portions thereof, wherein the one or more commands are for operating the one or more pivotable links to move a bottom surface of the gripped object to contact a distal end portion of the EOAT, wherein the distal end portion supports the gripped object while it is moved completely onto the EOAT.

4. The method of one or more examples herein, including example 2, one or more portions thereof, or a combination thereof, wherein the one or more commands are for positioning the EOAT and operating the pivotable links to tilt the gripped object with a top portion of a gripped surface of the object rotating away from the EOAT and a vertical axis.

5. The method of one or more examples herein, including example 4, one or more portions thereof, or a combination thereof, wherein the one or more commands are for operating the EOAT to pull the object onto the local conveyor while maintaining a tilted pose of the gripped object for reducing a surface friction between the gripped object and a supporting object under and contacting the gripped object.

6. The method of one or more examples herein, one or more portions thereof, or a combination thereof, wherein:
the obtained sensor data represents one or more depictions of the object from a laterally-facing sensor;
the represented object is (1) within a cargo storage room or a container and (2) stacked on top of and/or adjacent to one or more objects that each have exposed surfaces within a threshold distance from each other and relative to the laterally-facing sensor; and
the one or more generated commands are for operating the one or more segments and the EOAT to remove the object out from the cargo storage room or the container and along a continuous path over the EOAT and the one or more segments.

7. A method of operating a robotic system that includes a chassis, at least one segment, and an End-of-Arm-Tool (EOAT) connected to each other and configured to transfer objects, the method comprising:
determining a receiving structure location for locating a structure configured to receive the transferred objects; and
generating one or more commands for operating the robotic system to maintain the chassis (1) above and/or overlapping the receiving structure and (2) within a threshold distance from the receiving structure.

8. The method of one or more examples herein, one or more portions thereof, or a combination thereof, further comprising:
obtaining sensor data representative of an object at a start location,
wherein the generated one or more commands are for operating a set of legs attached to the chassis and corresponding actuators to elevate and/or lower the chassis according to the obtained sensor data.

9. The method of one or more examples herein, one or more portions thereof, or a combination thereof, wherein:
the obtained sensor data represents the object (1) within a cargo storage room or a container and (2) stacked on top of and/or adjacent to one or more surrounding objects; and
the receiving structure location represents a location of a conveyor or a transportable container configured to receive and further transport the one or more objects removed from the cargo storage room or the container; and
wherein the generated one or more commands are for (1) positioning the EOAT to grip the object, (2) transferring the object along a path over the EOAT, the at least one segment, and the chassis, and (3) positioning the chassis relative to the receiving structure location for placing the object at the conveyor or the transportable container located away or opposite the EOAT and the at least one segment.

10. A method of operating a robotic system having a chassis, a forward segment, and an End-of-Arm-Tool (EOAT) connected to each other and configured to transfer objects, the method comprising:
determining a receiving structure location for locating a structure configured to receive the transferred objects;
computing an exit location representative of a rear segment attached to the chassis opposite the forward segment and the EOAT; and
generating one or more commands to operate the robotic system and position the chassis for (1) transferring the objects along a path along the EOAT, the forward segment, the chassis, and the rear segment and (2) position the chassis and/or the rear segment (e.g., by operating a corresponding actuator to change an angle between the chassis and the rear segment) to have the exit location overlapping the receiving structure location as the transferred objects move past the rear segment.

11. A method of operating a robotic system, the method comprising:
obtaining a first sensor data that includes a two-dimensional (2D) visual representation and/or a three-dimensional (3D) representation from a first sensor of multiple objects at a start location;
identifying an unrecognized region within the first sensor data, wherein the unrecognized region represents one or more vertical and adjacent object surfaces that are within threshold distances of each other;
computing a minimum viable region (MVR) within the unrecognized region, wherein the MVR estimates at least a portion of a continuous surface belonging to one object located in the unrecognized region;
deriving a target grip location within the MVR for operating an end-of-arm-tool (EOAT) of the robotic system to contact and grip the one object;
generating one or more initial lift commands for operating the EOAT to (1) grip at the one object at the target grip location and (2) perform an initial lift to separate the one object from a bottom supporting object and/or a laterally adjacent object;
obtaining a second sensor data from a second sensor location different from a capturing location of the first sensor data, wherein the second sensor data includes at least a 3D representation of a bottom edge of the one object separated from the bottom supporting object by the initial lift;
generating a verified detection of the one object based on the second sensor data, wherein the verified detection includes a verified bottom edge and/or a verified side edge of the one object; and
generating one or more transfer commands based on the verified detection for operating the robotic system to transfer the one object from the start location, over the EOAT and one or more subsequent segments toward an interfacing downstream robot or location.

12. The method of one or more examples herein, one or more portions thereof, or a combination thereof, further comprising:
computing one or more vertical hypotheses for a potential object location for the one object based on:
identifying from the first sensor data a reference vertical edge and/or a reference lateral edge,
deriving, from the first sensor data, one or more potential vertical edges and/or one or more potential lateral edges within the unrecognized region, wherein the one or more potential vertical edges are parallel to and/or opposite the reference vertical edge and the one or more potential lateral edges are parallel to and/or opposite the reference lateral edge, and
identifying a reference 3D corner based on the identified one or more potential vertical edges and/or one or more potential lateral edges, wherein the reference 3D corner represents a portion logically belonging to the one object, wherein the MVR is computed based on the one or more vertical hypotheses.

13. The method of one or more examples herein, including example 12, one or more portions thereof, or a combination thereof, wherein the first sensor data includes depth sensor data and the one or more potential vertical edges and/or the one or more potential lateral edges are identified by identifying gap features between respective objects within the unrecognized region.

14. The method of one or more examples herein, including example 12, one or more portions thereof, or a combination thereof, wherein:
the one or more potential lateral edges include a potential bottom edge of the one object,
the target grip location abuts or is within a threshold gripping distance from the potential bottom edge of the one object,
the verified bottom edge is lower than the potential bottom edge of the one object, and
the method further comprises adjusting the target grip location based on the verified bottom edge so that the adjusted target grip location abuts or is within a threshold gripping distance from the verified bottom edge of the one object.

15. The method of one or more examples herein, including example 11, one or more portions thereof, or a combination thereof, further comprising:
identifying a removed portion based on adjusting the MVR according to the verified detection, wherein the removed portion represents a portion of the unrecognized region that corresponds to the one object after the initial lift and the verification;
adjusting the unrecognized region based on reclassifying the removed portion of the unrecognized region as open space, wherein the adjusted unrecognized region is used to (1) identify a subsequent MVR corresponding to a subsequent object depicted in the adjusted unrecognized region and (2) transfer the subsequent object.

16. The method of one or more examples herein, including example 15, one or more portions thereof, or a combination thereof, wherein the subsequent object is positioned adjacent to the removed portion and the subsequent MVR is identified from the first sensor data without acquiring further data from the first sensor.

17. The method of one or more examples herein, including example 15, one or more portions thereof, or a combination thereof, further comprising:
determining that the unrecognized region within the first sensor data is less than a threshold area for identifying the subsequent MVR after the reclassification of the removed portion; and
in response to the determination, obtaining additional sensor data for identifying an additional unrecognized region such that the additional unrecognized region has sufficient area for identifying the subsequent MVR.

18. The method of one or more examples herein, including example 15, one or more portions thereof, or a combination thereof, further comprising adjusting the target grip location based on the verified detection for transferring the one object.

19. The method of one or more examples herein, including example 18, one or more portions thereof, or a combination thereof, wherein the target grip location is lower based on the verified detection.

20. The method of one or more examples herein, including example 19, one or more portions thereof, or a combination thereof, wherein the target grip location abuts or is within a threshold gripping distance from a verified bottom edge of the one object.

21. The method of one or more examples herein, including example 11, one or more portions thereof, or a combination thereof, further comprising:
determining that at least a portion of the unrecognized region corresponds to a rotated pose of a rectangle,
wherein the MVR is computed to have the rotated pose,
wherein the target grip location for the initial lift is based on a higher corner corresponding a hypothesized bottom edge, and
wherein the one or more verified transfer commands are for transferring the one object based on gripping relative to a lower corner corresponding to a verified bottom edge.

22. The method of one or more examples herein, including example 11, one or more portions thereof, or a combination thereof, wherein the first sensor data represents multiple objects stacked on top of each other located within a cargo space of a carrier vehicle.

23. The method of one or more examples herein, including example 11, one or more portions thereof, or a combination thereof, wherein the first sensor data represents side views of the one or more objects.

24. The method of one or more examples herein, including example 11, one or more portions thereof, or a combination thereof, wherein:
the first sensor data represents an outer image; and
the second sensor data represents an output of the second sensor closer to the one object than the first sensor and/or local to the EOAT.

25. The method of one or more examples herein, including example 11, one or more portions thereof, or a combination thereof, wherein the unrecognized region represents one or more vertical and adjacent surfaces having insufficient confidence levels of matching registered objects.

26. The method of one or more examples herein, including example 11, one or more portions thereof, or a combination thereof, wherein the unrecognized region is defined by a continuous boundary having four or more corners, wherein each corner is within a predetermined range of 90 degrees.

27. The method of one or more examples herein, including example 11, one or more portions thereof, or a combination thereof, wherein identifying the unrecognized region includes:
detecting 3D edges based on the 3D representation of the first sensor data;
identifying 3D corners based on intersection between the 3D edges;
identifying a bounded area based on detecting a set of the 3D edges and a set of the 3D corners forming a continuously enclosing boundary;
identifying the bounded area as the unrecognized region when the bounded area (1) includes more than four 3D corners, (2) includes a dimension exceeding a maximum dimension amongst expected objects registered in master data, (3) includes a dimension less than a minimum dimension amongst the expected objects, (4) has a shape different than a rectangle, or a combination thereof.

28. The method of one or more examples herein, including example 27, one or more portions thereof, or a combination thereof, wherein identifying the unrecognized region includes:
identifying one or more detected portions within the first sensor data, wherein each detected portion sufficiently matches one registered object within master data; and
identifying a bounded area within one or more remaining portions of the first sensor data outside of the one or more detected portions.

29. The method of one or more examples herein, including example 28, one or more portions thereof, or a combination thereof, further comprising:
detecting edges based on the first sensor data; and
identifying lateral edges and vertical edges from the detected edges, wherein the vertical edges (1) represent peripheral edges of and/or spacing between laterally adjacent surfaces and (2) correspond to higher certainties based on vertical orientations of the depicted objects and a lateral orientation of the first sensor.

30. The method of one or more examples herein, including example 11, one or more portions thereof, or a combination thereof, wherein generating the verified detection includes:
deriving, based on the second sensor data, a height and/or a width for the one object; and
matching the height and/or the width with respective heights and/or widths of registered objects to verify the detection of the one object.

31. The method of one or more examples herein, including example 11, one or more portions thereof, or a combination thereof, further comprising:
deriving an additional target grip location for an additional object within the unrecognized region; and
wherein generating the one or more initial lift commands includes determining an order for the EOAT to grip the one object and the additional object based on a relative position of the EOAT to the target grip location and the additional target grip location.
identifying 3D corners in the outline of the unrecognized region, wherein each of the 3D corners represent a portion uniquely corresponding to one associated object;
determining a current location of the EOAT; and
selecting one of the 3D corners closest to the current location, wherein the MVR is computed based on the selected 3D corner.

32. The method of one or more examples herein, including example 11, one or more portions thereof, or a combination thereof, further comprising:
deriving an additional target grip location for an additional object within the unrecognized region;
determining that the one object is an outermost object within the unrecognized region and the additional object is a central object within the unrecognized region; and
wherein generating the one or more initial lift commands includes determining that the one object is to be gripped by the EOAT before gripping the additional object.

33. A method for controlling a robotic system, the method comprising:
obtaining a first sensor data representative of one or more objects in a container;
determining that a portion of the first sensor data corresponds to an unrecognized region depicting features different from known characteristics of registered objects as stored in master data;
generating a verified detection of one object amongst the unrecognized objects based on a second sensor data that represents the one object after displacement thereof according to a hypothesis computed from the unrecognized region;
deriving one or more characteristics of the verified one object based on the second sensor data;
registering the one object by updating the master data to include the one or more characteristics of the verified one object; and
identifying a newly detected object based on comparing a remaining portion of the unrecognized region to the updated master data and identifying the one or more characteristics of the verified one object in the remaining portion.

34. The method of one or more examples herein, including example 33, one or more portions thereof, or a combination thereof, further comprising:
detecting a placement of the one object onto a base surface of an end-of-arm-tool; and
based on the detected placement, updating the unrecognized region by changing a portion thereof corresponding to the removed one object to represent empty space or a surface located at a farther depth than initially sensed,
wherein the updated unrecognized region and the changed portion are used to generate a subsequent verified detection of a subsequent object.

35. The method of one or more examples herein, including example 33, further comprising:
searching the master data for the one or more characteristics of the verified one object; and
in response to a failed search, adding a new record of the one object to the master data.

36. A method for controlling a robotic system, the method comprising:
a sensor data representative of objects in a container;
determining that a portion of the sensor data corresponds to an unrecognized region;
identifying a set of corners along a border of the unrecognized region;
determining, based on the set of corners, a set of minimum viable regions, wherein each minimum viable region is an axis-aligned bounded-box that uniquely corresponds to a corner from the set of corners;
retrieving a first location for an end-of-arm-tool of the robotic system;
determining a vector between the first location and each minimum viable region in the set of minimum viable regions,
selecting a target minimum viable region having (1) the corresponding vector amongst the set of minimum viable regions closest to a horizontal axis and/or (2) a highest bottom edge amongst the set of minimum viable regions;
computing, based on the target minimum viable region, a second location for the end-of-arm-tool; and
positioning the end-of-arm-tool from the first location to the second location for grasping and transferring an object corresponding to the target MVR.

37. The method of one or more examples herein, including example 36, one or more portions thereof, or a combination thereof, wherein the selected target minimum viable region is closest to the first location.

38. The method of one or more examples herein, including example 36, one or more portions thereof, or a combination thereof, wherein selecting the target minimum viable region includes:
determining a subset within the set of minimum viable regions that are within a distance threshold; and
selecting the target minimum viable region that is closest to the first location from within the subset.

39. The method of one or more examples herein, including example 36, one or more portions thereof, or a combination thereof, wherein selecting the target minimum viable region includes:
computing a separation distance along a lateral direction between a vertical edge of each MVR to an adjacent surface coplanar or within a threshold distance from a surface corresponding to the MVR,
wherein the target minimum viable region has a maximum value for the separation distance amongst those in the set of minimum viable regions.

40. The method of one or more examples herein, including example 36, one or more portions thereof, or a combination thereof, further comprising:
identifying one or more surfaces corresponding to shortest depth measures from the sensor data,
wherein the unrecognized region is determined from the one or more surfaces for detecting and transferring one or more corresponding objects closest to an entrance of the container.

41. A method for operating a robotic system having an end-of-arm-tool (EOAT), the method comprising:
obtaining a sensor data depicting a vertical surface of an object located inside of a container;
generating a verified detection result at least partially based on the sensor data, wherein the verified detection result corresponds to verifying that the vertical surface depicted in the sensor data belongs to the object;
estimating a center-of-mass (COM) location relative to the vertical surface based on the sensor data, the detection result, or both;
computing a zero moment point (ZMP) range for gripping and transferring the object,
   wherein the ZMP is computed at least based on one or more dimensions of the vertical surface and an acceleration associated with the transfer of the object, and
   wherein the ZMP range is centered around the CoM location and represents one or more supporting locations on the vertical surface or the object depiction region where reactionary forces on the object are balanced during the transfer; and
deriving a grip pose based on placing at least one gripping element of the EOAT partially or fully overlapping the ZMP range, wherein the grip pose is for placing the EOAT to grip the vertical surface of the object in transferring the object out of the container.

42. The method of one or more examples herein, including example 41, one or more portions thereof, or a combination thereof, wherein the ZMP range is computed based on a height of the CoM on the vertical surface, a maximum acceleration associated with the transfer of the object, and a predetermined reference acceleration.

43. The method of one or more examples herein, including example 42, one or more portions thereof, or a combination thereof, wherein the ZMP range is computed based on comparing (1) a product of the height and the maximum acceleration to (2) a difference between the predetermined reference acceleration and the maximum acceleration.

44. The one or more examples herein, including example 41, one or more portions thereof, or a combination thereof, wherein:
the object associated with the grip pose is a first object;
the method further comprising:
deriving a motion plan for operating the EOAT to (1) transfer the first object along conveyors that are over the EOAT and along a subsequently attached segment and (2) move the EOAT to grip a second object while the first object is transferred over the EOAT and/or the subsequent segment,
wherein the motion plan is for operating one or more of the conveyors according to an intake speed that is derived based on the grip pose.

45. The method of one or more examples herein, including example 44, one or more portions thereof, or a combination thereof, further comprising:
computing an overlap between the at least one gripping element and the ZMP range; and
deriving a motion plan based on the overlap, wherein the derived motion plan includes an acceleration for moving the EOAT while gripping the vertical surface according to the grip pose.

46. A method for operating a robotic system, the method comprising:
obtaining a sensor data representative of a set of surfaces of objects within a container;
selecting a target object based on the sensor data for grasping and transferring the target object out of the container, wherein selecting the target object includes determining that a portion of the sensor data corresponds to an exposed vertical surface of the target object without overlapping a horizontally adjacent object;
deriving a padded target surface by laterally extending the determined portion according to a predetermined length, wherein the predetermined length represents (1) a lateral dimension of an End-of-Arm-Tool (EOAT) gripping the object, (2) a targeted clearance gap between laterally adjacent objects, or a combination thereof;
determining that the padded target surface does not overlap the horizontally adjacent object; and
based on the determination, deriving a motion plan for moving and operating the EOAT to grasp and transfer the target object.

47. The method of one or more examples herein, including example 46, one or more portions thereof, or a combination thereof, wherein determining that the padded target surface does not overlap the horizontally adjacent object includes comparing the padded target surface to (1) other detected objects or unrecognized regions depicted in the sensor data, (2) depth measures of adjacent locations, or both.

48. The method of one or more examples herein, including example 46, one or more portions thereof, or a combination thereof, wherein:
selecting the target object includes deriving a minimum viable region (MVR) that directly corresponds to the exposed vertical surface without overlapping a horizontally adjacent object; and
the derived motion plan is for initially lifting the object to verify one or more edges thereof.

49. A method for operating a robotic system, the system comprising:
obtaining a sensor data representative of objects within a container;
deriving motion plans based on the sensor data for operating (1) a segment to maneuver an End-of-Arm-Tool (EOAT) attached thereto, (2) the EOAT to grasp and initially displace the objects, (3) a set of conveyors that are over the EOAT and the segment to receive and transfer the objects from the EOAT and out of the container;
implementing the motion plans for transferring the objects out of the container;
monitoring in real-time a workload measure representative of performance capacity of the EOAT, the segment, and/or the set of conveyors; and
controlling the implementation of the motion plans according to the monitored workload measure.

50. The method of one or more examples herein, including example 49, one or more portions thereof, or a combination thereof, wherein controlling the implementation of the motion plans includes (1) pausing a picking portion of a motion plan configured to grasp and initially displace a corresponding object while (2) operating the set of conveyors to transfer the object when the monitored workload measure exceeds the performance capacity.

51. The method of one or more examples herein, including example 49, one or more portions thereof, or a combination thereof, wherein controlling the implementation of the motion plans includes increasing a speed of an EOAT conveyor when the monitored workload measure exceeds the performance capacity.

52. The method of one or more examples herein, including example 49, one or more portions thereof, or a combination thereof, wherein the workload measure comprises a heat measure, a weight of an object, a quantity of objects, and/or any combination thereof.

53. A robotic system comprising:
at least one processor;
at least one memory including processor instructions that, when executed, causes the at least one processor to perform the method of one or more of examples 1-52, one or more portions thereof, or a combination thereof.

54. A non-transitory computer readable medium including processor instructions that, when executed by one or more processors, causes the one or more processors to perform the method of one or more of examples 1-52, one or more portions thereof, or a combination thereof.

### REMARKS

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc.

The description and drawings herein are illustrative and are not to be construed as limiting. Numerous specific details are described to provide a thorough understanding of the disclosure. However, in certain instances, well-known details are not described in order to avoid obscuring the description. Further, various modifications can be made without deviating from the scope of the embodiments.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms can be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. One will recognize that “memory” is one form of a “storage” and that the terms can on occasion be used interchangeably.

Consequently, alternative language and synonyms can be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the disclosure is not limited to various embodiments given in this specification.

The above Detailed Description of examples of the disclosed technology is not intended to be exhaustive or to limit the disclosed technology to the precise form disclosed above. While specific examples for the disclosed technology are described above for illustrative purposes, various equivalent modifications are possible within the scope of the disclosed technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples; alternative implementations may employ differing values or ranges.

These and other changes can be made to the disclosed technology in light of the above Detailed Description. While the Detailed Description describes certain examples of the disclosed technology as well as the best mode contemplated, the disclosed technology can be practiced in many ways, no matter how detailed the above description appears in text. Details of the system may vary considerably in its specific implementation, while still being encompassed by the technology disclosed herein. As noted above, particular terminology used when describing certain features or aspects of the disclosed technology should not be taken to imply that the terminology is being redefined herein to be restricted to any specific characteristics, features, or aspects of the disclosed technology with which that terminology is associated. Accordingly, the invention is not limited, except as by the appended claims. In general, the terms used in the following claims should not be construed to limit the disclosed technology to the specific examples disclosed in the specification, unless the above Detailed Description section explicitly defines such terms.

Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

We claim:

1. A method for operating a robotic system, the method comprising:
obtaining sensor data representative of an object at a start location; and
generating one or more commands for operating one or more segments and an End-of-Arm-Tool (EOAT) to transfer the object from the start location toward a target location along a set of frame conveyors that are over the EOAT and the one or more segments robotic arm, wherein generating the one or more commands includes:
positioning the EOAT to grip the object with one or more gripping elements, wherein the EOAT is positioned with the set of frame conveyors of the EOAT at an incline to for pulling and lifting the gripped object during an initial portion of the transfer.

2. The method of claim 1, wherein the one or more commands are for operating one or more pivotable links of the EOAT, the one or more pivotable links operably coupled to the one or more gripping elements and configured to:
position the one or more gripping elements in a first position toward the object,
grip the object using the extended one or more gripping elements,
rotatably retract the one or more pivotable link to a second position for raising the one or more gripping elements and the gripped object.

3. The method of claim 2, wherein the one or more commands are for operating the one or more pivotable links to move a bottom portion of the gripped object to contact a distal end portion of the EOAT, wherein the distal end portion supports the gripped object while it is moved onto the EOAT.

4. The method of claim 2, wherein the one or more commands are for positioning the EOAT and operating the pivotable links to tilt the gripped object with a top portion of a gripped surface of the object rotating away from the EOAT.

5. The method of claim 4, wherein the one or more commands are for operating the EOAT to pull the object onto the local conveyor while maintaining a tilted pose of the gripped object for reducing a surface friction between the gripped object and a supporting object under and contacting the gripped object.

6. The method of claim 1, wherein:
the obtained sensor data represents one or more depictions of the object from a laterally-facing sensor;
the represented object is (1) within a cargo storage room or a container and (2) stacked on top of and/or adjacent to one or more objects that each have exposed surfaces within a threshold distance from each other and relative to the laterally-facing sensor; and
the one or more generated commands are for operating the one or more segments and the EOAT to remove the object out from the cargo storage room or the container and along a continuous path over the EOAT and the one or more segments.

7. The method of claim 1, further comprising:
determining a receiving structure location for locating a structure configured to receive the transferred objects;
wherein the generated one or more commands are for (1) positioning the one or more segments about a chassis and for positioning the EOAT, (2) gripping the object, (3) transferring the object along the EOAT and the one or more segments, (4) maintain the chassis (a) above and/or overlapping the receiving structure and (b) within a threshold distance from the receiving structure.

8. The method of claim 1, further comprising:
determining a receiving structure location for locating a structure configured to receive the transferred objects;
wherein the generated one or more commands are for:
operating the one or more segments including at least (1) a forward segment connecting a chassis to the EOAT and (2) a rear segment attached to a chassis opposite the forward segment,
positioning the chassis to (1) transfer the objects along a path along the EOAT, the forward segment, the chassis, and the rear segment, and
positioning the chassis and/or the rear segment to have an end portion of the rear segment overlapping the receiving structure location as the transferred objects move past the rear segment.

9. A method for operating a robotic system, the method comprising:
obtaining a first sensor data from a first sensor, wherein the first sensor data includes a two-dimensional (2D) visual representation and/or a three-dimensional (3D) representation of multiple objects at a start location;
identifying an unrecognized region within the first sensor data, wherein the unrecognized region represents one or more vertically oriented object surfaces that are adjacent to each other and located within a threshold depth of each other;
computing a minimum viable region (MVR) within the unrecognized region, wherein the MVR estimates at least a portion of a continuous surface belonging to one object located in the unrecognized region;
deriving a target grip location within the MVR for an end-of-arm-tool (EOAT) of the robotic system to contact and grip the one object;
generating one or more initial displacement commands for operating the EOAT to (1) grip at the one object at the target grip location and (2) perform an initial displacement to separate the one object from a bottom supporting object and/or a laterally adjacent object;
obtaining a second sensor data from a second sensor location different from a capturing location of the first sensor data, wherein the second sensor data includes at least a representation of a bottom edge of the one object separated from the bottom supporting object by the initial displacement;
generating a verified detection of the one object based on the second sensor data, wherein the verified detection includes a verified bottom edge and/or a verified side edge of the one object; and
generating one or more transfer commands, based on the verified detection, for operating the robotic system to transfer the one object from the start location, over the EOAT and one or more subsequent segments.

10. The method of claim 9, further comprising:
computing one or more vertical hypotheses for a potential object location for the one object based on:
identifying from the first sensor data a reference vertical edge and/or a reference lateral edge,
deriving, from the first sensor data, one or more potential vertical edges and/or one or more potential lateral edges within the unrecognized region, wherein the one or more potential vertical edges are parallel to and/or opposite the reference vertical edge and the one or more potential lateral edges are parallel to and/or opposite the reference lateral edge, and
identifying a reference 3D corner based on the identified one or more potential vertical edges and/or one or more potential lateral edges, wherein the reference 3D corner represents a portion corresponding to the one object, wherein the MVR is computed based on the one or more vertical hypotheses.

11. The method of claim 9, further comprising:
adjusting the unrecognized region based on reclassifying a portion of the unrecognized region corresponding to the one object,
wherein the unrecognized region is adjusted after generating the one or more transfer commands, and
wherein the adjusted unrecognized region is used to (1) identify a subsequent MVR corresponding to a subsequent object depicted in the adjusted unrecognized region and (2) generate instructions for transferring the subsequent object.

12. The method of claim 9, further comprising:
determining that at least a portion of the unrecognized region corresponds to a rotated pose of a rectangle,
wherein the MVR is computed to have the rotated pose,
wherein the target grip location for the initial displacement is based on a higher corner corresponding a hypothesized bottom edge, and
wherein the one or more verified transfer commands are for transferring the one object based on gripping relative to a lower corner corresponding to a verified bottom edge.

13. The method of claim 9, wherein identifying the unrecognized region includes:
detecting 3D edges based on the 3D representation of the first sensor data;
identifying 3D corners based on intersection between the 3D edges;
identifying a bounded area based on detecting a set of the 3D edges and a set of the 3D corners forming a continuously enclosing boundary; and
identifying the bounded area as the unrecognized region when the bounded area (1) includes more than four 3D corners, (2) includes a dimension exceeding a maximum dimension amongst expected objects registered in master data, (3) includes a dimension less than a minimum dimension amongst the expected objects, (4) has a shape different than a rectangle, or a combination thereof.

14. The method of claim 9, further comprising:
identifying 3D corners in the unrecognized region, wherein each of the 3D corners represent a portion uniquely corresponding to one associated object;
determining a current location of the EOAT; and
wherein deriving the target grip location includes selecting the MVR corresponding with one of the 3D corners closest to the current location.

15. The method of claim 9, further comprising:
computing a height based on the verified bottom edge;
registering the one object by updating master data to include the height for the one object; and
identifying a newly detected object based on comparing a remaining portion of the unrecognized region to the updated master data and identifying bounded areas in the remaining portion that have the computed height.

16. The method of claim 9, further comprising:
estimating a center-of-mass (COM) location relative to the continuous surface represented through the verified detection;
computing a zero moment point (ZMP) range for gripping and transferring the object,
wherein the ZMP is computed at least based on one or more dimensions of the vertical surface and an acceleration associated with the transfer of the object, and
wherein the ZMP range is centered around the CoM location and represents one or more supporting locations on the vertical surface or the object depiction region where reactionary forces on the object are balanced during the transfer; and
deriving a grip pose based on placing at least one gripping element of the EOAT partially or fully overlapping the ZMP range, wherein the grip pose is for positioning the EOAT to grip the vertical surface of the object in transferring the object out of the container.

17. The method of claim 9, further comprising:
deriving a motion plan, based on the verified detection, for the operation of the robotic system to transfer the one object, wherein the one or more transfer commands are generated according to the motion plan;
monitoring in real-time a workload measure representative of performance capacity of the EOAT, the segment, and/or the set of conveyors; and
controlling the implementation of the motion plans according to the monitored workload measure.

18. A robotic system, comprising:
a chassis;
a segment rotatably connected to the chassis and configured, via segment actuators, to move relative to the chassis;
an end-of-arm tool (EOAT) rotatably connected to the segment and configured via EOAT actuators to move relative to the segment, wherein the EOAT includes movable and actuatable gripper interface configured to grasp vertical surfaces of objects;
a first sensor located between the EOAT and the chassis, wherein the first sensor is configured to obtain three-dimensional (3D) and/or two-dimensional (2D) depictions of space beyond the EOAT;
a second sensor located on the EOAT and configured to obtain at least depictions of sensed space below and/or beyond the EOAT;
a processor communicatively coupled to the segment actuators, the EOAT actuators, the first sensor, the second sensor, and the EOAT, wherein the processor is configured to (1) receive outputs from the first and second sensors and (2) generate instructions for the segment actuators, the EOAT actuators, and the EOAT.

19. The robotic system of claim 18, further comprising:
a memory communicatively coupled to the processor, the memory including instructions that, when executed by the processor, causes the processor to:
obtain a first sensor data from the first sensor, wherein the first sensor data is representative of multiple objects at a start location;
identify an unrecognized region within the first sensor data, wherein the unrecognized region represents one or more vertical and adjacent object surfaces that are within threshold distances of each other;
compute a minimum viable region (MVR) within the unrecognized region, wherein the MVR estimates at least a portion of a continuous surface belonging to one object located in the unrecognized region;
derive a target grip location within the MVR for operating the EOAT to contact and grip the one object;
generate one or more initial displacement commands for operating the EOAT to (1) grip at the one object at the target grip location and (2) perform an initial displacement to separate the one object from a bottom supporting object and/or a laterally adjacent object;
obtain a second sensor data from the second sensor, wherein the second sensor data includes at least a 3D representation of a bottom edge of the one object separated from the bottom supporting object by the initial displacement;
generate a verified detection of the one object based on the second sensor data, wherein the verified detection includes a verified bottom edge and/or a verified side edge of the one object; and
generate one or more transfer commands based on the verified detection for operating the EOAT, the segment, and the chassis to transfer the one object over and across the EOAT, the segment, and the chassis toward an interfacing downstream robot or location.

20. The robotic system of claim 18, wherein:
the EOAT has a side-profile shape of a wedge and includes a local conveyor on a top portion thereof; and
the generated one or more commands are for positioning the EOAT with its local conveyor at an incline to for pulling and lifting the gripped object during an initial portion of the transfer.
